(19) United States
(12) Patent Application Publication
(10) Pub. No.: US 2026/0101893 A1
(43) Pub. Date: Apr. 16, 2026

(54) FUNGICIDAL COMPOSITIONS

(71) Applicant: SYNGENTA CROP PROTECTION AG, Basel (CH)

(72) Inventor: David BEATTIE, Basel (CH)

(73) Assignee: SYNGENTA CROP PROTECTION AG, Basel (CH)

(21) Appl. No.: 19/115,350

(22) PCT Filed: Sep. 28, 2023
(86) PCT No.: PCT/EP2023/076887

§ 371 Date: Mar. 26, 2025

(30) Foreign Application Priority Data
Sep. 28, 2022 (GB) 2214203.8

(51) Int. Cl. A01N 37/10; A01N 25/04; A01N 25/14; A01N 37/34; A01N 43/56; A01N 43/653; A01N 47/26

(52) U.S. Cl. CPC A01N 37/10; A01N 25/04; A01N 25/14; A01N 37/34; A01N 43/56; A01N 43/653; A01N 47/26

(57) ABSTRACT

A fungicidal composition comprising a mixture of components (A), (B) and (C), wherein components (A), (B) and (C) are as defined in claim 1, and use of the compositions in agriculture or horticulture for controlling or preventing infestation of plants by phytopathogenic microorganisms, preferably fungi.

The present invention relates to novel fungicidal compositions, to their use in agriculture or horticulture for controlling diseases caused by phytopathogens, especially phytopathogenic fungi, and to methods of controlling diseases on useful plants.

Whilst many fungicidal compounds and compositions, belonging to various different chemical classes, have been/are being developed for use as fungicides in crops of useful plants, crop tolerance and activity against particular phytopathogenic fungi do not always satisfy the needs of agricultural practice in many respects. Therefore, there is a continuing need to find new compounds and compositions having superior biological properties for use in controlling or preventing infestation of plants by phytopathogenic fungi. For example, compounds possessing a greater biological activity, an advantageous spectrum of activity, an increased safety profile, improved physico-chemical properties, increased biodegradability. Or else, compositions possessing a broader spectrum of activity, improved crop tolerance, synergistic interactions or potentiating properties, or compositions which display a more rapid onset of action or which have longer lasting residual activity or which enable a reduction in the number of applications and/or a reduction in the application rate of the compounds and compositions required for effective control of a phytopathogen, thereby enabling beneficial resistance-management practices, reduced environmental impact and reduced operator exposure.

The use of compositions comprising mixtures of different fungicidal compounds possessing different modes of action can address some of these needs (eg, by combining fungicides with differing spectrums of activity).

According to the present invention, there is provided a fungicidal composition comprising a mixture of components (A), (B) and (C) as active ingredients, wherein component (A) is a compound selected from:
methyl (2)-2-(5-cyclobutyl-2-methyl-phenoxy)-3-methoxy-prop-2-enoate (compound X.01),
methyl (2)-2-(5-cyclopentyl-2-methyl-phenoxy)-3-methoxy-prop-2-enoate (compound X.02),
methyl (2)-2-(5-cyclopropyl-2-methyl-phenoxy)-3-methoxy-prop-2-enoate (compound X.03), or
methyl (2)-2-(5-cyclohexyl-2-methyl-phenoxy)-3-methoxy-prop-2-enoate (compound X.04);
   or an agronomically acceptable salt thereof;
   component (B) is a compound selected from the group consisting of:
   bixafen, acibenzolar, acibenzolar-S-methyl, copper sulfate, copper hydroxide, copper oxychloride, copper oxide, cyproconazole, difenoconazole, hexaconazole, prothioconazole, propiconazole, tebuconazole, epoxiconazole, fenpropidin, fenpropimorph, azoxystrobin, dimoxystrobin, trifloxystrobin, picoxystrobin, pyraclostrobin, mancozeb, chlorothalonil, fluazinam, fluxapyroxad, isopyrazam, sedaxane, boscalid, flufenoxadiazam, benzovindiflupyr, pydiflumetofen, isoflucypram, fluindapyr, inpyrfluxam, mefentrifluconazole, florylpicoxamid, metarylpicoxamid and metyltetraprole;
   and
   component (C) is a compound selected from the group consisting of:
   bixafen, fenpyrazamine, copper sulfate, copper hydroxide, triclopyricarb, acibenzolar, acibenzolar-S-methyl, copper oxychloride, copper oxide, azaconazole, bitertanol, bromuconazole, cyproconazole, difenoconazole, diniconazole, epoxiconazole, fenbuconazole, fluquinconazole, flusilazole, flutriafol, furametpyr, hexaconazole, imazalil, imibenconazole, ipconazole, metconazole, myclobutanil, pefurazoate, penconazole, prothioconazole, pyrifenox, prochloraz, propiconazole, pyrisoxazole, simeconazole, tebuconazole, tetraconazole, triadimefon, triadimenol, triflumizole, triticonazole, fenarimol, nuarimol, dodemorph, fenpropidin, fenpropimorph, spiroxamine, tridemorph, boscalid, carboxin, fenfuram, flutolanil, mepronil, oxycarboxin, penthiopyrad, thifluzamide, azoxystrobin, dimoxystrobin, fenaminstrobin, flufenoxystrobin, fluoxastrobin, kresoxim-methyl, metominostrobin, trifloxystrobin, orysastrobin, picoxystrobin, pyraclostrobin, pyrametostrobin, pyraoxystrobin, mancozeb, chlorothalonil, cyclobutrifluram, famoxadone, fenamidone, fluazinam, fluoxytioconazole, fluxapyroxad, fenhexamid, pyribencarb, triforine, isopyrazam, sedaxane, benzovindiflupyr, pydiflumetofen, isoflucypram, fluindapyr, mandestrobin, pyraziflumid, inpyrfluxam, mefentrifluconazole, ipfentrifluconazole, penflufen, florylpicoxamid, metarylpicoxamid, isofetamid, ethyl 1-[[4-[[2-(trifluoromethyl)-1,3-dioxolan-2-yl]methoxy]phenyl]methyl]pyrazole-3-carboxylate, ethyl 1-[[4-[(Z)-2-ethoxy-3,3,3-trifluoro-prop-1-enoxy]phenyl]methyl]pyrazole-3-carboxylate, methyl N-[[4-[1-(4-cyclopropyl-2,6-difluoro-phenyl)pyrazol-4-yl]-2-methyl-phenyl]methyl]carbamate, methyl N-[[4-[1-(2,6-difluoro-4-isopropyl-phenyl)pyrazol-4-yl]-2-methyl-phenyl]methyl]carbamate, fluopyram, flufenoxadiazam, metyltetraprole, enoxastrobin, coumoxystrobin, N′-[5-bromo-2-methyl-6-[(1S)-1-methyl-2-propoxy-ethoxy]-3-pyridyl]-N-ethyl-N-methyl-formamidine, N′-[5-bromo-2-methyl-6-[(1R)-1-methyl-2-propoxy-ethoxy]-3-pyridyl]-N-ethyl-N-methyl-formamidine, N′-[5-bromo-2-methyl-6-(1-methyl-2-propoxy-ethoxy)-3-pyridyl]-N-ethyl-N-methyl-formamidine, N′-[5-chloro-2-methyl-6-(1-methyl-2-propoxy-ethoxy)-3-pyridyl]-N-ethyl-N-methyl-formamidine, N′-[5-bromo-2-methyl-6-(1-methyl-2-propoxy-ethoxy)-3-pyridyl]-N-isopropyl-N-methyl-formamidine, N′-[5-bromo-2-methyl-6-(2-propoxypropoxy)-3-pyridyl]-N-ethyl-N-methyl-formamidine, N-isopropyl-N′-[5-methoxy-2-methyl-4-(2,2,2-trifluoro-1-hydroxy-1-phenyl-ethyl)phenyl]-N-methyl-formamidine, N′-[4-(1-cyclopropyl-2,2,2-trifluoro-1-hydroxy-ethyl)-5-methoxy-2-methyl-phenyl]-N-isopropyl-N-methyl-formamidine, N-ethyl-N′-[5-methoxy-2-methyl-4-[(2-trifluoromethyl)oxetan-2-yl]phenyl]-N-methyl-formamidine, N-ethyl-N′-[5-methoxy-2-methyl-4-[(2-trifluoromethyl)tetrahydrofuran-2-yl]phenyl]-N-methyl-formamidine, N-[(1R)-1-benzyl-3-chloro-1-methyl-but-3-enyl]-8-fluoro-quinoline-3-carboxamide, N-[(1S)-1-benzyl-3-chloro-1-methyl-but-3-enyl]-8-fluoro-quinoline-3-carboxamide, N-[(1R)-1-benzyl-3,3,3-trifluoro-1-methyl-propyl]-8-fluoro-quinoline-3-carboxamide, N-[(1S)-1-benzyl-3,3,3-trifluoro-1-methyl-propyl]-8-fluoro-quinoline-3-carboxamide, N-[(1R)-1-benzyl-1,3-dimethyl-butyl]-7,8-difluoro-quinoline-3-carboxamide, N-[(1S)-1-benzyl-1,3-dimethyl-butyl]-7,8-difluoro-quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluorophenyl)methyl]-1,3-dimethyl-butyl]quinoline-3-carboxamide, N-[(1R)-1-benzyl-1,3-dimethyl-butyl]-8-fluoro-quinoline-3-carboxamide, N-[(1S)-1-benzyl-1,3-dimethyl-butyl]-8-fluoro-quinoline-3-carboxamide,
   N-((1R)-1-benzyl-3-chloro-1-methyl-but-3-enyl)-8-fluoro-quinoline-3-carboxamide, N-((1S)-1-benzyl-3-chloro-1-methyl-but-3-enyl)-8-fluoro-quinoline-3-carboxamide, 1-(6,7-dimethylpyrazolo[1,5-a]pyridin-3-yl)-4,4,5-trifluoro-3,3-dimethyl-isoquinoline, 1-(6,7-dimethylpyrazolo[1,5-a]pyridin-3-yl)-4,4,6-trifluoro-3,3-dimethyl-isoquinoline, 4,4-difluoro-3,3-dimethyl-1-(6-methylpyrazolo[1,5-a]pyridin-3-yl)isoquinoline, 4,4-difluoro-3,3-dimethyl-1-(7-methylpyrazolo[1,5-a]pyridin-3-yl)isoquinoline, 1-(6-chloro-7-methyl-pyrazolo[1,5-a]pyridin-3-yl)-4,4-difluoro-3,3-dimethyl-isoquinoline, 1-(4,5-dimethylbenzimidazol-1-yl)-4,4,5-trifluoro-3,3-dimethyl-isoquinoline, 1-(4,5-dimethylbenzimidazol-1-yl)-4,4-difluoro-3,3-dimethyl-isoquinoline, 6-chloro-4,4-difluoro-3,3-dimethyl-1-(4-methylbenzimidazol-1-yl)isoquinoline, 4,4-difluoro-1-(5-fluoro-4-methyl-benzimidazol-1-yl)-3,3-dimethyl-isoquinoline, 3-(4,4-difluoro-3,3-dimethyl-1-isoquinolyl)-7,8-dihydro-6H-cyclopenta[e]benzimidazole, 2-[6-(4-chlorophenoxy)-2-(trifluoromethyl)-3-pyridyl]-1-(1,2,4-triazol-1-yl)propan-2-ol, 2-[6-(4-bromophenoxy)-2-(trifluoromethyl)-3-pyridyl]-1-(1,2,4-triazol-1-yl)propan-2-ol, 3-[2-(1-chlorocyclopropyl)-3-(2-fluorophenyl)-2-hydroxy-propyl]imidazole-4-carbonitrile, 3-[2-(1-chlorocyclopropyl)-3-(3-chloro-2-fluoro-phenyl)-2-hydroxy-propyl]imidazole-4-carbonitrile, (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone, 2-oxo-N-propyl-2-[4-[5-(trifluoromethyl)-1,2,4-oxadiazol-3-yl]phenyl]acetamide, ethyl 1-[[5-[5-(trifluoromethyl)-1,2,4-oxadiazol-3-yl]-2-thienyl]methyl]pyrazole-4-carboxylate, 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide and N-[N-methoxy-C-methyl-carbonimidoyl]-4-[5-(trifluoromethyl)-1,2,4-oxadiazol-3-yl]benzamide.
   with the proviso that component (B) is different from component (C).

In general, the weight ratio of component (A) to the mixture of components (B) and (C) may preferably be from 100:1 to 1:100, from 50:1 to 1:50, from 20:1 to 1:50, from 15:1 to 1:50 from 15:1 to 1:30, from 12:1 to 1:25, from 10:1 to 1:20, from 5:1 and 1:15, from 3:1 to 1:10 or from 2:1 to 1:5. The skilled person will appreciate that weight ratios of component (B) and component (C) will vary depending on the choice of component (B) and component (C) and the chemical class of these compounds.

Further according to the invention, there is provided a method of controlling or preventing phytopathogenic diseases, especially phytopathogenic fungi, on useful plants or on propagation material thereof, which comprises applying to the useful plants, the locus thereof or propagation material thereof a fungicidal composition according to the invention.

The benefits provided by certain fungicidal mixture compositions according to the invention may also include, inter alia, advantageous levels of biological activity for protecting plants against diseases that are caused by fungi or superior properties for use as agrochemical active ingredients (for example, greater biological activity, an advantageous spectrum of activity, an increased safety profile, improved physico-chemical properties, or increased biodegradability).

The compounds of components (A), (B) and (C) as described herein may exist as E and/or Z isomers. This invention covers all compositions comprising such isomers and mixtures thereof in all proportions.

TABLE X
Compounds Representing Component (A)

| Compound | | |
|---|---|---|
| number | Compound structure | IUPAC name |
| X.01 | 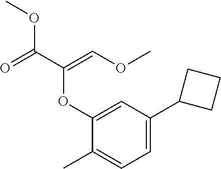 [SMILES: CO/C=C(\Oc1cc(C2CCC2)ccc1C)C(=O)OC] | methyl (Z)-2-(5-cyclobutyl-2-methyl- phenoxy)-3-methoxy-prop-2-enoate |
| X.02 | 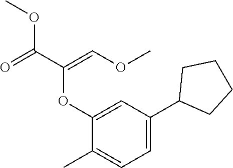 [SMILES: CO/C=C(\Oc1cc(C2CCCC2)ccc1C)C(=O)OC] | methyl (Z)-2-(5-cyclopentyl-2-methyl- phenoxy)-3-methoxy-prop-2-enoate |
| X.03 | 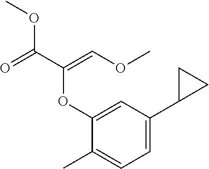 [SMILES: CO/C=C(\Oc1cc(C2CC2)ccc1C)C(=O)OC] | methyl (Z)-2-(5-cyclopropyl-2-methyl- phenoxy)-3-methoxy-prop-2-enoate |
| X.04 | 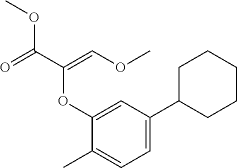 [SMILES: CO/C=C(\Oc1cc(C2CCCCC2)ccc1C)C(=O)OC] | methyl (Z)-2-(5-cyclohexyl-2-methyl- phenoxy)-3-methoxy-prop-2-enoate |

In each case, the compounds of component (A), component (B) and component (C) in a composition according to the invention are in free form, in covalently hydrated form, or in salt form, e.g., an agronomically usable or agrochemically acceptable salt form.

Particularly preferred embodiments of the invention are as set out below.

In one embodiment, (A) is compound methyl (Z)-2-(5-cyclobutyl-2-methyl-phenoxy)-3-methoxy-prop-2-enoate (compound X.01) as defined in table X above.

In one embodiment (A) is compound methyl (Z)-2-(5-cyclopentyl-2-methyl-phenoxy)-3-methoxy-prop-2-enoate (compound X.02) as defined in table X above.

In one embodiment (A) is compound methyl (Z)-2-(5-cyclopropyl-2-methyl-phenoxy)-3-methoxy-prop-2-enoate (compound X.03) as defined in table X above.

In one embodiment (A) is compound methyl (Z)-2-(5-cyclohexyl-2-methyl-phenoxy)-3-methoxy-prop-2-enoate (compound X.04) as defined in table X above.

Methods of preparing compounds X.01, X.02, X.03 and X.04 are known and disclosed in WO2020/193387 and WO2021/176057.

Preferably, component (B) is a compound selected from the group consisting of cyproconazole, difenoconazole, hexaconazole, prothioconazole, propiconazole, tebuconazole, epoxiconazole, fenpropidin, fenpropimorph, mancozeb, chlorothalonil, fluazinam, fluxapyroxad, isopyrazam, flufenoxadiazam, benzovindiflupyr, pydiflumetofen, isoflucypram, fluindapyr, inpyrfluxam, mefentrifluconazole, florylpicoxamid, metarylpicoxamid and metyltetraprole. More preferably component (B) is a compound selected from the group consisting of cyproconazole, difenoconazole, hexaconazole, prothioconazole, tebuconazole, fenpropidin, mancozeb, chlorothalonil, benzovindiflupyr and pydiflumetofen. Even more preferably component (B) is a compound selected from the group consisting of difenoconazole, prothioconazole, tebuconazole, fenpropidin and chlorothalonil. Yet even more preferably, component (B) is the compound difenoconazole or prothioconazole.

In one embodiment component (B) is prothioconazole.

In another embodiment component (B) is fenpropidin.

In another embodiment component (B) is difenoconazole.

In another embodiment component (B) is mancozeb.

In another embodiment component (B) is chlorothalonil.

Preferably, component (C) is a compound selected from the group consisting of bixafen, copper sulfate, copper hydroxide, acibenzolar, acibenzolar-S-methyl, copper oxychloride, copper oxide, cyproconazole, difenoconazole, diniconazole, epoxiconazole, fenbuconazole, fluquinconazole, hexaconazole, imibenconazole, ipconazole, metconazole, penconazole, prothioconazole, propiconazole, pyrisoxazole, simeconazole, tebuconazole, tetraconazole, triticonazole, fenpropidin, fenpropimorph, boscalid, azoxystrobin, dimoxystrobin, trifloxystrobin, picoxystrobin, pyraclostrobin, pyrametostrobin, pyraoxystrobin, mancozeb, chlorothalonil, fluazinam, fluxapyroxad, pyribencarb, isopyrazam, sedaxane, benzovindiflupyr, pydiflumetofen, isoflucypram, fluindapyr, inpyrfluxam, mefentrifluconazole, ipfentrifluconazole, florylpicoxamid, metarylpicoxamid, flufenoxadiazam, metyltetraprole, N-[(1R)-1-benzyl-3-chloro-1-methyl-but-3-enyl]-8-fluoro-quinoline-3-carboxamide, (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone, 2-oxo-N-propyl-2-[4-[5-(trifluoromethyl)-1,2,4-oxadiazol-3-yl]phenyl]acetamide, ethyl 1-[[5-[5-(trifluoromethyl)-1,2,4-oxadiazol-3-yl]-2-thienyl]methyl]pyrazole-4-carboxylate, 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide and N-[N-methoxy-C-methyl-carbonimidoyl]-4-[5-(trifluoromethyl)-1,2,4-oxadiazol-3-yl]benzamide. More preferably, component (C) is a compound selected from the group consisting of cyproconazole, difenoconazole, hexaconazole, prothioconazole, propiconazole, tebuconazole, epoxiconazole, fenpropidin, fenpropimorph, mancozeb, chlorothalonil, fluazinam, fluxapyroxad, isopyrazam, flufenoxadiazam, benzovindiflupyr, pydiflumetofen, isoflucypram, fluindapyr, inpyrfluxam, mefentrifluconazole, florylpicoxamid, metarylpicoxamid and metyltetraprole. Even more preferably, component (C) is a compound selected from the group consisting of cyproconazole, difenoconazole, hexaconazole, prothioconazole, tebuconazole, fenpropidin, mancozeb, chlorothalonil, benzovindiflupyr and pydiflumetofen.

In a preferred embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is a compound selected from the group consisting of cyproconazole, difenoconazole, hexaconazole, prothioconazole and tebuconazole; and

component (C) is a compound selected from the group consisting of cyproconazole, difenoconazole, hexaconazole, prothioconazole, tebuconazole, fenpropidin, mancozeb, chlorothalonil, benzovindiflupyr and pydiflumetofen, with the proviso that component (B) is different from component (C).

In another preferred embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is a compound selected from the group consisting of cyproconazole, difenoconazole, hexaconazole, prothioconazole and tebuconazole; and

component (C) is a compound selected from the group consisting of cyproconazole, difenoconazole, hexaconazole, prothioconazole, tebuconazole, fenpropidin, mancozeb, chlorothalonil, benzovindiflupyr and pydiflumetofen, with the proviso that component (B) is different from component (C).

In a more preferred embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound difenoconazole or prothioconazole; and

component (C) is a compound selected from the group consisting of cyproconazole, tebuconazole, fenpropidin, mancozeb, chlorothalonil, benzovindiflupyr and pydiflumetofen.

In another more preferred embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound difenoconazole or prothioconazole; and

component (C) is a compound selected from the group consisting of cyproconazole, tebuconazole, fenpropidin, mancozeb, chlorothalonil, benzovindiflupyr and pydiflumetofen.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound tebuconazole; and

component (C) is the compound prothioconazole (M2.003 disclosed in table M2 below). Preferably, the weight ratio of components (A) to (B) to (C) is from 1:30:30 to 3:2:2, more preferably from 1:6:6 to 3:2:2 and even more preferably from 3:10:10 to 5:6:6, most preferably 1:2:2.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound tebuconazole;

and component (C) is the compound mancozeb (M2.007 disclosed in table M2 below). Preferably, the weight ratio of components (A) to (B) to (C) is from 1:50:1000 to 6:4:45, more preferably from 2:12:135 to 6:4:45 and even more preferably from 6:20:225 to 10:12:135, most preferably 2:4:45.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound tebuconazole; and

component (C) is the compound difenoconazole (M2.024 disclosed in table M2 below). Preferably, the weight ratio of components (A) to (B) to (C) is from 1:30:30 to 6:4:3, more preferably from 2:12:9 to 6:4:3 and even more preferably from 6:20:15 to 10:12:9, most preferably 2:4:3.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound benzovindiflupyr; and

component (C) is the compound prothioconazole (M3.002 disclosed in table M3 below). Preferably, the weight ratio of components (A) to (B) to (C) is from 1:30:30 to 3:1:2, more preferably from 1:3:6 to 3:1:2 and even more preferably from 3:5:10 to 5:3:6, most preferably 1:1:2.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound benzovindiflupyr; and

component (C) is the compound difenoconazole (M3.023 disclosed in table M3 below). Preferably, the weight ratio of components (A) to (B) to (C) is from 1:30:30 to 6:2:3, more preferably from 2:6:9 to 6:2:3 and even more preferably from 6:10:15 to 10:6:9, most preferably 2:2:3.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound prothioconazole; and

component (C) is the compound mancozeb (M5.004 disclosed in table M5 below). Preferably, the weight ratio of components (A) to (B) to (C) is from 1:50:1000 to 6:4:45, more preferably from 2:12:135 to 6:4:45 and even more preferably from 6:20:225 to 10:12:135, most preferably 2:4:45.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound prothioconazole; and

component (C) is the compound difenoconazole (M5.021 disclosed in table M5 below). Preferably, the weight ratio of components (A) to (B) to (C) is from 1:30:30 to 6:4:3, more preferably from 2:12:9 to 6:4:3 and even more preferably from 6:20:15 to 10:12:9, most preferably 2:4:3.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound prothioconazole; and

component (C) is the compound chlorothalonil (M5.024 disclosed in table M5 below). Preferably, the weight ratio of components (A) to (B) to (C) is from 1:50:500 to 3:2:20, more preferably from 1:6:60 to 3:2:20 and even more preferably from 3:10:100 to 5:6:60, most preferably 1:2:20.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound prothioconazole; and

component (C) is the compound pydiflumetofen (M5.029 disclosed in table M5 below). Preferably, the weight ratio of components (A) to (B) to (C) is from 1:10:10 to 3:2:2, more preferably from 1:6:6 to 3:2:2 and even more preferably from 3:10:10 to 5:6:6, most preferably 1:2:2.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound mancozeb; and

component (C) is the compound difenoconazole (M9.017 disclosed in table M9 below). Preferably, the weight ratio of components (A) to (B) to (C) is from 1:1000:50 to 2:15:1, more preferably from 2:135:9 to 2:15:1 and even more preferably from 2:75:5 to 10:135:9, most preferably 2:45:3.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound difenoconazole; and

component (C) is the compound chlorothalonil (M26.003 disclosed in table M26 below). Preferably, the weight ratio of components (A) to (B) to (C) is from 1:50:500 to 6:3:40, more preferably from 2:9:120 to 6:3:40 and even more preferably from 6:15:200 to 10:9:120, most preferably 2:3:40.

In one embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is the compound difenoconazole; and

component (C) is the compound cyproconazole (M26.004 disclosed in table M26 below). Preferably, the weight ratio of components (A) to (B) to (C) is from 1:30:30 to 6:3:2, more preferably from 2:9:6 to 6:3:2 and even more preferably from 6:15:10 to 10:9:6, most preferably 2:3:2.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound tebuconazole; and

component (C) is the compound prothioconazole (M34.003 disclosed in table M34 below). Preferably, the weight ratio of components (A) to (B) to (C) is from 1:30:30 to 3:2:2, more preferably from 1:6:6 to 3:2:2 and even more preferably from 3:10:10 to 5:6:6, most preferably 1:2:2.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound tebuconazole; and

component (C) is the compound mancozeb (M34.007 disclosed in table M34 below). Preferably, the weight ratio of components (A) to (B) to (C) is from 1:50:1000 to 6:4:45, more preferably from 2:12:135 to 6:4:45 and even more preferably from 6:20:225 to 10:12:135, most preferably 2:4:45.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound tebuconazole; and

component (C) is the compound difenoconazole (M34.024 disclosed in table M34 below). Preferably, the weight ratio of components (A) to (B) to (C) is from 1:30:30 to 6:4:3, more preferably from 2:12:9 to 6:4:3 and even more preferably from 6:20:15 to 10:12:9, most preferably 2:4:3.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound benzovindiflupyr; and

component (C) is the compound prothioconazole (M35.002 disclosed in table M35 below). Preferably, the weight ratio of components (A) to (B) to (C) is from 1:30:30 to 3:1:2, more preferably from 1:3:6 to 3:1:2 and even more preferably from 3:5:10 to 5:3:6, most preferably 1:1:2.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound benzovindiflupyr; and

component (C) is the compound difenoconazole (M35.023 disclosed in table M35 below). Preferably, the weight ratio of components (A) to (B) to (C) is from 1:30:30 to 6:2:3, more preferably from 2:6:9 to 6:2:3 and even more preferably from 6:10:15 to 10:6:9, most preferably 2:2:3.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound prothioconazole; and

component (C) is the compound mancozeb (M37.004 disclosed in table M37 below). Preferably, the weight ratio of components (A) to (B) to (C) is from 1:50:1000 to 6:4:45, more preferably from 2:12:135 to 6:4:45 and even more preferably from 6:20:225 to 10:12:135, most preferably 2:4:45.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound prothioconazole; and

component (C) is the compound difenoconazole (M37.021 disclosed in table M37 below). Preferably, the weight ratio of components (A) to (B) to (C) is from 1:30:30 to 6:4:3, more preferably from 2:12:9 to 6:4:3 and even more preferably from 6:20:15 to 10:12:9, most preferably 2:4:3.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound prothioconazole; and

component (C) is the compound chlorothalonil (M37.024 disclosed in table M37 below). Preferably, the weight ratio of components (A) to (B) to (C) is from 1:50:500 to 3:2:20, more preferably from 1:6:60 to 3:2:20 and even more preferably from 3:10:100 to 5:6:60, most preferably 1:2:20.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound prothioconazole; and

component (C) is the compound pydiflumetofen (M37.029 disclosed in table M37 below). Preferably, the weight ratio of components (A) to (B) to (C) is from 1:10:10 to 3:2:2, more preferably from 1:6:6 to 3:2:2 and even more preferably from 3:10:10 to 5:6:6, most preferably 1:2:2.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound mancozeb; and

component (C) is the compound difenoconazole (M41.017 disclosed in table M41 below). Preferably, the weight ratio of components (A) to (B) to (C) is from 1:1000:50 to 2:15:1, more preferably from 2:135:9 to 2:15:1 and even more preferably from 2:75:5 to 10:135:9, most preferably 2:45:3.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound difenoconazole; and

component (C) is the compound chlorothalonil (M58.003 disclosed in table M58 below). Preferably, the weight ratio of components (A) to (B) to (C) is from 1:50:500 to 6:3:40, more preferably from 2:9:120 to 6:3:40 and even more preferably from 6:15:200 to 10:9:120, most preferably 2:3:40.

In one embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is the compound difenoconazole; and

component (C) is the compound cyproconazole (M58.004 disclosed in table M58 below). Preferably, the weight ratio of components (A) to (B) to (C) is from 1:30:30 to 6:3:2, more preferably from 2:9:6 to 6:3:2 and even more preferably from 6:15:10 to 10:9:6, most preferably 2:3:2.

In another embodiment of the invention there is provided a fungicidal composition comprising a mixture of components (A), (B) and (C) as active ingredients, wherein component (A) is the compound methyl (Z)-2-(5-cyclopentyl-2-methyl-phenoxy)-3-methoxy-prop-2-enoate (compound X.02), component (B) is a compound selected from the group consisting of difenoconazole, prothioconazole, tebuconazole, fenpropidin and chlorothalonil; and

component (C) is a compound selected from the group consisting of (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone, 2-oxo-N-propyl-2-[4-[5-(trifluoromethyl)-1,2,4-oxadiazol-3-yl]phenyl]acetamide, ethyl 1-[[5-[5-(trifluoromethyl)-1,2,4-oxadiazol-3-yl]-2-thienyl]methyl]pyrazole-4-carboxylate, 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide and N-[N-methoxy-C-methyl-carbonimidoyl]-4-[5-(trifluoromethyl)-1,2,4-oxadiazol-3-yl]benzamide. Preferably, in this embodiment component (B) is prothioconazole.

In another embodiment of the invention there is provided a fungicidal composition comprising a mixture of components (A), (B) and (C) as active ingredients, wherein component (A) is the compound methyl (Z)-2-(5-cyclohexyl-2-methyl-phenoxy)-3-methoxy-prop-2-enoate (compound X.04), component (B) is a compound selected from the group consisting of difenoconazole, prothioconazole, tebuconazole, fenpropidin and chlorothalonil; and

component (C) is a compound selected from the group consisting of (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone, 2-oxo-N-propyl-2-[4-[5-(trifluoromethyl)-1,2,4-oxadiazol-3-yl]phenyl]acetamide, ethyl 1-[[5-[5-(trifluoromethyl)-1,2,4-oxadiazol-3-yl]-2-thienyl]methyl]pyrazole-4-carboxylate, 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide and N-[N-methoxy-C-methyl-carbonimidoyl]-4-[5-(trifluoromethyl)-1,2,4-oxadiazol-3-yl]benzamide. Preferably, in this embodiment component (B) is prothioconazole.

The component (B) and (C) compounds are referred to herein and above by a so-called “ISO common name” or another “common name” being used in individual cases or a trademark name. The component (B) and (C) compounds are known and are commercially available and/or can be prepared using procedures known in the art and/or procedures reported in the literature.

In one embodiment preferred fungicidal compositions of the invention comprising a mixture of components (A), (B) and (C) are disclosed in Tables M1 to M64 below.

TABLE M1
Specific Fungicidal Compositions

| Mixture | A | B | C |
|---|---|---|---|
| M1.001 | X.02 | trifloxystrobin | tebuconazole |
| M1.002 | X.02 | trifloxystrobin | benzovindiflupyr |
| M1.003 | X.02 | trifloxystrobin | sedaxane |
| M1.004 | X.02 | trifloxystrobin | prothioconazole |
| M1.005 | X.02 | trifloxystrobin | pyraclostrobin |
| M1.006 | X.02 | trifloxystrobin | propiconazole |
| M1.007 | X.02 | trifloxystrobin | picoxystrobin |
| M1.008 | X.02 | trifloxystrobin | mancozeb |
| M1.009 | X.02 | trifloxystrobin | metyltetraprole |
| M1.010 | X.02 | trifloxystrobin | metarylpicoxamid |
| M1.011 | X.02 | trifloxystrobin | mefentrifluconazole |
| M1.012 | X.02 | trifloxystrobin | isopyrazam |
| M1.013 | X.02 | trifloxystrobin | isoflucypram |
| M1.014 | X.02 | trifloxystrobin | inpyrfluxam |
| M1.015 | X.02 | trifloxystrobin | hexaconazole |
| M1.016 | X.02 | trifloxystrobin | fluazinam |
| M1.017 | X.02 | trifloxystrobin | fluxapyroxad |
| M1.018 | X.02 | trifloxystrobin | fenpropimorph |
| M1.019 | X.02 | trifloxystrobin | fenpropidin |
| M1.020 | X.02 | trifloxystrobin | flufenoxadiazam |
| M1.021 | X.02 | trifloxystrobin | florylpicoxamid |
| M1.022 | X.02 | trifloxystrobin | fluindapyr |
| M1.023 | X.02 | trifloxystrobin | epoxiconazole |
| M1.024 | X.02 | trifloxystrobin | dimoxystrobin |
| M1.025 | X.02 | trifloxystrobin | difenoconazole |
| M1.026 | X.02 | trifloxystrobin | copper hydroxide |
| M1.027 | X.02 | trifloxystrobin | copper oxychloride |
| M1.028 | X.02 | trifloxystrobin | chlorothalonil |
| M1.029 | X.02 | trifloxystrobin | cyproconazole |
| M1.030 | X.02 | trifloxystrobin | boscalid |
| M1.031 | X.02 | trifloxystrobin | bixafen |
| M1.032 | X.02 | trifloxystrobin | azoxystrobin |
| M1.033 | X.02 | trifloxystrobin | pydiflumetofen |

TABLE M2
Specific Fungicidal Compositions

| Mixture | A | B | C |
|---|---|---|---|
| M2.001 | X.02 | tebuconazole | benzovindiflupyr |
| M2.002 | X.02 | tebuconazole | sedaxane |
| M2.003 | X.02 | tebuconazole | prothioconazole |
| M2.004 | X.02 | tebuconazole | pyraclostrobin |
| M2.005 | X.02 | tebuconazole | propiconazole |
| M2.006 | X.02 | tebuconazole | picoxystrobin |
| M2.007 | X.02 | tebuconazole | mancozeb |
| M2.008 | X.02 | tebuconazole | metyltetraprole |
| M2.009 | X.02 | tebuconazole | metarylpicoxamid |
| M2.010 | X.02 | tebuconazole | mefentrifluconazole |
| M2.011 | X.02 | tebuconazole | isopyrazam |
| M2.012 | X.02 | tebuconazole | isoflucypram |
| M2.013 | X.02 | tebuconazole | inpyrfluxam |
| M2.014 | X.02 | tebuconazole | hexaconazole |
| M2.015 | X.02 | tebuconazole | fluazinam |
| M2.016 | X.02 | tebuconazole | fluxapyroxad |
| M2.017 | X.02 | tebuconazole | fenpropimorph |
| M2.018 | X.02 | tebuconazole | fenpropidin |
| M2.019 | X.02 | tebuconazole | flufenoxadiazam |
| M2.020 | X.02 | tebuconazole | florylpicoxamid |
| M2.021 | X.02 | tebuconazole | fluindapyr |
| M2.022 | X.02 | tebuconazole | epoxiconazole |
| M2.023 | X.02 | tebuconazole | dimoxystrobin |
| M2.024 | X.02 | tebuconazole | difenoconazole |
| M2.025 | X.02 | tebuconazole | copper hydroxide |
| M2.026 | X.02 | tebuconazole | copper oxychloride |
| M2.027 | X.02 | tebuconazole | chlorothalonil |
| M2.028 | X.02 | tebuconazole | cyproconazole |
| M2.029 | X.02 | tebuconazole | boscalid |
| M2.030 | X.02 | tebuconazole | bixafen |
| M2.031 | X.02 | tebuconazole | azoxystrobin |
| M2.032 | X.02 | tebuconazole | pydiflumetofen |

TABLE M3
Specific Fungicidal Compositions

| Mixture | A | B | C |
|---|---|---|---|
| M3.001 | X.02 | benzovindiflupyr | sedaxane |
| M3.002 | X.02 | benzovindiflupyr | prothioconazole |
| M3.003 | X.02 | benzovindiflupyr | pyraclostrobin |
| M3.004 | X.02 | benzovindiflupyr | propiconazole |
| M3.005 | X.02 | benzovindiflupyr | picoxystrobin |
| M3.006 | X.02 | benzovindiflupyr | mancozeb |
| M3.007 | X.02 | benzovindiflupyr | metyltetraprole |
| M3.008 | X.02 | benzovindiflupyr | metarylpicoxamid |
| M3.009 | X.02 | benzovindiflupyr | mefentrifluconazole |
| M3.010 | X.02 | benzovindiflupyr | isopyrazam |
| M3.011 | X.02 | benzovindiflupyr | isoflucypram |
| M3.012 | X.02 | benzovindiflupyr | inpyrfluxam |
| M3.013 | X.02 | benzovindiflupyr | hexaconazole |
| M3.014 | X.02 | benzovindiflupyr | fluazinam |
| M3.015 | X.02 | benzovindiflupyr | fluxapyroxad |
| M3.016 | X.02 | benzovindiflupyr | fenpropimorph |
| M3.017 | X.02 | benzovindiflupyr | fenpropidin |
| M3.018 | X.02 | benzovindiflupyr | flufenoxadiazam |
| M3.019 | X.02 | benzovindiflupyr | florylpicoxamid |
| M3.020 | X.02 | benzovindiflupyr | fluindapyr |
| M3.021 | X.02 | benzovindiflupyr | epoxiconazole |
| M3.022 | X.02 | benzovindiflupyr | dimoxystrobin |
| M3.023 | X.02 | benzovindiflupyr | difenoconazole |
| M3.024 | X.02 | benzovindiflupyr | copper hydroxide |
| M3.025 | X.02 | benzovindiflupyr | copper oxychloride |
| M3.026 | X.02 | benzovindiflupyr | chlorothalonil |
| M3.027 | X.02 | benzovindiflupyr | cyproconazole |
| M3.028 | X.02 | benzovindiflupyr | boscalid |
| M3.029 | X.02 | benzovindiflupyr | bixafen |
| M3.030 | X.02 | benzovindiflupyr | azoxystrobin |
| M3.031 | X.02 | benzovindiflupyr | pydiflumetofen |

TABLE M4
Specific Fungicidal Compositions

| Mixture | A | B | C |
|---|---|---|---|
| M4.001 | X.02 | sedaxane | prothioconazole |
| M4.002 | X.02 | sedaxane | pyraclostrobin |
| M4.003 | X.02 | sedaxane | propiconazole |
| M4.004 | X.02 | sedaxane | picoxystrobin |
| M4.005 | X.02 | sedaxane | mancozeb |
| M4.006 | X.02 | sedaxane | metyltetraprole |
| M4.007 | X.02 | sedaxane | metarylpicoxamid |
| M4.008 | X.02 | sedaxane | mefentrifluconazole |
| M4.009 | X.02 | sedaxane | isopyrazam |
| M4.010 | X.02 | sedaxane | isoflucypram |
| M4.011 | X.02 | sedaxane | inpyrfluxam |
| M4.012 | X.02 | sedaxane | hexaconazole |
| M4.013 | X.02 | sedaxane | fluazinam |
| M4.014 | X.02 | sedaxane | fluxapyroxad |
| M4.015 | X.02 | sedaxane | fenpropimorph |
| M4.016 | X.02 | sedaxane | fenpropidin |
| M4.017 | X.02 | sedaxane | flufenoxadiazam |
| M4.018 | X.02 | sedaxane | florylpicoxamid |
| M4.019 | X.02 | sedaxane | fluindapyr |
| M4.020 | X.02 | sedaxane | epoxiconazole |
| M4.021 | X.02 | sedaxane | dimoxystrobin |
| M4.022 | X.02 | sedaxane | difenoconazole |
| M4.023 | X.02 | sedaxane | copper hydroxide |
| M4.024 | X.02 | sedaxane | copper oxychloride |
| M4.025 | X.02 | sedaxane | chlorothalonil |
| M4.026 | X.02 | sedaxane | cyproconazole |
| M4.027 | X.02 | sedaxane | boscalid |
| M4.028 | X.02 | sedaxane | bixafen |
| M4.029 | X.02 | sedaxane | azoxystrobin |
| M4.030 | X.02 | sedaxane | pydiflumetofen |

TABLE M5
Specific Fungicidal Compositions

| Mixture | A | B | C |
|---|---|---|---|
| M5.001 | X.02 | prothioconazole | pyraclostrobin |
| M5.002 | X.02 | prothioconazole | propiconazole |
| M5.003 | X.02 | prothioconazole | picoxystrobin |
| M5.004 | X.02 | prothioconazole | mancozeb |
| M5.005 | X.02 | prothioconazole | metyltetraprole |
| M5.006 | X.02 | prothioconazole | metarylpicoxamid |
| M5.007 | X.02 | prothioconazole | mefentrifluconazole |
| M5.008 | X.02 | prothioconazole | isopyrazam |
| M5.009 | X.02 | prothioconazole | isoflucypram |
| M5.010 | X.02 | prothioconazole | inpyrfluxam |
| M5.011 | X.02 | prothioconazole | hexaconazole |
| M5.012 | X.02 | prothioconazole | fluazinam |
| M5.013 | X.02 | prothioconazole | fluxapyroxad |
| M5.014 | X.02 | prothioconazole | fenpropimorph |
| M5.015 | X.02 | prothioconazole | fenpropidin |
| M5.016 | X.02 | prothioconazole | flufenoxadiazam |
| M5.017 | X.02 | prothioconazole | florylpicoxamid |
| M5.018 | X.02 | prothioconazole | fluindapyr |
| M5.019 | X.02 | prothioconazole | epoxiconazole |
| M5.020 | X.02 | prothioconazole | dimoxystrobin |
| M5.021 | X.02 | prothioconazole | difenoconazole |
| M5.022 | X.02 | prothioconazole | copper hydroxide |
| M5.023 | X.02 | prothioconazole | copper oxychloride |
| M5.024 | X.02 | prothioconazole | chlorothalonil |
| M5.025 | X.02 | prothioconazole | cyproconazole |
| M5.026 | X.02 | prothioconazole | boscalid |
| M5.027 | X.02 | prothioconazole | bixafen |
| M5.028 | X.02 | prothioconazole | azoxystrobin |
| M5.029 | X.02 | prothioconazole | pydiflumetofen |

TABLE M6
Specific Fungicidal Compositions

| Mixture | A | B | C |
|---|---|---|---|
| M6.001 | X.02 | pyraclostrobin | propiconazole |
| M6.002 | X.02 | pyraclostrobin | picoxystrobin |
| M6.003 | X.02 | pyraclostrobin | mancozeb |
| M6.004 | X.02 | pyraclostrobin | metyltetraprole |
| M6.005 | X.02 | pyraclostrobin | metarylpicoxamid |
| M6.006 | X.02 | pyraclostrobin | mefentrifluconazole |
| M6.007 | X.02 | pyraclostrobin | isopyrazam |
| M6.008 | X.02 | pyraclostrobin | isoflucypram |
| M6.009 | X.02 | pyraclostrobin | inpyrfluxam |
| M6.010 | X.02 | pyraclostrobin | hexaconazole |
| M6.011 | X.02 | pyraclostrobin | fluazinam |
| M6.012 | X.02 | pyraclostrobin | fluxapyroxad |
| M6.013 | X.02 | pyraclostrobin | fenpropimorph |
| M6.014 | X.02 | pyraclostrobin | fenpropidin |
| M6.015 | X.02 | pyraclostrobin | flufenoxadiazam |
| M6.016 | X.02 | pyraclostrobin | florylpicoxamid |
| M6.017 | X.02 | pyraclostrobin | fluindapyr |
| M6.018 | X.02 | pyraclostrobin | epoxiconazole |
| M6.019 | X.02 | pyraclostrobin | dimoxystrobin |
| M6.020 | X.02 | pyraclostrobin | difenoconazole |
| M6.021 | X.02 | pyraclostrobin | copper hydroxide |
| M6.022 | X.02 | pyraclostrobin | copper oxychloride |
| M6.023 | X.02 | pyraclostrobin | chlorothalonil |
| M6.024 | X.02 | pyraclostrobin | cyproconazole |
| M6.025 | X.02 | pyraclostrobin | boscalid |
| M6.026 | X.02 | pyraclostrobin | bixafen |
| M6.027 | X.02 | pyraclostrobin | azoxystrobin |
| M6.028 | X.02 | pyraclostrobin | pydiflumetofen |

TABLE M7
Specific Fungicidal Compositions

| Mixture | A | B | C |
|---|---|---|---|
| M7.001 | X.02 | propiconazole | picoxystrobin |
| M7.002 | X.02 | propiconazole | mancozeb |
| M7.003 | X.02 | propiconazole | metyltetraprole |
| M7.004 | X.02 | propiconazole | metarylpicoxamid |
| M7.005 | X.02 | propiconazole | mefentrifluconazole |
| M7.006 | X.02 | propiconazole | isopyrazam |
| M7.007 | X.02 | propiconazole | isoflucypram |
| M7.008 | X.02 | propiconazole | inpyrfluxam |
| M7.009 | X.02 | propiconazole | hexaconazole |
| M7.010 | X.02 | propiconazole | fluazinam |
| M7.011 | X.02 | propiconazole | fluxapyroxad |
| M7.012 | X.02 | propiconazole | fenpropimorph |
| M7.013 | X.02 | propiconazole | fenpropidin |
| M7.014 | X.02 | propiconazole | flufenoxadiazam |
| M7.015 | X.02 | propiconazole | florylpicoxamid |
| M7.016 | X.02 | propiconazole | fluindapyr |
| M7.017 | X.02 | propiconazole | epoxiconazole |
| M7.018 | X.02 | propiconazole | dimoxystrobin |
| M7.019 | X.02 | propiconazole | difenoconazole |
| M7.020 | X.02 | propiconazole | copper hydroxide |
| M7.021 | X.02 | propiconazole | copper oxychloride |
| M7.022 | X.02 | propiconazole | chlorothalonil |
| M7.023 | X.02 | propiconazole | cyproconazole |
| M7.024 | X.02 | propiconazole | boscalid |
| M7.025 | X.02 | propiconazole | bixafen |
| M7.026 | X.02 | propiconazole | azoxystrobin |
| M7.027 | X.02 | propiconazole | pydiflumetofen |

TABLE M8
Specific Fungicidal Compositions

| Mixture | A | B | C |
|---|---|---|---|
| M8.001 | X.02 | picoxystrobin | mancozeb |
| M8.002 | X.02 | picoxystrobin | metyltetraprole |
| M8.003 | X.02 | picoxystrobin | metarylpicoxamid |
| M8.004 | X.02 | picoxystrobin | mefentrifluconazole |
| M8.005 | X.02 | picoxystrobin | isopyrazam |
| M8.006 | X.02 | picoxystrobin | isoflucypram |
| M8.007 | X.02 | picoxystrobin | inpyrfluxam |
| M8.008 | X.02 | picoxystrobin | hexaconazole |
| M8.009 | X.02 | picoxystrobin | fluazinam |
| M8.010 | X.02 | picoxystrobin | fluxapyroxad |
| M8.011 | X.02 | picoxystrobin | fenpropimorph |
| M8.012 | X.02 | picoxystrobin | fenpropidin |
| M8.013 | X.02 | picoxystrobin | flufenoxadiazam |
| M8.014 | X.02 | picoxystrobin | florylpicoxamid |
| M8.015 | X.02 | picoxystrobin | fluindapyr |
| M8.016 | X.02 | picoxystrobin | epoxiconazole |
| M8.017 | X.02 | picoxystrobin | dimoxystrobin |
| M8.018 | X.02 | picoxystrobin | difenoconazole |
| M8.019 | X.02 | picoxystrobin | copper hydroxide |
| M8.020 | X.02 | picoxystrobin | copper oxychloride |
| M8.021 | X.02 | picoxystrobin | chlorothalonil |
| M8.022 | X.02 | picoxystrobin | cyproconazole |
| M8.023 | X.02 | picoxystrobin | boscalid |
| M8.024 | X.02 | picoxystrobin | bixafen |
| M8.025 | X.02 | picoxystrobin | azoxystrobin |
| M8.026 | X.02 | picoxystrobin | pydiflumetofen |

TABLE M9
Specific Fungicidal Compositions

| Mixture | A | B | C |
|---|---|---|---|
| M9.001 | X.02 | mancozeb | metyltetraprole |
| M9.002 | X.02 | mancozeb | metarylpicoxamid |
| M9.003 | X.02 | mancozeb | mefentrifluconazole |
| M9.004 | X.02 | mancozeb | isopyrazam |
| M9.005 | X.02 | mancozeb | isoflucypram |
| M9.006 | X.02 | mancozeb | inpyrfluxam |
| M9.007 | X.02 | mancozeb | hexaconazole |
| M9.008 | X.02 | mancozeb | fluazinam |
| M9.009 | X.02 | mancozeb | fluxapyroxad |
| M9.010 | X.02 | mancozeb | fenpropimorph |
| M9.011 | X.02 | mancozeb | fenpropidin |
| M9.012 | X.02 | mancozeb | flufenoxadiazam |
| M9.013 | X.02 | mancozeb | florylpicoxamid |
| M9.014 | X.02 | mancozeb | fluindapyr |
| M9.015 | X.02 | mancozeb | epoxiconazole |
| M9.016 | X.02 | mancozeb | dimoxystrobin |
| M9.017 | X.02 | mancozeb | difenoconazole |
| M9.018 | X.02 | mancozeb | copper hydroxide |
| M9.019 | X.02 | mancozeb | copper oxychloride |
| M9.020 | X.02 | mancozeb | chlorothalonil |
| M9.021 | X.02 | mancozeb | cyproconazole |
| M9.022 | X.02 | mancozeb | boscalid |
| M9.023 | X.02 | mancozeb | bixafen |
| M9.024 | X.02 | mancozeb | azoxystrobin |
| M9.025 | X.02 | mancozeb | pydiflumetofen |

TABLE M10
Specific Fungicidal Compositions

| Mixture | A | B | C |
|---|---|---|---|
| M10.001 | X.02 | metyltetraprole | metarylpicoxamid |
| M10.002 | X.02 | metyltetraprole | mefentrifluconazole |
| M10.003 | X.02 | metyltetraprole | isopyrazam |
| M10.004 | X.02 | metyltetraprole | isoflucypram |
| M10.005 | X.02 | metyltetraprole | inpyrfluxam |
| M10.006 | X.02 | metyltetraprole | hexaconazole |
| M10.007 | X.02 | metyltetraprole | fluazinam |
| M10.008 | X.02 | metyltetraprole | fluxapyroxad |
| M10.009 | X.02 | metyltetraprole | fenpropimorph |
| M10.010 | X.02 | metyltetraprole | fenpropidin |
| M10.011 | X.02 | metyltetraprole | flufenoxadiazam |
| M10.012 | X.02 | metyltetraprole | florylpicoxamid |
| M10.013 | X.02 | metyltetraprole | fluindapyr |
| M10.014 | X.02 | metyltetraprole | epoxiconazole |
| M10.015 | X.02 | metyltetraprole | dimoxystrobin |
| M10.016 | X.02 | metyltetraprole | difenoconazole |
| M10.017 | X.02 | metyltetraprole | copper hydroxide |
| M10.018 | X.02 | metyltetraprole | copper oxychloride |
| M10.019 | X.02 | metyltetraprole | chlorothalonil |
| M10.020 | X.02 | metyltetraprole | cyproconazole |
| M10.021 | X.02 | metyltetraprole | boscalid |
| M10.022 | X.02 | metyltetraprole | bixafen |
| M10.023 | X.02 | metyltetraprole | azoxystrobin |
| M10.024 | X.02 | metyltetraprole | pydiflumetofen |

TABLE M11
Specific Fungicidal Compositions

| Mixture | A | B | C |
|---|---|---|---|
| M11.001 | X.02 | metarylpicoxamid | mefentrifluconazole |
| M11.002 | X.02 | metarylpicoxamid | isopyrazam |
| M11.003 | X.02 | metarylpicoxamid | isoflucypram |
| M11.004 | X.02 | metarylpicoxamid | inpyrfluxam |
| M11.005 | X.02 | metarylpicoxamid | hexaconazole |
| M11.006 | X.02 | metarylpicoxamid | fluazinam |
| M11.007 | X.02 | metarylpicoxamid | fluxapyroxad |
| M11.008 | X.02 | metarylpicoxamid | fenpropimorph |
| M11.009 | X.02 | metarylpicoxamid | fenpropidin |
| M11.010 | X.02 | metarylpicoxamid | flufenoxadiazam |
| M11.011 | X.02 | metarylpicoxamid | florylpicoxamid |
| M11.012 | X.02 | metarylpicoxamid | fluindapyr |
| M11.013 | X.02 | metarylpicoxamid | epoxiconazole |
| M11.014 | X.02 | metarylpicoxamid | dimoxystrobin |
| M11.015 | X.02 | metarylpicoxamid | difenoconazole |
| M11.016 | X.02 | metarylpicoxamid | copper hydroxide |
| M11.017 | X.02 | metarylpicoxamid | copper oxychloride |
| M11.018 | X.02 | metarylpicoxamid | chlorothalonil |
| M11.019 | X.02 | metarylpicoxamid | cyproconazole |
| M11.020 | X.02 | metarylpicoxamid | boscalid |
| M11.021 | X.02 | metarylpicoxamid | bixafen |
| M11.022 | X.02 | metarylpicoxamid | azoxystrobin |
| M11.023 | X.02 | metarylpicoxamid | pydiflumetofen |

TABLE M12
Specific Fungicidal Compositions

| Mixture | A | B | C |
|---|---|---|---|
| M12.001 | X.02 | mefentrifluconazole | isopyrazam |
| M12.002 | X.02 | mefentrifluconazole | isoflucypram |
| M12.003 | X.02 | mefentrifluconazole | inpyrfluxam |
| M12.004 | X.02 | mefentrifluconazole | hexaconazole |
| M12.005 | X.02 | mefentrifluconazole | fluazinam |
| M12.006 | X.02 | mefentrifluconazole | fluxapyroxad |
| M12.007 | X.02 | mefentrifluconazole | fenpropimorph |
| M12.008 | X.02 | mefentrifluconazole | fenpropidin |
| M12.009 | X.02 | mefentrifluconazole | flufenoxadiazam |
| M12.010 | X.02 | mefentrifluconazole | florylpicoxamid |
| M12.011 | X.02 | mefentrifluconazole | fluindapyr |
| M12.012 | X.02 | mefentrifluconazole | epoxiconazole |
| M12.013 | X.02 | mefentrifluconazole | dimoxystrobin |
| M12.014 | X.02 | mefentrifluconazole | difenoconazole |
| M12.015 | X.02 | mefentrifluconazole | copper hydroxide |
| M12.016 | X.02 | mefentrifluconazole | copper oxychloride |
| M12.017 | X.02 | mefentrifluconazole | chlorothalonil |
| M12.018 | X.02 | mefentrifluconazole | cyproconazole |
| M12.019 | X.02 | mefentrifluconazole | boscalid |
| M12.020 | X.02 | mefentrifluconazole | bixafen |
| M12.021 | X.02 | mefentrifluconazole | azoxystrobin |
| M12.022 | X.02 | mefentrifluconazole | pydiflumetofen |

TABLE M13
Specific Fungicidal Compositions

| Mixture | A | B | C |
|---|---|---|---|
| M13.001 | X.02 | isopyrazam | isoflucypram |
| M13.002 | X.02 | isopyrazam | inpyrfluxam |
| M13.003 | X.02 | isopyrazam | hexaconazole |
| M13.004 | X.02 | isopyrazam | fluazinam |
| M13.005 | X.02 | isopyrazam | fluxapyroxad |
| M13.006 | X.02 | isopyrazam | fenpropimorph |
| M13.007 | X.02 | isopyrazam | fenpropidin |
| M13.008 | X.02 | isopyrazam | flufenoxadiazam |
| M13.009 | X.02 | isopyrazam | florylpicoxamid |
| M13.010 | X.02 | isopyrazam | fluindapyr |
| M13.011 | X.02 | isopyrazam | epoxiconazole |
| M13.012 | X.02 | isopyrazam | dimoxystrobin |
| M13.013 | X.02 | isopyrazam | difenoconazole |
| M13.014 | X.02 | isopyrazam | copper hydroxide |
| M13.015 | X.02 | isopyrazam | copper oxychloride |
| M13.016 | X.02 | isopyrazam | chlorothalonil |
| M13.017 | X.02 | isopyrazam | cyproconazole |
| M13.018 | X.02 | isopyrazam | boscalid |
| M13.019 | X.02 | isopyrazam | bixafen |
| M13.020 | X.02 | isopyrazam | azoxystrobin |
| M13.021 | X.02 | isopyrazam | pydiflumetofen |

TABLE M14
Specific Fungicidal Compositions

| Mixture | A | B | C |
|---|---|---|---|
| M14.001 | X.02 | isoflucypram | inpyrfluxam |
| M14.002 | X.02 | isoflucypram | hexaconazole |
| M14.003 | X.02 | isoflucypram | fluazinam |
| M14.004 | X.02 | isoflucypram | fluxapyroxad |
| M14.005 | X.02 | isoflucypram | fenpropimorph |
| M14.006 | X.02 | isoflucypram | fenpropidin |
| M14.007 | X.02 | isoflucypram | flufenoxadiazam |
| M14.008 | X.02 | isoflucypram | florylpicoxamid |
| M14.009 | X.02 | isoflucypram | fluindapyr |
| M14.010 | X.02 | isoflucypram | epoxiconazole |
| M14.011 | X.02 | isoflucypram | dimoxystrobin |
| M14.012 | X.02 | isoflucypram | difenoconazole |
| M14.013 | X.02 | isoflucypram | copper hydroxide |
| M14.014 | X.02 | isoflucypram | copper oxychloride |
| M14.015 | X.02 | isoflucypram | chlorothalonil |
| M14.016 | X.02 | isoflucypram | cyproconazole |
| M14.017 | X.02 | isoflucypram | boscalid |
| M14.018 | X.02 | isoflucypram | bixafen |
| M14.019 | X.02 | isoflucypram | azoxystrobin |
| M14.020 | X.02 | isoflucypram | pydiflumetofen |

TABLE M15
Specific Fungicidal Compositions

| Mixture | A | B | C |
|---|---|---|---|
| M15.001 | X.02 | inpyrfluxam | hexaconazole |
| M15.002 | X.02 | inpyrfluxam | fluazinam |
| M15.003 | X.02 | inpyrfluxam | fluxapyroxad |
| M15.004 | X.02 | inpyrfluxam | fenpropimorph |
| M15.005 | X.02 | inpyrfluxam | fenpropidin |
| M15.006 | X.02 | inpyrfluxam | flufenoxadiazam |
| M15.007 | X.02 | inpyrfluxam | florylpicoxamid |
| M15.008 | X.02 | inpyrfluxam | fluindapyr |
| M15.009 | X.02 | inpyrfluxam | epoxiconazole |
| M15.010 | X.02 | inpyrfluxam | dimoxystrobin |
| M15.011 | X.02 | inpyrfluxam | difenoconazole |
| M15.012 | X.02 | inpyrfluxam | copper hydroxide |
| M15.013 | X.02 | inpyrfluxam | copper oxychloride |
| M15.014 | X.02 | inpyrfluxam | chlorothalonil |
| M15.015 | X.02 | inpyrfluxam | cyproconazole |
| M15.016 | X.02 | inpyrfluxam | boscalid |
| M15.017 | X.02 | inpyrfluxam | bixafen |
| M15.018 | X.02 | inpyrfluxam | azoxystrobin |
| M15.019 | X.02 | inpyrfluxam | pydiflumetofen |

TABLE M16
Specific Fungicidal Compositions

| Mixture | A | B | C |
|---|---|---|---|
| M16.001 | X.02 | hexaconazole | fluazinam |
| M16.002 | X.02 | hexaconazole | fluxapyroxad |
| M16.003 | X.02 | hexaconazole | fenpropimorph |
| M16.004 | X.02 | hexaconazole | fenpropidin |
| M16.005 | X.02 | hexaconazole | flufenoxadiazam |
| M16.006 | X.02 | hexaconazole | florylpicoxamid |
| M16.007 | X.02 | hexaconazole | fluindapyr |
| M16.008 | X.02 | hexaconazole | epoxiconazole |
| M16.009 | X.02 | hexaconazole | dimoxystrobin |
| M16.010 | X.02 | hexaconazole | difenoconazole |
| M16.011 | X.02 | hexaconazole | copper hydroxide |
| M16.012 | X.02 | hexaconazole | copper oxychloride |
| M16.013 | X.02 | hexaconazole | chlorothalonil |
| M16.014 | X.02 | hexaconazole | cyproconazole |
| M16.015 | X.02 | hexaconazole | boscalid |
| M16.016 | X.02 | hexaconazole | bixafen |
| M16.017 | X.02 | hexaconazole | azoxystrobin |
| M16.018 | X.02 | hexaconazole | pydiflumetofen |

TABLE M17
Specific Fungicidal Compositions

| Mixture | A | B | C |
|---|---|---|---|
| M17.001 | X.02 | fluazinam | fluxapyroxad |
| M17.002 | X.02 | fluazinam | fenpropimorph |
| M17.003 | X.02 | fluazinam | fenpropidin |
| M17.004 | X.02 | fluazinam | flufenoxadiazam |
| M17.005 | X.02 | fluazinam | florylpicoxamid |
| M17.006 | X.02 | fluazinam | fluindapyr |
| M17.007 | X.02 | fluazinam | epoxiconazole |
| M17.008 | X.02 | fluazinam | dimoxystrobin |
| M17.009 | X.02 | fluazinam | difenoconazole |
| M17.010 | X.02 | fluazinam | copper hydroxide |
| M17.011 | X.02 | fluazinam | copper oxychloride |
| M17.012 | X.02 | fluazinam | chlorothalonil |
| M17.013 | X.02 | fluazinam | cyproconazole |
| M17.014 | X.02 | fluazinam | boscalid |
| M17.015 | X.02 | fluazinam | bixafen |
| M17.016 | X.02 | fluazinam | azoxystrobin |
| M17.017 | X.02 | fluazinam | pydiflumetofen |

TABLE M18
Specific Fungicidal Compositions

| Mixture | A | B | C |
|---|---|---|---|
| M18.001 | X.02 | fluxapyroxad | fenpropimorph |
| M18.002 | X.02 | fluxapyroxad | fenpropidin |
| M18.003 | X.02 | fluxapyroxad | flufenoxadiazam |
| M18.004 | X.02 | fluxapyroxad | florylpicoxamid |
| M18.005 | X.02 | fluxapyroxad | fluindapyr |
| M18.006 | X.02 | fluxapyroxad | epoxiconazole |
| M18.007 | X.02 | fluxapyroxad | dimoxystrobin |
| M18.008 | X.02 | fluxapyroxad | difenoconazole |
| M18.009 | X.02 | fluxapyroxad | copper hydroxide |
| M18.010 | X.02 | fluxapyroxad | copper oxychloride |
| M18.011 | X.02 | fluxapyroxad | chlorothalonil |
| M18.012 | X.02 | fluxapyroxad | cyproconazole |
| M18.013 | X.02 | fluxapyroxad | boscalid |
| M18.014 | X.02 | fluxapyroxad | bixafen |
| M18.015 | X.02 | fluxapyroxad | azoxystrobin |
| M18.016 | X.02 | fluxapyroxad | pydiflumetofen |

TABLE M19
Specific Fungicidal Compositions

| Mixture | A | B | C |
|---|---|---|---|
| M19.001 | X.02 | fenpropimorph | fenpropidin |
| M19.002 | X.02 | fenpropimorph | flufenoxadiazam |
| M19.003 | X.02 | fenpropimorph | florylpicoxamid |
| M19.004 | X.02 | fenpropimorph | fluindapyr |
| M19.005 | X.02 | fenpropimorph | epoxiconazole |
| M19.006 | X.02 | fenpropimorph | dimoxystrobin |
| M19.007 | X.02 | fenpropimorph | difenoconazole |
| M19.008 | X.02 | fenpropimorph | copper hydroxide |
| M19.009 | X.02 | fenpropimorph | copper oxychloride |
| M19.010 | X.02 | fenpropimorph | chlorothalonil |
| M19.011 | X.02 | fenpropimorph | cyproconazole |
| M19.012 | X.02 | fenpropimorph | boscalid |
| M19.013 | X.02 | fenpropimorph | bixafen |
| M19.014 | X.02 | fenpropimorph | azoxystrobin |
| M19.015 | X.02 | fenpropimorph | pydiflumetofen |

TABLE M20
Specific Fungicidal Compositions

| Mixture | A | B | C |
|---|---|---|---|
| M20.001 | X.02 | fenpropidin | flufenoxadiazam |
| M20.002 | X.02 | fenpropidin | florylpicoxamid |
| M20.003 | X.02 | fenpropidin | fluindapyr |
| M20.004 | X.02 | fenpropidin | epoxiconazole |
| M20.005 | X.02 | fenpropidin | dimoxystrobin |
| M20.006 | X.02 | fenpropidin | difenoconazole |
| M20.007 | X.02 | fenpropidin | copper hydroxide |
| M20.008 | X.02 | fenpropidin | copper oxychloride |
| M20.009 | X.02 | fenpropidin | chlorothalonil |
| M20.010 | X.02 | fenpropidin | cyproconazole |
| M20.011 | X.02 | fenpropidin | boscalid |
| M20.012 | X.02 | fenpropidin | bixafen |
| M20.013 | X.02 | fenpropidin | azoxystrobin |
| M20.014 | X.02 | fenpropidin | pydiflumetofen |

TABLE M21
Specific Fungicidal Compositions

| Mixture | A | B | C |
|---|---|---|---|
| M21.001 | X.02 | flufenoxadiazam | florylpicoxamid |
| M21.002 | X.02 | flufenoxadiazam | fluindapyr |
| M21.003 | X.02 | flufenoxadiazam | epoxiconazole |
| M21.004 | X.02 | flufenoxadiazam | dimoxystrobin |
| M21.005 | X.02 | flufenoxadiazam | difenoconazole |
| M21.006 | X.02 | flufenoxadiazam | copper hydroxide |
| M21.007 | X.02 | flufenoxadiazam | copper oxychloride |
| M21.008 | X.02 | flufenoxadiazam | chlorothalonil |
| M21.009 | X.02 | flufenoxadiazam | cyproconazole |
| M21.010 | X.02 | flufenoxadiazam | boscalid |
| M21.011 | X.02 | flufenoxadiazam | bixafen |
| M21.012 | X.02 | flufenoxadiazam | azoxystrobin |
| M21.013 | X.02 | flufenoxadiazam | pydiflumetofen |

TABLE M22
Specific Fungicidal Compositions

| Mixture | A | B | C |
|---|---|---|---|
| M22.001 | X.02 | florylpicoxamid | fluindapyr |
| M22.002 | X.02 | florylpicoxamid | epoxiconazole |
| M22.003 | X.02 | florylpicoxamid | dimoxystrobin |
| M22.004 | X.02 | florylpicoxamid | difenoconazole |
| M22.005 | X.02 | florylpicoxamid | copper hydroxide |
| M22.006 | X.02 | florylpicoxamid | copper oxychloride |
| M22.007 | X.02 | florylpicoxamid | chlorothalonil |
| M22.008 | X.02 | florylpicoxamid | cyproconazole |
| M22.009 | X.02 | florylpicoxamid | boscalid |
| M22.010 | X.02 | florylpicoxamid | bixafen |
| M22.011 | X.02 | florylpicoxamid | azoxystrobin |
| M22.012 | X.02 | florylpicoxamid | pydiflumetofen |

TABLE M23
Specific Fungicidal Compositions

| Mixture | A | B | C |
|---|---|---|---|
| M23.001 | X.02 | fluindapyr | epoxiconazole |
| M23.002 | X.02 | fluindapyr | dimoxystrobin |
| M23.003 | X.02 | fluindapyr | difenoconazole |
| M23.004 | X.02 | fluindapyr | copper hydroxide |
| M23.005 | X.02 | fluindapyr | copper oxychloride |
| M23.006 | X.02 | fluindapyr | chlorothalonil |
| M23.007 | X.02 | fluindapyr | cyproconazole |
| M23.008 | X.02 | fluindapyr | boscalid |
| M23.009 | X.02 | fluindapyr | bixafen |
| M23.010 | X.02 | fluindapyr | azoxystrobin |
| M23.011 | X.02 | fluindapyr | pydiflumetofen |

TABLE M24
Specific Fungicidal Compositions

| Mixture | A | B | C |
|---|---|---|---|
| M24.001 | X.02 | epoxiconazole | dimoxystrobin |
| M24.002 | X.02 | epoxiconazole | difenoconazole |
| M24.003 | X.02 | epoxiconazole | copper hydroxide |
| M24.004 | X.02 | epoxiconazole | copper oxychloride |
| M24.005 | X.02 | epoxiconazole | chlorothalonil |
| M24.006 | X.02 | epoxiconazole | cyproconazole |
| M24.007 | X.02 | epoxiconazole | boscalid |
| M24.008 | X.02 | epoxiconazole | bixafen |
| M24.009 | X.02 | epoxiconazole | azoxystrobin |
| M24.010 | X.02 | epoxiconazole | pydiflumetofen |

TABLE M25
Specific Fungicidal Compositions

| Mixture | A | B | C |
|---|---|---|---|
| M25.001 | X.02 | dimoxystrobin | difenoconazole |
| M25.002 | X.02 | dimoxystrobin | copper hydroxide |
| M25.003 | X.02 | dimoxystrobin | copper oxychloride |
| M25.004 | X.02 | dimoxystrobin | chlorothalonil |
| M25.005 | X.02 | dimoxystrobin | cyproconazole |
| M25.006 | X.02 | dimoxystrobin | boscalid |
| M25.007 | X.02 | dimoxystrobin | bixafen |
| M25.008 | X.02 | dimoxystrobin | azoxystrobin |
| M25.009 | X.02 | dimoxystrobin | pydiflumetofen |

TABLE M26
Specific Fungicidal Compositions

| Mixture | A | B | C |
|---|---|---|---|
| M26.001 | X.02 | difenoconazole | copper hydroxide |
| M26.002 | X.02 | difenoconazole | copper oxychloride |
| M26.003 | X.02 | difenoconazole | chlorothalonil |
| M26.004 | X.02 | difenoconazole | cyproconazole |
| M26.005 | X.02 | difenoconazole | boscalid |
| M26.006 | X.02 | difenoconazole | bixafen |
| M26.007 | X.02 | difenoconazole | azoxystrobin |
| M26.008 | X.02 | difenoconazole | pydiflumetofen |

TABLE M27
Specific Fungicidal Compositions

| Mixture | A | B | C |
|---|---|---|---|
| M27.001 | X.02 | copper hydroxide | copper oxychloride |
| M27.002 | X.02 | copper hydroxide | chlorothalonil |
| M27.003 | X.02 | copper hydroxide | cyproconazole |
| M27.004 | X.02 | copper hydroxide | boscalid |
| M27.005 | X.02 | copper hydroxide | bixafen |
| M27.006 | X.02 | copper hydroxide | azoxystrobin |
| M27.007 | X.02 | copper hydroxide | pydiflumetofen |

TABLE M28
Specific Fungicidal Compositions

| Mixture | A | B | C |
|---|---|---|---|
| M28.001 | X.02 | copper oxychloride | chlorothalonil |
| M28.002 | X.02 | copper oxychloride | cyproconazole |
| M28.003 | X.02 | copper oxychloride | boscalid |
| M28.004 | X.02 | copper oxychloride | bixafen |
| M28.005 | X.02 | copper oxychloride | azoxystrobin |
| M28.006 | X.02 | copper oxychloride | pydiflumetofen |

TABLE M29
Specific Fungicidal Compositions

| Mixture | A | B | C |
|---|---|---|---|
| M29.001 | X.02 | chlorothalonil | cyproconazole |
| M29.002 | X.02 | chlorothalonil | boscalid |
| M29.003 | X.02 | chlorothalonil | bixafen |
| M29.004 | X.02 | chlorothalonil | azoxystrobin |
| M29.005 | X.02 | chlorothalonil | pydiflumetofen |

TABLE M30
Specific Fungicidal Compositions

| Mixture | A | B | C |
|---|---|---|---|
| M30.001 | X.02 | cyproconazole | boscalid |
| M30.002 | X.02 | cyproconazole | bixafen |
| M30.003 | X.02 | cyproconazole | azoxystrobin |
| M30.004 | X.02 | cyproconazole | pydiflumetofen |

TABLE M31
Specific Fungicidal Compositions

| Mixture | A | B | C |
|---|---|---|---|
| M31.001 | X.02 | boscalid | bixafen |
| M31.002 | X.02 | boscalid | azoxystrobin |
| M31.003 | X.02 | boscalid | pydiflumetofen |

TABLE M32
Specific Fungicidal Compositions

| Mixture | A | B | C |
|---|---|---|---|
| M32.001 | X.02 | bixafen | azoxystrobin |
| M32.002 | X.02 | bixafen | pydiflumetofen |
| M32.003 | X.02 | azoxystrobin | pydiflumetofen |

TABLE M33
Specific Fungicidal Compositions

| Mixture | A | B | C |
|---|---|---|---|
| M33.001 | X.04 | trifloxystrobin | tebuconazole |
| M33.002 | X.04 | trifloxystrobin | benzovindiflupyr |
| M33.003 | X.04 | trifloxystrobin | sedaxane |
| M33.004 | X.04 | trifloxystrobin | prothioconazole |
| M33.005 | X.04 | trifloxystrobin | pyraclostrobin |
| M33.006 | X.04 | trifloxystrobin | propiconazole |
| M33.007 | X.04 | trifloxystrobin | picoxystrobin |
| M33.008 | X.04 | trifloxystrobin | mancozeb |
| M33.009 | X.04 | trifloxystrobin | metyltetraprole |
| M33.010 | X.04 | trifloxystrobin | metarylpicoxamid |
| M33.011 | X.04 | trifloxystrobin | mefentrifluconazole |
| M33.012 | X.04 | trifloxystrobin | isopyrazam |
| M33.013 | X.04 | trifloxystrobin | isoflucypram |
| M33.014 | X.04 | trifloxystrobin | inpyrfluxam |
| M33.015 | X.04 | trifloxystrobin | hexaconazole |
| M33.016 | X.04 | trifloxystrobin | fluazinam |
| M33.017 | X.04 | trifloxystrobin | fluxapyroxad |
| M33.018 | X.04 | trifloxystrobin | fenpropimorph |
| M33.019 | X.04 | trifloxystrobin | fenpropidin |
| M33.020 | X.04 | trifloxystrobin | flufenoxadiazam |
| M33.021 | X.04 | trifloxystrobin | florylpicoxamid |
| M33.022 | X.04 | trifloxystrobin | fluindapyr |
| M33.023 | X.04 | trifloxystrobin | epoxiconazole |
| M33.024 | X.04 | trifloxystrobin | dimoxystrobin |
| M33.025 | X.04 | trifloxystrobin | difenoconazole |
| M33.026 | X.04 | trifloxystrobin | copper hydroxide |
| M33.027 | X.04 | trifloxystrobin | copper oxychloride |
| M33.028 | X.04 | trifloxystrobin | chlorothalonil |
| M33.029 | X.04 | trifloxystrobin | cyproconazole |
| M33.030 | X.04 | trifloxystrobin | boscalid |
| M33.031 | X.04 | trifloxystrobin | bixafen |
| M33.032 | X.04 | trifloxystrobin | azoxystrobin |
| M33.033 | X.04 | trifloxystrobin | pydiflumetofen |

TABLE M34
Specific Fungicidal Compositions

| Mixture | A | B | C |
|---|---|---|---|
| M34.001 | X.04 | tebuconazole | benzovindiflupyr |
| M34.002 | X.04 | tebuconazole | sedaxane |
| M34.003 | X.04 | tebuconazole | prothioconazole |
| M34.004 | X.04 | tebuconazole | pyraclostrobin |
| M34.005 | X.04 | tebuconazole | propiconazole |
| M34.006 | X.04 | tebuconazole | picoxystrobin |
| M34.007 | X.04 | tebuconazole | mancozeb |
| M34.008 | X.04 | tebuconazole | metyltetraprole |
| M34.009 | X.04 | tebuconazole | metarylpicoxamid |
| M34.010 | X.04 | tebuconazole | mefentrifluconazole |
| M34.011 | X.04 | tebuconazole | isopyrazam |
| M34.012 | X.04 | tebuconazole | isoflucypram |
| M34.013 | X.04 | tebuconazole | inpyrfluxam |
| M34.014 | X.04 | tebuconazole | hexaconazole |
| M34.015 | X.04 | tebuconazole | fluazinam |
| M34.016 | X.04 | tebuconazole | fluxapyroxad |
| M34.017 | X.04 | tebuconazole | fenpropimorph |
| M34.018 | X.04 | tebuconazole | fenpropidin |
| M34.019 | X.04 | tebuconazole | flufenoxadiazam |
| M34.020 | X.04 | tebuconazole | florylpicoxamid |
| M34.021 | X.04 | tebuconazole | fluindapyr |
| M34.022 | X.04 | tebuconazole | epoxiconazole |
| M34.023 | X.04 | tebuconazole | dimoxystrobin |
| M34.024 | X.04 | tebuconazole | difenoconazole |
| M34.025 | X.04 | tebuconazole | copper hydroxide |
| M34.026 | X.04 | tebuconazole | copper oxychloride |
| M34.027 | X.04 | tebuconazole | chlorothalonil |
| M34.028 | X.04 | tebuconazole | cyproconazole |
| M34.029 | X.04 | tebuconazole | boscalid |
| M34.030 | X.04 | tebuconazole | bixafen |
| M34.031 | X.04 | tebuconazole | azoxystrobin |
| M34.032 | X.04 | tebuconazole | pydiflumetofen |

TABLE M35
Specific Fungicidal Compositions

| Mixture | A | B | C |
|---|---|---|---|
| M35.001 | X.04 | benzovindiflupyr | sedaxane |
| M35.002 | X.04 | benzovindiflupyr | prothioconazole |
| M35.003 | X.04 | benzovindiflupyr | pyraclostrobin |
| M35.004 | X.04 | benzovindiflupyr | propiconazole |
| M35.005 | X.04 | benzovindiflupyr | picoxystrobin |
| M35.006 | X.04 | benzovindiflupyr | mancozeb |
| M35.007 | X.04 | benzovindiflupyr | metyltetraprole |
| M35.008 | X.04 | benzovindiflupyr | metarylpicoxamid |
| M35.009 | X.04 | benzovindiflupyr | mefentrifluconazole |
| M35.010 | X.04 | benzovindiflupyr | isopyrazam |
| M35.011 | X.04 | benzovindiflupyr | isoflucypram |
| M35.012 | X.04 | benzovindiflupyr | inpyrfluxam |
| M35.013 | X.04 | benzovindiflupyr | hexaconazole |
| M35.014 | X.04 | benzovindiflupyr | fluazinam |
| M35.015 | X.04 | benzovindiflupyr | fluxapyroxad |
| M35.016 | X.04 | benzovindiflupyr | fenpropimorph |
| M35.017 | X.04 | benzovindiflupyr | fenpropidin |
| M35.018 | X.04 | benzovindiflupyr | flufenoxadiazam |
| M35.019 | X.04 | benzovindiflupyr | florylpicoxamid |
| M35.020 | X.04 | benzovindiflupyr | fluindapyr |
| M35.021 | X.04 | benzovindiflupyr | epoxiconazole |
| M35.022 | X.04 | benzovindiflupyr | dimoxystrobin |
| M35.023 | X.04 | benzovindiflupyr | difenoconazole |
| M35.024 | X.04 | benzovindiflupyr | copper hydroxide |
| M35.025 | X.04 | benzovindiflupyr | copper oxychloride |
| M35.026 | X.04 | benzovindiflupyr | chlorothalonil |
| M35.027 | X.04 | benzovindiflupyr | cyproconazole |
| M35.028 | X.04 | benzovindiflupyr | boscalid |
| M35.029 | X.04 | benzovindiflupyr | bixafen |
| M35.030 | X.04 | benzovindiflupyr | azoxystrobin |
| M35.031 | X.04 | benzovindiflupyr | pydiflumetofen |

TABLE M36
Specific Fungicidal Compositions

| Mixture | A | B | C |
|---|---|---|---|
| M36.001 | X.04 | sedaxane | prothioconazole |
| M36.002 | X.04 | sedaxane | pyraclostrobin |
| M36.003 | X.04 | sedaxane | propiconazole |
| M36.004 | X.04 | sedaxane | picoxystrobin |
| M36.005 | X.04 | sedaxane | mancozeb |
| M36.006 | X.04 | sedaxane | metyltetraprole |
| M36.007 | X.04 | sedaxane | metarylpicoxamid |
| M36.008 | X.04 | sedaxane | mefentrifluconazole |
| M36.009 | X.04 | sedaxane | isopyrazam |
| M36.010 | X.04 | sedaxane | isoflucypram |
| M36.011 | X.04 | sedaxane | inpyrfluxam |
| M36.012 | X.04 | sedaxane | hexaconazole |
| M36.013 | X.04 | sedaxane | fluazinam |
| M36.014 | X.04 | sedaxane | fluxapyroxad |
| M36.015 | X.04 | sedaxane | fenpropimorph |
| M36.016 | X.04 | sedaxane | fenpropidin |
| M36.017 | X.04 | sedaxane | flufenoxadiazam |
| M36.018 | X.04 | sedaxane | florylpicoxamid |
| M36.019 | X.04 | sedaxane | fluindapyr |
| M36.020 | X.04 | sedaxane | epoxiconazole |
| M36.021 | X.04 | sedaxane | dimoxystrobin |
| M36.022 | X.04 | sedaxane | difenoconazole |
| M36.023 | X.04 | sedaxane | copper hydroxide |
| M36.024 | X.04 | sedaxane | copper oxychloride |
| M36.025 | X.04 | sedaxane | chlorothalonil |
| M36.026 | X.04 | sedaxane | cyproconazole |
| M36.027 | X.04 | sedaxane | boscalid |
| M36.028 | X.04 | sedaxane | bixafen |
| M36.029 | X.04 | sedaxane | azoxystrobin |
| M36.030 | X.04 | sedaxane | pydiflumetofen |

TABLE M37
Specific Fungicidal Compositions

| Mixture | A | B | C |
|---|---|---|---|
| M37.001 | X.04 | prothioconazole | pyraclostrobin |
| M37.002 | X.04 | prothioconazole | propiconazole |
| M37.003 | X.04 | prothioconazole | picoxystrobin |
| M37.004 | X.04 | prothioconazole | mancozeb |
| M37.005 | X.04 | prothioconazole | metyltetraprole |
| M37.006 | X.04 | prothioconazole | metarylpicoxamid |
| M37.007 | X.04 | prothioconazole | mefentrifluconazole |
| M37.008 | X.04 | prothioconazole | isopyrazam |
| M37.009 | X.04 | prothioconazole | isoflucypram |
| M37.010 | X.04 | prothioconazole | inpyrfluxam |
| M37.011 | X.04 | prothioconazole | hexaconazole |
| M37.012 | X.04 | prothioconazole | fluazinam |
| M37.013 | X.04 | prothioconazole | fluxapyroxad |
| M37.014 | X.04 | prothioconazole | fenpropimorph |
| M37.015 | X.04 | prothioconazole | fenpropidin |
| M37.016 | X.04 | prothioconazole | flufenoxadiazam |
| M37.017 | X.04 | prothioconazole | florylpicoxamid |
| M37.018 | X.04 | prothioconazole | fluindapyr |
| M37.019 | X.04 | prothioconazole | epoxiconazole |
| M37.020 | X.04 | prothioconazole | dimoxystrobin |
| M37.021 | X.04 | prothioconazole | difenoconazole |
| M37.022 | X.04 | prothioconazole | copper hydroxide |
| M37.023 | X.04 | prothioconazole | copper oxychloride |
| M37.024 | X.04 | prothioconazole | chlorothalonil |
| M37.025 | X.04 | prothioconazole | cyproconazole |
| M37.026 | X.04 | prothioconazole | boscalid |
| M37.027 | X.04 | prothioconazole | bixafen |
| M37.028 | X.04 | prothioconazole | azoxystrobin |
| M37.029 | X.04 | prothioconazole | pydiflumetofen |

TABLE M38
Specific Fungicidal Compositions

| Mixture | A | B | C |
|---|---|---|---|
| M38.001 | X.04 | pyraclostrobin | propiconazole |
| M38.002 | X.04 | pyraclostrobin | picoxystrobin |
| M38.003 | X.04 | pyraclostrobin | mancozeb |
| M38.004 | X.04 | pyraclostrobin | metyltetraprole |
| M38.005 | X.04 | pyraclostrobin | metarylpicoxamid |
| M38.006 | X.04 | pyraclostrobin | mefentrifluconazole |
| M38.007 | X.04 | pyraclostrobin | isopyrazam |
| M38.008 | X.04 | pyraclostrobin | isoflucypram |
| M38.009 | X.04 | pyraclostrobin | inpyrfluxam |
| M38.010 | X.04 | pyraclostrobin | hexaconazole |
| M38.011 | X.04 | pyraclostrobin | fluazinam |
| M38.012 | X.04 | pyraclostrobin | fluxapyroxad |
| M38.013 | X.04 | pyraclostrobin | fenpropimorph |
| M38.014 | X.04 | pyraclostrobin | fenpropidin |
| M38.015 | X.04 | pyraclostrobin | flufenoxadiazam |
| M38.016 | X.04 | pyraclostrobin | florylpicoxamid |
| M38.017 | X.04 | pyraclostrobin | fluindapyr |
| M38.018 | X.04 | pyraclostrobin | epoxiconazole |
| M38.019 | X.04 | pyraclostrobin | dimoxystrobin |
| M38.020 | X.04 | pyraclostrobin | difenoconazole |
| M38.021 | X.04 | pyraclostrobin | copper hydroxide |
| M38.022 | X.04 | pyraclostrobin | copper oxychloride |
| M38.023 | X.04 | pyraclostrobin | chlorothalonil |
| M38.024 | X.04 | pyraclostrobin | cyproconazole |
| M38.025 | X.04 | pyraclostrobin | boscalid |
| M38.026 | X.04 | pyraclostrobin | bixafen |
| M38.027 | X.04 | pyraclostrobin | azoxystrobin |
| M38.028 | X.04 | pyraclostrobin | pydiflumetofen |

TABLE M39
Specific Fungicidal Compositions

| Mixture | A | B | C |
|---|---|---|---|
| M39.001 | X.04 | propiconazole | picoxystrobin |
| M39.002 | X.04 | propiconazole | mancozeb |
| M39.003 | X.04 | propiconazole | metyltetraprole |
| M39.004 | X.04 | propiconazole | metarylpicoxamid |
| M39.005 | X.04 | propiconazole | mefentrifluconazole |
| M39.006 | X.04 | propiconazole | isopyrazam |
| M39.007 | X.04 | propiconazole | isoflucypram |
| M39.008 | X.04 | propiconazole | inpyrfluxam |
| M39.009 | X.04 | propiconazole | hexaconazole |
| M39.010 | X.04 | propiconazole | fluazinam |
| M39.011 | X.04 | propiconazole | fluxapyroxad |
| M39.012 | X.04 | propiconazole | fenpropimorph |
| M39.013 | X.04 | propiconazole | fenpropidin |
| M39.014 | X.04 | propiconazole | flufenoxadiazam |
| M39.015 | X.04 | propiconazole | florylpicoxamid |
| M39.016 | X.04 | propiconazole | fluindapyr |
| M39.017 | X.04 | propiconazole | epoxiconazole |
| M39.018 | X.04 | propiconazole | dimoxystrobin |
| M39.019 | X.04 | propiconazole | difenoconazole |
| M39.020 | X.04 | propiconazole | copper hydroxide |
| M39.021 | X.04 | propiconazole | copper oxychloride |
| M39.022 | X.04 | propiconazole | chlorothalonil |
| M39.023 | X.04 | propiconazole | cyproconazole |
| M39.024 | X.04 | propiconazole | boscalid |
| M39.025 | X.04 | propiconazole | bixafen |
| M39.026 | X.04 | propiconazole | azoxystrobin |
| M39.027 | X.04 | propiconazole | pydiflumetofen |

TABLE M40
Specific Fungicidal Compositions

| Mixture | A | B | C |
|---|---|---|---|
| M40.001 | X.04 | picoxystrobin | mancozeb |
| M40.002 | X.04 | picoxystrobin | metyltetraprole |
| M40.003 | X.04 | picoxystrobin | metarylpicoxamid |
| M40.004 | X.04 | picoxystrobin | mefentrifluconazole |
| M40.005 | X.04 | picoxystrobin | isopyrazam |
| M40.006 | X.04 | picoxystrobin | isoflucypram |
| M40.007 | X.04 | picoxystrobin | inpyrfluxam |
| M40.008 | X.04 | picoxystrobin | hexaconazole |
| M40.009 | X.04 | picoxystrobin | fluazinam |
| M40.010 | X.04 | picoxystrobin | fluxapyroxad |
| M40.011 | X.04 | picoxystrobin | fenpropimorph |
| M40.012 | X.04 | picoxystrobin | fenpropidin |
| M40.013 | X.04 | picoxystrobin | flufenoxadiazam |
| M40.014 | X.04 | picoxystrobin | florylpicoxamid |
| M40.015 | X.04 | picoxystrobin | fluindapyr |
| M40.016 | X.04 | picoxystrobin | epoxiconazole |
| M40.017 | X.04 | picoxystrobin | dimoxystrobin |
| M40.018 | X.04 | picoxystrobin | difenoconazole |
| M40.019 | X.04 | picoxystrobin | copper hydroxide |
| M40.020 | X.04 | picoxystrobin | copper oxychloride |
| M40.021 | X.04 | picoxystrobin | chlorothalonil |
| M40.022 | X.04 | picoxystrobin | cyproconazole |
| M40.023 | X.04 | picoxystrobin | boscalid |
| M40.024 | X.04 | picoxystrobin | bixafen |
| M40.025 | X.04 | picoxystrobin | azoxystrobin |
| M40.026 | X.04 | picoxystrobin | pydiflumetofen |

TABLE M41
Specific Fungicidal Compositions

| Mixture | A | B | C |
|---|---|---|---|
| M41.001 | X.04 | mancozeb | metyltetraprole |
| M41.002 | X.04 | mancozeb | metarylpicoxamid |
| M41.003 | X.04 | mancozeb | mefentrifluconazole |
| M41.004 | X.04 | mancozeb | isopyrazam |
| M41.005 | X.04 | mancozeb | isoflucypram |
| M41.006 | X.04 | mancozeb | inpyrfluxam |
| M41.007 | X.04 | mancozeb | hexaconazole |
| M41.008 | X.04 | mancozeb | fluazinam |
| M41.009 | X.04 | mancozeb | fluxapyroxad |
| M41.010 | X.04 | mancozeb | fenpropimorph |
| M41.011 | X.04 | mancozeb | fenpropidin |
| M41.012 | X.04 | mancozeb | flufenoxadiazam |
| M41.013 | X.04 | mancozeb | florylpicoxamid |
| M41.014 | X.04 | mancozeb | fluindapyr |
| M41.015 | X.04 | mancozeb | epoxiconazole |
| M41.016 | X.04 | mancozeb | dimoxystrobin |
| M41.017 | X.04 | mancozeb | difenoconazole |
| M41.018 | X.04 | mancozeb | copper hydroxide |
| M41.019 | X.04 | mancozeb | copper oxychloride |
| M41.020 | X.04 | mancozeb | chlorothalonil |
| M41.021 | X.04 | mancozeb | cyproconazole |
| M41.022 | X.04 | mancozeb | boscalid |
| M41.023 | X.04 | mancozeb | bixafen |
| M41.024 | X.04 | mancozeb | azoxystrobin |
| M41.025 | X.04 | mancozeb | pydiflumetofen |

TABLE M42
Specific Fungicidal Compositions

| Mixture | A | B | C |
|---|---|---|---|
| M42.001 | X.04 | metyltetraprole | metarylpicoxamid |
| M42.002 | X.04 | metyltetraprole | mefentrifluconazole |
| M42.003 | X.04 | metyltetraprole | isopyrazam |
| M42.004 | X.04 | metyltetraprole | isoflucypram |
| M42.005 | X.04 | metyltetraprole | inpyrfluxam |
| M42.006 | X.04 | metyltetraprole | hexaconazole |
| M42.007 | X.04 | metyltetraprole | fluazinam |
| M42.008 | X.04 | metyltetraprole | fluxapyroxad |
| M42.009 | X.04 | metyltetraprole | fenpropimorph |
| M42.010 | X.04 | metyltetraprole | fenpropidin |
| M42.011 | X.04 | metyltetraprole | flufenoxadiazam |
| M42.012 | X.04 | metyltetraprole | florylpicoxamid |
| M42.013 | X.04 | metyltetraprole | fluindapyr |
| M42.014 | X.04 | metyltetraprole | epoxiconazole |
| M42.015 | X.04 | metyltetraprole | dimoxystrobin |
| M42.016 | X.04 | metyltetraprole | difenoconazole |
| M42.017 | X.04 | metyltetraprole | copper hydroxide |
| M42.018 | X.04 | metyltetraprole | copper oxychloride |
| M42.019 | X.04 | metyltetraprole | chlorothalonil |
| M42.020 | X.04 | metyltetraprole | cyproconazole |
| M42.021 | X.04 | metyltetraprole | boscalid |
| M42.022 | X.04 | metyltetraprole | bixafen |
| M42.023 | X.04 | metyltetraprole | azoxystrobin |
| M42.024 | X.04 | metyltetraprole | pydiflumetofen |

TABLE M43
Specific Fungicidal Compositions

| Mixture | A | B | C |
|---|---|---|---|
| M43.001 | X.04 | metarylpicoxamid | mefentrifluconazole |
| M43.002 | X.04 | metarylpicoxamid | isopyrazam |
| M43.003 | X.04 | metarylpicoxamid | isoflucypram |
| M43.004 | X.04 | metarylpicoxamid | inpyrfluxam |
| M43.005 | X.04 | metarylpicoxamid | hexaconazole |
| M43.006 | X.04 | metarylpicoxamid | fluazinam |
| M43.007 | X.04 | metarylpicoxamid | fluxapyroxad |
| M43.008 | X.04 | metarylpicoxamid | fenpropimorph |
| M43.009 | X.04 | metarylpicoxamid | fenpropidin |
| M43.010 | X.04 | metarylpicoxamid | flufenoxadiazam |
| M43.011 | X.04 | metarylpicoxamid | florylpicoxamid |
| M43.012 | X.04 | metarylpicoxamid | fluindapyr |
| M43.013 | X.04 | metarylpicoxamid | epoxiconazole |
| M43.014 | X.04 | metarylpicoxamid | dimoxystrobin |
| M43.015 | X.04 | metarylpicoxamid | difenoconazole |
| M43.016 | X.04 | metarylpicoxamid | copper hydroxide |
| M43.017 | X.04 | metarylpicoxamid | copper oxychloride |
| M43.018 | X.04 | metarylpicoxamid | chlorothalonil |
| M43.019 | X.04 | metarylpicoxamid | cyproconazole |
| M43.020 | X.04 | metarylpicoxamid | boscalid |
| M43.021 | X.04 | metarylpicoxamid | bixafen |
| M43.022 | X.04 | metarylpicoxamid | azoxystrobin |
| M43.023 | X.04 | metarylpicoxamid | pydiflumetofen |

TABLE M44
Specific Fungicidal Compositions

| Mixture | A | B | C |
|---|---|---|---|
| M44.001 | X.04 | mefentrifluconazole | isopyrazam |
| M44.002 | X.04 | mefentrifluconazole | isoflucypram |
| M44.003 | X.04 | mefentrifluconazole | inpyrfluxam |
| M44.004 | X.04 | mefentrifluconazole | hexaconazole |
| M44.005 | X.04 | mefentrifluconazole | fluazinam |
| M44.006 | X.04 | mefentrifluconazole | fluxapyroxad |
| M44.007 | X.04 | mefentrifluconazole | fenpropimorph |
| M44.008 | X.04 | mefentrifluconazole | fenpropidin |
| M44.009 | X.04 | mefentrifluconazole | flufenoxadiazam |
| M44.010 | X.04 | mefentrifluconazole | florylpicoxamid |
| M44.011 | X.04 | mefentrifluconazole | fluindapyr |
| M44.012 | X.04 | mefentrifluconazole | epoxiconazole |
| M44.013 | X.04 | mefentrifluconazole | dimoxystrobin |
| M44.014 | X.04 | mefentrifluconazole | difenoconazole |
| M44.015 | X.04 | mefentrifluconazole | copper hydroxide |
| M44.016 | X.04 | mefentrifluconazole | copper oxychloride |
| M44.017 | X.04 | mefentrifluconazole | chlorothalonil |
| M44.018 | X.04 | mefentrifluconazole | cyproconazole |
| M44.019 | X.04 | mefentrifluconazole | boscalid |
| M44.020 | X.04 | mefentrifluconazole | bixafen |
| M44.021 | X.04 | mefentrifluconazole | azoxystrobin |
| M44.022 | X.04 | mefentrifluconazole | pydiflumetofen |

TABLE M45
Specific Fungicidal Compositions

| Mixture | A | B | C |
|---|---|---|---|
| M45.001 | X.04 | isopyrazam | isoflucypram |
| M45.002 | X.04 | isopyrazam | inpyrfluxam |
| M45.003 | X.04 | isopyrazam | hexaconazole |
| M45.004 | X.04 | isopyrazam | fluazinam |
| M45.005 | X.04 | isopyrazam | fluxapyroxad |
| M45.006 | X.04 | isopyrazam | fenpropimorph |
| M45.007 | X.04 | isopyrazam | fenpropidin |
| M45.008 | X.04 | isopyrazam | flufenoxadiazam |
| M45.009 | X.04 | isopyrazam | florylpicoxamid |
| M45.010 | X.04 | isopyrazam | fluindapyr |
| M45.011 | X.04 | isopyrazam | epoxiconazole |
| M45.012 | X.04 | isopyrazam | dimoxystrobin |
| M45.013 | X.04 | isopyrazam | difenoconazole |
| M45.014 | X.04 | isopyrazam | copper hydroxide |
| M45.015 | X.04 | isopyrazam | copper oxychloride |
| M45.016 | X.04 | isopyrazam | chlorothalonil |
| M45.017 | X.04 | isopyrazam | cyproconazole |
| M45.018 | X.04 | isopyrazam | boscalid |
| M45.019 | X.04 | isopyrazam | bixafen |
| M45.020 | X.04 | isopyrazam | azoxystrobin |
| M45.021 | X.04 | isopyrazam | pydiflumetofen |

TABLE M46
Specific Fungicidal Compositions

| Mixture | A | B | C |
|---|---|---|---|
| M46.001 | X.04 | isoflucypram | inpyrfluxam |
| M46.002 | X.04 | isoflucypram | hexaconazole |
| M46.003 | X.04 | isoflucypram | fluazinam |
| M46.004 | X.04 | isoflucypram | fluxapyroxad |
| M46.005 | X.04 | isoflucypram | fenpropimorph |
| M46.006 | X.04 | isoflucypram | fenpropidin |
| M46.007 | X.04 | isoflucypram | flufenoxadiazam |
| M46.008 | X.04 | isoflucypram | florylpicoxamid |
| M46.009 | X.04 | isoflucypram | fluindapyr |
| M46.010 | X.04 | isoflucypram | epoxiconazole |
| M46.011 | X.04 | isoflucypram | dimoxystrobin |
| M46.012 | X.04 | isoflucypram | difenoconazole |
| M46.013 | X.04 | isoflucypram | copper hydroxide |
| M46.014 | X.04 | isoflucypram | copper oxychloride |
| M46.015 | X.04 | isoflucypram | chlorothalonil |
| M46.016 | X.04 | isoflucypram | cyproconazole |
| M46.017 | X.04 | isoflucypram | boscalid |
| M46.018 | X.04 | isoflucypram | bixafen |
| M46.019 | X.04 | isoflucypram | azoxystrobin |
| M46.020 | X.04 | isoflucypram | pydiflumetofen |

TABLE M47
Specific Fungicidal Compositions

| Mixture | A | B | C |
|---|---|---|---|
| M47.001 | X.04 | inpyrfluxam | hexaconazole |
| M47.002 | X.04 | inpyrfluxam | fluazinam |
| M47.003 | X.04 | inpyrfluxam | fluxapyroxad |
| M47.004 | X.04 | inpyrfluxam | fenpropimorph |
| M47.005 | X.04 | inpyrfluxam | fenpropidin |
| M47.006 | X.04 | inpyrfluxam | flufenoxadiazam |
| M47.007 | X.04 | inpyrfluxam | florylpicoxamid |
| M47.008 | X.04 | inpyrfluxam | fluindapyr |
| M47.009 | X.04 | inpyrfluxam | epoxiconazole |
| M47.010 | X.04 | inpyrfluxam | dimoxystrobin |
| M47.011 | X.04 | inpyrfluxam | difenoconazole |
| M47.012 | X.04 | inpyrfluxam | copper hydroxide |
| M47.013 | X.04 | inpyrfluxam | copper oxychloride |
| M47.014 | X.04 | inpyrfluxam | chlorothalonil |
| M47.015 | X.04 | inpyrfluxam | cyproconazole |
| M47.016 | X.04 | inpyrfluxam | boscalid |
| M47.017 | X.04 | inpyrfluxam | bixafen |
| M47.018 | X.04 | inpyrfluxam | azoxystrobin |
| M47.019 | X.04 | inpyrfluxam | pydiflumetofen |

TABLE M48
Specific Fungicidal Compositions

| Mixture | A | B | C |
|---|---|---|---|
| M48.001 | X.04 | hexaconazole | fluazinam |
| M48.002 | X.04 | hexaconazole | fluxapyroxad |
| M48.003 | X.04 | hexaconazole | fenpropimorph |
| M48.004 | X.04 | hexaconazole | fenpropidin |
| M48.005 | X.04 | hexaconazole | flufenoxadiazam |
| M48.006 | X.04 | hexaconazole | florylpicoxamid |
| M48.007 | X.04 | hexaconazole | fluindapyr |
| M48.008 | X.04 | hexaconazole | epoxiconazole |
| M48.009 | X.04 | hexaconazole | dimoxystrobin |
| M48.010 | X.04 | hexaconazole | difenoconazole |
| M48.011 | X.04 | hexaconazole | copper hydroxide |
| M48.012 | X.04 | hexaconazole | copper oxychloride |
| M48.013 | X.04 | hexaconazole | chlorothalonil |
| M48.014 | X.04 | hexaconazole | cyproconazole |
| M48.015 | X.04 | hexaconazole | boscalid |
| M48.016 | X.04 | hexaconazole | bixafen |
| M48.017 | X.04 | hexaconazole | azoxystrobin |
| M48.018 | X.04 | hexaconazole | pydiflumetofen |

TABLE M49
Specific Fungicidal Compositions

| Mixture | A | B | C |
|---|---|---|---|
| M49.001 | X.04 | fluazinam | fluxapyroxad |
| M49.002 | X.04 | fluazinam | fenpropimorph |
| M49.003 | X.04 | fluazinam | fenpropidin |
| M49.004 | X.04 | fluazinam | flufenoxadiazam |
| M49.005 | X.04 | fluazinam | florylpicoxamid |
| M49.006 | X.04 | fluazinam | fluindapyr |
| M49.007 | X.04 | fluazinam | epoxiconazole |
| M49.008 | X.04 | fluazinam | dimoxystrobin |
| M49.009 | X.04 | fluazinam | difenoconazole |
| M49.010 | X.04 | fluazinam | copper hydroxide |
| M49.011 | X.04 | fluazinam | copper oxychloride |
| M49.012 | X.04 | fluazinam | chlorothalonil |
| M49.013 | X.04 | fluazinam | cyproconazole |
| M49.014 | X.04 | fluazinam | boscalid |
| M49.015 | X.04 | fluazinam | bixafen |
| M49.016 | X.04 | fluazinam | azoxystrobin |
| M49.017 | X.04 | fluazinam | pydiflumetofen |

TABLE M50
Specific Fungicidal Compositions

| Mixture | A | B | C |
|---|---|---|---|
| M50.001 | X.04 | fluxapyroxad | fenpropimorph |
| M50.002 | X.04 | fluxapyroxad | fenpropidin |
| M50.003 | X.04 | fluxapyroxad | flufenoxadiazam |
| M50.004 | X.04 | fluxapyroxad | florylpicoxamid |
| M50.005 | X.04 | fluxapyroxad | fluindapyr |
| M50.006 | X.04 | fluxapyroxad | epoxiconazole |
| M50.007 | X.04 | fluxapyroxad | dimoxystrobin |
| M50.008 | X.04 | fluxapyroxad | difenoconazole |
| M50.009 | X.04 | fluxapyroxad | copper hydroxide |
| M50.010 | X.04 | fluxapyroxad | copper oxychloride |
| M50.011 | X.04 | fluxapyroxad | chlorothalonil |
| M50.012 | X.04 | fluxapyroxad | cyproconazole |
| M50.013 | X.04 | fluxapyroxad | boscalid |
| M50.014 | X.04 | fluxapyroxad | bixafen |
| M50.015 | X.04 | fluxapyroxad | azoxystrobin |
| M50.016 | X.04 | fluxapyroxad | pydiflumetofen |

TABLE M51
Specific Fungicidal Compositions

| Mixture | A | B | C |
|---|---|---|---|
| M51.001 | X.04 | fenpropimorph | fenpropidin |
| M51.002 | X.04 | fenpropimorph | flufenoxadiazam |
| M51.003 | X.04 | fenpropimorph | florylpicoxamid |
| M51.004 | X.04 | fenpropimorph | fluindapyr |
| M51.005 | X.04 | fenpropimorph | epoxiconazole |
| M51.006 | X.04 | fenpropimorph | dimoxystrobin |
| M51.007 | X.04 | fenpropimorph | difenoconazole |
| M51.008 | X.04 | fenpropimorph | copper hydroxide |
| M51.009 | X.04 | fenpropimorph | copper oxychloride |
| M51.010 | X.04 | fenpropimorph | chlorothalonil |
| M51.011 | X.04 | fenpropimorph | cyproconazole |
| M51.012 | X.04 | fenpropimorph | boscalid |
| M51.013 | X.04 | fenpropimorph | bixafen |
| M51.014 | X.04 | fenpropimorph | azoxystrobin |
| M51.015 | X.04 | fenpropimorph | pydiflumetofen |

TABLE M52
Specific Fungicidal Compositions

| Mixture | A | B | C |
|---|---|---|---|
| M52.001 | X.04 | fenpropidin | flufenoxadiazam |
| M52.002 | X.04 | fenpropidin | florylpicoxamid |
| M52.003 | X.04 | fenpropidin | fluindapyr |
| M52.004 | X.04 | fenpropidin | epoxiconazole |
| M52.005 | X.04 | fenpropidin | dimoxystrobin |
| M52.006 | X.04 | fenpropidin | difenoconazole |
| M52.007 | X.04 | fenpropidin | copper hydroxide |
| M52.008 | X.04 | fenpropidin | copper oxychloride |
| M52.009 | X.04 | fenpropidin | chlorothalonil |
| M52.010 | X.04 | fenpropidin | cyproconazole |
| M52.011 | X.04 | fenpropidin | boscalid |
| M52.012 | X.04 | fenpropidin | bixafen |
| M52.013 | X.04 | fenpropidin | azoxystrobin |
| M52.014 | X.04 | fenpropidin | pydiflumetofen |

TABLE M53
Specific Fungicidal Compositions

| Mixture | A | B | C |
|---|---|---|---|
| M53.001 | X.04 | flufenoxadiazam | florylpicoxamid |
| M53.002 | X.04 | flufenoxadiazam | fluindapyr |
| M53.003 | X.04 | flufenoxadiazam | epoxiconazole |
| M53.004 | X.04 | flufenoxadiazam | dimoxystrobin |
| M53.005 | X.04 | flufenoxadiazam | difenoconazole |
| M53.006 | X.04 | flufenoxadiazam | copper hydroxide |
| M53.007 | X.04 | flufenoxadiazam | copper oxychloride |
| M53.008 | X.04 | flufenoxadiazam | chlorothalonil |
| M53.009 | X.04 | flufenoxadiazam | cyproconazole |
| M53.010 | X.04 | flufenoxadiazam | boscalid |
| M53.011 | X.04 | flufenoxadiazam | bixafen |
| M53.012 | X.04 | flufenoxadiazam | azoxystrobin |
| M53.013 | X.04 | flufenoxadiazam | pydiflumetofen |

TABLE M54
Specific Fungicidal Compositions

| Mixture | A | B | C |
|---|---|---|---|
| M54.001 | X.04 | florylpicoxamid | fluindapyr |
| M54.002 | X.04 | florylpicoxamid | epoxiconazole |
| M54.003 | X.04 | florylpicoxamid | dimoxystrobin |
| M54.004 | X.04 | florylpicoxamid | difenoconazole |
| M54.005 | X.04 | florylpicoxamid | copper hydroxide |
| M54.006 | X.04 | florylpicoxamid | copper oxychloride |
| M54.007 | X.04 | florylpicoxamid | chlorothalonil |
| M54.008 | X.04 | florylpicoxamid | cyproconazole |
| M54.009 | X.04 | florylpicoxamid | boscalid |
| M54.010 | X.04 | florylpicoxamid | bixafen |
| M54.011 | X.04 | florylpicoxamid | azoxystrobin |
| M54.012 | X.04 | florylpicoxamid | pydiflumetofen |

TABLE M55
Specific Fungicidal Compositions

| Mixture | A | B | C |
|---|---|---|---|
| M55.001 | X.04 | fluindapyr | epoxiconazole |
| M55.002 | X.04 | fluindapyr | dimoxystrobin |
| M55.003 | X.04 | fluindapyr | difenoconazole |
| M55.004 | X.04 | fluindapyr | copper hydroxide |
| M55.005 | X.04 | fluindapyr | copper oxychloride |
| M55.006 | X.04 | fluindapyr | chlorothalonil |
| M55.007 | X.04 | fluindapyr | cyproconazole |
| M55.008 | X.04 | fluindapyr | boscalid |
| M55.009 | X.04 | fluindapyr | bixafen |
| M55.010 | X.04 | fluindapyr | azoxystrobin |
| M55.011 | X.04 | fluindapyr | pydiflumetofen |

TABLE M56
Specific Fungicidal Compositions

| Mixture | A | B | C |
|---|---|---|---|
| M56.001 | X.04 | epoxiconazole | dimoxystrobin |
| M56.002 | X.04 | epoxiconazole | difenoconazole |
| M56.003 | X.04 | epoxiconazole | copper hydroxide |
| M56.004 | X.04 | epoxiconazole | copper oxychloride |
| M56.005 | X.04 | epoxiconazole | chlorothalonil |
| M56.006 | X.04 | epoxiconazole | cyproconazole |
| M56.007 | X.04 | epoxiconazole | boscalid |
| M56.008 | X.04 | epoxiconazole | bixafen |
| M56.009 | X.04 | epoxiconazole | azoxystrobin |
| M56.010 | X.04 | epoxiconazole | pydiflumetofen |

TABLE M57
Specific Fungicidal Compositions

| Mixture | A | B | C |
|---|---|---|---|
| M57.001 | X.04 | dimoxystrobin | difenoconazole |
| M57.002 | X.04 | dimoxystrobin | copper hydroxide |
| M57.003 | X.04 | dimoxystrobin | copper oxychloride |
| M57.004 | X.04 | dimoxystrobin | chlorothalonil |
| M57.005 | X.04 | dimoxystrobin | cyproconazole |
| M57.006 | X.04 | dimoxystrobin | boscalid |
| M57.007 | X.04 | dimoxystrobin | bixafen |
| M57.008 | X.04 | dimoxystrobin | azoxystrobin |
| M57.009 | X.04 | dimoxystrobin | pydiflumetofen |

TABLE M58
Specific Fungicidal Compositions

| Mixture | A | B | C |
|---|---|---|---|
| M58.001 | X.04 | difenoconazole | copper hydroxide |
| M58.002 | X.04 | difenoconazole | copper oxychloride |
| M58.003 | X.04 | difenoconazole | chlorothalonil |
| M58.004 | X.04 | difenoconazole | cyproconazole |
| M58.005 | X.04 | difenoconazole | boscalid |
| M58.006 | X.04 | difenoconazole | bixafen |
| M58.007 | X.04 | difenoconazole | azoxystrobin |
| M58.008 | X.04 | difenoconazole | pydiflumetofen |

TABLE M59
Specific Fungicidal Compositions

| Mixture | A | B | C |
|---|---|---|---|
| M59.001 | X.04 | copper hydroxide | copper oxychloride |
| M59.002 | X.04 | copper hydroxide | chlorothalonil |
| M59.003 | X.04 | copper hydroxide | cyproconazole |
| M59.004 | X.04 | copper hydroxide | boscalid |
| M59.005 | X.04 | copper hydroxide | bixafen |
| M59.006 | X.04 | copper hydroxide | azoxystrobin |
| M59.007 | X.04 | copper hydroxide | pydiflumetofen |

TABLE M60
Specific Fungicidal Compositions

| Mixture | A | B | C |
|---|---|---|---|
| M60.001 | X.04 | copper oxychloride | chlorothalonil |
| M60.002 | X.04 | copper oxychloride | cyproconazole |
| M60.003 | X.04 | copper oxychloride | boscalid |
| M60.004 | X.04 | copper oxychloride | bixafen |
| M60.005 | X.04 | copper oxychloride | azoxystrobin |
| M60.006 | X.04 | copper oxychloride | pydiflumetofen |

TABLE M61
Specific Fungicidal Compositions

| Mixture | A | B | C |
|---|---|---|---|
| M61.001 | X.04 | chlorothalonil | cyproconazole |
| M61.002 | X.04 | chlorothalonil | boscalid |
| M61.003 | X.04 | chlorothalonil | bixafen |
| M61.004 | X.04 | chlorothalonil | azoxystrobin |
| M61.005 | X.04 | chlorothalonil | pydiflumetofen |

TABLE M62
Specific Fungicidal Compositions

| Mixture | A | B | C |
|---|---|---|---|
| M62.001 | X.04 | cyproconazole | boscalid |
| M62.002 | X.04 | cyproconazole | bixafen |
| M62.003 | X.04 | cyproconazole | azoxystrobin |
| M62.004 | X.04 | cyproconazole | pydiflumetofen |

TABLE M63
Specific Fungicidal Compositions

| Mixture | A | B | C |
|---|---|---|---|
| M63.001 | X.04 | boscalid | bixafen |
| M63.002 | X.04 | boscalid | azoxystrobin |
| M63.003 | X.04 | boscalid | pydiflumetofen |

TABLE M64
Specific Fungicidal Compositions

| Mixture | A | B | C |
|---|---|---|---|
| M64.001 | X.04 | bixafen | azoxystrobin |
| M64.002 | X.04 | bixafen | pydiflumetofen |
| M64.003 | X.04 | azoxystrobin | pydiflumetofen |

The preferred ratio ranges for preferred compositions used in the method of the invention are given in Tables R1 to R64 below. * Where component (B) or (C) exists in alternative forms (e.g salt/ester) then it should be understood that these can be substituted.

TABLE R1
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M1.001 | 1:3:6 to 3:1:2 | 3:5:10 to 5:3:6 | 1:1:2 |
| M1.002 | 1:3:3 to 3:1:1 | 3:5:5 to 5:3:3 | 1:1:1 |
| M1.003 | 1:3:6 to 3:1:2 | 3:5:10 to 5:3:6 | 1:1:2 |
| M1.004 | 1:3:6 to 3:1:2 | 3:5:10 to 5:3:6 | 1:1:2 |
| M1.005 | 1:3:3 to 3:1:1 | 3:5:5 to 5:3:3 | 1:1:1 |
| M1.006 | 2:6:9 to 6:2:3 | 6:10:15 to 10:6:9 | 2:2:3 |
| M1.007 | 1:3:3 to 3:1:1 | 3:5:5 to 5:3:3 | 1:1:1 |
| M1.008 | 2:6:135 to 6:2:45 | 6:10:225 to 10:6:135 | 2:2:45 |
| M1.009 | 1:3:3 to 3:1:1 | 3:5:5 to 5:3:3 | 1:1:1 |
| M1.010 | 1:3:3 to 3:1:1 | 3:5:5 to 5:3:3 | 1:1:1 |
| M1.011 | 2:6:9 to 6:2:3 | 6:10:15 to 10:6:9 | 2:2:3 |
| M1.012 | 1:3:6 to 3:1:2 | 3:5:10 to 5:3:6 | 1:1:2 |
| M1.013 | 1:3:6 to 3:1:2 | 3:5:10 to 5:3:6 | 1:1:2 |
| M1.014 | 1:3:6 to 3:1:2 | 3:5:10 to 5:3:6 | 1:1:2 |
| M1.015 | 1:3:6 to 3:1:2 | 3:5:10 to 5:3:6 | 1:1:2 |
| M1.016 | 1:3:30 to 3:1:10 | 3:5:50 to 5:3:30 | 1:1:10 |
| M1.017 | 1:3:6 to 3:1:2 | 3:5:10 to 5:3:6 | 1:1:2 |
| M1.018 | 1:3:18 to 3:1:6 | 3:5:30 to 5:3:18 | 1:1:6 |
| M1.019 | 1:3:18 to 3:1:6 | 3:5:30 to 5:3:18 | 1:1:6 |
| M1.020 | 1:3:6 to 3:1:2 | 3:5:10 to 5:3:6 | 1:1:2 |
| M1.021 | 1:3:3 to 3:1:1 | 3:5:5 to 5:3:3 | 1:1:1 |
| M1.022 | 1:3:6 to 3:1:2 | 3:5:10 to 5:3:6 | 1:1:2 |
| M1.023 | 1:3:6 to 3:1:2 | 3:5:10 to 5:3:6 | 1:1:2 |
| M1.024 | 1:3:3 to 3:1:1 | 3:5:5 to 5:3:3 | 1:1:1 |
| M1.025 | 2:6:9 to 6:2:3 | 6:10:15 to 10:6:9 | 2:2:3 |
| M1.026 | 1:3:24 to 3:1:8 | 3:5:40 to 5:3:24 | 1:1:8 |
| M1.027 | 1:3:24 to 3:1:8 | 3:5:40 to 5:3:24 | 1:1:8 |
| M1.028 | 1:3:60 to 3:1:20 | 3:5:100 to 5:3:60 | 1:1:20 |
| M1.029 | 1:3:3 to 3:1:1 | 3:5:5 to 5:3:3 | 1:1:1 |
| M1.030 | 1:3:3 to 3:1:1 | 3:5:5 to 5:3:3 | 1:1:1 |
| M1.031 | 1:3:3 to 3:1:1 | 3:5:5 to 5:3:3 | 1:1:1 |
| M1.032 | 1:3:3 to 3:1:1 | 3:5:5 to 5:3:3 | 1:1:1 |
| M1.033 | 1:3:6 to 3:1:2 | 3:5:10 to 5:3:6 | 1:1:2 |

TABLE R2
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M2.001 | 1:6:3 to 3:2:1 | 3:10:5 to 5:6:3 | 1:2:1 |
| M2.002 | 1:6:6 to 3:2:2 | 3:10:10 to 5:6:6 | 1:2:2 |
| M2.003 | 1:6:6 to 3:2:2 | 3:10:10 to 5:6:6 | 1:2:2 |
| M2.004 | 1:6:3 to 3:2:1 | 3:10:5 to 5:6:3 | 1:2:1 |
| M2.005 | 2:12:9 to 6:4:3 | 6:20:15 to 10:12:9 | 2:4:3 |
| M2.006 | 1:6:3 to 3:2:1 | 3:10:5 to 5:6:3 | 1:2:1 |
| M2.007 | 2:12:135 to 6:4:45 | 6:20:225 to 10:12:135 | 2:4:45 |
| M2.008 | 1:6:3 to 3:2:1 | 3:10:5 to 5:6:3 | 1:2:1 |
| M2.009 | 1:6:3 to 3:2:1 | 3:10:5 to 5:6:3 | 1:2:1 |
| M2.010 | 2:12:9 to 6:4:3 | 6:20:15 to 10:12:9 | 2:4:3 |
| M2.011 | 1:6:6 to 3:2:2 | 3:10:10 to 5:6:6 | 1:2:2 |
| M2.012 | 1:6:6 to 3:2:2 | 3:10:10 to 5:6:6 | 1:2:2 |
| M2.013 | 1:6:6 to 3:2:2 | 3:10:10 to 5:6:6 | 1:2:2 |
| M2.014 | 1:6:6 to 3:2:2 | 3:10:10 to 5:6:6 | 1:2:2 |
| M2.015 | 1:6:30 to 3:2:10 | 3:10:50 to 5:6:30 | 1:2:10 |
| M2.016 | 1:6:6 to 3:2:2 | 3:10:10 to 5:6:6 | 1:2:2 |
| M2.017 | 1:6:18 to 3:2:6 | 3:10:30 to 5:6:18 | 1:2:6 |
| M2.018 | 1:6:18 to 3:2:6 | 3:10:30 to 5:6:18 | 1:2:6 |
| M2.019 | 1:6:6 to 3:2:2 | 3:10:10 to 5:6:6 | 1:2:2 |
| M2.020 | 1:6:3 to 3:2:1 | 3:10:5 to 5:6:3 | 1:2:1 |
| M2.021 | 1:6:6 to 3:2:2 | 3:10:10 to 5:6:6 | 1:2:2 |
| M2.022 | 1:6:6 to 3:2:2 | 3:10:10 to 5:6:6 | 1:2:2 |
| M2.023 | 1:6:3 to 3:2:1 | 3:10:5 to 5:6:3 | 1:2:1 |
| M2.024 | 2:12:9 to 6:4:3 | 6:20:15 to 10:12:9 | 2:4:3 |
| M2.025 | 1:6:24 to 3:2:8 | 3:10:40 to 5:6:24 | 1:2:8 |
| M2.026 | 1:6:24 to 3:2:8 | 3:10:40 to 5:6:24 | 1:2:8 |
| M2.027 | 1:6:60 to 3:2:20 | 3:10:100 to 5:6:60 | 1:2:20 |
| M2.028 | 1:6:3 to 3:2:1 | 3:10:5 to 5:6:3 | 1:2:1 |
| M2.029 | 1:6:3 to 3:2:1 | 3:10:5 to 5:6:3 | 1:2:1 |
| M2.030 | 1:6:3 to 3:2:1 | 3:10:5 to 5:6:3 | 1:2:1 |
| M2.031 | 1:6:3 to 3:2:1 | 3:10:5 to 5:6:3 | 1:2:1 |
| M2.032 | 1:6:6 to 3:2:2 | 3:10:10 to 5:6:6 | 1:2:2 |

TABLE R3
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M3.001 | 1:3:6 to 3:1:2 | 3:5:10 to 5:3:6 | 1:1:2 |
| M3.002 | 1:3:6 to 3:1:2 | 3:5:10 to 5:3:6 | 1:1:2 |
| M3.003 | 1:3:3 to 3:1:1 | 3:5:5 to 5:3:3 | 1:1:1 |
| M3.004 | 2:6:9 to 6:2:3 | 6:10:15 to 10:6:9 | 2:2:3 |
| M3.005 | 1:3:3 to 3:1:1 | 3:5:5 to 5:3:3 | 1:1:1 |
| M3.006 | 2:6:135 to 6:2:45 | 6:10:225 to 10:6:135 | 2:2:45 |
| M3.007 | 1:3:3 to 3:1:1 | 3:5:5 to 5:3:3 | 1:1:1 |
| M3.008 | 1:3:3 to 3:1:1 | 3:5:5 to 5:3:3 | 1:1:1 |
| M3.009 | 2:6:9 to 6:2:3 | 6:10:15 to 10:6:9 | 2:2:3 |
| M3.010 | 1:3:6 to 3:1:2 | 3:5:10 to 5:3:6 | 1:1:2 |
| M3.011 | 1:3:6 to 3:1:2 | 3:5:10 to 5:3:6 | 1:1:2 |
| M3.012 | 1:3:6 to 3:1:2 | 3:5:10 to 5:3:6 | 1:1:2 |
| M3.013 | 1:3:6 to 3:1:2 | 3:5:10 to 5:3:6 | 1:1:2 |
| M3.014 | 1:3:30 to 3:1:10 | 3:5:50 to 5:3:30 | 1:1:10 |
| M3.015 | 1:3:6 to 3:1:2 | 3:5:10 to 5:3:6 | 1:1:2 |
| M3.016 | 1:3:18 to 3:1:6 | 3:5:30 to 5:3:18 | 1:1:6 |
| M3.017 | 1:3:18 to 3:1:6 | 3:5:30 to 5:3:18 | 1:1:6 |
| M3.018 | 1:3:6 to 3:1:2 | 3:5:10 to 5:3:6 | 1:1:2 |
| M3.019 | 1:3:3 to 3:1:1 | 3:5:5 to 5:3:3 | 1:1:1 |
| M3.020 | 1:3:6 to 3:1:2 | 3:5:10 to 5:3:6 | 1:1:2 |
| M3.021 | 1:3:6 to 3:1:2 | 3:5:10 to 5:3:6 | 1:1:2 |
| M3.022 | 1:3:3 to 3:1:1 | 3:5:5 to 5:3:3 | 1:1:1 |
| M3.023 | 2:6:9 to 6:2:3 | 6:10:15 to 10:6:9 | 2:2:3 |
| M3.024 | 1:3:24 to 3:1:8 | 3:5:40 to 5:3:24 | 1:1:8 |
| M3.025 | 1:3:24 to 3:1:8 | 3:5:40 to 5:3:24 | 1:1:8 |
| M3.026 | 1:3:60 to 3:1:20 | 3:5:100 to 5:3:60 | 1:1:20 |
| M3.027 | 1:3:3 to 3:1:1 | 3:5:5 to 5:3:3 | 1:1:1 |
| M3.028 | 1:3:3 to 3:1:1 | 3:5:5 to 5:3:3 | 1:1:1 |
| M3.029 | 1:3:3 to 3:1:1 | 3:5:5 to 5:3:3 | 1:1:1 |
| M3.030 | 1:3:3 to 3:1:1 | 3:5:5 to 5:3:3 | 1:1:1 |
| M3.031 | 1:3:6 to 3:1:2 | 3:5:10 to 5:3:6 | 1:1:2 |

TABLE R4
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M4.001 | 1:6:6 to 3:2:2 | 3:10:10 to 5:6:6 | 1:2:2 |
| M4.002 | 1:6:3 to 3:2:1 | 3:10:5 to 5:6:3 | 1:2:1 |
| M4.003 | 2:12:9 to 6:4:3 | 6:20:15 to 10:12:9 | 2:4:3 |
| M4.004 | 1:6:3 to 3:2:1 | 3:10:5 to 5:6:3 | 1:2:1 |
| M4.005 | 2:12:135 to 6:4:45 | 6:20:225 to 10:12:135 | 2:4:45 |
| M4.006 | 1:6:3 to 3:2:1 | 3:10:5 to 5:6:3 | 1:2:1 |
| M4.007 | 1:6:3 to 3:2:1 | 3:10:5 to 5:6:3 | 1:2:1 |
| M4.008 | 2:12:9 to 6:4:3 | 6:20:15 to 10:12:9 | 2:4:3 |
| M4.009 | 1:6:6 to 3:2:2 | 3:10:10 to 5:6:6 | 1:2:2 |
| M4.010 | 1:6:6 to 3:2:2 | 3:10:10 to 5:6:6 | 1:2:2 |
| M4.011 | 1:6:6 to 3:2:2 | 3:10:10 to 5:6:6 | 1:2:2 |
| M4.012 | 1:6:6 to 3:2:2 | 3:10:10 to 5:6:6 | 1:2:2 |
| M4.013 | 1:6:30 to 3:2:10 | 3:10:50 to 5:6:30 | 1:2:10 |
| M4.014 | 1:6:6 to 3:2:2 | 3:10:10 to 5:6:6 | 1:2:2 |
| M4.015 | 1:6:18 to 3:2:6 | 3:10:30 to 5:6:18 | 1:2:6 |
| M4.016 | 1:6:18 to 3:2:6 | 3:10:30 to 5:6:18 | 1:2:6 |
| M4.017 | 1:6:6 to 3:2:2 | 3:10:10 to 5:6:6 | 1:2:2 |
| M4.018 | 1:6:3 to 3:2:1 | 3:10:5 to 5:6:3 | 1:2:1 |
| M4.019 | 1:6:6 to 3:2:2 | 3:10:10 to 5:6:6 | 1:2:2 |
| M4.020 | 1:6:6 to 3:2:2 | 3:10:10 to 5:6:6 | 1:2:2 |
| M4.021 | 1:6:3 to 3:2:1 | 3:10:5 to 5:6:3 | 1:2:1 |
| M4.022 | 2:12:9 to 6:4:3 | 6:20:15 to 10:12:9 | 2:4:3 |
| M4.023 | 1:6:24 to 3:2:8 | 3:10:40 to 5:6:24 | 1:2:8 |
| M4.024 | 1:6:24 to 3:2:8 | 3:10:40 to 5:6:24 | 1:2:8 |
| M4.025 | 1:6:60 to 3:2:20 | 3:10:100 to 5:6:60 | 1:2:20 |
| M4.026 | 1:6:3 to 3:2:1 | 3:10:5 to 5:6:3 | 1:2:1 |
| M4.027 | 1:6:3 to 3:2:1 | 3:10:5 to 5:6:3 | 1:2:1 |
| M4.028 | 1:6:3 to 3:2:1 | 3:10:5 to 5:6:3 | 1:2:1 |
| M4.029 | 1:6:3 to 3:2:1 | 3:10:5 to 5:6:3 | 1:2:1 |
| M4.030 | 1:6:6 to 3:2:2 | 3:10:10 to 5:6:6 | 1:2:2 |

TABLE R5
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M5.001 | 1:6:3 to 3:2:1 | 3:10:5 to 5:6:3 | 1:2:1 |
| M5.002 | 2:12:9 to 6:4:3 | 6:20:15 to 10:12:9 | 2:4:3 |
| M5.003 | 1:6:3 to 3:2:1 | 3:10:5 to 5:6:3 | 1:2:1 |
| M5.004 | 2:12:135 to 6:4:45 | 6:20:225 to 10:12:135 | 2:4:45 |
| M5.005 | 1:6:3 to 3:2:1 | 3:10:5 to 5:6:3 | 1:2:1 |
| M5.006 | 1:6:3 to 3:2:1 | 3:10:5 to 5:6:3 | 1:2:1 |
| M5.007 | 2:12:9 to 6:4:3 | 6:20:15 to 10:12:9 | 2:4:3 |
| M5.008 | 1:6:6 to 3:2:2 | 3:10:10 to 5:6:6 | 1:2:2 |
| M5.009 | 1:6:6 to 3:2:2 | 3:10:10 to 5:6:6 | 1:2:2 |
| M5.010 | 1:6:6 to 3:2:2 | 3:10:10 to 5:6:6 | 1:2:2 |
| M5.011 | 1:6:6 to 3:2:2 | 3:10:10 to 5:6:6 | 1:2:2 |
| M5.012 | 1:6:30 to 3:2:10 | 3:10:50 to 5:6:30 | 1:2:10 |
| M5.013 | 1:6:6 to 3:2:2 | 3:10:10 to 5:6:6 | 1:2:2 |
| M5.014 | 1:6:18 to 3:2:6 | 3:10:30 to 5:6:18 | 1:2:6 |
| M5.015 | 1:6:18 to 3:2:6 | 3:10:30 to 5:6:18 | 1:2:6 |
| M5.016 | 1:6:6 to 3:2:2 | 3:10:10 to 5:6:6 | 1:2:2 |
| M5.017 | 1:6:3 to 3:2:1 | 3:10:5 to 5:6:3 | 1:2:1 |
| M5.018 | 1:6:6 to 3:2:2 | 3:10:10 to 5:6:6 | 1:2:2 |
| M5.019 | 1:6:6 to 3:2:2 | 3:10:10 to 5:6:6 | 1:2:2 |
| M5.020 | 1:6:3 to 3:2:1 | 3:10:5 to 5:6:3 | 1:2:1 |
| M5.021 | 2:12:9 to 6:4:3 | 6:20:15 to 10:12:9 | 2:4:3 |
| M5.022 | 1:6:24 to 3:2:8 | 3:10:40 to 5:6:24 | 1:2:8 |
| M5.023 | 1:6:24 to 3:2:8 | 3:10:40 to 5:6:24 | 1:2:8 |
| M5.024 | 1:6:60 to 3:2:20 | 3:10:100 to 5:6:60 | 1:2:20 |
| M5.025 | 1:6:3 to 3:2:1 | 3:10:5 to 5:6:3 | 1:2:1 |
| M5.026 | 1:6:3 to 3:2:1 | 3:10:5 to 5:6:3 | 1:2:1 |
| M5.027 | 1:6:3 to 3:2:1 | 3:10:5 to 5:6:3 | 1:2:1 |
| M5.028 | 1:6:3 to 3:2:1 | 3:10:5 to 5:6:3 | 1:2:1 |
| M5.029 | 1:6:6 to 3:2:2 | 3:10:10 to 5:6:6 | 1:2:2 |

TABLE R6
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M6.001 | 2:6:9 to 6:2:3 | 6:10:15 to 10:6:9 | 2:2:3 |
| M6.002 | 1:3:3 to 3:1:1 | 3:5:5 to 5:3:3 | 1:1:1 |
| M6.003 | 2:6:135 to 6:2:45 | 6:10:225 to 10:6:135 | 2:2:45 |
| M6.004 | 1:3:3 to 3:1:1 | 3:5:5 to 5:3:3 | 1:1:1 |
| M6.005 | 1:3:3 to 3:1:1 | 3:5:5 to 5:3:3 | 1:1:1 |
| M6.006 | 2:6:9 to 6:2:3 | 6:10:15 to 10:6:9 | 2:2:3 |
| M6.007 | 1:3:6 to 3:1:2 | 3:5:10 to 5:3:6 | 1:1:2 |
| M6.008 | 1:3:6 to 3:1:2 | 3:5:10 to 5:3:6 | 1:1:2 |
| M6.009 | 1:3:6 to 3:1:2 | 3:5:10 to 5:3:6 | 1:1:2 |
| M6.010 | 1:3:6 to 3:1:2 | 3:5:10 to 5:3:6 | 1:1:2 |
| M6.011 | 1:3:30 to 3:1:10 | 3:5:50 to 5:3:30 | 1:1:10 |
| M6.012 | 1:3:6 to 3:1:2 | 3:5:10 to 5:3:6 | 1:1:2 |
| M6.013 | 1:3:18 to 3:1:6 | 3:5:30 to 5:3:18 | 1:1:6 |
| M6.014 | 1:3:18 to 3:1:6 | 3:5:30 to 5:3:18 | 1:1:6 |
| M6.015 | 1:3:6 to 3:1:2 | 3:5:10 to 5:3:6 | 1:1:2 |
| M6.016 | 1:3:3 to 3:1:1 | 3:5:5 to 5:3:3 | 1:1:1 |
| M6.017 | 1:3:6 to 3:1:2 | 3:5:10 to 5:3:6 | 1:1:2 |
| M6.018 | 1:3:6 to 3:1:2 | 3:5:10 to 5:3:6 | 1:1:2 |
| M6.019 | 1:3:3 to 3:1:1 | 3:5:5 to 5:3:3 | 1:1:1 |
| M6.020 | 2:6:9 to 6:2:3 | 6:10:15 to 10:6:9 | 2:2:3 |
| M6.021 | 1:3:24 to 3:1:8 | 3:5:40 to 5:3:24 | 1:1:8 |
| M6.022 | 1:3:24 to 3:1:8 | 3:5:40 to 5:3:24 | 1:1:8 |
| M6.023 | 1:3:60 to 3:1:20 | 3:5:100 to 5:3:60 | 1:1:20 |
| M6.024 | 1:3:3 to 3:1:1 | 3:5:5 to 5:3:3 | 1:1:1 |
| M6.025 | 1:3:3 to 3:1:1 | 3:5:5 to 5:3:3 | 1:1:1 |
| M6.026 | 1:3:3 to 3:1:1 | 3:5:5 to 5:3:3 | 1:1:1 |
| M6.027 | 1:3:3 to 3:1:1 | 3:5:5 to 5:3:3 | 1:1:1 |
| M6.028 | 1:3:6 to 3:1:2 | 3:5:10 to 5:3:6 | 1:1:2 |

TABLE R7
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M7.001 | 2:9:6 to 6:3:2 | 6:15:10 to 10:9:6 | 2:3:2 |
| M7.002 | 2:9:135 to 2:1:15 | 2:5:75 to 10:9:135 | 2:3:45 |
| M7.003 | 2:9:6 to 6:3:2 | 6:15:10 to 10:9:6 | 2:3:2 |
| M7.004 | 2:9:6 to 6:3:2 | 6:15:10 to 10:9:6 | 2:3:2 |
| M7.005 | 2:9:9 to 2:1:1 | 2:5:5 to 10:9:9 | 2:3:3 |
| M7.006 | 2:9:12 to 6:3:4 | 6:15:20 to 10:9:12 | 2:3:4 |
| M7.007 | 2:9:12 to 6:3:4 | 6:15:20 to 10:9:12 | 2:3:4 |
| M7.008 | 2:9:12 to 6:3:4 | 6:15:20 to 10:9:12 | 2:3:4 |
| M7.009 | 2:9:12 to 6:3:4 | 6:15:20 to 10:9:12 | 2:3:4 |
| M7.010 | 2:9:60 to 6:3:20 | 6:15:100 to 10:9:60 | 2:3:20 |
| M7.011 | 2:9:12 to 6:3:4 | 6:15:20 to 10:9:12 | 2:3:4 |
| M7.012 | 2:9:36 to 2:1:4 | 2:5:20 to 10:9:36 | 2:3:12 |
| M7.013 | 2:9:36 to 2:1:4 | 2:5:20 to 10:9:36 | 2:3:12 |
| M7.014 | 2:9:12 to 6:3:4 | 6:15:20 to 10:9:12 | 2:3:4 |
| M7.015 | 2:9:6 to 6:3:2 | 6:15:10 to 10:9:6 | 2:3:2 |
| M7.016 | 2:9:12 to 6:3:4 | 6:15:20 to 10:9:12 | 2:3:4 |
| M7.017 | 2:9:12 to 6:3:4 | 6:15:20 to 10:9:12 | 2:3:4 |
| M7.018 | 2:9:6 to 6:3:2 | 6:15:10 to 10:9:6 | 2:3:2 |
| M7.019 | 2:9:9 to 2:1:1 | 2:5:5 to 10:9:9 | 2:3:3 |
| M7.020 | 2:9:48 to 6:3:16 | 6:15:80 to 10:9:48 | 2:3:16 |
| M7.021 | 2:9:48 to 6:3:16 | 6:15:80 to 10:9:48 | 2:3:16 |
| M7.022 | 2:9:120 to 6:3:40 | 6:15:200 to 10:9:120 | 2:3:40 |
| M7.023 | 2:9:6 to 6:3:2 | 6:15:10 to 10:9:6 | 2:3:2 |
| M7.024 | 2:9:6 to 6:3:2 | 6:15:10 to 10:9:6 | 2:3:2 |
| M7.025 | 2:9:6 to 6:3:2 | 6:15:10 to 10:9:6 | 2:3:2 |
| M7.026 | 2:9:6 to 6:3:2 | 6:15:10 to 10:9:6 | 2:3:2 |
| M7.027 | 2:9:12 to 6:3:4 | 6:15:20 to 10:9:12 | 2:3:4 |

TABLE R8
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M8.001 | 2:6:135 to 6:2:45 | 6:10:225 to 10:6:135 | 2:2:45 |
| M8.002 | 1:3:3 to 3:1:1 | 3:5:5 to 5:3:3 | 1:1:1 |
| M8.003 | 1:3:3 to 3:1:1 | 3:5:5 to 5:3:3 | 1:1:1 |
| M8.004 | 2:6:9 to 6:2:3 | 6:10:15 to 10:6:9 | 2:2:3 |
| M8.005 | 1:3:6 to 3:1:2 | 3:5:10 to 5:3:6 | 1:1:2 |
| M8.006 | 1:3:6 to 3:1:2 | 3:5:10 to 5:3:6 | 1:1:2 |
| M8.007 | 1:3:6 to 3:1:2 | 3:5:10 to 5:3:6 | 1:1:2 |
| M8.008 | 1:3:6 to 3:1:2 | 3:5:10 to 5:3:6 | 1:1:2 |
| M8.009 | 1:3:30 to 3:1:10 | 3:5:50 to 5:3:30 | 1:1:10 |
| M8.010 | 1:3:6 to 3:1:2 | 3:5:10 to 5:3:6 | 1:1:2 |
| M8.011 | 1:3:18 to 3:1:6 | 3:5:30 to 5:3:18 | 1:1:6 |
| M8.012 | 1:3:18 to 3:1:6 | 3:5:30 to 5:3:18 | 1:1:6 |
| M8.013 | 1:3:6 to 3:1:2 | 3:5:10 to 5:3:6 | 1:1:2 |
| M8.014 | 1:3:3 to 3:1:1 | 3:5:5 to 5:3:3 | 1:1:1 |
| M8.015 | 1:3:6 to 3:1:2 | 3:5:10 to 5:3:6 | 1:1:2 |
| M8.016 | 1:3:6 to 3:1:2 | 3:5:10 to 5:3:6 | 1:1:2 |
| M8.017 | 1:3:3 to 3:1:1 | 3:5:5 to 5:3:3 | 1:1:1 |
| M8.018 | 2:6:9 to 6:2:3 | 6:10:15 to 10:6:9 | 2:2:3 |
| M8.019 | 1:3:24 to 3:1:8 | 3:5:40 to 5:3:24 | 1:1:8 |
| M8.020 | 1:3:24 to 3:1:8 | 3:5:40 to 5:3:24 | 1:1:8 |
| M8.021 | 1:3:60 to 3:1:20 | 3:5:100 to 5:3:60 | 1:1:20 |
| M8.022 | 1:3:3 to 3:1:1 | 3:5:5 to 5:3:3 | 1:1:1 |
| M8.023 | 1:3:3 to 3:1:1 | 3:5:5 to 5:3:3 | 1:1:1 |
| M8.024 | 1:3:3 to 3:1:1 | 3:5:5 to 5:3:3 | 1:1:1 |
| M8.025 | 1:3:3 to 3:1:1 | 3:5:5 to 5:3:3 | 1:1:1 |
| M8.026 | 1:3:6 to 3:1:2 | 3:5:10 to 5:3:6 | 1:1:2 |

TABLE R9
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M9.001 | 2:135:6 to 6:45:2 | 6:225:10 to 10:135:6 | 2:45:2 |
| M9.002 | 2:135:6 to 6:45:2 | 6:225:10 to 10:135:6 | 2:45:2 |
| M9.003 | 2:135:9 to 2:15:1 | 2:75:5 to 10:135:9 | 2:45:3 |
| M9.004 | 2:135:12 to 6:45:4 | 6:225:20 to 10:135:12 | 2:45:4 |
| M9.005 | 2:135:12 to 6:45:4 | 6:225:20 to 10:135:12 | 2:45:4 |
| M9.006 | 2:135:12 to 6:45:4 | 6:225:20 to 10:135:12 | 2:45:4 |
| M9.007 | 2:135:12 to 6:45:4 | 6:225:20 to 10:135:12 | 2:45:4 |
| M9.008 | 2:135:60 to 6:45:20 | 6:225:100 to 2:27:12 | 2:45:20 |
| M9.009 | 2:135:12 to 6:45:4 | 6:225:20 to 10:135:12 | 2:45:4 |
| M9.010 | 2:135:36 to 2:15:4 | 2:75:20 to 10:135:36 | 2:45:12 |
| M9.011 | 2:135:36 to 2:15:4 | 2:75:20 to 10:135:36 | 2:45:12 |
| M9.012 | 2:135:12 to 6:45:4 | 6:225:20 to 10:135:12 | 2:45:4 |
| M9.013 | 2:135:6 to 6:45:2 | 6:225:10 to 10:135:6 | 2:45:2 |
| M9.014 | 2:135:12 to 6:45:4 | 6:225:20 to 10:135:12 | 2:45:4 |
| M9.015 | 2:135:12 to 6:45:4 | 6:225:20 to 10:135:12 | 2:45:4 |
| M9.016 | 2:135:6 to 6:45:2 | 6:225:10 to 10:135:6 | 2:45:2 |
| M9.017 | 2:135:9 to 2:15:1 | 2:75:5 to 10:135:9 | 2:45:3 |
| M9.018 | 2:135:48 to 6:45:16 | 6:225:80 to 10:135:48 | 2:45:16 |
| M9.019 | 2:135:48 to 6:45:16 | 6:225:80 to 10:135:48 | 2:45:16 |
| M9.020 | 2:135:120 to 6:45:40 | 6:225:200 to 2:27:24 | 2:45:40 |
| M9.021 | 2:135:6 to 6:45:2 | 6:225:10 to 10:135:6 | 2:45:2 |
| M9.022 | 2:135:6 to 6:45:2 | 6:225:10 to 10:135:6 | 2:45:2 |
| M9.023 | 2:135:6 to 6:45:2 | 6:225:10 to 10:135:6 | 2:45:2 |
| M9.024 | 2:135:6 to 6:45:2 | 6:225:10 to 10:135:6 | 2:45:2 |
| M9.025 | 2:135:12 to 6:45:4 | 6:225:20 to 10:135:12 | 2:45:4 |

TABLE R10
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M10.001 | 1:3:3 to 3:1:1 | 3:5:5 to 5:3:3 | 1:1:1 |
| M10.002 | 2:6:9 to 6:2:3 | 6:10:15 to 10:6:9 | 2:2:3 |
| M10.003 | 1:3:6 to 3:1:2 | 3:5:10 to 5:3:6 | 1:1:2 |
| M10.004 | 1:3:6 to 3:1:2 | 3:5:10 to 5:3:6 | 1:1:2 |
| M10.005 | 1:3:6 to 3:1:2 | 3:5:10 to 5:3:6 | 1:1:2 |
| M10.006 | 1:3:6 to 3:1:2 | 3:5:10 to 5:3:6 | 1:1:2 |
| M10.007 | 1:3:30 to 3:1:10 | 3:5:50 to 5:3:30 | 1:1:10 |
| M10.008 | 1:3:6 to 3:1:2 | 3:5:10 to 5:3:6 | 1:1:2 |
| M10.009 | 1:3:18 to 3:1:6 | 3:5:30 to 5:3:18 | 1:1:6 |
| M10.010 | 1:3:18 to 3:1:6 | 3:5:30 to 5:3:18 | 1:1:6 |
| M10.011 | 1:3:6 to 3:1:2 | 3:5:10 to 5:3:6 | 1:1:2 |
| M10.012 | 1:3:3 to 3:1:1 | 3:5:5 to 5:3:3 | 1:1:1 |
| M10.013 | 1:3:6 to 3:1:2 | 3:5:10 to 5:3:6 | 1:1:2 |
| M10.014 | 1:3:6 to 3:1:2 | 3:5:10 to 5:3:6 | 1:1:2 |
| M10.015 | 1:3:3 to 3:1:1 | 3:5:5 to 5:3:3 | 1:1:1 |
| M10.016 | 2:6:9 to 6:2:3 | 6:10:15 to 10:6:9 | 2:2:3 |
| M10.017 | 1:3:24 to 3:1:8 | 3:5:40 to 5:3:24 | 1:1:8 |
| M10.018 | 1:3:24 to 3:1:8 | 3:5:40 to 5:3:24 | 1:1:8 |
| M10.019 | 1:3:60 to 3:1:20 | 3:5:100 to 5:3:60 | 1:1:20 |
| M10.020 | 1:3:3 to 3:1:1 | 3:5:5 to 5:3:3 | 1:1:1 |
| M10.021 | 1:3:3 to 3:1:1 | 3:5:5 to 5:3:3 | 1:1:1 |
| M10.022 | 1:3:3 to 3:1:1 | 3:5:5 to 5:3:3 | 1:1:1 |
| M10.023 | 1:3:3 to 3:1:1 | 3:5:5 to 5:3:3 | 1:1:1 |
| M10.024 | 1:3:6 to 3:1:2 | 3:5:10 to 5:3:6 | 1:1:2 |

TABLE R11
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M11.001 | 2:6:9 to 6:2:3 | 6:10:15 to 10:6:9 | 2:2:3 |
| M11.002 | 1:3:6 to 3:1:2 | 3:5:10 to 5:3:6 | 1:1:2 |
| M11.003 | 1:3:6 to 3:1:2 | 3:5:10 to 5:3:6 | 1:1:2 |
| M11.004 | 1:3:6 to 3:1:2 | 3:5:10 to 5:3:6 | 1:1:2 |
| M11.005 | 1:3:6 to 3:1:2 | 3:5:10 to 5:3:6 | 1:1:2 |
| M11.006 | 1:3:30 to 3:1:10 | 3:5:50 to 5:3:30 | 1:1:10 |
| M11.007 | 1:3:6 to 3:1:2 | 3:5:10 to 5:3:6 | 1:1:2 |
| M11.008 | 1:3:18 to 3:1:6 | 3:5:30 to 5:3:18 | 1:1:6 |
| M11.009 | 1:3:18 to 3:1:6 | 3:5:30 to 5:3:18 | 1:1:6 |
| M11.010 | 1:3:6 to 3:1:2 | 3:5:10 to 5:3:6 | 1:1:2 |
| M11.011 | 1:3:3 to 3:1:1 | 3:5:5 to 5:3:3 | 1:1:1 |
| M11.012 | 1:3:6 to 3:1:2 | 3:5:10 to 5:3:6 | 1:1:2 |
| M11.013 | 1:3:6 to 3:1:2 | 3:5:10 to 5:3:6 | 1:1:2 |
| M11.014 | 1:3:3 to 3:1:1 | 3:5:5 to 5:3:3 | 1:1:1 |
| M11.015 | 2:6:9 to 6:2:3 | 6:10:15 to 10:6:9 | 2:2:3 |
| M11.016 | 1:3:24 to 3:1:8 | 3:5:40 to 5:3:24 | 1:1:8 |
| M11.017 | 1:3:24 to 3:1:8 | 3:5:40 to 5:3:24 | 1:1:8 |
| M11.018 | 1:3:60 to 3:1:20 | 3:5:100 to 5:3:60 | 1:1:20 |
| M11.019 | 1:3:3 to 3:1:1 | 3:5:5 to 5:3:3 | 1:1:1 |
| M11.020 | 1:3:3 to 3:1:1 | 3:5:5 to 5:3:3 | 1:1:1 |
| M11.021 | 1:3:3 to 3:1:1 | 3:5:5 to 5:3:3 | 1:1:1 |
| M11.022 | 1:3:3 to 3:1:1 | 3:5:5 to 5:3:3 | 1:1:1 |
| M11.023 | 1:3:6 to 3:1:2 | 3:5:10 to 5:3:6 | 1:1:2 |

TABLE R12
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M12.001 | 2:9:12 to 6:3:4 | 6:15:20 to 10:9:12 | 2:3:4 |
| M12.002 | 2:9:12 to 6:3:4 | 6:15:20 to 10:9:12 | 2:3:4 |
| M12.003 | 2:9:12 to 6:3:4 | 6:15:20 to 10:9:12 | 2:3:4 |
| M12.004 | 2:9:12 to 6:3:4 | 6:15:20 to 10:9:12 | 2:3:4 |
| M12.005 | 2:9:60 to 6:3:20 | 6:15:100 to 10:9:60 | 2:3:20 |
| M12.006 | 2:9:12 to 6:3:4 | 6:15:20 to 10:9:12 | 2:3:4 |
| M12.007 | 2:9:36 to 2:1:4 | 2:5:20 to 10:9:36 | 2:3:12 |
| M12.008 | 2:9:36 to 2:1:4 | 2:5:20 to 10:9:36 | 2:3:12 |
| M12.009 | 2:9:12 to 6:3:4 | 6:15:20 to 10:9:12 | 2:3:4 |
| M12.010 | 2:9:6 to 6:3:2 | 6:15:10 to 10:9:6 | 2:3:2 |
| M12.011 | 2:9:12 to 6:3:4 | 6:15:20 to 10:9:12 | 2:3:4 |
| M12.012 | 2:9:12 to 6:3:4 | 6:15:20 to 10:9:12 | 2:3:4 |
| M12.013 | 2:9:6 to 6:3:2 | 6:15:10 to 10:9:6 | 2:3:2 |
| M12.014 | 2:9:9 to 2:1:1 | 2:5:5 to 10:9:9 | 2:3:3 |
| M12.015 | 2:9:48 to 6:3:16 | 6:15:80 to 10:9:48 | 2:3:16 |
| M12.016 | 2:9:48 to 6:3:16 | 6:15:80 to 10:9:48 | 2:3:16 |
| M12.017 | 2:9:120 to 6:3:40 | 6:15:200 to 10:9:120 | 2:3:40 |
| M12.018 | 2:9:6 to 6:3:2 | 6:15:10 to 10:9:6 | 2:3:2 |
| M12.019 | 2:9:6 to 6:3:2 | 6:15:10 to 10:9:6 | 2:3:2 |
| M12.020 | 2:9:6 to 6:3:2 | 6:15:10 to 10:9:6 | 2:3:2 |
| M12.021 | 2:9:6 to 6:3:2 | 6:15:10 to 10:9:6 | 2:3:2 |
| M12.022 | 2:9:12 to 6:3:4 | 6:15:20 to 10:9:12 | 2:3:4 |

TABLE R13
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M13.001 | 1:6:6 to 3:2:2 | 3:10:10 to 5:6:6 | 1:2:2 |
| M13.002 | 1:6:6 to 3:2:2 | 3:10:10 to 5:6:6 | 1:2:2 |
| M13.003 | 1:6:6 to 3:2:2 | 3:10:10 to 5:6:6 | 1:2:2 |
| M13.004 | 1:6:30 to 3:2:10 | 3:10:50 to 5:6:30 | 1:2:10 |
| M13.005 | 1:6:6 to 3:2:2 | 3:10:10 to 5:6:6 | 1:2:2 |
| M13.006 | 1:6:18 to 3:2:6 | 3:10:30 to 5:6:18 | 1:2:6 |
| M13.007 | 1:6:18 to 3:2:6 | 3:10:30 to 5:6:18 | 1:2:6 |
| M13.008 | 1:6:6 to 3:2:2 | 3:10:10 to 5:6:6 | 1:2:2 |
| M13.009 | 1:6:3 to 3:2:1 | 3:10:5 to 5:6:3 | 1:2:1 |
| M13.010 | 1:6:6 to 3:2:2 | 3:10:10 to 5:6:6 | 1:2:2 |
| M13.011 | 1:6:6 to 3:2:2 | 3:10:10 to 5:6:6 | 1:2:2 |
| M13.012 | 1:6:3 to 3:2:1 | 3:10:5 to 5:6:3 | 1:2:1 |
| M13.013 | 2:12:9 to 6:4:3 | 6:20:15 to 10:12:9 | 2:4:3 |
| M13.014 | 1:6:24 to 3:2:8 | 3:10:40 to 5:6:24 | 1:2:8 |
| M13.015 | 1:6:24 to 3:2:8 | 3:10:40 to 5:6:24 | 1:2:8 |
| M13.016 | 1:6:60 to 3:2:20 | 3:10:100 to 5:6:60 | 1:2:20 |
| M13.017 | 1:6:3 to 3:2:1 | 3:10:5 to 5:6:3 | 1:2:1 |
| M13.018 | 1:6:3 to 3:2:1 | 3:10:5 to 5:6:3 | 1:2:1 |
| M13.019 | 1:6:3 to 3:2:1 | 3:10:5 to 5:6:3 | 1:2:1 |
| M13.020 | 1:6:3 to 3:2:1 | 3:10:5 to 5:6:3 | 1:2:1 |
| M13.021 | 1:6:6 to 3:2:2 | 3:10:10 to 5:6:6 | 1:2:2 |

TABLE R14
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M14.001 | 1:6:6 to 3:2:2 | 3:10:10 to 5:6:6 | 1:2:2 |
| M14.002 | 1:6:6 to 3:2:2 | 3:10:10 to 5:6:6 | 1:2:2 |
| M14.003 | 1:6:30 to 3:2:10 | 3:10:50 to 5:6:30 | 1:2:10 |
| M14.004 | 1:6:6 to 3:2:2 | 3:10:10 to 5:6:6 | 1:2:2 |
| M14.005 | 1:6:18 to 3:2:6 | 3:10:30 to 5:6:18 | 1:2:6 |
| M14.006 | 1:6:18 to 3:2:6 | 3:10:30 to 5:6:18 | 1:2:6 |
| M14.007 | 1:6:6 to 3:2:2 | 3:10:10 to 5:6:6 | 1:2:2 |
| M14.008 | 1:6:3 to 3:2:1 | 3:10:5 to 5:6:3 | 1:2:1 |
| M14.009 | 1:6:6 to 3:2:2 | 3:10:10 to 5:6:6 | 1:2:2 |
| M14.010 | 1:6:6 to 3:2:2 | 3:10:10 to 5:6:6 | 1:2:2 |
| M14.011 | 1:6:3 to 3:2:1 | 3:10:5 to 5:6:3 | 1:2:1 |
| M14.012 | 2:12:9 to 6:4:3 | 6:20:15 to 10:12:9 | 2:4:3 |
| M14.013 | 1:6:24 to 3:2:8 | 3:10:40 to 5:6:24 | 1:2:8 |
| M14.014 | 1:6:24 to 3:2:8 | 3:10:40 to 5:6:24 | 1:2:8 |
| M14.015 | 1:6:60 to 3:2:20 | 3:10:100 to 5:6:60 | 1:2:20 |
| M14.016 | 1:6:3 to 3:2:1 | 3:10:5 to 5:6:3 | 1:2:1 |
| M14.017 | 1:6:3 to 3:2:1 | 3:10:5 to 5:6:3 | 1:2:1 |
| M14.018 | 1:6:3 to 3:2:1 | 3:10:5 to 5:6:3 | 1:2:1 |
| M14.019 | 1:6:3 to 3:2:1 | 3:10:5 to 5:6:3 | 1:2:1 |
| M14.020 | 1:6:6 to 3:2:2 | 3:10:10 to 5:6:6 | 1:2:2 |

TABLE R15
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M15.001 | 1:6:6 to 3:2:2 | 3:10:10 to 5:6:6 | 1:2:2 |
| M15.002 | 1:6:30 to 3:2:10 | 3:10:50 to 5:6:30 | 1:2:10 |
| M15.003 | 1:6:6 to 3:2:2 | 3:10:10 to 5:6:6 | 1:2:2 |
| M15.004 | 1:6:18 to 3:2:6 | 3:10:30 to 5:6:18 | 1:2:6 |
| M15.005 | 1:6:18 to 3:2:6 | 3:10:30 to 5:6:18 | 1:2:6 |
| M15.006 | 1:6:6 to 3:2:2 | 3:10:10 to 5:6:6 | 1:2:2 |
| M15.007 | 1:6:3 to 3:2:1 | 3:10:5 to 5:6:3 | 1:2:1 |
| M15.008 | 1:6:6 to 3:2:2 | 3:10:10 to 5:6:6 | 1:2:2 |
| M15.009 | 1:6:6 to 3:2:2 | 3:10:10 to 5:6:6 | 1:2:2 |
| M15.010 | 1:6:3 to 3:2:1 | 3:10:5 to 5:6:3 | 1:2:1 |
| M15.011 | 2:12:9 to 6:4:3 | 6:20:15 to 10:12:9 | 2:4:3 |
| M15.012 | 1:6:24 to 3:2:8 | 3:10:40 to 5:6:24 | 1:2:8 |
| M15.013 | 1:6:24 to 3:2:8 | 3:10:40 to 5:6:24 | 1:2:8 |
| M15.014 | 1:6:60 to 3:2:20 | 3:10:100 to 5:6:60 | 1:2:20 |
| M15.015 | 1:6:3 to 3:2:1 | 3:10:5 to 5:6:3 | 1:2:1 |
| M15.016 | 1:6:3 to 3:2:1 | 3:10:5 to 5:6:3 | 1:2:1 |
| M15.017 | 1:6:3 to 3:2:1 | 3:10:5 to 5:6:3 | 1:2:1 |
| M15.018 | 1:6:3 to 3:2:1 | 3:10:5 to 5:6:3 | 1:2:1 |
| M15.019 | 1:6:6 to 3:2:2 | 3:10:10 to 5:6:6 | 1:2:2 |

TABLE R16
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M16.001 | 1:6:30 to 3:2:10 | 3:10:50 to 5:6:30 | 1:2:10 |
| M16.002 | 1:6:6 to 3:2:2 | 3:10:10 to 5:6:6 | 1:2:2 |
| M16.003 | 1:6:18 to 3:2:6 | 3:10:30 to 5:6:18 | 1:2:6 |
| M16.004 | 1:6:18 to 3:2:6 | 3:10:30 to 5:6:18 | 1:2:6 |
| M16.005 | 1:6:6 to 3:2:2 | 3:10:10 to 5:6:6 | 1:2:2 |
| M16.006 | 1:6:3 to 3:2:1 | 3:10:5 to 5:6:3 | 1:2:1 |
| M16.007 | 1:6:6 to 3:2:2 | 3:10:10 to 5:6:6 | 1:2:2 |
| M16.008 | 1:6:6 to 3:2:2 | 3:10:10 to 5:6:6 | 1:2:2 |
| M16.009 | 1:6:3 to 3:2:1 | 3:10:5 to 5:6:3 | 1:2:1 |
| M16.010 | 2:12:9 to 6:4:3 | 6:20:15 to 10:12:9 | 2:4:3 |
| M16.011 | 1:6:24 to 3:2:8 | 3:10:40 to 5:6:24 | 1:2:8 |
| M16.012 | 1:6:24 to 3:2:8 | 3:10:40 to 5:6:24 | 1:2:8 |
| M16.013 | 1:6:60 to 3:2:20 | 3:10:100 to 5:6:60 | 1:2:20 |
| M16.014 | 1:6:3 to 3:2:1 | 3:10:5 to 5:6:3 | 1:2:1 |
| M16.015 | 1:6:3 to 3:2:1 | 3:10:5 to 5:6:3 | 1:2:1 |
| M16.016 | 1:6:3 to 3:2:1 | 3:10:5 to 5:6:3 | 1:2:1 |
| M16.017 | 1:6:3 to 3:2:1 | 3:10:5 to 5:6:3 | 1:2:1 |
| M16.018 | 1:6:6 to 3:2:2 | 3:10:10 to 5:6:6 | 1:2:2 |

TABLE R17
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M17.001 | 1:30:6 to 3:10:2 | 3:50:10 to 5:30:6 | 1:10:2 |
| M17.002 | 1:30:18 to 3:10:6 | 3:50:30 to 5:30:18 | 1:10:6 |
| M17.003 | 1:30:18 to 3:10:6 | 3:50:30 to 5:30:18 | 1:10:6 |
| M17.004 | 1:30:6 to 3:10:2 | 3:50:10 to 5:30:6 | 1:10:2 |
| M17.005 | 1:30:3 to 3:10:1 | 3:50:5 to 5:30:3 | 1:10:1 |
| M17.006 | 1:30:6 to 3:10:2 | 3:50:10 to 5:30:6 | 1:10:2 |
| M17.007 | 1:30:6 to 3:10:2 | 3:50:10 to 5:30:6 | 1:10:2 |
| M17.008 | 1:30:3 to 3:10:1 | 3:50:5 to 5:30:3 | 1:10:1 |
| M17.009 | 2:60:9 to 6:20:3 | 6:100:15 to 10:60:9 | 2:20:3 |
| M17.010 | 1:30:24 to 3:10:8 | 3:50:40 to 5:30:24 | 1:10:8 |
| M17.011 | 1:30:24 to 3:10:8 | 3:50:40 to 5:30:24 | 1:10:8 |
| M17.012 | 1:30:60 to 3:10:20 | 3:50:100 to 1:6:12 | 1:10:20 |
| M17.013 | 1:30:3 to 3:10:1 | 3:50:5 to 5:30:3 | 1:10:1 |
| M17.014 | 1:30:3 to 3:10:1 | 3:50:5 to 5:30:3 | 1:10:1 |
| M17.015 | 1:30:3 to 3:10:1 | 3:50:5 to 5:30:3 | 1:10:1 |
| M17.016 | 1:30:3 to 3:10:1 | 3:50:5 to 5:30:3 | 1:10:1 |
| M17.017 | 1:30:6 to 3:10:2 | 3:50:10 to 5:30:6 | 1:10:2 |

TABLE R18
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M18.001 | 1:6:18 to 3:2:6 | 3:10:30 to 5:6:18 | 1:2:6 |
| M18.002 | 1:6:18 to 3:2:6 | 3:10:30 to 5:6:18 | 1:2:6 |
| M18.003 | 1:6:6 to 3:2:2 | 3:10:10 to 5:6:6 | 1:2:2 |
| M18.004 | 1:6:3 to 3:2:1 | 3:10:5 to 5:6:3 | 1:2:1 |
| M18.005 | 1:6:6 to 3:2:2 | 3:10:10 to 5:6:6 | 1:2:2 |
| M18.006 | 1:6:6 to 3:2:2 | 3:10:10 to 5:6:6 | 1:2:2 |
| M18.007 | 1:6:3 to 3:2:1 | 3:10:5 to 5:6:3 | 1:2:1 |
| M18.008 | 2:12:9 to 6:4:3 | 6:20:15 to 10:12:9 | 2:4:3 |
| M18.009 | 1:6:24 to 3:2:8 | 3:10:40 to 5:6:24 | 1:2:8 |
| M18.010 | 1:6:24 to 3:2:8 | 3:10:40 to 5:6:24 | 1:2:8 |
| M18.011 | 1:6:60 to 3:2:20 | 3:10:100 to 5:6:60 | 1:2:20 |
| M18.012 | 1:6:3 to 3:2:1 | 3:10:5 to 5:6:3 | 1:2:1 |
| M18.013 | 1:6:3 to 3:2:1 | 3:10:5 to 5:6:3 | 1:2:1 |
| M18.014 | 1:6:3 to 3:2:1 | 3:10:5 to 5:6:3 | 1:2:1 |
| M18.015 | 1:6:3 to 3:2:1 | 3:10:5 to 5:6:3 | 1:2:1 |
| M18.016 | 1:6:6 to 3:2:2 | 3:10:10 to 5:6:6 | 1:2:2 |

TABLE R19
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M19.001 | 1:18:18 to 1:2:2 | 1:10:10 to 5:18:18 | 1:6:6 |
| M19.002 | 1:18:6 to 3:6:2 | 3:30:10 to 5:18:6 | 1:6:2 |
| M19.003 | 1:18:3 to 3:6:1 | 3:30:5 to 5:18:3 | 1:6:1 |
| M19.004 | 1:18:6 to 3:6:2 | 3:30:10 to 5:18:6 | 1:6:2 |
| M19.005 | 1:18:6 to 3:6:2 | 3:30:10 to 5:18:6 | 1:6:2 |
| M19.006 | 1:18:3 to 3:6:1 | 3:30:5 to 5:18:3 | 1:6:1 |
| M19.007 | 2:36:9 to 2:4:1 | 2:20:5 to 10:36:9 | 2:12:3 |
| M19.008 | 1:18:24 to 3:6:8 | 3:30:40 to 5:18:24 | 1:6:8 |
| M19.009 | 1:18:24 to 3:6:8 | 3:30:40 to 5:18:24 | 1:6:8 |
| M19.010 | 1:18:60 to 3:6:20 | 3:30:100 to 5:18:60 | 1:6:20 |
| M19.011 | 1:18:3 to 3:6:1 | 3:30:5 to 5:18:3 | 1:6:1 |
| M19.012 | 1:18:3 to 3:6:1 | 3:30:5 to 5:18:3 | 1:6:1 |
| M19.013 | 1:18:3 to 3:6:1 | 3:30:5 to 5:18:3 | 1:6:1 |
| M19.014 | 1:18:3 to 3:6:1 | 3:30:5 to 5:18:3 | 1:6:1 |
| M19.015 | 1:18:6 to 3:6:2 | 3:30:10 to 5:18:6 | 1:6:2 |

TABLE R20
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M20.001 | 1:18:6 to 3:6:2 | 3:30:10 to 5:18:6 | 1:6:2 |
| M20.002 | 1:18:3 to 3:6:1 | 3:30:5 to 5:18:3 | 1:6:1 |
| M20.003 | 1:18:6 to 3:6:2 | 3:30:10 to 5:18:6 | 1:6:2 |
| M20.004 | 1:18:6 to 3:6:2 | 3:30:10 to 5:18:6 | 1:6:2 |
| M20.005 | 1:18:3 to 3:6:1 | 3:30:5 to 5:18:3 | 1:6:1 |
| M20.006 | 2:36:9 to 2:4:1 | 2:20:5 to 10:36:9 | 2:12:3 |
| M20.007 | 1:18:24 to 3:6:8 | 3:30:40 to 5:18:24 | 1:6:8 |
| M20.008 | 1:18:24 to 3:6:8 | 3:30:40 to 5:18:24 | 1:6:8 |
| M20.009 | 1:18:60 to 3:6:20 | 3:30:100 to 5:18:60 | 1:6:20 |
| M20.010 | 1:18:3 to 3:6:1 | 3:30:5 to 5:18:3 | 1:6:1 |
| M20.011 | 1:18:3 to 3:6:1 | 3:30:5 to 5:18:3 | 1:6:1 |
| M20.012 | 1:18:3 to 3:6:1 | 3:30:5 to 5:18:3 | 1:6:1 |
| M20.013 | 1:18:3 to 3:6:1 | 3:30:5 to 5:18:3 | 1:6:1 |
| M20.014 | 1:18:6 to 3:6:2 | 3:30:10 to 5:18:6 | 1:6:2 |

TABLE R21
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M21.001 | 1:6:3 to 3:2:1 | 3:10:5 to 5:6:3 | 1:2:1 |
| M21.002 | 1:6:6 to 3:2:2 | 3:10:10 to 5:6:6 | 1:2:2 |
| M21.003 | 1:6:6 to 3:2:2 | 3:10:10 to 5:6:6 | 1:2:2 |
| M21.004 | 1:6:3 to 3:2:1 | 3:10:5 to 5:6:3 | 1:2:1 |
| M21.005 | 2:12:9 to 6:4:3 | 6:20:15 to 10:12:9 | 2:4:3 |
| M21.006 | 1:6:24 to 3:2:8 | 3:10:40 to 5:6:24 | 1:2:8 |
| M21.007 | 1:6:24 to 3:2:8 | 3:10:40 to 5:6:24 | 1:2:8 |
| M21.008 | 1:6:60 to 3:2:20 | 3:10:100 to 5:6:60 | 1:2:20 |
| M21.009 | 1:6:3 to 3:2:1 | 3:10:5 to 5:6:3 | 1:2:1 |
| M21.010 | 1:6:3 to 3:2:1 | 3:10:5 to 5:6:3 | 1:2:1 |
| M21.011 | 1:6:3 to 3:2:1 | 3:10:5 to 5:6:3 | 1:2:1 |
| M21.012 | 1:6:3 to 3:2:1 | 3:10:5 to 5:6:3 | 1:2:1 |
| M21.013 | 1:6:6 to 3:2:2 | 3:10:10 to 5:6:6 | 1:2:2 |

TABLE R22
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M22.001 | 1:3:6 to 3:1:2 | 3:5:10 to 5:3:6 | 1:1:2 |
| M22.002 | 1:3:6 to 3:1:2 | 3:5:10 to 5:3:6 | 1:1:2 |
| M22.003 | 1:3:3 to 3:1:1 | 3:5:5 to 5:3:3 | 1:1:1 |
| M22.004 | 2:6:9 to 6:2:3 | 6:10:15 to 10:6:9 | 2:2:3 |
| M22.005 | 1:3:24 to 3:1:8 | 3:5:40 to 5:3:24 | 1:1:8 |
| M22.006 | 1:3:24 to 3:1:8 | 3:5:40 to 5:3:24 | 1:1:8 |
| M22.007 | 1:3:60 to 3:1:20 | 3:5:100 to 5:3:60 | 1:1:20 |
| M22.008 | 1:3:3 to 3:1:1 | 3:5:5 to 5:3:3 | 1:1:1 |
| M22.009 | 1:3:3 to 3:1:1 | 3:5:5 to 5:3:3 | 1:1:1 |
| M22.010 | 1:3:3 to 3:1:1 | 3:5:5 to 5:3:3 | 1:1:1 |
| M22.011 | 1:3:3 to 3:1:1 | 3:5:5 to 5:3:3 | 1:1:1 |
| M22.012 | 1:3:6 to 3:1:2 | 3:5:10 to 5:3:6 | 1:1:2 |

TABLE R23
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M23.001 | 1:6:6 to 3:2:2 | 3:10:10 to 5:6:6 | 1:2:2 |
| M23.002 | 1:6:3 to 3:2:1 | 3:10:5 to 5:6:3 | 1:2:1 |
| M23.003 | 2:12:9 to 6:4:3 | 6:20:15 to 10:12:9 | 2:4:3 |
| M23.004 | 1:6:24 to 3:2:8 | 3:10:40 to 5:6:24 | 1:2:8 |
| M23.005 | 1:6:24 to 3:2:8 | 3:10:40 to 5:6:24 | 1:2:8 |
| M23.006 | 1:6:60 to 3:2:20 | 3:10:100 to 5:6:60 | 1:2:20 |
| M23.007 | 1:6:3 to 3:2:1 | 3:10:5 to 5:6:3 | 1:2:1 |
| M23.008 | 1:6:3 to 3:2:1 | 3:10:5 to 5:6:3 | 1:2:1 |
| M23.009 | 1:6:3 to 3:2:1 | 3:10:5 to 5:6:3 | 1:2:1 |
| M23.010 | 1:6:3 to 3:2:1 | 3:10:5 to 5:6:3 | 1:2:1 |
| M23.011 | 1:6:6 to 3:2:2 | 3:10:10 to 5:6:6 | 1:2:2 |

TABLE R24
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M24.001 | 1:6:3 to 3:2:1 | 3:10:5 to 5:6:3 | 1:2:1 |
| M24.002 | 2:12:9 to 6:4:3 | 6:20:15 to 10:12:9 | 2:4:3 |
| M24.003 | 1:6:24 to 3:2:8 | 3:10:40 to 5:6:24 | 1:2:8 |
| M24.004 | 1:6:24 to 3:2:8 | 3:10:40 to 5:6:24 | 1:2:8 |
| M24.005 | 1:6:60 to 3:2:20 | 3:10:100 to 5:6:60 | 1:2:20 |
| M24.006 | 1:6:3 to 3:2:1 | 3:10:5 to 5:6:3 | 1:2:1 |
| M24.007 | 1:6:3 to 3:2:1 | 3:10:5 to 5:6:3 | 1:2:1 |
| M24.008 | 1:6:3 to 3:2:1 | 3:10:5 to 5:6:3 | 1:2:1 |
| M24.009 | 1:6:3 to 3:2:1 | 3:10:5 to 5:6:3 | 1:2:1 |
| M24.010 | 1:6:6 to 3:2:2 | 3:10:10 to 5:6:6 | 1:2:2 |

TABLE R25
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M25.001 | 2:6:9 to 6:2:3 | 6:10:15 to 10:6:9 | 2:2:3 |
| M25.002 | 1:3:24 to 3:1:8 | 3:5:40 to 5:3:24 | 1:1:8 |
| M25.003 | 1:3:24 to 3:1:8 | 3:5:40 to 5:3:24 | 1:1:8 |
| M25.004 | 1:3:60 to 3:1:20 | 3:5:100 to 5:3:60 | 1:1:20 |
| M25.005 | 1:3:3 to 3:1:1 | 3:5:5 to 5:3:3 | 1:1:1 |
| M25.006 | 1:3:3 to 3:1:1 | 3:5:5 to 5:3:3 | 1:1:1 |
| M25.007 | 1:3:3 to 3:1:1 | 3:5:5 to 5:3:3 | 1:1:1 |
| M25.008 | 1:3:3 to 3:1:1 | 3:5:5 to 5:3:3 | 1:1:1 |
| M25.009 | 1:3:6 to 3:1:2 | 3:5:10 to 5:3:6 | 1:1:2 |

TABLE R26
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M26.001 | 2:9:48 to 6:3:16 | 6:15:80 to 10:9:48 | 2:3:16 |
| M26.002 | 2:9:48 to 6:3:16 | 6:15:80 to 10:9:48 | 2:3:16 |
| M26.003 | 2:9:120 to 6:3:40 | 6:15:200 to 10:9:120 | 2:3:40 |
| M26.004 | 2:9:6 to 6:3:2 | 6:15:10 to 10:9:6 | 2:3:2 |
| M26.005 | 2:9:6 to 6:3:2 | 6:15:10 to 10:9:6 | 2:3:2 |
| M26.006 | 2:9:6 to 6:3:2 | 6:15:10 to 10:9:6 | 2:3:2 |
| M26.007 | 2:9:6 to 6:3:2 | 6:15:10 to 10:9:6 | 2:3:2 |
| M26.008 | 2:9:12 to 6:3:4 | 6:15:20 to 10:9:12 | 2:3:4 |

TABLE R27
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M27.001 | 1:24:24 to 3:8:8 | 3:40:40 to 5:24:24 | 1:8:8 |
| M27.002 | 1:24:60 to 3:8:20 | 3:40:100 to 5:24:60 | 1:8:20 |
| M27.003 | 1:24:3 to 3:8:1 | 3:40:5 to 5:24:3 | 1:8:1 |
| M27.004 | 1:24:3 to 3:8:1 | 3:40:5 to 5:24:3 | 1:8:1 |
| M27.005 | 1:24:3 to 3:8:1 | 3:40:5 to 5:24:3 | 1:8:1 |
| M27.006 | 1:24:3 to 3:8:1 | 3:40:5 to 5:24:3 | 1:8:1 |
| M27.007 | 1:24:6 to 3:8:2 | 3:40:10 to 5:24:6 | 1:8:2 |

TABLE R28
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M28.001 | 1:24:60 to 3:8:20 | 3:40:100 to 5:24:60 | 1:8:20 |
| M28.002 | 1:24:3 to 3:8:1 | 3:40:5 to 5:24:3 | 1:8:1 |
| M28.003 | 1:24:3 to 3:8:1 | 3:40:5 to 5:24:3 | 1:8:1 |
| M28.004 | 1:24:3 to 3:8:1 | 3:40:5 to 5:24:3 | 1:8:1 |
| M28.005 | 1:24:3 to 3:8:1 | 3:40:5 to 5:24:3 | 1:8:1 |
| M28.006 | 1:24:6 to 3:8:2 | 3:40:10 to 5:24:6 | 1:8:2 |

TABLE R29
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M29.001 | 1:60:3 to 3:20:1 | 3:100:5 to 5:60:3 | 1:20:1 |
| M29.002 | 1:60:3 to 3:20:1 | 3:100:5 to 5:60:3 | 1:20:1 |
| M29.003 | 1:60:3 to 3:20:1 | 3:100:5 to 5:60:3 | 1:20:1 |
| M29.004 | 1:60:3 to 3:20:1 | 3:100:5 to 5:60:3 | 1:20:1 |
| M29.005 | 1:60:6 to 3:20:2 | 3:100:10 to 5:60:6 | 1:20:2 |

TABLE R30
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M30.001 | 1:3:3 to 3:1:1 | 3:5:5 to 5:3:3 | 1:1:1 |
| M30.002 | 1:3:3 to 3:1:1 | 3:5:5 to 5:3:3 | 1:1:1 |
| M30.003 | 1:3:3 to 3:1:1 | 3:5:5 to 5:3:3 | 1:1:1 |
| M30.004 | 1:3:6 to 3:1:2 | 3:5:10 to 5:3:6 | 1:1:2 |

TABLE R31
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M31.001 | 1:3:3 to 3:1:1 | 3:5:5 to 5:3:3 | 1:1:1 |
| M31.002 | 1:3:3 to 3:1:1 | 3:5:5 to 5:3:3 | 1:1:1 |
| M31.003 | 1:3:6 to 3:1:2 | 3:5:10 to 5:3:6 | 1:1:2 |

TABLE R32
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M32.001 | 1:3:3 to 3:1:1 | 3:5:5 to 5:3:3 | 1:1:1 |
| M32.002 | 1:3:6 to 3:1:2 | 3:5:10 to 5:3:6 | 1:1:2 |
| M32.003 | 1:3:6 to 3:1:2 | 3:5:10 to 5:3:6 | 1:1:2 |

TABLE R33
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M33.001 | 1:3:6 to 3:1:2 | 3:5:10 to 5:3:6 | 1:1:2 |
| M33.002 | 1:3:3 to 3:1:1 | 3:5:5 to 5:3:3 | 1:1:1 |
| M33.003 | 1:3:6 to 3:1:2 | 3:5:10 to 5:3:6 | 1:1:2 |
| M33.004 | 1:3:6 to 3:1:2 | 3:5:10 to 5:3:6 | 1:1:2 |
| M33.005 | 1:3:3 to 3:1:1 | 3:5:5 to 5:3:3 | 1:1:1 |
| M33.006 | 2:6:9 to 6:2:3 | 6:10:15 to 10:6:9 | 2:2:3 |
| M33.007 | 1:3:3 to 3:1:1 | 3:5:5 to 5:3:3 | 1:1:1 |
| M33.008 | 2:6:135 to 6:2:45 | 6:10:225 to 10:6:135 | 2:2:45 |
| M33.009 | 1:3:3 to 3:1:1 | 3:5:5 to 5:3:3 | 1:1:1 |
| M33.010 | 1:3:3 to 3:1:1 | 3:5:5 to 5:3:3 | 1:1:1 |
| M33.011 | 2:6:9 to 6:2:3 | 6:10:15 to 10:6:9 | 2:2:3 |
| M33.012 | 1:3:6 to 3:1:2 | 3:5:10 to 5:3:6 | 1:1:2 |
| M33.013 | 1:3:6 to 3:1:2 | 3:5:10 to 5:3:6 | 1:1:2 |
| M33.014 | 1:3:6 to 3:1:2 | 3:5:10 to 5:3:6 | 1:1:2 |
| M33.015 | 1:3:6 to 3:1:2 | 3:5:10 to 5:3:6 | 1:1:2 |
| M33.016 | 1:3:30 to 3:1:10 | 3:5:50 to 5:3:30 | 1:1:10 |
| M33.017 | 1:3:6 to 3:1:2 | 3:5:10 to 5:3:6 | 1:1:2 |
| M33.018 | 1:3:18 to 3:1:6 | 3:5:30 to 5:3:18 | 1:1:6 |
| M33.019 | 1:3:18 to 3:1:6 | 3:5:30 to 5:3:18 | 1:1:6 |
| M33.020 | 1:3:6 to 3:1:2 | 3:5:10 to 5:3:6 | 1:1:2 |
| M33.021 | 1:3:3 to 3:1:1 | 3:5:5 to 5:3:3 | 1:1:1 |
| M33.022 | 1:3:6 to 3:1:2 | 3:5:10 to 5:3:6 | 1:1:2 |
| M33.023 | 1:3:6 to 3:1:2 | 3:5:10 to 5:3:6 | 1:1:2 |
| M33.024 | 1:3:3 to 3:1:1 | 3:5:5 to 5:3:3 | 1:1:1 |
| M33.025 | 2:6:9 to 6:2:3 | 6:10:15 to 10:6:9 | 2:2:3 |
| M33.026 | 1:3:24 to 3:1:8 | 3:5:40 to 5:3:24 | 1:1:8 |
| M33.027 | 1:3:24 to 3:1:8 | 3:5:40 to 5:3:24 | 1:1:8 |
| M33.028 | 1:3:60 to 3:1:20 | 3:5:100 to 5:3:60 | 1:1:20 |
| M33.029 | 1:3:3 to 3:1:1 | 3:5:5 to 5:3:3 | 1:1:1 |
| M33.030 | 1:3:3 to 3:1:1 | 3:5:5 to 5:3:3 | 1:1:1 |
| M33.031 | 1:3:3 to 3:1:1 | 3:5:5 to 5:3:3 | 1:1:1 |
| M33.032 | 1:3:3 to 3:1:1 | 3:5:5 to 5:3:3 | 1:1:1 |
| M33.033 | 1:3:6 to 3:1:2 | 3:5:10 to 5:3:6 | 1:1:2 |

TABLE R34
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M34.001 | 1:6:3 to 3:2:1 | 3:10:5 to 5:6:3 | 1:2:1 |
| M34.002 | 1:6:6 to 3:2:2 | 3:10:10 to 5:6:6 | 1:2:2 |
| M34.003 | 1:6:6 to 3:2:2 | 3:10:10 to 5:6:6 | 1:2:2 |
| M34.004 | 1:6:3 to 3:2:1 | 3:10:5 to 5:6:3 | 1:2:1 |
| M34.005 | 2:12:9 to 6:4:3 | 6:20:15 to 10:12:9 | 2:4:3 |
| M34.006 | 1:6:3 to 3:2:1 | 3:10:5 to 5:6:3 | 1:2:1 |
| M34.007 | 2:12:135 to 6:4:45 | 6:20:225 to 10:12:135 | 2:4:45 |
| M34.008 | 1:6:3 to 3:2:1 | 3:10:5 to 5:6:3 | 1:2:1 |
| M34.009 | 1:6:3 to 3:2:1 | 3:10:5 to 5:6:3 | 1:2:1 |
| M34.010 | 2:12:9 to 6:4:3 | 6:20:15 to 10:12:9 | 2:4:3 |
| M34.011 | 1:6:6 to 3:2:2 | 3:10:10 to 5:6:6 | 1:2:2 |
| M34.012 | 1:6:6 to 3:2:2 | 3:10:10 to 5:6:6 | 1:2:2 |
| M34.013 | 1:6:6 to 3:2:2 | 3:10:10 to 5:6:6 | 1:2:2 |
| M34.014 | 1:6:6 to 3:2:2 | 3:10:10 to 5:6:6 | 1:2:2 |
| M34.015 | 1:6:30 to 3:2:10 | 3:10:50 to 5:6:30 | 1:2:10 |
| M34.016 | 1:6:6 to 3:2:2 | 3:10:10 to 5:6:6 | 1:2:2 |
| M34.017 | 1:6:18 to 3:2:6 | 3:10:30 to 5:6:18 | 1:2:6 |
| M34.018 | 1:6:18 to 3:2:6 | 3:10:30 to 5:6:18 | 1:2:6 |
| M34.019 | 1:6:6 to 3:2:2 | 3:10:10 to 5:6:6 | 1:2:2 |
| M34.020 | 1:6:3 to 3:2:1 | 3:10:5 to 5:6:3 | 1:2:1 |
| M34.021 | 1:6:6 to 3:2:2 | 3:10:10 to 5:6:6 | 1:2:2 |
| M34.022 | 1:6:6 to 3:2:2 | 3:10:10 to 5:6:6 | 1:2:2 |
| M34.023 | 1:6:3 to 3:2:1 | 3:10:5 to 5:6:3 | 1:2:1 |
| M34.024 | 2:12:9 to 6:4:3 | 6:20:15 to 10:12:9 | 2:4:3 |
| M34.025 | 1:6:24 to 3:2:8 | 3:10:40 to 5:6:24 | 1:2:8 |
| M34.026 | 1:6:24 to 3:2:8 | 3:10:40 to 5:6:24 | 1:2:8 |
| M34.027 | 1:6:60 to 3:2:20 | 3:10:100 to 5:6:60 | 1:2:20 |
| M34.028 | 1:6:3 to 3:2:1 | 3:10:5 to 5:6:3 | 1:2:1 |
| M34.029 | 1:6:3 to 3:2:1 | 3:10:5 to 5:6:3 | 1:2:1 |
| M34.030 | 1:6:3 to 3:2:1 | 3:10:5 to 5:6:3 | 1:2:1 |
| M34.031 | 1:6:3 to 3:2:1 | 3:10:5 to 5:6:3 | 1:2:1 |
| M34.032 | 1:6:6 to 3:2:2 | 3:10:10 to 5:6:6 | 1:2:2 |

TABLE R35
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M35.001 | 1:3:6 to 3:1:2 | 3:5:10 to 5:3:6 | 1:1:2 |
| M35.002 | 1:3:6 to 3:1:2 | 3:5:10 to 5:3:6 | 1:1:2 |
| M35.003 | 1:3:3 to 3:1:1 | 3:5:5 to 5:3:3 | 1:1:1 |
| M35.004 | 2:6:9 to 6:2:3 | 6:10:15 to 10:6:9 | 2:2:3 |
| M35.005 | 1:3:3 to 3:1:1 | 3:5:5 to 5:3:3 | 1:1:1 |
| M35.006 | 2:6:135 to 6:2:45 | 6:10:225 to 10:6:135 | 2:2:45 |
| M35.007 | 1:3:3 to 3:1:1 | 3:5:5 to 5:3:3 | 1:1:1 |
| M35.008 | 1:3:3 to 3:1:1 | 3:5:5 to 5:3:3 | 1:1:1 |
| M35.009 | 2:6:9 to 6:2:3 | 6:10:15 to 10:6:9 | 2:2:3 |
| M35.010 | 1:3:6 to 3:1:2 | 3:5:10 to 5:3:6 | 1:1:2 |
| M35.011 | 1:3:6 to 3:1:2 | 3:5:10 to 5:3:6 | 1:1:2 |
| M35.012 | 1:3:6 to 3:1:2 | 3:5:10 to 5:3:6 | 1:1:2 |
| M35.013 | 1:3:6 to 3:1:2 | 3:5:10 to 5:3:6 | 1:1:2 |
| M35.014 | 1:3:30 to 3:1:10 | 3:5:50 to 5:3:30 | 1:1:10 |
| M35.015 | 1:3:6 to 3:1:2 | 3:5:10 to 5:3:6 | 1:1:2 |
| M35.016 | 1:3:18 to 3:1:6 | 3:5:30 to 5:3:18 | 1:1:6 |
| M35.017 | 1:3:18 to 3:1:6 | 3:5:30 to 5:3:18 | 1:1:6 |
| M35.018 | 1:3:6 to 3:1:2 | 3:5:10 to 5:3:6 | 1:1:2 |
| M35.019 | 1:3:3 to 3:1:1 | 3:5:5 to 5:3:3 | 1:1:1 |
| M35.020 | 1:3:6 to 3:1:2 | 3:5:10 to 5:3:6 | 1:1:2 |
| M35.021 | 1:3:6 to 3:1:2 | 3:5:10 to 5:3:6 | 1:1:2 |
| M35.022 | 1:3:3 to 3:1:1 | 3:5:5 to 5:3:3 | 1:1:1 |
| M35.023 | 2:6:9 to 6:2:3 | 6:10:15 to 10:6:9 | 2:2:3 |
| M35.024 | 1:3:24 to 3:1:8 | 3:5:40 to 5:3:24 | 1:1:8 |
| M35.025 | 1:3:24 to 3:1:8 | 3:5:40 to 5:3:24 | 1:1:8 |
| M35.026 | 1:3:60 to 3:1:20 | 3:5:100 to 5:3:60 | 1:1:20 |
| M35.027 | 1:3:3 to 3:1:1 | 3:5:5 to 5:3:3 | 1:1:1 |
| M35.028 | 1:3:3 to 3:1:1 | 3:5:5 to 5:3:3 | 1:1:1 |
| M35.029 | 1:3:3 to 3:1:1 | 3:5:5 to 5:3:3 | 1:1:1 |
| M35.030 | 1:3:3 to 3:1:1 | 3:5:5 to 5:3:3 | 1:1:1 |
| M35.031 | 1:3:6 to 3:1:2 | 3:5:10 to 5:3:6 | 1:1:2 |

TABLE R36
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M36.001 | 1:6:6 to 3:2:2 | 3:10:10 to 5:6:6 | 1:2:2 |
| M36.002 | 1:6:3 to 3:2:1 | 3:10:5 to 5:6:3 | 1:2:1 |
| M36.003 | 2:12:9 to 6:4:3 | 6:20:15 to 10:12:9 | 2:4:3 |
| M36.004 | 1:6:3 to 3:2:1 | 3:10:5 to 5:6:3 | 1:2:1 |
| M36.005 | 2:12:135 to 6:4:45 | 6:20:225 to 10:12:135 | 2:4:45 |
| M36.006 | 1:6:3 to 3:2:1 | 3:10:5 to 5:6:3 | 1:2:1 |
| M36.007 | 1:6:3 to 3:2:1 | 3:10:5 to 5:6:3 | 1:2:1 |
| M36.008 | 2:12:9 to 6:4:3 | 6:20:15 to 10:12:9 | 2:4:3 |
| M36.009 | 1:6:6 to 3:2:2 | 3:10:10 to 5:6:6 | 1:2:2 |
| M36.010 | 1:6:6 to 3:2:2 | 3:10:10 to 5:6:6 | 1:2:2 |
| M36.011 | 1:6:6 to 3:2:2 | 3:10:10 to 5:6:6 | 1:2:2 |
| M36.012 | 1:6:6 to 3:2:2 | 3:10:10 to 5:6:6 | 1:2:2 |
| M36.013 | 1:6:30 to 3:2:10 | 3:10:50 to 5:6:30 | 1:2:10 |
| M36.014 | 1:6:6 to 3:2:2 | 3:10:10 to 5:6:6 | 1:2:2 |
| M36.015 | 1:6:18 to 3:2:6 | 3:10:30 to 5:6:18 | 1:2:6 |
| M36.016 | 1:6:18 to 3:2:6 | 3:10:30 to 5:6:18 | 1:2:6 |
| M36.017 | 1:6:6 to 3:2:2 | 3:10:10 to 5:6:6 | 1:2:2 |
| M36.018 | 1:6:3 to 3:2:1 | 3:10:5 to 5:6:3 | 1:2:1 |
| M36.019 | 1:6:6 to 3:2:2 | 3:10:10 to 5:6:6 | 1:2:2 |
| M36.020 | 1:6:6 to 3:2:2 | 3:10:10 to 5:6:6 | 1:2:2 |
| M36.021 | 1:6:3 to 3:2:1 | 3:10:5 to 5:6:3 | 1:2:1 |
| M36.022 | 2:12:9 to 6:4:3 | 6:20:15 to 10:12:9 | 2:4:3 |
| M36.023 | 1:6:24 to 3:2:8 | 3:10:40 to 5:6:24 | 1:2:8 |
| M36.024 | 1:6:24 to 3:2:8 | 3:10:40 to 5:6:24 | 1:2:8 |
| M36.025 | 1:6:60 to 3:2:20 | 3:10:100 to 5:6:60 | 1:2:20 |
| M36.026 | 1:6:3 to 3:2:1 | 3:10:5 to 5:6:3 | 1:2:1 |
| M36.027 | 1:6:3 to 3:2:1 | 3:10:5 to 5:6:3 | 1:2:1 |
| M36.028 | 1:6:3 to 3:2:1 | 3:10:5 to 5:6:3 | 1:2:1 |
| M36.029 | 1:6:3 to 3:2:1 | 3:10:5 to 5:6:3 | 1:2:1 |
| M36.030 | 1:6:6 to 3:2:2 | 3:10:10 to 5:6:6 | 1:2:2 |

TABLE R37
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M37.001 | 1:6:3 to 3:2:1 | 3:10:5 to 5:6:3 | 1:2:1 |
| M37.002 | 2:12:9 to 6:4:3 | 6:20:15 to 10:12:9 | 2:4:3 |
| M37.003 | 1:6:3 to 3:2:1 | 3:10:5 to 5:6:3 | 1:2:1 |
| M37.004 | 2:12:135 to 6:4:45 | 6:20:225 to 10:12:135 | 2:4:45 |
| M37.005 | 1:6:3 to 3:2:1 | 3:10:5 to 5:6:3 | 1:2:1 |
| M37.006 | 1:6:3 to 3:2:1 | 3:10:5 to 5:6:3 | 1:2:1 |
| M37.007 | 2:12:9 to 6:4:3 | 6:20:15 to 10:12:9 | 2:4:3 |
| M37.008 | 1:6:6 to 3:2:2 | 3:10:10 to 5:6:6 | 1:2:2 |
| M37.009 | 1:6:6 to 3:2:2 | 3:10:10 to 5:6:6 | 1:2:2 |
| M37.010 | 1:6:6 to 3:2:2 | 3:10:10 to 5:6:6 | 1:2:2 |
| M37.011 | 1:6:6 to 3:2:2 | 3:10:10 to 5:6:6 | 1:2:2 |
| M37.012 | 1:6:30 to 3:2:10 | 3:10:50 to 5:6:30 | 1:2:10 |
| M37.013 | 1:6:6 to 3:2:2 | 3:10:10 to 5:6:6 | 1:2:2 |
| M37.014 | 1:6:18 to 3:2:6 | 3:10:30 to 5:6:18 | 1:2:6 |
| M37.015 | 1:6:18 to 3:2:6 | 3:10:30 to 5:6:18 | 1:2:6 |
| M37.016 | 1:6:6 to 3:2:2 | 3:10:10 to 5:6:6 | 1:2:2 |
| M37.017 | 1:6:3 to 3:2:1 | 3:10:5 to 5:6:3 | 1:2:1 |
| M37.018 | 1:6:6 to 3:2:2 | 3:10:10 to 5:6:6 | 1:2:2 |
| M37.019 | 1:6:6 to 3:2:2 | 3:10:10 to 5:6:6 | 1:2:2 |
| M37.020 | 1:6:3 to 3:2:1 | 3:10:5 to 5:6:3 | 1:2:1 |
| M37.021 | 2:12:9 to 6:4:3 | 6:20:15 to 10:12:9 | 2:4:3 |
| M37.022 | 1:6:24 to 3:2:8 | 3:10:40 to 5:6:24 | 1:2:8 |
| M37.023 | 1:6:24 to 3:2:8 | 3:10:40 to 5:6:24 | 1:2:8 |
| M37.024 | 1:6:60 to 3:2:20 | 3:10:100 to 5:6:60 | 1:2:20 |
| M37.025 | 1:6:3 to 3:2:1 | 3:10:5 to 5:6:3 | 1:2:1 |
| M37.026 | 1:6:3 to 3:2:1 | 3:10:5 to 5:6:3 | 1:2:1 |
| M37.027 | 1:6:3 to 3:2:1 | 3:10:5 to 5:6:3 | 1:2:1 |
| M37.028 | 1:6:3 to 3:2:1 | 3:10:5 to 5:6:3 | 1:2:1 |
| M37.029 | 1:6:6 to 3:2:2 | 3:10:10 to 5:6:6 | 1:2:2 |

TABLE R38
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M38.001 | 2:6:9 to 6:2:3 | 6:10:15 to 10:6:9 | 2:2:3 |
| M38.002 | 1:3:3 to 3:1:1 | 3:5:5 to 5:3:3 | 1:1:1 |
| M38.003 | 2:6:135 to 6:2:45 | 6:10:225 to 10:6:135 | 2:2:45 |
| M38.004 | 1:3:3 to 3:1:1 | 3:5:5 to 5:3:3 | 1:1:1 |
| M38.005 | 1:3:3 to 3:1:1 | 3:5:5 to 5:3:3 | 1:1:1 |
| M38.006 | 2:6:9 to 6:2:3 | 6:10:15 to 10:6:9 | 2:2:3 |
| M38.007 | 1:3:6 to 3:1:2 | 3:5:10 to 5:3:6 | 1:1:2 |
| M38.008 | 1:3:6 to 3:1:2 | 3:5:10 to 5:3:6 | 1:1:2 |
| M38.009 | 1:3:6 to 3:1:2 | 3:5:10 to 5:3:6 | 1:1:2 |
| M38.010 | 1:3:6 to 3:1:2 | 3:5:10 to 5:3:6 | 1:1:2 |
| M38.011 | 1:3:30 to 3:1:10 | 3:5:50 to 5:3:30 | 1:1:10 |
| M38.012 | 1:3:6 to 3:1:2 | 3:5:10 to 5:3:6 | 1:1:2 |
| M38.013 | 1:3:18 to 3:1:6 | 3:5:30 to 5:3:18 | 1:1:6 |
| M38.014 | 1:3:18 to 3:1:6 | 3:5:30 to 5:3:18 | 1:1:6 |
| M38.015 | 1:3:6 to 3:1:2 | 3:5:10 to 5:3:6 | 1:1:2 |
| M38.016 | 1:3:3 to 3:1:1 | 3:5:5 to 5:3:3 | 1:1:1 |
| M38.017 | 1:3:6 to 3:1:2 | 3:5:10 to 5:3:6 | 1:1:2 |
| M38.018 | 1:3:6 to 3:1:2 | 3:5:10 to 5:3:6 | 1:1:2 |
| M38.019 | 1:3:3 to 3:1:1 | 3:5:5 to 5:3:3 | 1:1:1 |
| M38.020 | 2:6:9 to 6:2:3 | 6:10:15 to 10:6:9 | 2:2:3 |
| M38.021 | 1:3:24 to 3:1:8 | 3:5:40 to 5:3:24 | 1:1:8 |
| M38.022 | 1:3:24 to 3:1:8 | 3:5:40 to 5:3:24 | 1:1:8 |
| M38.023 | 1:3:60 to 3:1:20 | 3:5:100 to 5:3:60 | 1:1:20 |
| M38.024 | 1:3:3 to 3:1:1 | 3:5:5 to 5:3:3 | 1:1:1 |
| M38.025 | 1:3:3 to 3:1:1 | 3:5:5 to 5:3:3 | 1:1:1 |
| M38.026 | 1:3:3 to 3:1:1 | 3:5:5 to 5:3:3 | 1:1:1 |
| M38.027 | 1:3:3 to 3:1:1 | 3:5:5 to 5:3:3 | 1:1:1 |
| M38.028 | 1:3:6 to 3:1:2 | 3:5:10 to 5:3:6 | 1:1:2 |

TABLE R39
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M39.001 | 2:9:6 to 6:3:2 | 6:15:10 to 10:9:6 | 2:3:2 |
| M39.002 | 2:9:135 to 2:1:15 | 2:5:75 to 10:9:135 | 2:3:45 |
| M39.003 | 2:9:6 to 6:3:2 | 6:15:10 to 10:9:6 | 2:3:2 |
| M39.004 | 2:9:6 to 6:3:2 | 6:15:10 to 10:9:6 | 2:3:2 |
| M39.005 | 2:9:9 to 2:1:1 | 2:5:5 to 10:9:9 | 2:3:3 |
| M39.006 | 2:9:12 to 6:3:4 | 6:15:20 to 10:9:12 | 2:3:4 |
| M39.007 | 2:9:12 to 6:3:4 | 6:15:20 to 10:9:12 | 2:3:4 |
| M39.008 | 2:9:12 to 6:3:4 | 6:15:20 to 10:9:12 | 2:3:4 |
| M39.009 | 2:9:12 to 6:3:4 | 6:15:20 to 10:9:12 | 2:3:4 |
| M39.010 | 2:9:60 to 6:3:20 | 6:15:100 to 10:9:60 | 2:3:20 |
| M39.011 | 2:9:12 to 6:3:4 | 6:15:20 to 10:9:12 | 2:3:4 |
| M39.012 | 2:9:36 to 2:1:4 | 2:5:20 to 10:9:36 | 2:3:12 |
| M39.013 | 2:9:36 to 2:1:4 | 2:5:20 to 10:9:36 | 2:3:12 |
| M39.014 | 2:9:12 to 6:3:4 | 6:15:20 to 10:9:12 | 2:3:4 |
| M39.015 | 2:9:6 to 6:3:2 | 6:15:10 to 10:9:6 | 2:3:2 |
| M39.016 | 2:9:12 to 6:3:4 | 6:15:20 to 10:9:12 | 2:3:4 |
| M39.017 | 2:9:12 to 6:3:4 | 6:15:20 to 10:9:12 | 2:3:4 |
| M39.018 | 2:9:6 to 6:3:2 | 6:15:10 to 10:9:6 | 2:3:2 |
| M39.019 | 2:9:9 to 2:1:1 | 2:5:5 to 10:9:9 | 2:3:3 |
| M39.020 | 2:9:48 to 6:3:16 | 6:15:80 to 10:9:48 | 2:3:16 |
| M39.021 | 2:9:48 to 6:3:16 | 6:15:80 to 10:9:48 | 2:3:16 |
| M39.022 | 2:9:120 to 6:3:40 | 6:15:200 to 10:9:120 | 2:3:40 |
| M39.023 | 2:9:6 to 6:3:2 | 6:15:10 to 10:9:6 | 2:3:2 |
| M39.024 | 2:9:6 to 6:3:2 | 6:15:10 to 10:9:6 | 2:3:2 |
| M39.025 | 2:9:6 to 6:3:2 | 6:15:10 to 10:9:6 | 2:3:2 |
| M39.026 | 2:9:6 to 6:3:2 | 6:15:10 to 10:9:6 | 2:3:2 |
| M39.027 | 2:9:12 to 6:3:4 | 6:15:20 to 10:9:12 | 2:3:4 |

TABLE R40
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M40.001 | 2:6:135 to 6:2:45 | 6:10:225 to 10:6:135 | 2:2:45 |
| M40.002 | 1:3:3 to 3:1:1 | 3:5:5 to 5:3:3 | 1:1:1 |
| M40.003 | 1:3:3 to 3:1:1 | 3:5:5 to 5:3:3 | 1:1:1 |
| M40.004 | 2:6:9 to 6:2:3 | 6:10:15 to 10:6:9 | 2:2:3 |
| M40.005 | 1:3:6 to 3:1:2 | 3:5:10 to 5:3:6 | 1:1:2 |
| M40.006 | 1:3:6 to 3:1:2 | 3:5:10 to 5:3:6 | 1:1:2 |
| M40.007 | 1:3:6 to 3:1:2 | 3:5:10 to 5:3:6 | 1:1:2 |
| M40.008 | 1:3:6 to 3:1:2 | 3:5:10 to 5:3:6 | 1:1:2 |
| M40.009 | 1:3:30 to 3:1:10 | 3:5:50 to 5:3:30 | 1:1:10 |
| M40.010 | 1:3:6 to 3:1:2 | 3:5:10 to 5:3:6 | 1:1:2 |
| M40.011 | 1:3:18 to 3:1:6 | 3:5:30 to 5:3:18 | 1:1:6 |
| M40.012 | 1:3:18 to 3:1:6 | 3:5:30 to 5:3:18 | 1:1:6 |
| M40.013 | 1:3:6 to 3:1:2 | 3:5:10 to 5:3:6 | 1:1:2 |
| M40.014 | 1:3:3 to 3:1:1 | 3:5:5 to 5:3:3 | 1:1:1 |
| M40.015 | 1:3:6 to 3:1:2 | 3:5:10 to 5:3:6 | 1:1:2 |
| M40.016 | 1:3:6 to 3:1:2 | 3:5:10 to 5:3:6 | 1:1:2 |
| M40.017 | 1:3:3 to 3:1:1 | 3:5:5 to 5:3:3 | 1:1:1 |
| M40.018 | 2:6:9 to 6:2:3 | 6:10:15 to 10:6:9 | 2:2:3 |
| M40.019 | 1:3:24 to 3:1:8 | 3:5:40 to 5:3:24 | 1:1:8 |
| M40.020 | 1:3:24 to 3:1:8 | 3:5:40 to 5:3:24 | 1:1:8 |
| M40.021 | 1:3:60 to 3:1:20 | 3:5:100 to 5:3:60 | 1:1:20 |
| M40.022 | 1:3:3 to 3:1:1 | 3:5:5 to 5:3:3 | 1:1:1 |
| M40.023 | 1:3:3 to 3:1:1 | 3:5:5 to 5:3:3 | 1:1:1 |
| M40.024 | 1:3:3 to 3:1:1 | 3:5:5 to 5:3:3 | 1:1:1 |
| M40.025 | 1:3:3 to 3:1:1 | 3:5:5 to 5:3:3 | 1:1:1 |
| M40.026 | 1:3:6 to 3:1:2 | 3:5:10 to 5:3:6 | 1:1:2 |

TABLE R41
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M41.001 | 2:135:6 to 6:45:2 | 6:225:10 to 10:135:6 | 2:45:2 |
| M41.002 | 2:135:6 to 6:45:2 | 6:225:10 to 10:135:6 | 2:45:2 |
| M41.003 | 2:135:9 to 2:15:1 | 2:75:5 to 10:135:9 | 2:45:3 |
| M41.004 | 2:135:12 to 6:45:4 | 6:225:20 to 10:135:12 | 2:45:4 |
| M41.005 | 2:135:12 to 6:45:4 | 6:225:20 to 10:135:12 | 2:45:4 |
| M41.006 | 2:135:12 to 6:45:4 | 6:225:20 to 10:135:12 | 2:45:4 |
| M41.007 | 2:135:12 to 6:45:4 | 6:225:20 to 10:135:12 | 2:45:4 |
| M41.008 | 2:135:60 to 6:45:20 | 6:225:100 to 2:27:12 | 2:45:20 |
| M41.009 | 2:135:12 to 6:45:4 | 6:225:20 to 10:135:12 | 2:45:4 |
| M41.010 | 2:135:36 to 2:15:4 | 2:75:20 to 10:135:36 | 2:45:12 |
| M41.011 | 2:135:36 to 2:15:4 | 2:75:20 to 10:135:36 | 2:45:12 |
| M41.012 | 2:135:12 to 6:45:4 | 6:225:20 to 10:135:12 | 2:45:4 |
| M41.013 | 2:135:6 to 6:45:2 | 6:225:10 to 10:135:6 | 2:45:2 |
| M41.014 | 2:135:12 to 6:45:4 | 6:225:20 to 10:135:12 | 2:45:4 |
| M41.015 | 2:135:12 to 6:45:4 | 6:225:20 to 10:135:12 | 2:45:4 |
| M41.016 | 2:135:6 to 6:45:2 | 6:225:10 to 10:135:6 | 2:45:2 |
| M41.017 | 2:135:9 to 2:15:1 | 2:75:5 to 10:135:9 | 2:45:3 |
| M41.018 | 2:135:48 to 6:45:16 | 6:225:80 to 10:135:48 | 2:45:16 |
| M41.019 | 2:135:48 to 6:45:16 | 6:225:80 to 10:135:48 | 2:45:16 |
| M41.020 | 2:135:120 to 6:45:40 | 6:225:200 to 2:27:24 | 2:45:40 |
| M41.021 | 2:135:6 to 6:45:2 | 6:225:10 to 10:135:6 | 2:45:2 |
| M41.022 | 2:135:6 to 6:45:2 | 6:225:10 to 10:135:6 | 2:45:2 |
| M41.023 | 2:135:6 to 6:45:2 | 6:225:10 to 10:135:6 | 2:45:2 |
| M41.024 | 2:135:6 to 6:45:2 | 6:225:10 to 10:135:6 | 2:45:2 |
| M41.025 | 2:135:12 to 6:45:4 | 6:225:20 to 10:135:12 | 2:45:4 |

TABLE R42
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M42.001 | 1:3:3 to 3:1:1 | 3:5:5 to 5:3:3 | 1:1:1 |
| M42.002 | 2:6:9 to 6:2:3 | 6:10:15 to 10:6:9 | 2:2:3 |
| M42.003 | 1:3:6 to 3:1:2 | 3:5:10 to 5:3:6 | 1:1:2 |
| M42.004 | 1:3:6 to 3:1:2 | 3:5:10 to 5:3:6 | 1:1:2 |
| M42.005 | 1:3:6 to 3:1:2 | 3:5:10 to 5:3:6 | 1:1:2 |
| M42.006 | 1:3:6 to 3:1:2 | 3:5:10 to 5:3:6 | 1:1:2 |
| M42.007 | 1:3:30 to 3:1:10 | 3:5:50 to 5:3:30 | 1:1:10 |
| M42.008 | 1:3:6 to 3:1:2 | 3:5:10 to 5:3:6 | 1:1:2 |
| M42.009 | 1:3:18 to 3:1:6 | 3:5:30 to 5:3:18 | 1:1:6 |
| M42.010 | 1:3:18 to 3:1:6 | 3:5:30 to 5:3:18 | 1:1:6 |
| M42.011 | 1:3:6 to 3:1:2 | 3:5:10 to 5:3:6 | 1:1:2 |
| M42.012 | 1:3:3 to 3:1:1 | 3:5:5 to 5:3:3 | 1:1:1 |
| M42.013 | 1:3:6 to 3:1:2 | 3:5:10 to 5:3:6 | 1:1:2 |
| M42.014 | 1:3:6 to 3:1:2 | 3:5:10 to 5:3:6 | 1:1:2 |
| M42.015 | 1:3:3 to 3:1:1 | 3:5:5 to 5:3:3 | 1:1:1 |
| M42.016 | 2:6:9 to 6:2:3 | 6:10:15 to 10:6:9 | 2:2:3 |
| M42.017 | 1:3:24 to 3:1:8 | 3:5:40 to 5:3:24 | 1:1:8 |
| M42.018 | 1:3:24 to 3:1:8 | 3:5:40 to 5:3:24 | 1:1:8 |
| M42.019 | 1:3:60 to 3:1:20 | 3:5:100 to 5:3:60 | 1:1:20 |
| M42.020 | 1:3:3 to 3:1:1 | 3:5:5 to 5:3:3 | 1:1:1 |
| M42.021 | 1:3:3 to 3:1:1 | 3:5:5 to 5:3:3 | 1:1:1 |
| M42.022 | 1:3:3 to 3:1:1 | 3:5:5 to 5:3:3 | 1:1:1 |
| M42.023 | 1:3:3 to 3:1:1 | 3:5:5 to 5:3:3 | 1:1:1 |
| M42.024 | 1:3:6 to 3:1:2 | 3:5:10 to 5:3:6 | 1:1:2 |

TABLE R43
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M43.001 | 2:6:9 to 6:2:3 | 6:10:15 to 10:6:9 | 2:2:3 |
| M43.002 | 1:3:6 to 3:1:2 | 3:5:10 to 5:3:6 | 1:1:2 |
| M43.003 | 1:3:6 to 3:1:2 | 3:5:10 to 5:3:6 | 1:1:2 |
| M43.004 | 1:3:6 to 3:1:2 | 3:5:10 to 5:3:6 | 1:1:2 |
| M43.005 | 1:3:6 to 3:1:2 | 3:5:10 to 5:3:6 | 1:1:2 |
| M43.006 | 1:3:30 to 3:1:10 | 3:5:50 to 5:3:30 | 1:1:10 |
| M43.007 | 1:3:6 to 3:1:2 | 3:5:10 to 5:3:6 | 1:1:2 |
| M43.008 | 1:3:18 to 3:1:6 | 3:5:30 to 5:3:18 | 1:1:6 |
| M43.009 | 1:3:18 to 3:1:6 | 3:5:30 to 5:3:18 | 1:1:6 |
| M43.010 | 1:3:6 to 3:1:2 | 3:5:10 to 5:3:6 | 1:1:2 |
| M43.011 | 1:3:3 to 3:1:1 | 3:5:5 to 5:3:3 | 1:1:1 |
| M43.012 | 1:3:6 to 3:1:2 | 3:5:10 to 5:3:6 | 1:1:2 |
| M43.013 | 1:3:6 to 3:1:2 | 3:5:10 to 5:3:6 | 1:1:2 |
| M43.014 | 1:3:3 to 3:1:1 | 3:5:5 to 5:3:3 | 1:1:1 |
| M43.015 | 2:6:9 to 6:2:3 | 6:10:15 to 10:6:9 | 2:2:3 |
| M43.016 | 1:3:24 to 3:1:8 | 3:5:40 to 5:3:24 | 1:1:8 |
| M43.017 | 1:3:24 to 3:1:8 | 3:5:40 to 5:3:24 | 1:1:8 |
| M43.018 | 1:3:60 to 3:1:20 | 3:5:100 to 5:3:60 | 1:1:20 |
| M43.019 | 1:3:3 to 3:1:1 | 3:5:5 to 5:3:3 | 1:1:1 |
| M43.020 | 1:3:3 to 3:1:1 | 3:5:5 to 5:3:3 | 1:1:1 |
| M43.021 | 1:3:3 to 3:1:1 | 3:5:5 to 5:3:3 | 1:1:1 |
| M43.022 | 1:3:3 to 3:1:1 | 3:5:5 to 5:3:3 | 1:1:1 |
| M43.023 | 1:3:6 to 3:1:2 | 3:5:10 to 5:3:6 | 1:1:2 |

TABLE R44
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M44.001 | 2:9:12 to 6:3:4 | 6:15:20 to 10:9:12 | 2:3:4 |
| M44.002 | 2:9:12 to 6:3:4 | 6:15:20 to 10:9:12 | 2:3:4 |
| M44.003 | 2:9:12 to 6:3:4 | 6:15:20 to 10:9:12 | 2:3:4 |
| M44.004 | 2:9:12 to 6:3:4 | 6:15:20 to 10:9:12 | 2:3:4 |
| M44.005 | 2:9:60 to 6:3:20 | 6:15:100 to 10:9:60 | 2:3:20 |
| M44.006 | 2:9:12 to 6:3:4 | 6:15:20 to 10:9:12 | 2:3:4 |
| M44.007 | 2:9:36 to 2:1:4 | 2:5:20 to 10:9:36 | 2:3:12 |
| M44.008 | 2:9:36 to 2:1:4 | 2:5:20 to 10:9:36 | 2:3:12 |
| M44.009 | 2:9:12 to 6:3:4 | 6:15:20 to 10:9:12 | 2:3:4 |
| M44.010 | 2:9:6 to 6:3:2 | 6:15:10 to 10:9:6 | 2:3:2 |
| M44.011 | 2:9:12 to 6:3:4 | 6:15:20 to 10:9:12 | 2:3:4 |
| M44.012 | 2:9:12 to 6:3:4 | 6:15:20 to 10:9:12 | 2:3:4 |
| M44.013 | 2:9:6 to 6:3:2 | 6:15:10 to 10:9:6 | 2:3:2 |
| M44.014 | 2:9:9 to 2:1:1 | 2:5:5 to 10:9:9 | 2:3:3 |
| M44.015 | 2:9:48 to 6:3:16 | 6:15:80 to 10:9:48 | 2:3:16 |
| M44.016 | 2:9:48 to 6:3:16 | 6:15:80 to 10:9:48 | 2:3:16 |
| M44.017 | 2:9:120 to 6:3:40 | 6:15:200 to 10:9:120 | 2:3:40 |
| M44.018 | 2:9:6 to 6:3:2 | 6:15:10 to 10:9:6 | 2:3:2 |
| M44.019 | 2:9:6 to 6:3:2 | 6:15:10 to 10:9:6 | 2:3:2 |
| M44.020 | 2:9:6 to 6:3:2 | 6:15:10 to 10:9:6 | 2:3:2 |
| M44.021 | 2:9:6 to 6:3:2 | 6:15:10 to 10:9:6 | 2:3:2 |
| M44.022 | 2:9:12 to 6:3:4 | 6:15:20 to 10:9:12 | 2:3:4 |

TABLE R45
Exemplar ratio ranges for specific compositions of the invention

| | | | Even More |
|---|---|---|---|
| | Preferred | More Preferred | Preferred |
| | Weight Ratio | Weight Ratio | Weight Ratio |
| Mixture | (A:B:C) | (A:B:C) | (A:B:C) |
| M45.001 | 1:6:6 to 3:2:2 | 3:10:10 to 5:6:6 | 1:2:2 |
| M45.002 | 1:6:6 to 3:2:2 | 3:10:10 to 5:6:6 | 1:2:2 |
| M45.003 | 1:6:6 to 3:2:2 | 3:10:10 to 5:6:6 | 1:2:2 |
| M45.004 | 1:6:30 to 3:2:10 | 3:10:50 to 5:6:30 | 1:2:10 |
| M45.005 | 1:6:6 to 3:2:2 | 3:10:10 to 5:6:6 | 1:2:2 |
| M45.006 | 1:6:18 to 3:2:6 | 3:10:30 to 5:6:18 | 1:2:6 |
| M45.007 | 1:6:18 to 3:2:6 | 3:10:30 to 5:6:18 | 1:2:6 |
| M45.008 | 1:6:6 to 3:2:2 | 3:10:10 to 5:6:6 | 1:2:2 |
| M45.009 | 1:6:3 to 3:2:1 | 3:10:5 to 5:6:3 | 1:2:1 |
| M45.010 | 1:6:6 to 3:2:2 | 3:10:10 to 5:6:6 | 1:2:2 |
| M45.011 | 1:6:6 to 3:2:2 | 3:10:10 to 5:6:6 | 1:2:2 |
| M45.012 | 1:6:3 to 3:2:1 | 3:10:5 to 5:6:3 | 1:2:1 |
| M45.013 | 2:12:9 to 6:4:3 | 6:20:15 to 10:12:9 | 2:4:3 |
| M45.014 | 1:6:24 to 3:2:8 | 3:10:40 to 5:6:24 | 1:2:8 |
| M45.015 | 1:6:24 to 3:2:8 | 3:10:40 to 5:6:24 | 1:2:8 |
| M45.016 | 1:6:60 to 3:2:20 | 3:10:100 to 5:6:60 | 1:2:20 |
| M45.017 | 1:6:3 to 3:2:1 | 3:10:5 to 5:6:3 | 1:2:1 |
| M45.018 | 1:6:3 to 3:2:1 | 3:10:5 to 5:6:3 | 1:2:1 |
| M45.019 | 1:6:3 to 3:2:1 | 3:10:5 to 5:6:3 | 1:2:1 |
| M45.020 | 1:6:3 to 3:2:1 | 3:10:5 to 5:6:3 | 1:2:1 |
| M45.021 | 1:6:6 to 3:2:2 | 3:10:10 to 5:6:6 | 1:2:2 |

TABLE R46
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M46.001 | 1:6:6 to 3:2:2 | 3:10:10 to 5:6:6 | 1:2:2 |
| M46.002 | 1:6:6 to 3:2:2 | 3:10:10 to 5:6:6 | 1:2:2 |
| M46.003 | 1:6:30 to 3:2:10 | 3:10:50 to 5:6:30 | 1:2:10 |
| M46.004 | 1:6:6 to 3:2:2 | 3:10:10 to 5:6:6 | 1:2:2 |
| M46.005 | 1:6:18 to 3:2:6 | 3:10:30 to 5:6:18 | 1:2:6 |
| M46.006 | 1:6:18 to 3:2:6 | 3:10:30 to 5:6:18 | 1:2:6 |
| M46.007 | 1:6:6 to 3:2:2 | 3:10:10 to 5:6:6 | 1:2:2 |
| M46.008 | 1:6:3 to 3:2:1 | 3:10:5 to 5:6:3 | 1:2:1 |
| M46.009 | 1:6:6 to 3:2:2 | 3:10:10 to 5:6:6 | 1:2:2 |
| M46.010 | 1:6:6 to 3:2:2 | 3:10:10 to 5:6:6 | 1:2:2 |
| M46.011 | 1:6:3 to 3:2:1 | 3:10:5 to 5:6:3 | 1:2:1 |
| M46.012 | 2:12:9 to 6:4:3 | 6:20:15 to 10:12:9 | 2:4:3 |
| M46.013 | 1:6:24 to 3:2:8 | 3:10:40 to 5:6:24 | 1:2:8 |
| M46.014 | 1:6:24 to 3:2:8 | 3:10:40 to 5:6:24 | 1:2:8 |
| M46.015 | 1:6:60 to 3:2:20 | 3:10:100 to 5:6:60 | 1:2:20 |
| M46.016 | 1:6:3 to 3:2:1 | 3:10:5 to 5:6:3 | 1:2:1 |
| M46.017 | 1:6:3 to 3:2:1 | 3:10:5 to 5:6:3 | 1:2:1 |
| M46.018 | 1:6:3 to 3:2:1 | 3:10:5 to 5:6:3 | 1:2:1 |
| M46.019 | 1:6:3 to 3:2:1 | 3:10:5 to 5:6:3 | 1:2:1 |
| M46.020 | 1:6:6 to 3:2:2 | 3:10:10 to 5:6:6 | 1:2:2 |

TABLE R47
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M47.001 | 1:6:6 to 3:2:2 | 3:10:10 to 5:6:6 | 1:2:2 |
| M47.002 | 1:6:30 to 3:2:10 | 3:10:50 to 5:6:30 | 1:2:10 |
| M47.003 | 1:6:6 to 3:2:2 | 3:10:10 to 5:6:6 | 1:2:2 |
| M47.004 | 1:6:18 to 3:2:6 | 3:10:30 to 5:6:18 | 1:2:6 |
| M47.005 | 1:6:18 to 3:2:6 | 3:10:30 to 5:6:18 | 1:2:6 |
| M47.006 | 1:6:6 to 3:2:2 | 3:10:10 to 5:6:6 | 1:2:2 |
| M47.007 | 1:6:3 to 3:2:1 | 3:10:5 to 5:6:3 | 1:2:1 |
| M47.008 | 1:6:6 to 3:2:2 | 3:10:10 to 5:6:6 | 1:2:2 |
| M47.009 | 1:6:6 to 3:2:2 | 3:10:10 to 5:6:6 | 1:2:2 |
| M47.010 | 1:6:3 to 3:2:1 | 3:10:5 to 5:6:3 | 1:2:1 |
| M47.011 | 2:12:9 to 6:4:3 | 6:20:15 to 10:12:9 | 2:4:3 |
| M47.012 | 1:6:24 to 3:2:8 | 3:10:40 to 5:6:24 | 1:2:8 |
| M47.013 | 1:6:24 to 3:2:8 | 3:10:40 to 5:6:24 | 1:2:8 |
| M47.014 | 1:6:60 to 3:2:20 | 3:10:100 to 5:6:60 | 1:2:20 |
| M47.015 | 1:6:3 to 3:2:1 | 3:10:5 to 5:6:3 | 1:2:1 |
| M47.016 | 1:6:3 to 3:2:1 | 3:10:5 to 5:6:3 | 1:2:1 |
| M47.017 | 1:6:3 to 3:2:1 | 3:10:5 to 5:6:3 | 1:2:1 |
| M47.018 | 1:6:3 to 3:2:1 | 3:10:5 to 5:6:3 | 1:2:1 |
| M47.019 | 1:6:6 to 3:2:2 | 3:10:10 to 5:6:6 | 1:2:2 |

TABLE R48
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M48.001 | 1:6:30 to 3:2:10 | 3:10:50 to 5:6:30 | 1:2:10 |
| M48.002 | 1:6:6 to 3:2:2 | 3:10:10 to 5:6:6 | 1:2:2 |
| M48.003 | 1:6:18 to 3:2:6 | 3:10:30 to 5:6:18 | 1:2:6 |
| M48.004 | 1:6:18 to 3:2:6 | 3:10:30 to 5:6:18 | 1:2:6 |
| M48.005 | 1:6:6 to 3:2:2 | 3:10:10 to 5:6:6 | 1:2:2 |
| M48.006 | 1:6:3 to 3:2:1 | 3:10:5 to 5:6:3 | 1:2:1 |
| M48.007 | 1:6:6 to 3:2:2 | 3:10:10 to 5:6:6 | 1:2:2 |
| M48.008 | 1:6:6 to 3:2:2 | 3:10:10 to 5:6:6 | 1:2:2 |
| M48.009 | 1:6:3 to 3:2:1 | 3:10:5 to 5:6:3 | 1:2:1 |
| M48.010 | 2:12:9 to 6:4:3 | 6:20:15 to 10:12:9 | 2:4:3 |
| M48.011 | 1:6:24 to 3:2:8 | 3:10:40 to 5:6:24 | 1:2:8 |
| M48.012 | 1:6:24 to 3:2:8 | 3:10:40 to 5:6:24 | 1:2:8 |
| M48.013 | 1:6:60 to 3:2:20 | 3:10:100 to 5:6:60 | 1:2:20 |
| M48.014 | 1:6:3 to 3:2:1 | 3:10:5 to 5:6:3 | 1:2:1 |
| M48.015 | 1:6:3 to 3:2:1 | 3:10:5 to 5:6:3 | 1:2:1 |
| M48.016 | 1:6:3 to 3:2:1 | 3:10:5 to 5:6:3 | 1:2:1 |
| M48.017 | 1:6:3 to 3:2:1 | 3:10:5 to 5:6:3 | 1:2:1 |
| M48.018 | 1:6:6 to 3:2:2 | 3:10:10 to 5:6:6 | 1:2:2 |

TABLE R49
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M49.001 | 1:30:6 to 3:10:2 | 3:50:10 to 5:30:6 | 1:10:2 |
| M49.002 | 1:30:18 to 3:10:6 | 3:50:30 to 5:30:18 | 1:10:6 |
| M49.003 | 1:30:18 to 3:10:6 | 3:50:30 to 5:30:18 | 1:10:6 |
| M49.004 | 1:30:6 to 3:10:2 | 3:50:10 to 5:30:6 | 1:10:2 |
| M49.005 | 1:30:3 to 3:10:1 | 3:50:5 to 5:30:3 | 1:10:1 |
| M49.006 | 1:30:6 to 3:10:2 | 3:50:10 to 5:30:6 | 1:10:2 |
| M49.007 | 1:30:6 to 3:10:2 | 3:50:10 to 5:30:6 | 1:10:2 |
| M49.008 | 1:30:3 to 3:10:1 | 3:50:5 to 5:30:3 | 1:10:1 |
| M49.009 | 2:60:9 to 6:20:3 | 6:100:15 to 10:60:9 | 2:20:3 |
| M49.010 | 1:30:24 to 3:10:8 | 3:50:40 to 5:30:24 | 1:10:8 |
| M49.011 | 1:30:24 to 3:10:8 | 3:50:40 to 5:30:24 | 1:10:8 |
| M49.012 | 1:30:60 to 3:10:20 | 3:50:100 to 1:6:12 | 1:10:20 |
| M49.013 | 1:30:3 to 3:10:1 | 3:50:5 to 5:30:3 | 1:10:1 |
| M49.014 | 1:30:3 to 3:10:1 | 3:50:5 to 5:30:3 | 1:10:1 |
| M49.015 | 1:30:3 to 3:10:1 | 3:50:5 to 5:30:3 | 1:10:1 |
| M49.016 | 1:30:3 to 3:10:1 | 3:50:5 to 5:30:3 | 1:10:1 |
| M49.017 | 1:30:6 to 3:10:2 | 3:50:10 to 5:30:6 | 1:10:2 |

TABLE R50
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M50.001 | 1:6:18 to 3:2:6 | 3:10:30 to 5:6:18 | 1:2:6 |
| M50.002 | 1:6:18 to 3:2:6 | 3:10:30 to 5:6:18 | 1:2:6 |
| M50.003 | 1:6:6 to 3:2:2 | 3:10:10 to 5:6:6 | 1:2:2 |
| M50.004 | 1:6:3 to 3:2:1 | 3:10:5 to 5:6:3 | 1:2:1 |
| M50.005 | 1:6:6 to 3:2:2 | 3:10:10 to 5:6:6 | 1:2:2 |
| M50.006 | 1:6:6 to 3:2:2 | 3:10:10 to 5:6:6 | 1:2:2 |
| M50.007 | 1:6:3 to 3:2:1 | 3:10:5 to 5:6:3 | 1:2:1 |
| M50.008 | 2:12:9 to 6:4:3 | 6:20:15 to 10:12:9 | 2:4:3 |
| M50.009 | 1:6:24 to 3:2:8 | 3:10:40 to 5:6:24 | 1:2:8 |
| M50.010 | 1:6:24 to 3:2:8 | 3:10:40 to 5:6:24 | 1:2:8 |
| M50.011 | 1:6:60 to 3:2:20 | 3:10:100 to 5:6:60 | 1:2:20 |
| M50.012 | 1:6:3 to 3:2:1 | 3:10:5 to 5:6:3 | 1:2:1 |
| M50.013 | 1:6:3 to 3:2:1 | 3:10:5 to 5:6:3 | 1:2:1 |
| M50.014 | 1:6:3 to 3:2:1 | 3:10:5 to 5:6:3 | 1:2:1 |
| M50.015 | 1:6:3 to 3:2:1 | 3:10:5 to 5:6:3 | 1:2:1 |
| M50.016 | 1:6:6 to 3:2:2 | 3:10:10 to 5:6:6 | 1:2:2 |

TABLE R51
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M51.001 | 1:18:18 to 1:2:2 | 1:10:10 to 5:18:18 | 1:6:6 |
| M51.002 | 1:18:6 to 3:6:2 | 3:30:10 to 5:18:6 | 1:6:2 |
| M51.003 | 1:18:3 to 3:6:1 | 3:30:5 to 5:18:3 | 1:6:1 |
| M51.004 | 1:18:6 to 3:6:2 | 3:30:10 to 5:18:6 | 1:6:2 |
| M51.005 | 1:18:6 to 3:6:2 | 3:30:10 to 5:18:6 | 1:6:2 |
| M51.006 | 1:18:3 to 3:6:1 | 3:30:5 to 5:18:3 | 1:6:1 |
| M51.007 | 2:36:9 to 2:4:1 | 2:20:5 to 10:36:9 | 2:12:3 |
| M51.008 | 1:18:24 to 3:6:8 | 3:30:40 to 5:18:24 | 1:6:8 |
| M51.009 | 1:18:24 to 3:6:8 | 3:30:40 to 5:18:24 | 1:6:8 |
| M51.010 | 1:18:60 to 3:6:20 | 3:30:100 to 5:18:60 | 1:6:20 |
| M51.011 | 1:18:3 to 3:6:1 | 3:30:5 to 5:18:3 | 1:6:1 |
| M51.012 | 1:18:3 to 3:6:1 | 3:30:5 to 5:18:3 | 1:6:1 |
| M51.013 | 1:18:3 to 3:6:1 | 3:30:5 to 5:18:3 | 1:6:1 |
| M51.014 | 1:18:3 to 3:6:1 | 3:30:5 to 5:18:3 | 1:6:1 |
| M51.015 | 1:18:6 to 3:6:2 | 3:30:10 to 5:18:6 | 1:6:2 |

TABLE R52
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M52.001 | 1:18:6 to 3:6:2 | 3:30:10 to 5:18:6 | 1:6:2 |
| M52.002 | 1:18:3 to 3:6:1 | 3:30:5 to 5:18:3 | 1:6:1 |
| M52.003 | 1:18:6 to 3:6:2 | 3:30:10 to 5:18:6 | 1:6:2 |
| M52.004 | 1:18:6 to 3:6:2 | 3:30:10 to 5:18:6 | 1:6:2 |
| M52.005 | 1:18:3 to 3:6:1 | 3:30:5 to 5:18:3 | 1:6:1 |
| M52.006 | 2:36:9 to 2:4:1 | 2:20:5 to 10:36:9 | 2:12:3 |
| M52.007 | 1:18:24 to 3:6:8 | 3:30:40 to 5:18:24 | 1:6:8 |
| M52.008 | 1:18:24 to 3:6:8 | 3:30:40 to 5:18:24 | 1:6:8 |
| M52.009 | 1:18:60 to 3:6:20 | 3:30:100 to 5:18:60 | 1:6:20 |
| M52.010 | 1:18:3 to 3:6:1 | 3:30:5 to 5:18:3 | 1:6:1 |
| M52.011 | 1:18:3 to 3:6:1 | 3:30:5 to 5:18:3 | 1:6:1 |
| M52.012 | 1:18:3 to 3:6:1 | 3:30:5 to 5:18:3 | 1:6:1 |
| M52.013 | 1:18:3 to 3:6:1 | 3:30:5 to 5:18:3 | 1:6:1 |
| M52.014 | 1:18:6 to 3:6:2 | 3:30:10 to 5:18:6 | 1:6:2 |

TABLE R53
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M53.001 | 1:6:3 to 3:2:1 | 3:10:5 to 5:6:3 | 1:2:1 |
| M53.002 | 1:6:6 to 3:2:2 | 3:10:10 to 5:6:6 | 1:2:2 |
| M53.003 | 1:6:6 to 3:2:2 | 3:10:10 to 5:6:6 | 1:2:2 |
| M53.004 | 1:6:3 to 3:2:1 | 3:10:5 to 5:6:3 | 1:2:1 |
| M53.005 | 2:12:9 to 6:4:3 | 6:20:15 to 10:12:9 | 2:4:3 |
| M53.006 | 1:6:24 to 3:2:8 | 3:10:40 to 5:6:24 | 1:2:8 |
| M53.007 | 1:6:24 to 3:2:8 | 3:10:40 to 5:6:24 | 1:2:8 |
| M53.008 | 1:6:60 to 3:2:20 | 3:10:100 to 5:6:60 | 1:2:20 |
| M53.009 | 1:6:3 to 3:2:1 | 3:10:5 to 5:6:3 | 1:2:1 |
| M53.010 | 1:6:3 to 3:2:1 | 3:10:5 to 5:6:3 | 1:2:1 |
| M53.011 | 1:6:3 to 3:2:1 | 3:10:5 to 5:6:3 | 1:2:1 |
| M53.012 | 1:6:3 to 3:2:1 | 3:10:5 to 5:6:3 | 1:2:1 |
| M53.013 | 1:6:6 to 3:2:2 | 3:10:10 to 5:6:6 | 1:2:2 |

TABLE R54
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M54.001 | 1:3:6 to 3:1:2 | 3:5:10 to 5:3:6 | 1:1:2 |
| M54.002 | 1:3:6 to 3:1:2 | 3:5:10 to 5:3:6 | 1:1:2 |
| M54.003 | 1:3:3 to 3:1:1 | 3:5:5 to 5:3:3 | 1:1:1 |
| M54.004 | 2:6:9 to 6:2:3 | 6:10:15 to 10:6:9 | 2:2:3 |
| M54.005 | 1:3:24 to 3:1:8 | 3:5:40 to 5:3:24 | 1:1:8 |
| M54.006 | 1:3:24 to 3:1:8 | 3:5:40 to 5:3:24 | 1:1:8 |
| M54.007 | 1:3:60 to 3:1:20 | 3:5:100 to 5:3:60 | 1:1:20 |
| M54.008 | 1:3:3 to 3:1:1 | 3:5:5 to 5:3:3 | 1:1:1 |
| M54.009 | 1:3:3 to 3:1:1 | 3:5:5 to 5:3:3 | 1:1:1 |
| M54.010 | 1:3:3 to 3:1:1 | 3:5:5 to 5:3:3 | 1:1:1 |
| M54.011 | 1:3:3 to 3:1:1 | 3:5:5 to 5:3:3 | 1:1:1 |
| M54.012 | 1:3:6 to 3:1:2 | 3:5:10 to 5:3:6 | 1:1:2 |

TABLE R55
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M55.001 | 1:6:6 to 3:2:2 | 3:10:10 to 5:6:6 | 1:2:2 |
| M55.002 | 1:6:3 to 3:2:1 | 3:10:5 to 5:6:3 | 1:2:1 |
| M55.003 | 2:12:9 to 6:4:3 | 6:20:15 to 10:12:9 | 2:4:3 |
| M55.004 | 1:6:24 to 3:2:8 | 3:10:40 to 5:6:24 | 1:2:8 |
| M55.005 | 1:6:24 to 3:2:8 | 3:10:40 to 5:6:24 | 1:2:8 |
| M55.006 | 1:6:60 to 3:2:20 | 3:10:100 to 5:6:60 | 1:2:20 |
| M55.007 | 1:6:3 to 3:2:1 | 3:10:5 to 5:6:3 | 1:2:1 |
| M55.008 | 1:6:3 to 3:2:1 | 3:10:5 to 5:6:3 | 1:2:1 |
| M55.009 | 1:6:3 to 3:2:1 | 3:10:5 to 5:6:3 | 1:2:1 |
| M55.010 | 1:6:3 to 3:2:1 | 3:10:5 to 5:6:3 | 1:2:1 |
| M55.011 | 1:6:6 to 3:2:2 | 3:10:10 to 5:6:6 | 1:2:2 |

TABLE R56
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M56.001 | 1:6:3 to 3:2:1 | 3:10:5 to 5:6:3 | 1:2:1 |
| M56.002 | 2:12:9 to 6:4:3 | 6:20:15 to 10:12:9 | 2:4:3 |
| M56.003 | 1:6:24 to 3:2:8 | 3:10:40 to 5:6:24 | 1:2:8 |
| M56.004 | 1:6:24 to 3:2:8 | 3:10:40 to 5:6:24 | 1:2:8 |
| M56.005 | 1:6:60 to 3:2:20 | 3:10:100 to 5:6:60 | 1:2:20 |
| M56.006 | 1:6:3 to 3:2:1 | 3:10:5 to 5:6:3 | 1:2:1 |
| M56.007 | 1:6:3 to 3:2:1 | 3:10:5 to 5:6:3 | 1:2:1 |
| M56.008 | 1:6:3 to 3:2:1 | 3:10:5 to 5:6:3 | 1:2:1 |
| M56.009 | 1:6:3 to 3:2:1 | 3:10:5 to 5:6:3 | 1:2:1 |
| M56.010 | 1:6:6 to 3:2:2 | 3:10:10 to 5:6:6 | 1:2:2 |

TABLE R57
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M57.001 | 2:6:9 to 6:2:3 | 6:10:15 to 10:6:9 | 2:2:3 |
| M57.002 | 1:3:24 to 3:1:8 | 3:5:40 to 5:3:24 | 1:1:8 |
| M57.003 | 1:3:24 to 3:1:8 | 3:5:40 to 5:3:24 | 1:1:8 |
| M57.004 | 1:3:60 to 3:1:20 | 3:5:100 to 5:3:60 | 1:1:20 |
| M57.005 | 1:3:3 to 3:1:1 | 3:5:5 to 5:3:3 | 1:1:1 |
| M57.006 | 1:3:3 to 3:1:1 | 3:5:5 to 5:3:3 | 1:1:1 |
| M57.007 | 1:3:3 to 3:1:1 | 3:5:5 to 5:3:3 | 1:1:1 |
| M57.008 | 1:3:3 to 3:1:1 | 3:5:5 to 5:3:3 | 1:1:1 |
| M57.009 | 1:3:6 to 3:1:2 | 3:5:10 to 5:3:6 | 1:1:2 |

TABLE R58
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M58.001 | 2:9:48 to 6:3:16 | 6:15:80 to 10:9:48 | 2:3:16 |
| M58.002 | 2:9:48 to 6:3:16 | 6:15:80 to 10:9:48 | 2:3:16 |
| M58.003 | 2:9:120 to 6:3:40 | 6:15:200 to 10:9:120 | 2:3:40 |
| M58.004 | 2:9:6 to 6:3:2 | 6:15:10 to 10:9:6 | 2:3:2 |
| M58.005 | 2:9:6 to 6:3:2 | 6:15:10 to 10:9:6 | 2:3:2 |
| M58.006 | 2:9:6 to 6:3:2 | 6:15:10 to 10:9:6 | 2:3:2 |
| M58.007 | 2:9:6 to 6:3:2 | 6:15:10 to 10:9:6 | 2:3:2 |
| M58.008 | 2:9:12 to 6:3:4 | 6:15:20 to 10:9:12 | 2:3:4 |

TABLE R59
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M59.001 | 1:24:24 to 3:8:8 | 3:40:40 to 5:24:24 | 1:8:8 |
| M59.002 | 1:24:60 to 3:8:20 | 3:40:100 to 5:24:60 | 1:8:20 |
| M59.003 | 1:24:3 to 3:8:1 | 3:40:5 to 5:24:3 | 1:8:1 |
| M59.004 | 1:24:3 to 3:8:1 | 3:40:5 to 5:24:3 | 1:8:1 |
| M59.005 | 1:24:3 to 3:8:1 | 3:40:5 to 5:24:3 | 1:8:1 |
| M59.006 | 1:24:3 to 3:8:1 | 3:40:5 to 5:24:3 | 1:8:1 |
| M59.007 | 1:24:6 to 3:8:2 | 3:40:10 to 5:24:6 | 1:8:2 |

TABLE R60
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M60.001 | 1:24:60 to 3:8:20 | 3:40:100 to 5:24:60 | 1:8:20 |
| M60.002 | 1:24:3 to 3:8:1 | 3:40:5 to 5:24:3 | 1:8:1 |
| M60.003 | 1:24:3 to 3:8:1 | 3:40:5 to 5:24:3 | 1:8:1 |
| M60.004 | 1:24:3 to 3:8:1 | 3:40:5 to 5:24:3 | 1:8:1 |
| M60.005 | 1:24:3 to 3:8:1 | 3:40:5 to 5:24:3 | 1:8:1 |
| M60.006 | 1:24:6 to 3:8:2 | 3:40:10 to 5:24:6 | 1:8:2 |

TABLE R61
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M61.001 | 1:60:3 to 3:20:1 | 3:100:5 to 5:60:3 | 1:20:1 |
| M61.002 | 1:60:3 to 3:20:1 | 3:100:5 to 5:60:3 | 1:20:1 |
| M61.003 | 1:60:3 to 3:20:1 | 3:100:5 to 5:60:3 | 1:20:1 |
| M61.004 | 1:60:3 to 3:20:1 | 3:100:5 to 5:60:3 | 1:20:1 |
| M61.005 | 1:60:6 to 3:20:2 | 3:100:10 to 5:60:6 | 1:20:2 |

TABLE R62
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M62.001 | 1:3:3 to 3:1:1 | 3:5:5 to 5:3:3 | 1:1:1 |
| M62.002 | 1:3:3 to 3:1:1 | 3:5:5 to 5:3:3 | 1:1:1 |
| M62.003 | 1:3:3 to 3:1:1 | 3:5:5 to 5:3:3 | 1:1:1 |
| M62.004 | 1:3:6 to 3:1:2 | 3:5:10 to 5:3:6 | 1:1:2 |

TABLE R63
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M63.001 | 1:3:3 to 3:1:1 | 3:5:5 to 5:3:3 | 1:1:1 |
| M63.002 | 1:3:3 to 3:1:1 | 3:5:5 to 5:3:3 | 1:1:1 |
| M63.003 | 1:3:6 to 3:1:2 | 3:5:10 to 5:3:6 | 1:1:2 |

TABLE R64
Exemplar ratio ranges for specific compositions of the invention

| | | More | Even More |
|---|---|---|---|
| | Preferred | Preferred | Preferred |
| | Weight Ratio | Weight Ratio | Weight Ratio |
| Mixture | (A:B:C) | (A:B:C) | (A:B:C) |
| M64.001 | 1:3:3 to 3:1:1 | 3:5:5 to 5:3:3 | 1:1:1 |
| M64.002 | 1:3:6 to 3:1:2 | 3:5:10 to 5:3:6 | 1:1:2 |
| M64.003 | 1:3:6 to 3:1:2 | 3:5:10 to 5:3:6 | 1:1:2 |

In an embodiment of the invention there is provided a composition, wherein the composition is a composition selected from the group consisting of M34.003, M34.007, M34.024, M35.002, M35.023, M37.004, M37.021, M37.024, M37.029, M41.017, M58.003 and M58.004 (disclosed in tables M34, M35, M37, M41 and M58 above). Preferably, in this embodiment of the invention the preferred weight ratio of components A:B:C is as disclosed in tables R34, R35, R37, R41 or R58 and/or tables B1 to B12.

In another embodiment of the invention there is provided a method of controlling or preventing infestation by phytopathogenic fungi (preferably, Phakopsora pachyrhizi) in a plant (preferably, soybean), wherein said phytopathogenic fungi comprises a F129L mutation in the mitochondrial cytochrome b which confers resistance to Qo inhibitors, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of component A:B:C is as disclosed in tables R1 to R64 above.

In another embodiment of the invention there is provided a method of controlling or preventing infestation by phytopathogenic fungi (preferably, Alternaria alternata, Plasmopara viticola, Sclerotinia sclerotiorum or Septoria tritici also known as Mycosphaerella graminicola) in a plant (preferably, a cereal plant), wherein said phytopathogenic fungi comprises a G143A mutation in the mitochondrial cytochrome b which confers resistance to Qo inhibitors, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of component A:B:C is as disclosed in tables R1 to R64 above.

The level of resistance and therefore the impact on the performance of the fungicide can be measured by the use of a ‘Resistance Factor’ (RF). The resistance factor can be calculated by dividing the concentration of a fungicide that provides a set level of disease control (i.e. 50 percent) for the ‘resistant’ fungal strain with the concentration of the same fungicide that provides the same level of disease control for the ‘susceptible’ strain of the same fungal species (RF=EC50 value of the resistant strain/EC50 value of the sensitive strain). Three categories can thus be defined: 1) RF≥50=resistant strain, 2) 5<RF<50=less sensitive strain (shift in sensitivity), and 3) RF<5=sensitive strain.

In order to obtain resistant fungal strains, a researcher is to locate a host crop and geographical region where the relevant resistance had been reported in literature. Leaf samples infected by the target disease are then collected from the locations/host crops and sent to a laboratory, where pure cultures would be isolated. The resistant phenotype of the fungal cultures is determined either by conducting a full dose response bioassay and comparing the bioassay results to similar bioassay results for a known susceptible strain of the same species. Alternatively the resistance genotype of the fungal strain can be determined by molecular techniques (e.g. qPCR) if the resistance mechanism for the relevant species is known.

The stated mutation F129L is made with reference to the amino acid sequence of the Phakopsora pachyrhizi mitochondrial Cytochrome b, Genbank ID NC_014344.1. The corresponding gene is referred to in Genbank ID 9481042.

The stated mutation G143A is made with reference to the amino acid sequence of the Corynespora cassiicola mitochondrial Cytochrome b, Genbank ID NC_056323.1. The corresponding gene is referred to in Genbank ID 65337677.

The stated mutation G143A is also made with reference to the amino acid sequence of the Mycosphaerella graminicola (Zymoseptoria tritici) mitochondrial Cytochrome b, Genbank ID ABU40271.1. The corresponding gene is referred to in Genbank ID EU090238.1.

The term “fungicide” as used herein means a compound that controls, modifies, or prevents the growth of fungi. The term “fungicidally effective amount” means the quantity of such a compound or combination of such compounds that is capable of producing an effect on the growth of fungi. Controlling or modifying effects include all deviation from natural development, such as killing, retardation and the like, and prevention includes barrier or other defensive formation in or on a plant to prevent fungal infection.

The term “plants” refers to all physical parts of a plant, including seeds, seedlings, saplings, roots, tubers, stems, stalks, foliage, and fruits.

The term “plant propagation material” denotes all generative parts of a plant, for example seeds or vegetative parts of plants such as cuttings and tubers. It includes seeds in the strict sense, as well as roots, fruits, tubers, bulbs, rhizomes, and parts of plants.

The term “locus” as used herein means fields in or on which plants are growing, or where seeds of cultivated plants are sown, or where seed will be placed into the soil. It includes soil, seeds, and seedlings, as well as established vegetation.

Throughout this document the expression “composition” stands for the various mixtures or combinations of components (A), (B) and (C) (including the above-defined embodiments), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components (A), (B) and (C) is not essential for working the present invention.

The compositions as disclosed herein (including a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003) are effective against harmful microorganisms, such as microorganisms, that cause phytopathogenic diseases, in particular against phytopathogenic fungi and bacteria.

The compositions as disclosed herein (including a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003) may be used to control plant diseases caused by a broad spectrum of fungal plant pathogens in the Basidiomycete, Ascomycete, Oomycete and/or Deuteromycete, Blasocladiomycete, Chrytidiomycete, Glomeromycete and/or Mucoromycete classes.

The compositions as disclosed herein (including a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003) are effective in controlling a broad spectrum of plant diseases, such as foliar and/or soil-borne pathogens of ornamental, turf, vegetable, field, cereal, and fruit crops.

These pathogens may include:

Oomycetes, including Phytophthora species such as Phytophthora cactorum, Phytophthora capsici, Phytophthora cinnamomi, Phytophthora citricola, Phytophthora citrophthora, Phytophthora erythroseptica, Phytophthora fragariae, Phytophthora infestans, Phytophthora nicotianae, Phytophthora porri, and Phytophthora sojae; Pythium species such as Pythium aphanidermatum, Pythium arrhenomanes, Pythium graminicola, Pythium irregulare and Pythium ultimum; other Peronosporales such as Bremia lactucae, Hyaloperonospora parasitica, Hyaloperonospora brassicae, Sclerophthora macrospora, Sclerospora graminicola; Peronospora species including Peronospora destructor, Peronospora farinosa f. sp. spinaciae and Peronospora viciae f. sp. pisi; Plasmopara species including Plasmopara halstedii and Plasmopara viticola; Pseudoperonospora species including Pseudoperonospora cubensis and Pseudoperonospora humili; Peronosclerospora species including Peronosclerospora maydis, Peronosclerospora philippinensis and Peronosclerospora sorghi; Albuginales such as Albugo candida, Albugo occidentalis, and Albugo tragopogonis; and Saprolegniales such as Aphanomyces species, including Aphanomyces cochliodes.

Ascomycetes, including Mycosphaerellales such as Actinothyrium graminis, Asperisporium caricae, Cercospora species including Cercospora arachidicola, Cercospora beticola, Cercospora brassicicola, Cercospora canescens, Cercospora cf. flagellaris, Cercospora janseana, Cercospora kikuchii, Cercospora lagenariae, Cercospora sojinae, Cercospora sorghi, Cercospora zeae-maydis; Dothistroma septosporum, Fulvia fulva, Mycosphaerella species including Mycosphaerella pomi and Mycosphaerella linicola; Neopseudocercosporella brassicae, Neopseudocercosporella capsellae, Nothopassalora personata, Nothophaeocrytopus gaeumannii, Passalora bataticola, Passalora koepkei, Pseudocercospora griseola, Pseudocercospora musaei, Pseudocercospora vitis, Pseudocercospora fijiensis, Ramularia species including Ramularia beticola and Ramularia collo-cygni; Ramulariopsis gossypii, Ramulariopsis pseudoglycines, Ramulispora sorghi, Scolecostigmina palmivora, Septoria species including Septoria apiicola, Septoria glycines and Septoria lycopersici; Zasmidium citri-griseum, and Zymosepotria tritici; Helotiales such as Blumeriella jaapii, Botrytis species including Botrytis cinerea, Botrytis aclada and Botrytis fabae; Botryotinia squamosa, Cadophora gregata, Civorinia allii, Claireedia homoeocarpa, Diplocarpon coronariae, Diplocarpon rosae, Drepanopeziza campestris, Gloeotinia temulenta, Hymenoscyphus fraxineus, Leptotrochila medicaginis, Marssonina graminicola, Monilinia species including Monilinia fructicola, Monilinia fructigena and Monilinia laxa; Neofabraea perennans, Neofabraea vagabunda, Oculimacula yallundae, Pezicula spp., Pseudopeziza medicaginis, Pseudopeziza tracheiphila, Pyrenopeziza species including Pyrenopeziza brassicae; Rhabdocline pseudotsugae, Rhynchosporium species including Rhynchosporium secalis; Sclerotinia species including Sclerotinia minor, Sclerotinia borealis and Sclerotinia sclerotiorum; Hypocreales such as Acremonium strictum, Albifimbria verrucaria, Claviceps africana, Claviceps purpurea, Fusarium species including Fusarium avenaceum, Fusarium culmorum, Fusarium fujikuroi, Fusarium graminearum, Fusarium incarnatum, Fusarium langsethiae, Fusarium moniliforme, Fusarium oxysporum, Fusarium oxysporum f.sp. cubense, Fusarium poae, Fusarium proliferatum, Fusarium pseudograminearum, Fusarium subglutinans, Fusarium sulphureum, Fusarium tricinctum and Fusarium verticillioides; Gliocladium spp., Neocosmospora phaseoli, Neocosmospora solani, Neonectria candida, Paramyrothecium roridum, Sarocladium oryzae, Trichoderma species including Trichoderma harzianum, Trichoderma pseudokoningii and Trichoderma viride; Trichothecium roseum and Ustilaginoidea virens; Magnaporthales such as Gaeumannomyces avenae, Gaeumannomyces graminis, Gaeumannomyces graminis tritici, Gaeumannomyces wongoonoo, Magnaporthiopsis poae, Pyricularia species including Pyricularia grisea and Pyricularia oryzae; Pleosporales, such as Alternaria species including Alternaria allii, Alternaria alternata, Alternaria arachidis, Alternaria brassicae, Alternaria brassicicola, Alternaria citri, Alternaria dauci, Alternaria grandisi, Alternaria helianthicola, Alternaria linariae, Alternaria mali, Alternaria porri, Alternaria solani and Alternaria tomato; Boeremia coffeae, Ascochyta species including Ascochyta pisi and Ascochyta rabiei; Bipolaris maydis, Bipolaris oryzae, Bipolaris sorokiniana, Cochliobolus spp., Corynespora cassiicola, Curvularia species including Curvularia australiensis, Curvularia cactivora and Curvularia lunata; Didymella species including Didymella pinodella and Didymela pinodes; Xenodidymella applanata, Drechslera species including Drechslera glycines; Epicoccum nigrum, Exserohilum turcicum, Helminthosporium species including Helminthosporium solani; Hendersonia creberrima, Leptosphaerulina crassiasca, Neocamarosporium betae, Ophiosphaerella agrostidis, Ophiosphaerella herpotricha, Ophiosphaerella korrae, Ophiosphaerella narmari, Parastagonospora nodorum, Phaeosphaeria herpotrichoides, Phaerosphaeria maydis, Phoma spp., Plenodomus lindquistii, Plenodomus lingam, Pleospora spp., Pseudopyrenochaeta lycopersici, Pyrenophora species including Pyrenophora poae, Pyrenophora teres and Pyrenophora tritici-repentis; Remotididymella destructiva, Stagonospora tainanensis, Stagonosporopsis cucurbitacearum, Stemphylium species including Stemphylium botryosum, Stemphylium solani and Stemphylium vesicarium; Diaporthales such as Anisogramma anonmala, Apiognomonia errabunda, Cytospora platani, Diaporthe species including Diaporthe amygdali, Diaporthe helianthin, Diaporthe neoviticola and Diaporthe phaseolorum; Dicarpella spp., Discula destructiva, Gnomoniopsis fructicola, Greeneria uvicola, Juglanconis juglandina, Ophiognomonia clavigignenti-juglandacearum, Stenocarpella maydis and Tubakia dryina; Dothideales such as Aureobasidium species including Aureobasidium pullulans; Discosphaerina fulvida; Erysiphales such as Blumeria graminis, Brasiliomyces malachrae, Erysiphe species including Erysiphe betae, Erysiphe cruciferarum, Erysiphe diffusa, Erysiphe heraclei, Erysiphe necator and Erysiphe pisi; Golovinomyces cichoracearum, Golovinomyces orontii, Leveillula taurica, Oidium arachidisi, Oidium neolycoperisci, Phyllactinia guttata, Podosphaera species including Pososphaera aphanis, Podosphaera fuliginea, Podosphaera fusca, Podosphaera leucotricha, Podosphaera macularis, Podosphaera mors-uvae, Podosphaera pannosa, Podosphaera tridactyla and Podosphaera xanthii; Glomerellales such as Colletotrichum species including Colletotrichum acutatum, Colletotrichum cereale, Colletotrichum chrysanthemi, Colletotrichum cliviicola, Colletotrichum coccodes, Colletotrichum fragariae, Colletotrichum gloeosporioides, Colletotrichum graminicola, Colletotrichum lentis, Colletotrichum lindemuthianum, Colletotrichum musae, Colletotrichum orbiculare, Colletotrichum siamense and Colletotrichum truncatum; Glomerella cingluata, Glomerella gossypii, Musicillium theobromae, Plectosphaerella cucumerina, Verticillium species including Verticillium dahlia; Venturiales such as Venturia species including Venturia carpophila, Venturia effusa, Venturia inaequalis, Venturia oleaginea, and Venturia pyrina; Xylariales such as Eutypa lata, Microdochium albescens, Microdochium majus, Microdochium nivale, Microdochium paspali, Microdochium sorghi, Physalospora abdita, Rosellinia spp. and Seimatosporium mariae; Botryosphaeriales such as Botryosphaeria species including Botryosphaeria dothidea; Diplodia species including Diplodia seriata; Dothiorella aromatica, Lasiodiplodia theobromae, Macrophoma theicola, Macrophomina phaseolina, Phyllosticta ampelicida and Phyllosticta cucurbitacearum; Eurotiales such as Aspergillus species including Aspergillus flavus, Aspergillus fumigatus, Aspergillus niger and Aspergillus terreus; Penicillium species including Penicillium digitatum, Penicillium expansum and Penicillium italicum; Microascales such as Berkeleyomyces basicola, Thielaviopsis paradoxa, Ceratocystis species including Ceratocystis fimbriata, Ceratocystis manginecans and Ceratocystis platani; Scedosporium species including Scedosporium apiospermum and Scedosporium prolificans; Myriangiales such as Elsinoe species including Elsinoe ampelina and Elsinoe perseae; Ophiostomatales such as Leptographium lundbergii, Leptographium microsporum, Ophiostoma novo-ulmi, Ophiostoma piceae and Sporothrix spp.; Pezizomycetes such as Phymatotrichopsis omnivore and Polyscytalum pustulans; Phyllachorales such as Gibellina cerealis, Phyllachora maydis and Phyllachora pomigena; Amphisphaeriales such as Griphosphaeria corticola, Lepteutypa cupressi and Pestalotia rhododendri; Capnodiales such as Capnodium ramosum and Schizothyrium pomi; Chaetothyriales such as Phialophroa spp.; Cladosporiales such as Cladosporium species including Cladosporium oxysporum, Cladosporium cucumerinum and Cladosporium allii-cepae; Rhytismatales such as Lophodermium seditiosum and Naemacyclus spp.; Saccharomycetales such as Cephaloascus species including Cephaloascus fragrans; Geotrichum candidum, Candida species including Candida glabrata, Candida krusei, Candida lusitaniae, Candida parapsilosis, Candida albicans and Candida tropicalis; Sordariales such as Chaetomium spp. and Monosporascus cannonballus; Sordariomycetes such as Wongia garrettii and Wongia griffinii; Taphrinales such as Taphrina bullata and Taphrina deformans; Onygenales such as Ajellomyces capsulatus, Blastomyces dermatitidis, Coccidioides species including Coccidioides immitis; Epidermophyton spp., Histoplasma spp., Microsporum spp., Trichophyton spp., and Paracoccidioides species including Paracoccioides brasiliensis; and others such as Hymenula cerealis, Petriellidum spp., and Septocyta ruborum.

Basidiomycetes, including Pucciniales such as Cerotelium fici, Chrysomyxa arctostaphyli, Coleosporium ipomoeae, Cronartium ribicola, Gymnosporangium juniperi-virginianae, Gymnosporangium sabinae, Hemileia species including Hemileia vastatrix; Melampsora medusae, Melampsora lini, Phakopsora ampelopsidis, Phakopsora pachyrhizi, Phragmidium mucronatum, Puccinia species including Puccinia allii, Puccinia arachidis, Puccinia asparagi, Puccinia cacabata, Puccinia coronata, Puccinia graminis, Puccinia helianthi, Puccinia hieracii, Puccinia hordei, Puccinia horiana, Puccinia melanocephala, Puccinia polysora, Puccinia porri, Puccinia recondita, Puccinia sorghi, Puccinia striiformis, Puccinia striiformis f.sp. hordei, Puccinia striiformis f.sp. tritici and Puccinia triticina; Pucciniastrum coryli, Tranzschelia discolor, Uromyces species including Uromyces betae, Uromyces pisi and Uromyces viciae-fabae; Tilletiales such as Neovossia moliniae, and Tilletia species including Tilletia caries and Tilletia controversa; Ustilaginales such as Sporisorium reilianum and Ustilago species including Ustilago maydis, Ustilago segetum var. nuda, Ustilago segetum var. tritici and Ustilago striiformis; Urocystidales such as Urocystis species including Urocystis agropyri; Agaricales such as Marasmiellus inoderma, Mycena spp., Moniliophthora roreri and Moniliophthora perniciosa; Cantharellales such as Sclerotium spp. and Typhula species including Typhula incarnata and Typhula ishikariensis; Ceratobasidiales such as Waitea circinata, and Rhizoctonia species including Rhizoctonia cerealis, Rhizoctonia solani and Rhizoctonia theobromae; Atheliales such as Athelia rolfsii; Corticiales such as Corticium invisum and Laetisaria fuciformis; Cystodilobasidiales such as Itersonilia perplexans; Entylomatales such as Entyloma calendulae f.sp. dahliae and Entylomella microspore; Exobasidiales such as Exobasidium vexans; Hymenochaetales such as Phellinus igniarius; Russulales such as Stereum hirsutum; and Tremellales such as Cryptococcus species including Cryptococcus neoformans.

Zygomycetes, including Mucorales such as Choanephora cucurbitarum, Mucor spp., Rhizopus oryzae, Absidia corymbifera and Rhizomucor pusillus.

Blastocladiomycetes, including Physoderma maydis.

as well as diseases caused by other species and genera closely related to those listed above.

In addition to their fungicidal activity, the compositions may also have activity against diseases caused by Actinobacteria such as Streptomyces scabiei; Proteobacteria such as Erwinia amylovora, Pectobacterium carotovorum, Xanthomonas species including Xanthomonas axonopodis, Xanthomonas campestris, Xanthomonas citri, Xanthomonas oryzae and Xanthomonas vesicatoria; Xylella fastidiosa, and Pseudomonas species including Pseudomonas syringae; Cercozoa such as Polymyxa betae, Polymyxa graminis and Spongospora subterranea; and Bigyra such as Labyrinthula zosterae.

as well as diseases caused by other species and genera closely related to those listed above.

The compositions as disclosed herein are particularly effective against phytopathogenic fungi belonging to the following classes: Ascomycetes (e.g. Venturia, Podosphaera, Erysiphe, Monilinia, Mycosphaerella, Uncinula); Basidiomycetes (e.g. the genus Hemileia, Rhizoctonia, Phakopsora, Puccinia, Ustilago, Tilletia); Fungi imperfecti (also known as Deuteromycetes; e.g. Botrytis, Helminthosporium, Rhynchosporium, Fusarium, Septoria, Cercospora, Alternaria, Pyricularia and Pseudocercosporella); Oomycetes (e.g. Phytophthora, Peronospora, Pseudoperonospora, Albugo, Bremia, Pythium, Pseudosclerospora, Plasmopara).

Further, there is provided a method of controlling or preventing phytopathogenic fungi, especially Corynespora cassiicola, on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Furthermore, according to the invention, there is provided a method of controlling or preventing Corynespora cassiicola, on useful plants (preferably, soybean) or on propagation material thereof, wherein said Corynespora cassiicola comprises a G143A mutation in the mitochondrial cytochrome b which confers resistance to Qo inhibitors, said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing Corynespora cassiicola, on useful plants (preferably, soybean) or on propagation material thereof, wherein said Corynespora cassiicola comprises at least one of a H278Y, H278R or 1280V mutation in the SDH subunit B, or a S73P or N75S mutation in the SDH subunit C, or a S89P, G109V or V1521 mutation in the SDH subunit D which confers resistance to succinate dehydrogenase inhibitors (SDHI), said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Phakopsora (including Phakopsora ampelopsidis and Phakopsora pachyrhizi), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing Phakopsora pachyrhizi, on useful plants (preferably, soybean) or on propagation material thereof, wherein said Phakopsora pachyrhizi comprises at least one of a I86F, N88S/D, H154R or G92R mutation in the SDH subunit C, which confers resistance to succinate dehydrogenase inhibitors (SDHI), said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing Phakopsora pachyrhizi, on useful plants (preferably, soybean) or on propagation material thereof, wherein said Phakopsora pachyrhizi comprises at least one of a F120L, V130A, Y131F/H, K142R, 1145F, 1145V or 1475T mutation in the CYP51 gene which confers resistance to sterol demethylation-inhibitors (DMI), said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Cercospora (including Cercospora arachidicola, Cercospora beticola, Cercospora brassicicola, Cercospora canescens, Cercospora cf. flagellaris, Cercospora janseana, Cercospora kikuchii, Cercospora lagenariae, Cercospora sojinae, Cercospora sorghi and Cercospora zeae-maydis), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Furthermore, according to the invention, there is provided a method of controlling or preventing Cercospora (including Cercospora arachidicola, Cercospora beticola, Cercospora brassicicola, Cercospora canescens, Cercospora cf. flagellaris, Cercospora janseana, Cercospora kikuchii, Cercospora lagenariae, Cercospora sojinae, Cercospora sorghi and Cercospora zeae-maydis), on useful plants (preferably, soybean) or on propagation material thereof, wherein said Cercospora comprises a G143A mutation in the mitochondrial cytochrome b which confers resistance to Qo inhibitors, said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing Cercospora (including Cercospora arachidicola, Cercospora beticola, Cercospora brassicicola, Cercospora canescens, Cercospora cf. flagellaris, Cercospora janseana, Cercospora kikuchii, Cercospora lagenariae, Cercospora sojinae, Cercospora sorghi and Cercospora zeae-maydis), on useful plants (preferably, soybean) or on propagation material thereof, wherein said Cercospora comprises at least one of a E297K, 1330T or P384S mutation in the CYP51 gene which confers resistance to sterol demethylation-inhibitors (DMI), said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Colletotrichum (including Colletotrichum acutatum, Colletotrichum cereale, Colletotrichum chrysanthemi, Colletotrichum cliviicola, Colletotrichum coccodes, Colletotrichum fragariae, Colletotrichum gloeosporioides, Colletotrichum graminicola, Colletotrichum lentis, Colletotrichum lindemuthianum, Colletotrichum musae, Colletotrichum orbiculare, Colletotrichum siamense and Colletotrichum truncatum), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

In another embodiment according to the invention, there is provided, a method of controlling or preventing phytopathogenic fungi, especially Colletotrichum lagenarium on useful plants (preferably, soybean) or on propagation material thereof, which comprises applying to the useful plants, the locus thereof or propagation material thereof a fungicidal composition, wherein the the composition is a composition selected from the group consisting of M34.003, M34.007, M34.024, M35.002, M35.023, M37.004, M37.021, M37.024, M37.029, M41.017, M58.003 and M58.004 (disclosed in tables M34, M35, M37, M41 and M58 above). Preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Sclerotinia (including Sclerotinia minor, Sclerotinia borealis and Sclerotinia sclerotiorum), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing Sclerotinia sclerotiorum, on useful plants (preferably, soybean) or on propagation material thereof, wherein said Sclerotinia sclerotiorum comprises at least one of a H273Y mutation in the SDH subunit B, or a G91R, H146R, H146Y or G150R mutation in the SDH subunit C, or a H132R mutation in the SDH subunit D which confers resistance to succinate dehydrogenase inhibitors (SDHI), said method comprising applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Septoria (including Septoria apiicola, Septoria glycines and Septoria lycopersici), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

In another embodiment according to the invention, there is provided, a method of controlling or preventing phytopathogenic fungi, especially Septoria tritici on useful plants (preferably, soybean) or on propagation material thereof, which comprises applying to the useful plants, the locus thereof or propagation material thereof a fungicidal composition, wherein the the composition is a composition selected from the group consisting of M34.003, M34.007, M34.024, M35.002, M35.023, M37.004, M37.021, M37.024, M37.029, M41.017, M58.003 and M58.004 (disclosed in tables M34, M35, M37, M41 and M58 above). Preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Peronospora (including Peronospora destructor, Peronospora farinosa f. sp. spinaciae and Peronospora viciae f. sp. Pisi), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic fungi, especially Diaporthe (including Diaporthe amygdali, Diaporthe helianthin, Diaporthe neoviticola and Diaporthe phaseolorum), on useful plants (preferably, soybean) or on propagation material thereof, which comprises applying to the useful plants, the locus thereof or propagation material thereof a fungicidal composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of component A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Crops of useful plants in which the compositions disclosed herein (including a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003) can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

In a preferred embodiment of the invention there is provided a method of controlling or preventing infestation by phytopathogenic fungi (preferably, Phakopsora pachyrhizi) in legumes, wherein said phytopathogenic fungi comprises a F129L mutation in the mitochondrial cytochrome b which confers resistance to Qo inhibitors, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

In a preferred embodiment of the invention there is provided a method of controlling or preventing infestation by phytopathogenic fungi (preferably, Phakopsora pachyrhizi) in soybean, wherein said phytopathogenic fungi comprises a F129L mutation in the mitochondrial cytochrome b which confers resistance to Qo inhibitors, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic diseases, especially phytopathogenic fungi, in maize (corn) or on propagation material thereof, which comprises applying to the maize (corn), the locus thereof or propagation material thereof a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic diseases, especially phytopathogenic fungi, in wheat or on propagation material thereof, which comprises applying to the wheat, the locus thereof or propagation material thereof a fungicidal composition wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of components A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Further according to the invention, there is provided a method of controlling or preventing phytopathogenic diseases, especially phytopathogenic fungi, in cotton or on propagation material thereof, which comprises applying to the cotton, the locus thereof or propagation material thereof a fungicidal composition wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, in this embodiment of the invention the preferred weight ratio of component A:B:C is as disclosed in tables R1 to R64. More preferably, in this embodiment of the invention the preferred weight ratio of components A:B:C is as disclosed in tables R34, R35, R37, R41 or R58 and/or tables B1 to B12.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides like bromoxynil or classes of herbicides such as ALS-, EPSPS-, GS-, HPPD- and PPO-inhibitors. An example of a crop that has been rendered tolerant to imidazolinones, e.g. imazamox, by conventional methods of breeding is Clearfield® summer canola. Examples of crops that have been rendered tolerant to herbicides by genetic engineering methods include e.g. glyphosate- and glufosinate-resistant maize varieties commercially available under the trade names RoundupReady®, Herculex I® and LibertyLink®.

Crops are also to be understood as being those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include δ-endotoxins, vegetative insecticidal proteins (Vip), insecticidal proteins of bacteria colonising nematodes, and toxins produced by scorpions, arachnids, wasps and fungi.

An example of a crop that has been modified to express the Bacillus thuringiensis toxin is the Bt maize KnockOut® (Syngenta Seeds). An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex I® (Dow AgroSciences, Pioneer Hi-Bred International).

The fungicidal compositions as disclosed herein comprising a mixture of components (A) and (B) as active ingredients, may be used in controlling or preventing phytopathogenic diseases, especially phytopathogenic fungi (such as Phakopsora pachyrhizi) on transgenic soybean plants.

In particular, transgenic soybean plants expressing toxins, for example insecticidal proteins such as delta-endotoxins, e.g. Cry1Ac (Cry1Ac Bt protein). Accordingly, this may include transgenic soybean plants comprising event MON87701 (disclosed in WO2009/064652, as well as WO2014/170327 (eg, see paragraph [008] reference to Intacta RR2 PRO® soybean)), event MON87751 (disclosed in WO2014/201235) or event DAS-81419-2 (aka Conkesta™ Soybean, described in WO2013016527).

Useful transgenic events in transgenic soybean plants, which can be treated according to the invention, include event DAS-44406-6/pDAB8264.44.06.1 (soybean, herbicide-tolerance, disclosed in WO2012/075426); event DAS-81419-2 (aka Conkesta™ Soybean, described in WO2013016527 (aka Conkesta™ Enlist E3™ Soybean, DAS-81419-2×DAS-44406-6); event DAS-14536-7/pDAB8291.45.36.2 (soybean, herbicide-tolerance, disclosed in WO2012/075429); DAS-68416-4 (soybean, herbicide-tolerance, ATCC Accession No. PTA-10442, disclosed in WO2011/066384, WO2011/066360); event DP-305423-1 (soybean, quality mark, disclosed in WO2008/054747); event DP-356043-5 (soybean, herbicide-tolerance, deposited as ATCC PTA-8287, disclosed in WO2008/002872); event FG72 (soybean, herbicide-tolerance, disclosed in WO2011/063413); event LL27 (soybean, herbicide-tolerance, disclosed in WO2006/108674); event LL55 (soybean, herbicide-tolerance, disclosed in WO 2006/108675); event EE-GM3/FG72 (soybean, herbicide-tolerance) optionally stacked with event EE-GM1/LL27 or event EE-GM2/LL55 (disclosed in WO2011/063413); event MON87701 (soybean, insect control, disclosed in WO2009/064652, WO2014/170327); event MON87705 (soybean, improved fatty acid profile, herbicide-tolerance, disclosed in WO2010/037016); event MON87751 (lepidopteran-resistant, ATCC accession no. PTA-120166. disclosed in WO2014/201235); event MON87708 (soybean, herbicide-tolerance, disclosed in WO2011/034704); event MON87712 (soybean, yield, disclosed in WO2012/051199); event MON87754 (soybean, quality feature, disclosed in WO2010/024976); event MON87769 (soybean, quality attribute, disclosed in WO2009/102873); event MON89788 (soybean, herbicide-tolerance, disclosed in WO2006/130436); event SYHT0H2/SYN-000H2-5 (soybean, herbicide-tolerance, disclosed in WO2012/082548); event DAS-21606-3 (soybean, herbicide-tolerance, disclosed in WO2012/033794); event 8264.44.06.1 (soybean, stacked herbicide-tolerance, disclosed in WO2022/012075426); event pDAB8291.45.36.2 (soybean, stacked herbicide-tolerance, disclosed in WO2012/075429); event pDAB8264.42.32.1 (soybean, stacked herbicide-tolerance, disclosed in WO2013/010094); event A2704-12 (glufosinate tolerance, disclosed in WO2006/108647); event A5547-127 (phosphinothricin tolerant, disclosed in WO2006/108675); event BPS-CV127-91 (herbicide tolerance, disclosed in WO 2010/080829); event GU262 (phosphinothricin tolerant, described in APHIS regulatory reference US 98-238-01p); Particularly useful transgenic events in transgenic soybean plants, which can preferably be treated according to the invention, include event A2704-12 (glufosinate tolerance, disclosed in WO2006/108647), event A5547-127 (phosphinothricin tolerant, disclosed in WO2006/108675); event GU262 (phosphinothricin tolerant, described in APHIS regulatory reference US 98-238-01p); event MON89788 (disclosed in WO2006/130494A; event DP-305423-1 (soybean, quality mark, disclosed in WO2008/054747); event MON87701 (soybean, insect resistant, disclosed in WO2009/064652); event MON87705 (soybean, improved fatty acid profile, herbicide-tolerance, disclosed in WO2010/037016 or US20100080887A); event MON87769 (soybean, quality attribute, disclosed in WO2009/102873 or US20110067141A); event FG72 (soybean, herbicide-tolerance, disclosed in WO2011/063413); event MON87712 (soybean, yield, disclosed in WO2012/051199); event BPS-CV127-9 (soybean, herbicide tolerance, deposited as NCIMB No. 41603, disclosed in WO2010/08082); event DAS-68416-4 (soybean, herbicide-tolerance, ATCC Accession No. PTA-10442, disclosed in WO2011/066384, WO2011/066360); event SYHT0H2/SYN-000H2-5 (soybean, herbicide-tolerance, disclosed in WO2012/082548); event DAS-44406-6/pDAB8264.44.06.1 (soybean, herbicide-tolerance, disclosed in WO2012/075426); event MON87751 (lepidopteran-resistant, ATCC accession no. PTA-120166. disclosed in WO2014/201235); event MON87708 (soybean, herbicide-tolerance, disclosed in WO2011/034704) and event GMB151 (also called BCS-GM151-6, HPPD tolerance, disclosed in WO2018119364A1).

Furthermore, such a list of transgenic events is provided by the United States Department of Agriculture's (USDA) Animal and Plant Health Inspection Service (APHIS) and can be found on their website on the World Wide Web at aphis.usda.gov.

The term “event” as used herein refers to the event name that relates to a unique DNA recombination event that took place in one plant cell and which was then used to generate an entire transgenic plant.

Detailed information on the events and associated products can be found on http://www.isaaa.org/gmapprovaldatabase. The events listed herein have been introduced into plants that are now commercially available.

Commercially available examples of transgenic soybeans, which can preferably be treated in a method according to the invention, include commercially available products such as plant seeds, which are under the ROUNDUP READY 2 XTEN®, INTACTA RR2 PRO®, VISTIVE® GOLD, Conkesta E3©, Conkesta Enlist E3™, LibertyLink® and/or XtendFlex® trade names are sold or distributed.

Exemplary genetically modified traits in soybean that the compositions disclosed herein (particularly a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003, preferably M34.003, M34.007, M34.024, M35.002, M35.023, M37.004, M37.021, M37.024, M37.029, M41.017, M58.003 and M58.004) can be applied to and that confer enhanced Asian Soybean Rust (ASR) resistance comprise resistance genes encoding resistance proteins as set forth in: WO2019103918 (for example, but not limited to, RG-1 (SEQ ID NO: 47) and active variants or fragments thereof; or R-genes as set forth at SEQ ID NO: 28, 42, 43, 44, 45 or 46 of WO2019103918); WO202100878 (for example Rpp6907 (SEQ ID NO: 1 of WO202100878) and active variants or fragments thereof); WO2021022022 (for example, TirA or Tir B (SEQ ID NOS: 11 or 16 of WO2021022022, respectively) or active variants or fragments thereof); WO2021260673 (for example, but not limited to, RG21 and/or RG22 (SEQ ID NOS: 1 or 12 of WO2021260673) or active variants or fragments thereof); WO2022173659 (for example, but not limited to, RG30 (SEQ ID NO: 5 of WO2022173659) or active variants or fragments thereof); WO2022159341 (for example but not limited to SEQ ID NOS: 1 and 148 of WO2022159341 or active variants or fragments thereof); WO2021154632A1, WO2021022026, WO2021022101, US20220135997 (for example, but not limited to, FIT1 (SEQ ID NO: 2 of US20220135997), an active variant or fragment thereof or any of the FIT1 paralogs or orthologs disclosed therein (such as SEQ ID NOS: 4, 6, 8, 10, 12, 14, 16, 18 or 20 of US20220135997); U.S. Ser. No. 10/842,097 (for example, but not limited to, CcRpp1 or active variants or fragments thereof or any other resistance genes disclosed therein); WO2022140257 (for example, CcRpp2-R1 and/or CcRpp2-R3 (SEQ ID NOS: 2 or 4 of WO2022140257) or an active variant or fragment thereof); the resistance genes disclosed in U.S. Provisional Application No. 63/481,627 as RG31 (SEQ ID NOS: 1, 3, or 4) or RG35 (SEQ ID NOS: 2 or 5); and/or the resistance genes disclosed in U.S. Provisional Application Nos. 63/426,524 and 63/509,586 as RG32 (SEQ ID NOS: 1, 3, or 4) or RG34 (SEQ ID NOS: 2, 5, 6, or 17); each of which is incorporated by reference in their entirety.

Exemplary native traits in soybean that the compositions disclosed herein (particularly a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003, preferably M34.003, M34.007, M34.024, M35.002, M35.023, M37.004, M37.021, M37.024, M37.029, M41.017, M58.003 and M58.004) can be applied to and that confer increased resistance to ASR or to pathogens from the genus Phakopsora, including the species Phakopsora pachyrhizi and Phakopsora meibomiae include various intervals and locus (loci) associated with Rpp1, Rpp1 b, Rpp2, Rpp4, Rpp5, Rpp6 and ASR resistance locus 1-16 can be found, for example, in WO2009079729, U.S. Pat. Nos. 8,759,607, 8,962,914, WO2008054546, U.S. Pat. Nos. 8,692,054, 9,091,681, WO2009132089, U.S. Pat. Nos. 8,669,414, 8,796,503, 8,921,645, WO2010096227, WO2010009404, WO2021154632, US20230067451, WO2021022026, US20220256795, WO2021022101, US20220338433A1, WO2022173659, WO2010009404, WO2017222827, US20210024950, WO2021000878, US20220380796, US20230147114, and PCT App. No. PCT/US23/60373, each of which is incorporated by reference in their entirety.

Soybean varieties that confer increased resistance to ASR (caused by Phakopsora pachyrhizi) for example, but not limited to soybean cultivars TMG 7062, TMG 7161, TMG 7261, to TMG7368 IPRO (disclosed in WO2009079729), TMG7062 IPRO, TMG 7063 IPRO, and TMG 7061 IPRO.

Further Soybean varieties that confer increased resistance against ASR (caused by Phakopsora pachyrhizi) include for example, but not limited to soybeans with Shield Technology, like for example BRS511 soybean, BRS 531 soybean, or Soy-BRS 539 (conventional soybean with Shield® and Block® Technologies).

In another embodiment of the invention there is provided a method of controlling or preventing infestation by phytopathogenic fungi (preferably, Phakopsora pachyrhizi) in a genetically modified plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably the genetically modified plant is a soybean plant. More preferably the genetically modified plants of soybean are selected from the list consisting of Intacta®, Intacta®2, Intacta® Roundup Ready™ 2 Pro (Intacta®RR2 PRO), Intacta®2 Xtend™ Cultivance, Conkesta Soybean, Conkesta Enlist E3™ Soybean, Enlist™ Soybean, Enlist E3™ Soybean, Roundup Ready™ Soybean, Roundup Ready™ 2 Xtend™, Genuity® Roundup Ready™ 2 Xtend™, Genuity® Roundup Ready 2 Yield™, Herbicide-tolerant Soybean line, Optimum GAT™ Liberty Link™ Soybean, Vistive Gold™, Verdeca HB4 Soybean, Treus™ and Plenish™.

In another embodiment of the invention there is provided a method of controlling or preventing infestation by phytopathogenic fungi (preferably, Phakopsora pachyrhizi) in a Bt soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004). Preferably, the Bt soybeanplant is a soybean variety which are sold under the trade names Intacta®, Intacta®2, Intacta® Roundup Ready™ 2 Pro (Intacta®RR2 PRO), Cultivance, Conkesta Soybean, Conkesta Enlist E3™ Soybean, Enlist™ Soybean, Enlist E3™ Soybean, Roundup Ready™ Soybean, Genuity® Roundup Ready™ 2 Xtend™, Genuity® Roundup Ready 2 Yield™, Herbicide-tolerant Soybean line, Optimum GAT™, Liberty Link™ Soybean, Vistive Gold™, Verdeca HB4 Soybean, Treus™ or Plenish™. Even more preferably, the Bt soybean plant is Intacta RR2 PRO® or Conkesta Enlist E3®.

As used herein, the term “genetically modified plant” or “genetically modified soybean plant” refers to a plant or soybean plant, in which the genetic material has been altered in a way that does not occur naturally by mating and/or natural recombination. These plants are also called transgenic or genetically engineered plants. Genetic modification of plants involves adding a specific stretch of DNA into the plant's genome, giving it new or different characteristics. This could include changing the way the plant grows or making it resistant to a particular disease. Examples of genetically modified soybean plants are available under the tradenames YIELD GARD®, Intacta®, Intacta®2, Intacta® Roundup Ready™ 2 Pro (Intacta®RR2 PRO), Cultivance, Conkesta Soybean, Conkesta Enlist E3™ Soybean, Enlist™ Soybean, Enlist E3™ Soybean, Roundup Ready™ Soybean, Genuity® Roundup Ready™ 2 Xtend™ Genuity® Roundup Ready 2 Yield™, Herbicide-tolerant Soybean line, Optimum GAT™, Liberty Link™ Soybean, Vistive Gold™, Verdeca HB4 Soybean, Treus™, Plenish™ In another embodiment of the invention there is provided a method of controlling or preventing infestation by phytopathogenic fungi (preferably, Phakopsora pachyrhizi) in a soybean variety, said method comprising applying to the soybean variety selected from the list consisting of TMG 7062, TMG 7161, TMG 7261, to TMG7368 IPRO (disclosed in WO2009079729), TMG7062 IPRO, TMG 7063 IPRO, TMG 7061 IPRO, BRS511 soybean, BRS 531 soybean and Soy-BRS 539, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004).

As used herein, the term “Bt soybean plant” refers to soybean plants that are genetically engineered soybeans that produce an insecticidal protein like the one naturally produced by the bacteria species Bacillus thuringiensis, for example by the genes CryIA(a), CryIA(b), CryIA(c), CryIIA, CryIIIA, CryIIIB2, Cry9c, Cry2Ab, Cry3Bb and CryIF and also combinations thereof. These soybeans that are genetically engineered to produce the same toxin as Bacillus thuringiensis (Bt) in every cell of the plant, with the goal of protecting the soybean from pests, are referred to herein as “Bt soybeans”. Examples Bt soybean plants are Intacta RR2 PRO®, or Conkesta Enlist E3®.

In a preferred embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87701.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87751.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A) and (B) as active ingredients, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DAS-81419-2.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DAS-44406-6/pDAB8264.44.06.1.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DAS-14536-7/pDAB8291.45.36.2.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DAS-68416-4.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DP-305423-1.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DP-356043-5.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event FG72.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event LL27.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event LL55.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event EE-GM3/FG72 (optionally stacked with event EE-GM1/LL27 or event EE-GM2/LL55).

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87705.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87708.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87712.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87754.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON87769.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event MON89788.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event SYHT0H2/SYN-000H2-5.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event DAS-21606-3.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event 8264.44.06.1.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event pDAB8291.45.36.2.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event pDAB8264.42.32.1.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event A2704-12.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event A5547-127.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event BPS-CV127-91.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event GU262.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event BPS-CV127-9.

In another embodiment of the invention there is provided a method of controlling or preventing infestation by phytopathogenic fungi (preferably, Phakopsora pachyrhizi) in a transgenic soybean plant, said method comprising applying to the plant, to parts thereof or the locus thereof, a fungicidal composition comprising a mixture of components (A), (B) and (C) as active ingredients, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004), wherein the transgenic soybean plant comprises the event GMB151.

The fungicidal compositions as disclosed herein may be used in controlling or preventing phytopathogenic diseases, especially phytopathogenic fungi (such as Phakopsora pachyrhizi) on soybean plants. In particular, there are known in the scientific literature certain Elite soybean plant varieties where R-gene stacks, conferring a degree of immunity or resistance to specific Phakopsora pachyrhizi, have been been introgressed in the plant genome, see for example: “Fighting Asian Soybean Rust”, Langenbach C, et al, Front Plant Science 7(797) 2016).

An elite plant is any plant from an elite line, such that an elite plant is a representative plant from an elite variety. Non-limiting examples of elite soybean varieties that are commercially available to farmers or soybean breeders include: AG00802, A0868, AG0902, A1923, AG2403, A2824, A3704, A4324, A5404, AG5903, AG6202 AG0934; AG1435; AG2031; AG2035; AG2433; AG2733; AG2933; AG3334; AG3832; AG4135; AG4632; AG4934; AG5831; AG6534; and AG7231 (Asgrow Seeds, Des Moines, Iowa, USA); BPR0144RR, BPR 4077NRR and BPR 4390NRR (Bio Plant Research, Camp Point, Ill., USA); DKB17-51 and DKB37-51 (DeKalb Genetics, DeKalb, Ill., USA); DP 4546 RR, and DP 7870 RR (Delta & Pine Land Company, Lubbock, Tex., USA); JG 03R501, JG 32R606C ADD and JG 55R503C (JGL Inc., Greencastle, Ind., USA); NKS 13-K2 (NK Division of Syngenta Seeds, Golden Valley, Minnesota, USA); 90M01, 91M30, 92M33, 93M11, 94M30, 95M30, 97B52, P008T22R2; P16T17R2; P22T69R; P25T51R; P34T07R2; P35T58R; P39T67R; P47T36R; P46T21R; and P56T03R2 (Pioneer Hi-Bred International, Johnston, Iowa, USA); SG4771NRR and SG5161NRR/STS (Soygenetics, LLC, Lafayette, Ind., USA); S00-K5, S11-L2, S28-Y2, S43-B1, S53-A1, S76-L9, S78-G6, S0009-M2; S007-Y4; S04-D3; S14-A6; S20-T6; S21-M7; S26-P3; S28-N6; S30-V6; S35-C3; S36-Y6; S39-C4; S47-K5; S48-D9; S52-Y2; S58-Z4; S67-R6; S73-S8; and S78-G6 (Syngenta Seeds, Henderson, Ky., USA); Richer (Northstar Seed Ltd. Alberta, CA); 14RD62 (Stine Seed Co. Ia., USA); or Armor 4744 (Armor Seed, LLC, Ar., USA).

Thus, in a further preferred embodiment, fungicidal compositions as disclosed herein, are used to control Phakopsora pachyrhizi, (including fungicidally-resistant strains thereof, as outlined below) on Elite soybean plant varieties where R-gene stacks, conferring a degree of immunity or resistance to specific Phakopsora pachyrhizi, have been been introgressed in the plant genome. Numerous benefits may be expected to ensue from said use, e.g. improved biological activity, an advantageous or broader spectrum of activity (inc. sensitive and resistant strains of Phakopsora pachyrhizi), an increased safety profile, improved crop tolerance, synergistic interactions or potentiating properties, improved onset of action or a longer lasting residual activity, a reduction in the number of applications and/or a reduction in the application rate of the compounds and compositions required for effective control of the phytopathogen (Phakopsora pachyrhizi), thereby enabling beneficial resistance-management practices, reduced environmental impact and reduced operator exposure.

Under certain circumstances, fungicidal compositions according to the present invention comprising a mixture of components (A), (B) and (C) as active ingredients, when used in controlling or preventing phytopathogenic diseases, especially phytopathogenic fungi (such as Phakopsora pachyrhizi) on soy bean plants (in particular any of the transgenic soybean plants as described above), may display a synergistic interaction between the active ingredients.

Fungicidal-resistant strains of Phakopsora pachyrhizi have been reported in the scientific literature, with strains resistant to one or more fungicides from at least each of the following fungicidal mode of action classes being observed: sterol demethylation-inhibitors (DMI), quinone-outside-inhibitors (Qo) and succinate dehydrogenase inhibitors (SDHI). See for example: “Sensitivity of Phakopsora pachyrhizi towards quinone-outside-inhibitors and demethylation-inhibitors, and corresponding resistance mechanisms.” Schmitz H K et al, Pest Manag Sci (2014) 70: 378-388; “First detection of a SDH variant with reduced SDHI sensitivity in Phakopsora pachyrhizi” Simões K et al, J Plant Dis Prot (2018) 125: 21-2; “Competitive fitness of Phakopsora pachyrhizi isolates with mutations in the CYP51 and CYTB genes.” Klosowski A C et al, Phytopathology (2016) 106: 1278-1284; “Detection of the F129L mutation in the cytochrome b gene in Phakopsora pachyrhizi.” Klosowski A C et al, Pest Manag Sci (2016) 72: 1211-1215.

Thus, in a preferred embodiment, the fungicidal compositions as disclosed herein comprising a mixture of components (A), (B) and (C) as active ingredients (including a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003, preferably M34.003, M34.007, M34.024, M35.002, M35.023, M37.004, M37.021, M37.024, M37.029, M41.017, M58.003 and M58.004), are used to control Phakopsora pachyrhizi which are resistant to one or more fungicides from any of the following fungicidal MoA classes: sterol demethylation-inhibitors (DMI), quinone-outside-inhibitors (Qo) and succinate dehydrogenase inhibitors (SDHI).

Compositions in the method of this invention, including all of the above disclosed embodiments and preferred examples thereof, can be mixed with one or more further pesticides including further fungicides, insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection.

Examples of such agricultural protectants with which the composition of this invention can be formulated are:

Fungicides such as etridiazole, fluazinam, benalaxyl, benalaxyl-M (kiralaxyl), furalaxyl, metalaxyl, metalaxyl-M (mefenoxam), dodicin, N′-(2,5-dimethyl-4-phenoxy-phenyl)-N-ethyl-N-methyl-formamidine, N′-[4-(4,5-dichloro-thiazol-2-yloxy)-2,5-dimethyl-phenyl]-N-ethyl-N-methyl-formamidine, N′-[4-[[3-[(4-chlorophenyl)methyl]-1,2,4-thiadiazol-5-yl]oxy]-2,5-dimethyl-phenyl]-N-ethyl-N-methyl-formamidine, ethirimol, 3′-chloro-2-methoxy-N-[(3RS)-tetrahydro-2-oxofuran-3-yl]acet-2′,6′-xylidide (clozylacon), cyprodinil, mepanipyrim, pyrimethanil, dithianon, aureofungin, blasticidin-S, biphenyl, chloroneb, dicloran, benzovindiflupyr, pydiflumetofen, hexachlorobenzene, quintozene, tecnazene, (TCNB), tolclofos-methyl, metrafenone, 2,6-dichloro-N-(4-trifluoromethylbenzyl)-benzamide, fluopicolide (flupicolide), tioxymid, flusulfamide, benomyl, carbendazim, carbendazim chlorhydrate, chlorfenazole, fuberidazole, thiabendazole, thiophanate-methyl, benthiavalicarb, chlobenthiazone, probenazole, acibenzolar, bethoxazin, pyriofenone (IKF-309), acibenzolar-S-methyl, pyribencarb (KIF-7767), butylamine, 3-iodo-2-propinyl n-butylcarbamate (IPBC), iodocarb (isopropanyl butylcarbamate), isopropanyl butylcarbamate (iodocarb), picarbutrazox, polycarbamate, propamocarb, tolprocarb, 3-(difluoromethyl)-N-(7-fluoro-1,1,3,3-tetramethyl-indan-4-yl)-1-methyl-pyrazole-4-carboxamide diclocymet, N-[(5-chloro-2-isopropyl-phenyl)methyl]-N-cyclopropyl-3-(difluoromethyl)-5-fluoro-1-methyl-pyrazole-4-carboxamide N-cyclopropyl-3-(difluoromethyl)-5-fluoro-N-[(2-isopropylphenyl)methyl]-1-methyl-pyrazole-4-carboxamide carpropamid, chlorothalonil, flumorph, oxine-copper, cymoxanil, phenamacril, cyazofamid, flutianil, thicyofen, chlozolinate, iprodione, procymidone, vinclozolin, bupirimate, dinocton, dinopenton, dinobuton, dinocap, meptyldinocap, diphenylamine, phosdiphen, 2,6-dimethyl-[1,4]dithiino[2,3-c:5,6-c′]dipyrrole-1,3,5,7(2H,6H)-tetraone, azithiram, etem, ferbam, mancozeb, maneb, metam, metiram (polyram), metiram-zinc, nabam, propineb, thiram, vapam (metam sodium), zineb, ziram, dithioether, isoprothiolane, ethaboxam, fosetyl, phosetyl-Al (fosetyl-al), methyl bromide, methyl iodide, methyl isothiocyanate, cyclafuramid, fenfuram, validamycin, streptomycin, (2RS)-2-bromo-2-(bromomethyl)glutaronitrile (bromothalonil), dodine, doguadine, guazatine, iminoctadine, iminoctadine triacetate, 2,4-D, 2,4-DB, kasugamycin, dimethirimol, fenhexamid, hymexazole, hydroxyisoxazole imazalil, imazalil sulphate, oxpoconazole, pefurazoate, prochloraz, triflumizole, fenamidone, Bordeaux mixture, calcium polysulfide, copper acetate, copper carbonate, copper hydroxide, copper naphthenate, copper oleate, copper oxychloride, copper oxyquinolate, copper silicate, copper sulphate, copper tallate, cuprous oxide, sulphur, carbaryl, phthalide (fthalide), dingjunezuo (Jun Si Qi), oxathiapiprolin, fluoroimide, mandipropamid, KSF-1002, benzamorf, dimethomorph, fenpropimorph, tridemorph, dodemorph, diethofencarb, fentin acetate, fentin hydroxide, carboxin, oxycarboxin, drazoxolon, famoxadone, m-phenylphenol, p-phenylphenol, tribromophenol (TBP), 2-[2-[(7,8-difluoro-2-methyl-3-quinolyl)oxy]-6-fluoro-phenyl]propan-2-ol 2-[2-fluoro-6-[(8-fluoro-2-methyl-3-quinolyl)oxy]phenyl]propan-2-ol cyflufenamid, ofurace, oxadixyl, flutolanil, mepronil, isofetamid, fenpiclonil, fludioxonil, pencycuron, edifenphos, iprobenfos, pyrazophos, phosphorus acids, tecloftalam, captafol, captan, ditalimfos, triforine, fenpropidin, piperalin, osthol, 1-methylcyclopropene, 4-CPA, chlormequat, clofencet, dichlorprop, dimethipin, endothal, ethephon, flumetralin, forchlorfenuron, gibberellic acid, gibberellins, hymexazol, maleic hydrazide, mepiquat, naphthalene acetamide, paclobutrazol, prohexadione, prohexadione-calcium, thidiazuron, tribufos (tributyl phosphorotrithioate), trinexapac, uniconazole, α-naphthalene acetic acid, polyoxin D (polyoxrim), BLAD, chitosan, fenoxanil, folpet, 3-(difluoromethyl)-N-methoxy-1-methyl-N-[1-methyl-2-(2,4,6-trichlorophenyl)ethyl]pyrazole-4-carboxamide, bixafen, fluxapyroxad, furametpyr, isopyrazam, penflufen, penthiopyrad, sedaxane, fenpyrazamine, diclomezine, pyrifenox, boscalid, fluopyram, diflumetorim, fenarimol, 5-fluoro-2-(p-tolylmethoxy)pyrimidin-4-amine ferimzone, dimetachlone (dimethaclone), pyroquilon, proquinazid, ethoxyquin, quinoxyfen, 4,4,5-trifluoro-3,3-dimethyl-1-(3-quinolyl)isoquinoline, 4,4-difluoro-3,3-dimethyl-1-(3-quinolyl)isoquinoline 5-fluoro-3,3,4,4-tetramethyl-1-(3-quinolyl)isoquinoline 9-fluoro-2,2-dimethyl-5-(3-quinolyl)-3H-1,4-benzoxazepine, tebufloquin, oxolinic acid, chinomethionate (oxythioquinox, quinoxymethionate), spiroxamine, (E)-N-methyl-2-[2-(2, 5-dimethylphenoxymethyl) phenyl]-2-methoxy-iminoacetamide, (mandestrobin), azoxystrobin, coumoxystrobin, dimoxystrobin, enestroburin, enoxastrobin, fenamistrobin, flufenoxystrobin, fluoxastrobin, kresoxim-methyl, mandestrobin, metaminostrobin, metominostrobin, orysastrobin, picoxystrobin, pyraclostrobin, pyrametostrobin, pyraoxystrobin, triclopyricarb, trifloxystrobin, amisulbrom, dichlofluanid, tolylfluanid, but-3-ynyl N-[6-[[(Z)-[(1-methyltetrazol-5-yl)-phenyl-methylene]amino]oxymethyl]-2-pyridyl]carbamate, dazomet, isotianil, tiadinil, thifluzamide, benthiazole (TCMTB), silthiofam, zoxamide, anilazine, tricyclazole, (.+−.)-cis-1-(4-chlorophenyl)-2-(1H-1,2,4-triazol-1-yl)-cycloheptanol (huanjunzuo), 1-(5-bromo-2-pyridyl)-2-(2,4-difluorophenyl)-1,1-difluoro-3-(1,2,4-triazol-1-yl)propan-2-ol 2-(1-tert-butyl)-1-(2-chlorophenyl)-3-(1,2,4-triazol-1-yl)-propan-2-ol (TCDP), azaconazole, bitertanol (biloxazol), bromuconazole, climbazole, cyproconazole, difenoconazole, dimetconazole, diniconazole, diniconazole-M, epoxiconazole, etaconazole, fenbuconazole, fluquinconazole, flusilazole, flutriafol, hexaconazole, imibenconazole, ipconazole, ipfentrifluconazole, metconazole, myclobutanil, penconazole, propiconazole, prothioconazole, simeconazole, tebuconazole, tetraconazole, triadimefon, triadimenol, triazoxide, triticonazole, mefentrifluconazole, 2-[[(1R,5S)-5-[(4-fluorophenyl)methyl]-1-hydroxy-2,2-dimethyl-cyclopentyl]methyl]-4H-1,2,4-triazole-3-thione, 2-[[3-(2-chlorophenyl)-2-(2,4-difluorophenyl)oxiran-2-yl]methyl]-4H-1,2,4-triazole-3-thione, ametoctradin (imidium), iprovalicarb, valifenalate, 2-benzyl-4-chlorophenol (Chlorophene), allyl alcohol, azafenidin, benzalkonium chloride, chloropicrin, cresol, daracide, dichlorophen (dichlorophene), difenzoquat, dipyrithione, N-(2-p-chlorobenzoylethyl)-hexaminium chloride, NNF-0721, octhilinone, oxasulfuron, propamidine and propionic acid.

Insecticides such as abamectin, acephate, acetamiprid, amidoflumet (S-1955), avermectin, azadirachtin, azinphos-methyl, bifenthrin, bifenazate, buprofezin, carbofuran, cartap, chlorantraniliprole (DPX-E2Y45), chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, metofluthrin, monocrotophos, methoxyfenozide, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulprofos, tebufenozide, teflubenzuron, tefluthrin, terbufos, tetrachlorvinphos, thiacloprid, thiamethoxam, thiodicarb, thiosultap-sodium, tralomethrin, triazamate, trichlorfon and triflumuron;
Bactericides such as streptomycin;
Acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and
Biological agents such as Bacillus thuringiensis, Bacillus thuringiensis delta endotoxin, baculovirus, and entomopathogenic bacteria, virus and fungi.

Preferred binary mixtures of components (A) with components (B) are disclosed in Tables N1 to N3 below.

TABLE N1
Specific Fungicidal Compositions

| Mixture | A | B |
|---|---|---|
| N1.001 | X.02 | bixafen |
| N1.002 | X.02 | acibenzolar |
| N1.003 | X.02 | acibenzolar-S-methyl |
| N1.004 | X.02 | copper sulfate |
| N1.005 | X.02 | copper hydroxide |
| N1.006 | X.02 | copper oxychloride |
| N1.007 | X.02 | copper oxide |
| N1.008 | X.02 | cyproconazole |
| N1.009 | X.02 | difenoconazole |
| N1.010 | X.02 | hexaconazole |
| N1.011 | X.02 | prothioconazole |
| N1.012 | X.02 | propiconazole |
| N1.013 | X.02 | tebuconazole |
| N1.014 | X.02 | epoxiconazole |
| N1.015 | X.02 | fenpropidin |
| N1.016 | X.02 | fenpropimorph |
| N1.017 | X.02 | azoxystrobin |
| N1.018 | X.02 | dimoxystrobin |
| N1.019 | X.02 | trifloxystrobin |
| N1.020 | X.02 | picoxystrobin |
| N1.021 | X.02 | pyraclostrobin |
| N1.022 | X.02 | mancozeb |
| N1.023 | X.02 | chlorothalonil |
| N1.024 | X.02 | fluazinam |
| N1.025 | X.02 | fluxapyroxad |
| N1.026 | X.02 | isopyrazam |
| N1.027 | X.02 | sedaxane |
| N1.028 | X.02 | boscalid |
| N1.029 | X.02 | flufenoxadiazam |
| N1.030 | X.02 | benzovindiflupyr |
| N1.031 | X.02 | pydiflumetofen |
| N1.032 | X.02 | isoflucypram |
| N1.033 | X.02 | fluindapyr |
| N1.034 | X.02 | inpyrfluxam |
| N1.035 | X.02 | mefentrifluconazole |
| N1.036 | X.02 | florylpicoxamid |
| N1.037 | X.02 | metarylpicoxamid |
| N1.038 | X.02 | metyltetraprole |
| N2.001 | X.04 | bixafen |
| N2.002 | X.04 | acibenzolar |
| N2.003 | X.04 | acibenzolar-S-methyl |
| N2.004 | X.04 | copper sulfate |
| N2.005 | X.04 | copper hydroxide |
| N2.006 | X.04 | copper oxychloride |
| N2.007 | X.04 | copper oxide |
| N2.008 | X.04 | cyproconazole |
| N2.009 | X.04 | difenoconazole |
| N2.010 | X.04 | hexaconazole |
| N2.011 | X.04 | prothioconazole |
| N2.012 | X.04 | propiconazole |
| N2.013 | X.04 | tebuconazole |
| N2.014 | X.04 | epoxiconazole |
| N2.015 | X.04 | fenpropidin |
| N2.016 | X.04 | fenpropimorph |
| N2.017 | X.04 | azoxystrobin |
| N2.018 | X.04 | dimoxystrobin |
| N2.019 | X.04 | trifloxystrobin |
| N2.020 | X.04 | picoxystrobin |
| N2.021 | X.04 | pyraclostrobin |
| N2.022 | X.04 | mancozeb |
| N2.023 | X.04 | chlorothalonil |
| N2.024 | X.04 | fluazinam |
| N2.025 | X.04 | fluxapyroxad |
| N2.026 | X.04 | isopyrazam |
| N2.027 | X.04 | sedaxane |
| N2.028 | X.04 | boscalid |
| N2.029 | X.04 | flufenoxadiazam |
| N2.030 | X.04 | benzovindiflupyr |
| N2.031 | X.04 | pydiflumetofen |
| N2.032 | X.04 | isoflucypram |
| N2.033 | X.04 | fluindapyr |
| N2.034 | X.04 | inpyrfluxam |
| N2.035 | X.04 | mefentrifluconazole |
| N2.036 | X.04 | florylpicoxamid |
| N2.037 | X.04 | metarylpicoxamid |
| N2.038 | X.04 | metyltetraprole |

The preferred ratio ranges for preferred compositions used in the method of the invention are given in Tables 2 and 3 below. * Where component (B) exists in alternative forms (e.g salt/ester) then it should be understood that these can be substituted.

TABLE N2
Exemplar ratio ranges for specific
compositions disclosed in table N1

| | | More | Even More |
|---|---|---|---|
| | Preferred | Preferred | Preferred |
| | Weight Ratio | Weight Ratio | Weight Ratio |
| Mixture | (A:B) | (A:B) | (A:B) |
| N1.001 | 3:1 to 1:3 | 5:3 to 3:5 | 1:1 |
| N1.002 | 10:1 to 1:10 | 7:2 to 2:7 | 2:1 |
| N1.003 | 10:1 to 1:10 | 7:2 to 2:7 | 2:1 |
| N1.004 | 3:8 to 1:24 | 5:24 to 3:40 | 1:8 |
| N1.005 | 3:8 to 1:24 | 5:24 to 3:40 | 1:8 |
| N1.006 | 3:8 to 1:24 | 5:24 to 3:40 | 1:8 |
| N1.007 | 3:8 to 1:24 | 5:24 to 3:40 | 1:8 |
| N1.008 | 3:1 to 1:3 | 5:3 to 3:5 | 1:1 |
| N1.009 | 2:1 to 2:9 | 10:9 to 2:5 | 2:3 |
| N1.010 | 3:2 to 1:6 | 5:6 to 3:10 | 1:2 |
| N1.011 | 3:2 to 1:6 | 5:6 to 3:10 | 1:2 |
| N1.012 | 2:1 to 2:9 | 10:9 to 2:5 | 2:3 |
| N1.013 | 3:2 to 1:6 | 5:6 to 3:10 | 1:2 |
| N1.014 | 3:2 to 1:6 | 5:6 to 3:10 | 1:2 |
| N1.015 | 1:2 to 1:18 | 5:18 to 1:10 | 1:6 |
| N1.016 | 1:2 to 1:18 | 5:18 to 1:10 | 1:6 |
| N1.017 | 3:1 to 1:3 | 5:3 to 3:5 | 1:1 |
| N1.018 | 3:1 to 1:3 | 5:3 to 3:5 | 1:1 |
| N1.019 | 3:1 to 1:3 | 5:3 to 3:5 | 1:1 |
| N1.020 | 3:1 to 1:3 | 5:3 to 3:5 | 1:1 |
| N1.021 | 3:1 to 1:3 | 5:3 to 3:5 | 1:1 |
| N1.022 | 2:15 to 2:135 | 2:27 to 2:75 | 2:45 |
| N1.023 | 3:20 to 1:60 | 1:12 to 3:100 | 1:20 |
| N1.024 | 3:10 to 1:30 | 1:6 to 3:50 | 1:10 |
| N1.025 | 3:2 to 1:6 | 5:6 to 3:10 | 1:2 |
| N1.026 | 3:2 to 1:6 | 5:6 to 3:10 | 1:2 |
| N1.027 | 3:2 to 1:6 | 5:6 to 3:10 | 1:2 |
| N1.028 | 3:1 to 1:3 | 5:3 to 3:5 | 1:1 |
| N1.029 | 3:2 to 1:6 | 5:6 to 3:10 | 1:2 |
| N1.030 | 3:1 to 1:3 | 5:3 to 3:5 | 1:1 |
| N1.031 | 3:2 to 1:6 | 5:6 to 3:10 | 1:2 |
| N1.032 | 3:2 to 1:6 | 5:6 to 3:10 | 1:2 |
| N1.033 | 3:2 to 1:6 | 5:6 to 3:10 | 1:2 |
| N1.034 | 3:2 to 1:6 | 5:6 to 3:10 | 1:2 |
| N1.035 | 2:1 to 2:9 | 10:9 to 2:5 | 2:3 |
| N1.036 | 3:1 to 1:3 | 5:3 to 3:5 | 1:1 |
| N1.037 | 3:1 to 1:3 | 5:3 to 3:5 | 1:1 |
| N1.038 | 3:1 to 1:3 | 5:3 to 3:5 | 1:1 |

TABLE N3
Exemplar ratio ranges for specific
compositions disclosed in table N1

| | | More | Even More |
|---|---|---|---|
| | Preferred | Preferred | Preferred |
| | Weight Ratio | Weight Ratio | Weight Ratio |
| Mixture | (A:B) | (A:B) | (A:B) |
| N2.001 | 3:1 to 1:3 | 5:3 to 3:5 | 1:1 |
| N2.002 | 10:1 to 1:10 | 7:2 to 2:7 | 2:1 |
| N2.003 | 10:1 to 1:10 | 7:2 to 2:7 | 2:1 |
| N2.004 | 3:8 to 1:24 | 5:24 to 3:40 | 1:8 |
| N2.005 | 3:8 to 1:24 | 5:24 to 3:40 | 1:8 |
| N2.006 | 3:8 to 1:24 | 5:24 to 3:40 | 1:8 |
| N2.007 | 3:8 to 1:24 | 5:24 to 3:40 | 1:8 |
| N2.008 | 3:1 to 1:3 | 5:3 to 3:5 | 1:1 |
| N2.009 | 2:1 to 2:9 | 10:9 to 2:5 | 2:3 |
| N2.010 | 3:2 to 1:6 | 5:6 to 3:10 | 1:2 |
| N2.011 | 3:2 to 1:6 | 5:6 to 3:10 | 1:2 |
| N2.012 | 2:1 to 2:9 | 10:9 to 2:5 | 2:3 |
| N2.013 | 3:2 to 1:6 | 5:6 to 3:10 | 1:2 |
| N2.014 | 3:2 to 1:6 | 5:6 to 3:10 | 1:2 |
| N2.015 | 1:2 to 1:18 | 5:18 to 1:10 | 1:6 |
| N2.016 | 1:2 to 1:18 | 5:18 to 1:10 | 1:6 |
| N2.017 | 3:1 to 1:3 | 5:3 to 3:5 | 1:1 |
| N2.018 | 3:1 to 1:3 | 5:3 to 3:5 | 1:1 |
| N2.019 | 3:1 to 1:3 | 5:3 to 3:5 | 1:1 |
| N2.020 | 3:1 to 1:3 | 5:3 to 3:5 | 1:1 |
| N2.021 | 3:1 to 1:3 | 5:3 to 3:5 | 1:1 |
| N2.022 | 2:15 to 2:135 | 2:27 to 2:75 | 2:45 |
| N2.023 | 3:20 to 1:60 | 1:12 to 3:100 | 1:20 |
| N2.024 | 3:10 to 1:30 | 1:6 to 3:50 | 1:10 |
| N2.025 | 3:2 to 1:6 | 5:6 to 3:10 | 1:2 |
| N2.026 | 3:2 to 1:6 | 5:6 to 3:10 | 1:2 |
| N2.027 | 3:2 to 1:6 | 5:6 to 3:10 | 1:2 |
| N2.028 | 3:1 to 1:3 | 5:3 to 3:5 | 1:1 |
| N2.029 | 3:2 to 1:6 | 5:6 to 3:10 | 1:2 |
| N2.030 | 3:1 to 1:3 | 5:3 to 3:5 | 1:1 |
| N2.031 | 3:2 to 1:6 | 5:6 to 3:10 | 1:2 |
| N2.032 | 3:2 to 1:6 | 5:6 to 3:10 | 1:2 |
| N2.033 | 3:2 to 1:6 | 5:6 to 3:10 | 1:2 |
| N2.034 | 3:2 to 1:6 | 5:6 to 3:10 | 1:2 |
| N2.035 | 2:1 to 2:9 | 10:9 to 2:5 | 2:3 |
| N2.036 | 3:1 to 1:3 | 5:3 to 3:5 | 1:1 |
| N2.037 | 3:1 to 1:3 | 5:3 to 3:5 | 1:1 |
| N2.038 | 3:1 to 1:3 | 5:3 to 3:5 | 1:1 |

Other examples of mixture compositions according to the invention are as follows (wherein the term “TX” represents a compound (according to the definition of component (A) of the compositions of the present invention) selected from compound no. X.01, X.02, X.03 or X.04 as defined in the Table X above): a compound selected from the group of substances consisting of petroleum oils+TX, 1,1-bis(4-chlorophenyl)-2-ethoxyethanol+TX, 2,4-dichlorophenyl benzenesulfonate+TX, 2-fluoro-N-methyl-N-1-naphthylacetamide+TX, 4-chlorophenyl phenyl sulfone+TX, acetoprole+TX, aldoxycarb+TX, amidithion+TX, amidothioate+TX, amiton+TX, amiton hydrogen oxalate+TX, amitraz+TX, aramite+TX, arsenous oxide+TX, azobenzene+TX, azothoate+TX, benomyl+TX, benoxafos+TX, benzyl benzoate+TX, bixafen+TX, brofenvalerate+TX, bromocyclen+TX, bromophos+TX, bromopropylate+TX, buprofezin+TX, butocarboxim+TX, butoxycarboxim+TX, butylpyridaben+TX, calcium polysulfide+TX, camphechlor+TX, carbanolate+TX, carbophenothion+TX, cymiazole+TX, chinomethionat+TX, chlorbenside+TX, chlordimeform+TX, chlordimeform hydrochloride+TX, chlorfenethol+TX, chlorfenson+TX, chlorfensulfide+TX, chlorobenzilate+TX, chloromebuform+TX, chloromethiuron+TX, chloropropylate+TX, chlorthiophos+TX, cinerin I+TX, cinerin II+TX, cinerins+TX, closantel+TX, coumaphos+TX, crotamiton+TX, crotoxyphos+TX, cufraneb+TX, cyanthoate+TX, DCPM+TX, DDT+TX, demephion+TX, demephion-O+TX, demephion-S+TX, demeton-methyl+TX, demeton-O+TX, demeton-O-methyl+TX, demeton-S+TX, demeton-S-methyl+TX, demeton-S-methylsulfon+TX, dichlofluanid+TX, dichlorvos+TX, dicliphos+TX, dienochlor+TX, dimefox+TX, dinex+TX, dinex-diclexine+TX, dinocap-4+TX, dinocap-6+TX, dinocton+TX, dinopenton+TX, dinosulfon+TX, dinoterbon+TX, dioxathion+TX, diphenyl sulfone+TX, disulfiram+TX, DNOC+TX, dofenapyn+TX, doramectin+TX, endothion+TX, eprinomectin+TX, ethoate-methyl+TX, etrimfos+TX, fenazaflor+TX, fenbutatin oxide+TX, fenothiocarb+TX, fenpyrad+TX, fenpyroximate+TX, fenpyrazamine+TX, fenson+TX, fentrifanil+TX, flubenzimine+TX, flucycloxuron+TX, fluenetil+TX, fluorbenside+TX, FMC 1137+TX, formetanate+TX, formetanate hydrochloride+TX, formparanate+TX, gamma-HCH+TX, glyodin+TX, halfenprox+TX, hexadecyl cyclopropanecarboxylate+TX, isocarbophos+TX, jasmolin I+TX, jasmolin II+TX, jodfenphos+TX, lindane+TX, malonoben+TX, mecarbam+TX, mephosfolan+TX, mesulfen+TX, methacrifos+TX, methyl bromide+TX, metolcarb+TX, mexacarbate+TX, milbemycin oxime+TX, mipafox+TX, monocrotophos+TX, morphothion+TX, moxidectin+TX, naled+TX, 4-chloro-2-(2-chloro-2-methyl-propyl)-5-[(6-iodo-3-pyridyl)methoxy]pyridazin-3-one+TX, nifluridide+TX, nikkomycins+TX, nitrilacarb+TX, nitrilacarb 1:1 zinc chloride complex+TX, omethoate+TX, oxydeprofos+TX, oxydisulfoton+TX, pp′-DDT+TX, parathion+TX, permethrin+TX, phenkapton+TX, phosalone+TX, phosfolan+TX, phosphamidon+TX, polychloroterpenes+TX, polynactins+TX, proclonol+TX, promacyl+TX, propoxur+TX, prothidathion+TX, prothoate+TX, pyrethrin I+TX, pyrethrin II+TX, pyrethrins+TX, pyridaphenthion+TX, pyrimitate+TX, quinalphos+TX, quintiofos+TX, R-1492+TX, phosglycin+TX, rotenone+TX, schradan+TX, sebufos+TX, selamectin+TX, sophamide+TX, SSI-121+TX, sulfiram+TX, sulfluramid+TX, sulfotep+TX, sulfur+TX, diflovidazin+TX, tau-fluvalinate+TX, TEPP+TX, terbam+TX, tetradifon+TX, tetrasul+TX, thiafenox+TX, thiocarboxime+TX, thiofanox+TX, thiometon+TX, thioquinox+TX, thuringiensin+TX, triamiphos+TX, triarathene+TX, triazophos+TX, triazuron+TX, trifenofos+TX, trinactin+TX, vamidothion+TX, vaniliprole+TX, bethoxazin+TX, copper dioctanoate+TX, copper sulfate+TX, cybutryne+TX, dichlone+TX, dichlorophen+TX, endothal+TX, fentin+TX, hydrated lime+TX, nabam+TX, quinoclamine+TX, quinonamid+TX, simazine+TX, triphenyltin acetate+TX, triphenyltin hydroxide+TX, crufomate+TX, piperazine+TX, thiophanate+TX, chloralose+TX, fenthion+TX, pyridin-4-amine+TX, strychnine+TX, 1-hydroxy-1H-pyridine-2-thione+TX, 4-(quinoxalin-2-ylamino)benzenesulfonamide+TX, 8-hydroxyquinoline sulfate+TX, bronopol+TX, copper hydroxide+TX, cresol+TX, dipyrithione+TX, dodicin+TX, fenaminosulf+TX, formaldehyde+TX, hydrargaphen+TX, kasugamycin+TX, kasugamycin hydrochloride hydrate+TX, nickel bis(dimethyldithiocarbamate)+TX, nitrapyrin+TX, octhilinone+TX, oxolinic acid+TX, oxytetracycline+TX, potassium hydroxyquinoline sulfate+TX, probenazole+TX, streptomycin+TX, streptomycin sesquisulfate+TX, tecloftalam+TX, thiomersal+TX, Adoxophyes orana GV+TX, Agrobacterium radiobacter+TX, Amblyseius spp.+TX, Anagrapha falcifera NPV+TX, Anagrus atomus+TX, Aphelinus abdominalis+TX, Aphidius colemani+TX, Aphidoletes aphidimyza+TX, Autographa californica NPV+TX, Bacillus sphaericus Neide+TX, Beauveria brongniartii+TX, Chrysoperla carnea+TX, Cryptolaemus montrouzieri+TX, Cydia pomonella GV+TX, Dacnusa sibirica+TX, Diglyphus isaea+TX, Encarsia formosa+TX, Eretmocerus eremicus+TX, Heterorhabditis bacteriophora and H. megidis+TX, Hippodamia convergens+TX, Leptomastix dactylopii+TX, Macrolophus caliginosus+TX, Mamestra brassicae NPV+TX, Metaphycus helvolus+TX, Metarhizium anisopliae var. acridum+TX, Metarhizium anisopliae var. anisopliae+TX, Neodiprion sertifer NPV and N. lecontei NPV+TX, Orius spp.+TX, Paecilomyces fumosoroseus+TX, Phytoseiulus persimilis+TX, Steinernema bibionis+TX, Steinernema carpocapsae+TX, Steinernema feltiae+TX, Steinernema glaseri+TX, Steinernema riobrave+TX, Steinernema riobravis+TX, Steinernema scapterisci+TX, Steinernema spp.+TX, Trichogramma spp.+TX, Typhlodromus occidentalis+TX, Verticillium lecanii+TX, apholate+TX, bisazir+TX, busulfan+TX, dimatif+TX, hemel+TX, hempa+TX, metepa+TX, methiotepa+TX, methyl apholate+TX, morzid+TX, penfluron+TX, tepa+TX, thiohempa+TX, thiotepa+TX, tretamine+TX, uredepa+TX, (E)-dec-5-en-1-yl acetate with (E)-dec-5-en-1-ol+TX, (E)-tridec-4-en-1-yl acetate+TX, (E)-6-methylhept-2-en-4-ol+TX, (E,Z)-tetradeca-4,10-dien-1-yl acetate+TX, (Z)-dodec-7-en-1-yl acetate+TX, (Z)-hexadec-11-enal+TX, (Z)-hexadec-11-en-1-yl acetate+TX, (Z)-hexadec-13-en-11-yn-1-yl acetate+TX, (Z)-icos-13-en-10-one+TX, (Z)-tetradec-7-en-1-ol+TX, (Z)-tetradec-9-en-1-ol+TX, (Z)-tetradec-9-en-1-yl acetate+TX, (7E,9Z)-dodeca-7,9-dien-1-yl acetate+TX, (9Z,11E)-tetradeca-9,11-dien-1-yl acetate+TX, (9Z,12E)-tetradeca-9,12-dien-1-yl acetate+TX, 14-methyloctadec-1-ene+TX, 4-methylnonan-5-ol with 4-methylnonan-5-one+TX, alpha-multistriatin+TX, brevicomin+TX, codlelure+TX, codlemone+TX, cuelure+TX, disparlure+TX, dodec-8-en-1-yl acetate+TX, dodec-9-en-1-yl acetate+TX, dodeca-8+TX, 10-dien-1-yl acetate+TX, dominicalure+TX, ethyl 4-methyloctanoate+TX, eugenol+TX, frontalin+TX, grandlure+TX, grandlure I+TX, grandlure II+TX, grandlure III+TX, grandlure IV+TX, hexalure+TX, ipsdienol+TX, ipsenol+TX, japonilure+TX, lineatin+TX, litlure+TX, looplure+TX, medlure+TX, megatomoic acid+TX, methyl eugenol+TX, muscalure+TX, octadeca-2,13-dien-1-yl acetate+TX, octadeca-3,13-dien-1-yl acetate+TX, orfralure+TX, oryctalure+TX, ostramone+TX, siglure+TX, sordidin+TX, sulcatol+TX, tetradec-11-en-1-yl acetate+TX, trimedlure+TX, trimedlure A+TX, trimedlure B₁+TX, trimedlure B₂+TX, trimedlure C+TX, trunc-call+TX, 2-(octylthio)ethanol+TX, butopyronoxyl+TX, butoxy(polypropylene glycol)+TX, dibutyl adipate+TX, dibutyl phthalate+TX, dibutyl succinate+TX, diethyltoluamide+TX, dimethyl carbate+TX, dimethyl phthalate+TX, ethyl hexanediol+TX, hexamide+TX, methoquin-butyl+TX, methylneodecanamide+TX, oxamate+TX, picaridin+TX, 1-dichloro-1-nitroethane+TX, 1,1-dichloro-2,2-bis(4-ethylphenyl)ethane+TX, 1,2-dichloropropane with 1,3-dichloropropene+TX, 1-bromo-2-chloroethane+TX, 2,2,2-trichloro-1-(3,4-dichlorophenyl)ethyl acetate+TX, 2,2-dichlorovinyl 2-ethylsulfinylethyl methyl phosphate+TX, 2-(1,3-dithiolan-2-yl)phenyl dimethylcarbamate+TX, 2-(2-butoxyethoxy)ethyl thiocyanate+TX, 2-(4,5-dimethyl-1,3-dioxolan-2-yl)phenyl methylcarbamate+TX, 2-(4-chloro-3,5-xylyloxy)ethanol+TX, 2-chlorovinyl diethyl phosphate+TX, 2-imidazolidone+TX, 2-isovalerylindan-1,3-dione+TX, 2-methyl(prop-2-ynyl)aminophenyl methylcarbamate+TX, 2-thiocyanatoethyl laurate+TX, 3-bromo-1-chloroprop-1-ene+TX, 3-methyl-1-phenylpyrazol-5-yl dimethylcarbamate+TX, 4-methyl(prop-2-ynyl)amino-3,5-xylyl methylcarbamate+TX, 5,5-dimethyl-3-oxocyclohex-1-enyl dimethylcarbamate+TX, acethion+TX, acrylonitrile+TX, aldrin+TX, allosamidin+TX, allyxycarb+TX, alpha-ecdysone+TX, aluminium phosphide+TX, aminocarb+TX, anabasine+TX, athidathion+TX, azamethiphos+TX, Bacillus thuringiensis delta endotoxins+TX, barium hexafluorosilicate+TX, barium polysulfide+TX, barthrin+TX, Bayer 22/190+TX, Bayer 22408+TX, beta-cyfluthrin+TX, beta-cypermethrin+TX, bioethanomethrin+TX, biopermethrin+TX, bis(2-chloroethyl) ether+TX, borax+TX, bromfenvinfos+TX, bromo-DDT+TX, bufencarb+TX, butacarb+TX, butathiofos+TX, butonate+TX, calcium arsenate+TX, calcium cyanide+TX, carbon disulfide+TX, carbon tetrachloride+TX, cartap hydrochloride+TX, cevadine+TX, chlorbicyclen+TX, chlordane+TX, chlordecone+TX, chloroform+TX, chloropicrin+TX, chlorphoxim+TX, chlorprazophos+TX, cis-resmethrin+TX, cismethrin+TX, clocythrin+TX, copper acetoarsenite+TX, copper arsenate+TX, copper oleate+TX, coumithoate+TX, cryolite+TX, CS 708+TX, cyanofenphos+TX, cyanophos+TX, cyclethrin+TX, cythioate+TX, d-tetramethrin+TX, DAEP+TX, dazomet+TX, decarbofuran+TX, diamidafos+TX, dicapthon+TX, dichlofenthion+TX, dicresyl+TX, dicyclanil+TX, dieldrin+TX, diethyl 5-methylpyrazol-3-yl phosphate+TX, dilor+TX, dimefluthrin+TX, dimetan+TX, dimethrin+TX, dimethylvinphos+TX, dimetilan+TX, dinoprop+TX, dinosam+TX, dinoseb+TX, diofenolan+TX, dioxabenzofos+TX, dithicrofos+TX, DSP+TX, ecdysterone+TX, EI 1642+TX, EMPC+TX, EPBP+TX, etaphos+TX, ethiofencarb+TX, ethyl formate+TX, ethylene dibromide+TX, ethylene dichloride+TX, ethylene oxide+TX, EXD+TX, fenchlorphos+TX, fenethacarb+TX, fenitrothion+TX, fenoxacrim+TX, fenpirithrin+TX, fensulfothion+TX, fenthion-ethyl+TX, flucofuron+TX, fosmethilan+TX, fospirate+TX, fosthietan+TX, furathiocarb+TX, furethrin+TX, guazatine+TX, guazatine acetates+TX, sodium tetrathiocarbonate+TX, halfenprox+TX, HCH+TX, HEOD+TX, heptachlor+TX, heterophos+TX, HHDN+TX, hydrogen cyanide+TX, hyquincarb+TX, IPSP+TX, isazofos+TX, isobenzan+TX, isodrin+TX, isofenphos+TX, isolane+TX, isoprothiolane+TX, isoxathion+TX, juvenile hormone I+TX, juvenile hormone II+TX, juvenile hormone III+TX, kelevan+TX, kinoprene+TX, lead arsenate+TX, leptophos+TX, lirimfos+TX, lythidathion+TX, m-cumenyl methylcarbamate+TX, magnesium phosphide+TX, mazidox+TX, mecarphon+TX, menazon+TX, mercurous chloride+TX, mesulfenfos+TX, metam+TX, metam-potassium+TX, metam-sodium+TX, methanesulfonyl fluoride+TX, methocrotophos+TX, methoprene+TX, methothrin+TX, methoxychlor+TX, methyl isothiocyanate+TX, methylchloroform+TX, methylene chloride+TX, metoxadiazone+TX, mirex+TX, naftalofos+TX, naphthalene+TX, NC-170+TX, nicotine+TX, nicotine sulfate+TX, nithiazine+TX, nornicotine+TX, O-5-dichloro-4-iodophenyl O-ethyl ethylphosphonothioate+TX, O,O-diethyl O-4-methyl-2-oxo-2H-chromen-7-yl phosphorothioate+TX, O,O-diethyl O-6-methyl-2-propylpyrimidin-4-yl phosphorothioate+TX, O,O,O′,O′-tetrapropyl dithiopyrophosphate+TX, oleic acid+TX, para-dichlorobenzene+TX, parathion-methyl+TX, pentachlorophenol+TX, pentachlorophenyl laurate+TX, PH 60-38+TX, phenkapton+TX, phosnichlor+TX, phosphine+TX, phoxim-methyl+TX, pirimetaphos+TX, polychlorodicyclopentadiene isomers+TX, potassium arsenite+TX, potassium thiocyanate+TX, precocene I+TX, precocene II+TX, precocene III+TX, primidophos+TX, profluthrin+TX, promecarb+TX, prothiofos+TX, pyrazophos+TX, pyresmethrin+TX, Quassia+TX, quinalphos-methyl+TX, quinothion+TX, rafoxanide+TX, resmethrin+TX, rotenone+TX, kadethrin+TX, ryania+TX, ryanodine+TX, sabadilla+TX, schradan+TX, sebufos+TX, SI-0009+TX, thiapronil+TX, sodium arsenite+TX, sodium cyanide+TX, sodium fluoride+TX, sodium hexafluorosilicate+TX, sodium pentachlorophenoxide+TX, sodium selenate+TX, sodium thiocyanate+TX, sulcofuron+TX, sulcofuron-sodium+TX, sulfuryl fluoride+TX, sulprofos+TX, tar oils+TX, tazimcarb+TX, TDE+TX, tebupirimfos+TX, temephos+TX, terallethrin+TX, tetrachloroethane+TX, thicrofos+TX, thiocyclam+TX, thiocyclam hydrogen oxalate+TX, thionazin+TX, thiosultap+TX, thiosultap-sodium+TX, tralomethrin+TX, transpermethrin+TX, triazamate+TX, trichlormetaphos-3+TX, trichloronat+TX, trimethacarb+TX, tolprocarb+TX, triclopyricarb+TX, triprene+TX, veratridine+TX, veratrine+TX, XMC+TX, zetamethrin+TX, zinc phosphide+TX, zolaprofos+TX, meperfluthrin+TX, tetramethylfluthrin+TX, bis(tributyltin) oxide+TX, bromoacetamide+TX, ferric phosphate+TX, niclosamide-olamine+TX, tributyltin oxide+TX, pyrimorph+TX, trifenmorph+TX, 1,2-dibromo-3-chloropropane+TX, 1,3-dichloropropene+TX, 3,4-dichlorotetrahydrothiophene 1,1-dioxide+TX, 3-(4-chlorophenyl)-5-methylrhodanine+TX, 5-methyl-6-thioxo-1,3,5-thiadiazinan-3-ylacetic acid+TX, 6-isopentenylaminopurine+TX, anisiflupurin+TX, benclothiaz+TX, cytokinins+TX, DCIP+TX, furfural+TX, isamidofos+TX, kinetin+TX, Myrothecium verrucaria composition+TX, tetrachlorothiophene+TX, xylenols+TX, zeatin+TX, potassium ethylxanthate+TX, acibenzolar+TX, acibenzolar-S-methyl+TX, Reynoutria sachalinensis extract+TX, alpha-chlorohydrin+TX, antu+TX, barium carbonate+TX, bisthiosemi+TX, brodifacoum+TX, bromadiolone+TX, bromethalin+TX, chlorophacinone+TX, cholecalciferol+TX, coumachlor+TX, coumafuryl+TX, coumatetralyl+TX, crimidine+TX, difenacoum+TX, difethialone+TX, diphacinone+TX, ergocalciferol+TX, flocoumafen+TX, fluoroacetamide+TX, flupropadine+TX, flupropadine hydrochloride+TX, norbormide+TX, phosacetim+TX, phosphorus+TX, pindone+TX, pyrinuron+TX, scilliroside+TX, sodium fluoroacetate+TX, thallium sulfate+TX, warfarin+TX, 2-(2-butoxyethoxy)ethyl piperonylate+TX, 5-(1,3-benzodioxol-5-yl)-3-hexylcyclohex-2-enone+TX, farnesol with nerolidol+TX, verbutin+TX, MGK 264+TX, piperonyl butoxide+TX, piprotal+TX, propyl isomer+TX, S421+TX, sesamex+TX, sesasmolin+TX, sulfoxide+TX, anthraquinone+TX, copper naphthenate+TX, copper oxychloride+TX, dicyclopentadiene+TX, thiram+TX, zinc naphthenate+TX, ziram+TX, imanin+TX, ribavirin+TX, chloroinconazide+TX, mercuric oxide+TX, thiophanate-methyl+TX, azaconazole+TX, bitertanol+TX, bromuconazole+TX, cyproconazole+TX, difenoconazole+TX, diniconazole+TX, epoxiconazole+TX, fenbuconazole+TX, fluquinconazole+TX, flusilazole+TX, flutriafol+TX, furametpyr+TX, hexaconazole+TX, imazalil+TX, imibenconazole+TX, ipconazole+TX, metconazole+TX, myclobutanil+TX, paclobutrazole+TX, pefurazoate+TX, penconazole+TX, prothioconazole+TX, pyrifenox+TX, prochloraz+TX, propiconazole+TX, pyrisoxazole+TX, simeconazole+TX, tebuconazole+TX, tetraconazole+TX, triadimefon+TX, triadimenol+TX, triflumizole+TX, triticonazole+TX, ancymidol+TX, fenarimol+TX, nuarimol+TX, bupirimate+TX, dimethirimol+TX, ethirimol+TX, dodemorph+TX, fenpropidin+TX, fenpropimorph+TX, spiroxamine+TX, tridemorph+TX, cyprodinil+TX, mepanipyrim+TX, pyrimethanil+TX, fenpiclonil+TX, fludioxonil+TX, benalaxyl+TX, furalaxyl+TX, metalaxyl+TX, R-metalaxyl+TX, ofurace+TX, oxadixyl+TX, carbendazim+TX, debacarb+TX, fuberidazole+TX, thiabendazole+TX, chlozolinate+TX, dichlozoline+TX, myclozoline+TX, procymidone+TX, vinclozoline+TX, boscalid+TX, carboxin+TX, fenfuram+TX, flutolanil+TX, mepronil+TX, oxycarboxin+TX, penthiopyrad+TX, thifluzamide+TX, dodine+TX, iminoctadine+TX, azoxystrobin+TX, dimoxystrobin+TX, enestroburin+TX, fenaminstrobin+TX, flufenoxystrobin+TX, fluoxastrobin+TX, kresoxim-methyl+TX, metominostrobin+TX, trifloxystrobin+TX, orysastrobin+TX, picoxystrobin+TX, pyraclostrobin+TX, pyrametostrobin+TX, pyraoxystrobin+TX, ferbam+TX, mancozeb+TX, maneb+TX, metiram+TX, propineb+TX, zineb+TX, captafol+TX, captan+TX, fluoroimide+TX, folpet+TX, tolylfluanid+TX, bordeaux mixture+TX, copper oxide+TX, mancopper+TX, oxine-copper+TX, nitrothal-isopropyl+TX, edifenphos+TX, iprobenphos+TX, phosdiphen+TX, tolclofos-methyl+TX, anilazine+TX, benthiavalicarb+TX, blasticidin-S+TX, chloroneb+TX, chlorothalonil+TX, cyflufenamid+TX, cymoxanil+TX, cyclobutrifluram+TX, diclocymet+TX, diclomezine+TX, dicloran+TX, diethofencarb+TX, dimethomorph+TX, flumorph+TX, dithianon+TX, ethaboxam+TX, etridiazole+TX, famoxadone+TX, fenamidone+TX, fenoxanil+TX, ferimzone+TX, fluazinam+TX, flumetylsulforim+TX, fluopicolide+TX, fluoxytioconazole+TX, flusulfamide+TX, fluxapyroxad+TX, fenhexamid+TX, fosetyl-aluminium+TX, hymexazol+TX, iprovalicarb+TX, cyazofamid+TX, methasulfocarb+TX, metrafenone+TX, pencycuron+TX, phthalide+TX, polyoxins+TX, propamocarb+TX, pyribencarb+TX, proquinazid+TX, pyroquilon+TX, pyriofenone+TX, quinoxyfen+TX, quintozene+TX, tiadinil+TX, triazoxide+TX, tricyclazole+TX, triforine+TX, validamycin+TX, valifenalate+TX, silthiofam+TX, zoxamide+TX, mandipropamid+TX, flubeneteram+TX, isopyrazam+TX, sedaxane+TX, benzovindiflupyr+TX, pydiflumetofen+TX, 3-difluoromethyl-1-methyl-1H-pyrazole-4-carboxylic acid (3′,4′,5′-trifluoro-biphenyl-2-yl)-amide+TX, isoflucypram+TX, isotianil+TX, dipymetitrone+TX, 6-ethyl-5,7-dioxo-pyrrolo[4,5][1,4]dithiino[1,2-c]isothiazole-3-carbonitrile+TX, 2-(difluoromethyl)-N-[3-ethyl-1,1-dimethyl-indan-4-yl]pyridine-3-carboxamide+TX, 4-(2,6-difluorophenyl)-6-methyl-5-phenyl-pyridazine-3-carbonitrile+TX, (R)-3-(difluoromethyl)-1-methyl-N-[1,1,3-trimethylindan-4-yl]pyrazole-4-carboxamide+TX, 4-(2-bromo-4-fluoro-phenyl)-N-(2-chloro-6-fluoro-phenyl)-2,5-dimethyl-pyrazol-3-amine+TX, 4-(2-bromo-4-fluorophenyl)-N-(2-chloro-6-fluorophenyl)-1, 3-dimethyl-1H-pyrazol-5-amine+TX, fluindapyr+TX, coumethoxystrobin (jiaxiangjunzhi)+TX, Ivbenmixianan+TX, dichlobentiazox+TX, mandestrobin+TX, 3-(4,4-difluoro-3,4-dihydro-3,3-dimethylisoquinolin-1-yl)quinolone+TX, 2-[2-fluoro-6-[(8-fluoro-2-methyl-3-quinolyl)oxy]phenyl]propan-2-ol+TX, oxathiapiprolin+TX, tert-butyl N-[6-[[[(1-methyltetrazol-5-yl)-phenyl-methylene]amino]oxymethyl]-2-pyridyl]carbamate+TX, pyraziflumid+TX, inpyrfluxam+TX, trolprocarb+TX, mefentrifluconazole+TX, ipfentrifluconazole+TX, 2-(difluoromethyl)-N-[(3R)-3-ethyl-1,1-dimethyl-indan-4-yl]pyridine-3-carboxamide+TX, N′-(2,5-dimethyl-4-phenoxy-phenyl)-N-ethyl-N-methyl-formamidine+TX, N′-[4-(4,5-dichlorothiazol-2-yl)oxy-2,5-dimethyl-phenyl]-N-ethyl-N-methyl-formamidine+TX, [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl]methanesulfonate+TX, but-3-ynyl N-[6-[[(Z)-[(1-methyltetrazol-5-yl)-phenyl-methylene]amino]oxymethyl]-2-pyridyl]carbamate+TX, methyl N-[[5-[4-(2,4-dimethylphenyl)triazol-2-yl]-2-methyl-phenyl]methyl]carbamate+TX, 3-chloro-6-methyl-5-phenyl-4-(2,4,6-trifluorophenyl)pyridazine+TX, pyridachlometyl+TX, 3-(difluoromethyl)-1-methyl-N-[1,1,3-trimethylindan-4-yl]pyrazole-4-carboxamide+TX, 1-[2-[[1-(4-chlorophenyl)pyrazol-3-yl]oxymethyl]-3-methyl-phenyl]-4-methyl-tetrazol-5-one+TX, 1-methyl-4-[3-methyl-2-[[2-methyl-4-(3,4,5-trimethylpyrazol-1-yl)phenoxy]methyl]phenyl]tetrazol-5-one+TX, aminopyrifen+TX, ametoctradin+TX, amisulbrom+TX, penflufen+TX, (Z,2E)-5-[1-(4-chlorophenyl)pyrazol-3-yl]oxy-2-methoxyimino-N,3-dimethyl-pent-3-enamide+TX, florylpicoxamid+TX, fenpicoxamid+TX, metarylpicoxamid+TX, tebufloquin+TX, ipflufenoquin+TX, quinofumelin+TX, isofetamid+TX, ethyl 1-[[4-[[2-(trifluoromethyl)-1,3-dioxolan-2-yl]methoxy]phenyl]methyl]pyrazole-3-carboxylate+TX (may be prepared from the methods described in WO 2020/056090), ethyl 1-[[4-[(Z)-2-ethoxy-3,3,3-trifluoro-prop-1-enoxy]phenyl]methyl]pyrazole-3-carboxylate+TX (may be prepared from the methods described in WO 2020/056090), methyl N-[[4-[1-(4-cyclopropyl-2,6-difluoro-phenyl)pyrazol-4-yl]-2-methyl-phenyl]methyl]carbamate+TX (may be prepared from the methods described in WO 2020/097012), methyl N-[[4-[1-(2,6-difluoro-4-isopropyl-phenyl)pyrazol-4-yl]-2-methyl-phenyl]methyl]carbamate+TX (may be prepared from the methods described in WO 2020/097012), 6-chloro-3-(3-cyclopropyl-2-fluoro-phenoxy)-N-[2-(2,4-dimethylphenyl)-2,2-difluoro-ethyl]-5-methyl-pyridazine-4-carboxamide+TX (may be prepared from the methods described in WO 2020/109391), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide+TX (may be prepared from the methods described in WO 2020/109391), 6-chloro-3-(3-cyclopropyl-2-fluoro-phenoxy)-N-[2-(3,4-dimethylphenyl)-2,2-difluoro-ethyl]-5-methyl-pyridazine-4-carboxamide+TX (may be prepared from the methods described in WO 2020/109391), N-[2-[2,4-dichloro-phenoxy]phenyl]-3-(difluoromethyl)-1-methyl-pyrazole-4-carboxamide+TX, N-[2-[2-chloro-4-(trifluoromethyl)phenoxy]phenyl]-3-(difluoromethyl)-1-methyl-pyrazole-4-carboxamide+TX, benzothiostrobin+TX, phenamacril+TX, 5-amino-1,3,4-thiadiazole-2-thiol zinc salt (2:1)+TX, fluopyram+TX, flufenoxadiazam+TX, flutianil+TX, fluopimomide+TX, pyrapropoyne+TX, picarbutrazox+TX, 2-(difluoromethyl)-N-(3-ethyl-1, 1-dimethyl-indan-4-yl)pyridine-3-carboxamide+TX, 2-(difluoromethyl)-N-((3R)-1, 1, 3-trimethylindan-4-yl) pyridine-3-carboxamide+TX, 4-[[6-[2-(2,4-difluorophenyl)-1, 1-difluoro-2-hydroxy-3-(1,2,4-triazol-1-yl)propyl]-3-pyridyl]oxy]benzonitrile+TX, metyltetraprole+TX, 2-(difluoromethyl)-N-((3R)-1, 1, 3-trimethylindan-4-yl) pyridine-3-carboxamide+TX, α-(1, 1-dimethylethyl)-α-[4′-(trifluoromethoxy) [1, 1-biphenyl]-4-yl]-5-pyrimidinemethanol+TX, fluoxapiprolin+TX, enoxastrobin+TX, 4-[[6-[2-(2,4-difluorophenyl)-1,1-difluoro-2-hydroxy-3-(1,2,4-triazol-1-yl)propyl]-3-pyridyl]oxy]benzonitrile+TX, 4-[[6-[2-(2,4-difluorophenyl)-1,1-difluoro-2-hydroxy-3-(5-sulfanyl-1,2,4-triazol-1-yl)propyl]-3-pyridyl]oxy]benzonitrile+TX, 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile+TX, trinexapac+TX, coumoxystrobin+TX, zhongshengmycin+TX, thiodiazole copper+TX, zinc thiazole+TX, amectotractin+TX, iprodione+TX, seboctylamine+TX, N′-[5-bromo-2-methyl-6-[(1S)-1-methyl-2-propoxy-ethoxy]-3-pyridyl]-N-ethyl-N-methyl-formamidine+TX, N′-[5-bromo-2-methyl-6-[(1R)-1-methyl-2-propoxy-ethoxy]-3-pyridyl]-N-ethyl-N-methyl-formamidine+TX, N′-[5-bromo-2-methyl-6-(1-methyl-2-propoxy-ethoxy)-3-pyridyl]-N-ethyl-N-methyl-formamidine+TX, N′-[5-chloro-2-methyl-6-(1-methyl-2-propoxy-ethoxy)-3-pyridyl]-N-ethyl-N-methyl-formamidine+TX, N′-[5-bromo-2-methyl-6-(1-methyl-2-propoxy-ethoxy)-3-pyridyl]-N-isopropyl-N-methyl-formamidine+TX (these compounds may be prepared from the methods described in WO2015/155075); N′-[5-bromo-2-methyl-6-(2-propoxypropoxy)-3-pyridyl]-N-ethyl-N-methyl-formamidine+TX (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine+TX, N′-[4-(1-cyclopropyl-2,2,2-trifluoro-1-hydroxy-ethyl)-5-methoxy-2-methyl-phenyl]-N-isopropyl-N-methyl-formamidine+TX (these compounds may be prepared from the methods described in WO2018/228896); N-ethyl-N′-[5-methoxy-2-methyl-4-[(2-trifluoromethyl)oxetan-2-yl]phenyl]-N-methyl-formamidine+TX, N-ethyl-N′-[5-methoxy-2-methyl-4-[(2-trifuoromethyl)tetrahydrofuran-2-yl]phenyl]-N-methyl-formamidine+TX (these compounds may be prepared from the methods described in WO2019/110427); N-[(1R)-1-benzyl-3-chloro-1-methyl-but-3-enyl]-8-fluoro-quinoline-3-carboxamide+TX, N-[(1S)-1-benzyl-3-chloro-1-methyl-but-3-enyl]-8-fluoro-quinoline-3-carboxamide+TX, N-[(1R)-1-benzyl-3,3,3-trifluoro-1-methyl-propyl]-8-fluoro-quinoline-3-carboxamide+TX, N-[(1S)-1-benzyl-3,3,3-trifluoro-1-methyl-propyl]-8-fluoro-quinoline-3-carboxamide+TX, N-[(1R)-1-benzyl-1,3-dimethyl-butyl]-7,8-difluoro-quinoline-3-carboxamide+TX, N-[(1S)-1-benzyl-1,3-dimethyl-butyl]-7,8-difluoro-quinoline-3-carboxamide+TX, 8-fluoro-N-[(1R)-1-[(3-fluorophenyl)methyl]-1,3-dimethyl-butyl]quinoline-3-carboxamide+TX, 8-fluoro-N-[(1S)-1-[(3-fluorophenyl)methyl]-1,3-dimethyl-butyl]quinoline-3-carboxamide+TX, N-[(1R)-1-benzyl-1,3-dimethyl-butyl]-8-fluoro-quinoline-3-carboxamide+TX, N-[(1S)-1-benzyl-1,3-dimethyl-butyl]-8-fluoro-quinoline-3-carboxamide+TX, N-((1R)-1-benzyl-3-chloro-1-methyl-but-3-enyl)-8-fluoro-quinoline-3-carboxamide+TX, N-((1S)-1-benzyl-3-chloro-1-methyl-but-3-enyl)-8-fluoro-quinoline-3-carboxamide+TX (these compounds may be prepared from the methods described in WO2017/153380); 1-(6,7-dimethylpyrazolo[1,5-a]pyridin-3-yl)-4,4,5-trifluoro-3,3-dimethyl-isoquinoline+TX, 1-(6,7-dimethylpyrazolo[1,5-a]pyridin-3-yl)-4,4,6-trifluoro-3,3-dimethyl-isoquinoline+TX, 4,4-difluoro-3,3-dimethyl-1-(6-methylpyrazolo[1,5-a]pyridin-3-yl)isoquinoline+TX, 4,4-difluoro-3,3-dimethyl-1-(7-methylpyrazolo[1,5-a]pyridin-3-yl)isoquinoline+TX, 1-(6-chloro-7-methyl-pyrazolo[1,5-a]pyridin-3-yl)-4,4-difluoro-3,3-dimethyl-isoquinoline+TX (these compounds may be prepared from the methods described in WO2017/025510); 1-(4,5-dimethylbenzimidazol-1-yl)-4,4,5-trifluoro-3,3-dimethyl-isoquinoline+TX, 1-(4,5-dimethylbenzimidazol-1-yl)-4,4-difluoro-3,3-dimethyl-isoquinoline+TX, 6-chloro-4,4-difluoro-3,3-dimethyl-1-(4-methylbenzimidazol-1-yl)isoquinoline+TX, 4,4-difluoro-1-(5-fluoro-4-methyl-benzimidazol-1-yl)-3,3-dimethyl-isoquinoline+TX, 3-(4,4-difluoro-3,3-dimethyl-1-isoquinolyl)-7,8-dihydro-6H-cyclopenta[e]benzimidazole+TX (these compounds may be prepared from the methods described in WO2016/156085); N-methoxy-N-[[4-[5-(trifluoromethyl)-1,2,4-oxadiazol-3-yl]phenyl]methyl]cyclopropanecarboxamide+TX, N,2-dimethoxy-N-[[4-[5-(trifluoromethyl)-1,2,4-oxadiazol-3-yl]phenyl]methyl]propanamide+TX, N-ethyl-2-methyl-N-[[4-[5-(trifluoromethyl)-1,2,4-oxadiazol-3-yl]phenyl]methyl]propanamide+TX, 1-methoxy-3-methyl-1-[[4-[5-(trifluoromethyl)-1,2,4-oxadiazol-3-yl]phenyl]methyl]urea+TX, 1,3-dimethoxy-1-[[4-[5-(trifluoromethyl)-1,2,4-oxadiazol-3-yl]phenyl]methyl]urea+TX, 3-ethyl-1-methoxy-1-[[4-[5-(trifluoromethyl)-1,2,4-oxadiazol-3-yl]phenyl]methyl]urea+TX, N-[[4-[5-(trifluoromethyl)-1,2,4-oxadiazol-3-yl]phenyl]methyl]propanamide+TX, 4,4-dimethyl-2-[[4-[5-(trifluoromethyl)-1,2,4-oxadiazol-3-yl]phenyl]methyl]isoxazolidin-3-one+TX, 5,5-dimethyl-2-[[4-[5-(trifluoromethyl)-1,2,4-oxadiazol-3-yl]phenyl]methyl]isoxazolidin-3-one+TX, ethyl 1-[[4-[5-(trifluoromethyl)-1,2,4-oxadiazol-3-yl]phenyl]methyl]pyrazole-4-carboxylate+TX, N,N-dimethyl-1-[[4-[5-(trifluoromethyl)-1,2,4-oxadiazol-3-yl]phenyl]methyl]-1,2,4-triazol-3-amine+TX. The compounds in this paragraph may be prepared from the methods described in WO 2017/055473, WO 2017/055469, WO 2017/093348 and WO 2017/118689; 2-[6-(4-chlorophenoxy)-2-(trifluoromethyl)-3-pyridyl]-1-(1,2,4-triazol-1-yl)propan-2-ol+TX (this compound may be prepared from the methods described in WO 2017/029179); 2-[6-(4-bromophenoxy)-2-(trifluoromethyl)-3-pyridyl]-1-(1,2,4-triazol-1-yl)propan-2-ol+TX (this compound may be prepared from the methods described in WO 2017/029179); 3-[2-(1-chlorocyclopropyl)-3-(2-fluorophenyl)-2-hydroxy-propyl]imidazole-4-carbonitrile+TX (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile+TX (this compound may be prepared from the methods described in WO 2016/156290); (4-phenoxyphenyl)methyl 2-amino-6-methyl-pyridine-3-carboxylate+TX (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone+TX (this compound may be prepared from the methods described in WO 2011/138281); N-methyl-4-[5-(trifluoromethyl)-1,2,4-oxadiazol-3-yl]benzenecarbothioamide+TX; N-methyl-4-[5-(trifluoromethyl)-1,2,4-oxadiazol-3-yl]benzamide+TX; (Z,2E)-5-[1-(2,4-dichlorophenyl)pyrazol-3-yl]oxy-2-methoxyimino-N,3-dimethyl-pent-3-enamide+TX (this compound may be prepared from the methods described in WO 2018/153707); N′-(2-chloro-5-methyl-4-phenoxy-phenyl)-N-ethyl-N-methyl-formamidine+TX; N′-[2-chloro-4-(2-fluorophenoxy)-5-methyl-phenyl]-N-ethyl-N-methyl-formamidine+TX (this compound may be prepared from the methods described in WO 2016/202742); 2-(difluoromethyl)-N-[(3S)-3-ethyl-1,1-dimethyl-indan-4-yl]pyridine-3-carboxamide+TX (this compound may be prepared from the methods described in WO 2014/095675); (5-methyl-2-pyridyl)-[4-[5-(trifluoromethyl)-1,2,4-oxadiazol-3-yl]phenyl]methanone+TX, (3-methylisoxazol-5-yl)-[4-[5-(trifluoromethyl)-1,2,4-oxadiazol-3-yl]phenyl]methanone+TX (these compounds may be prepared from the methods described in WO 2017/220485); 2-oxo-N-propyl-2-[4-[5-(trifluoromethyl)-1,2,4-oxadiazol-3-yl]phenyl]acetamide+TX (this compound may be prepared from the methods described in WO 2018/065414); ethyl 1-[[5-[5-(trifluoromethyl)-1,2,4-oxadiazol-3-yl]-2-thienyl]methyl]pyrazole-4-carboxylate+TX (this compound may be prepared from the methods described in WO 2018/158365); 2,2-difluoro-N-methyl-2-[4-[5-(trifluoromethyl)-1,2,4-oxadiazol-3-yl]phenyl]acetamide+TX, N-[(E)-methoxyiminomethyl]-4-[5-(trifluoromethyl)-1,2,4-oxadiazol-3-yl]benzamide+TX, N-[(Z)-methoxyiminomethyl]-4-[5-(trifluoromethyl)-1,2,4-oxadiazol-3-yl]benzamide+TX, N-[N-methoxy-C-methyl-carbonimidoyl]-4-[5-(trifluoromethyl)-1,2,4-oxadiazol-3-yl]benzamide+TX (these compounds may be prepared from the methods described in WO 2018/202428).

In one set of embodiments particularly preferred two-way compositions of the invention will comprise, and more preferably consist of compound X.02 as component (A) (represented by the term “TX”) in any of the two-way combinations described directly above.

In another set of embodiments particularly preferred two-way compositions of the invention will comprise, and more preferably consist of compound X.04 as component (A) (represented by the term “TX”) in any of the two-way combinations described directly above.

Further examples of mixture compositions according to the invention are as follows (wherein the nature of the component, for example component (A), component (B) or component (C) is indicated in parenthesis), wherein the term “TX1” represents a composition (according to the definition of component (A) and component (B) as defined in table N1 above) selected from the group consisting of N1.001 to N1.038 and N2.001 to N2.038, provided that the compositions wherein component (B) is identical to component (C) are excluded: a compound selected from the group of substances consisting of petroleum oils (C)+TX1 (A+B), 1,1-bis(4-chlorophenyl)-2-ethoxyethanol (C)+TX1 (A+B), 2,4-dichlorophenyl benzenesulfonate (C)+TX1 (A+B), 2-fluoro-N-methyl-N-1-naphthylacetamide (C)+TX1 (A+B), 4-chlorophenyl phenyl sulfone (C)+TX1 (A+B), acetoprole (C)+TX1 (A+B), aldoxycarb (C)+TX1 (A+B), amidithion (C)+TX1 (A+B), amidothioate (C)+TX1 (A+B), amiton (C)+TX1 (A+B), amiton hydrogen oxalate (C)+TX1 (A+B), amitraz (C)+TX1 (A+B), aramite (C)+TX1 (A+B), arsenous oxide (C)+TX1 (A+B), azobenzene (C)+TX1 (A+B), azothoate (C)+TX1 (A+B), benomyl (C)+TX1 (A+B), benoxafos (C)+TX1 (A+B), benzyl benzoate (C)+TX1 (A+B), bixafen (C)+TX1 (A+B), brofenvalerate (C)+TX1 (A+B), bromocyclen (C)+TX1 (A+B), bromophos (C)+TX1 (A+B), bromopropylate (C)+TX1 (A+B), buprofezin (C)+TX1 (A+B), butocarboxim (C)+TX1 (A+B), butoxycarboxim (C)+TX1 (A+B), butylpyridaben (C)+TX1 (A+B), calcium polysulfide (C)+TX1 (A+B), camphechlor (C)+TX1 (A+B), carbanolate (C)+TX1 (A+B), carbophenothion (C)+TX1 (A+B), cymiazole (C)+TX1 (A+B), chinomethionat (C)+TX1 (A+B), chlorbenside (C)+TX1 (A+B), chlordimeform (C)+TX1 (A+B), chlordimeform hydrochloride (C)+TX1 (A+B), chlorfenethol (C)+TX1 (A+B), chlorfenson (C)+TX1 (A+B), chlorfensulfide (C)+TX1 (A+B), chlorobenzilate (C)+TX1 (A+B), chloromebuform (C)+TX1 (A+B), chloromethiuron (C)+TX1 (A+B), chloropropylate (C)+TX1 (A+B), chlorthiophos (C)+TX1 (A+B), cinerin I (C)+TX1 (A+B), cinerin II (C)+TX1 (A+B), cinerins (C)+TX1 (A+B), closantel (C)+TX1 (A+B), coumaphos (C)+TX1 (A+B), crotamiton (C)+TX1 (A+B), crotoxyphos (C)+TX1 (A+B), cufraneb (C)+TX1 (A+B), cyanthoate (C)+TX1 (A+B), DCPM (C)+TX1 (A+B), DDT (C)+TX1 (A+B), demephion (C)+TX1 (A+B), demephion-O (C)+TX1 (A+B), demephion-S(C)+TX1 (A+B), demeton-methyl (C)+TX1 (A+B), demeton-O (C)+TX1 (A+B), demeton-O-methyl (C)+TX1 (A+B), demeton-S(C)+TX1 (A+B), demeton-S-methyl (C)+TX1 (A+B), demeton-S-methylsulfon (C)+TX1 (A+B), dichlofluanid (C)+TX1 (A+B), dichlorvos (C)+TX1 (A+B), dicliphos (C)+TX1 (A+B), dienochlor (C)+TX1 (A+B), dimefox (C)+TX1 (A+B), dinex (C)+TX1 (A+B), dinex-diclexine (C)+TX1 (A+B), dinocap-4 (C)+TX1 (A+B), dinocap-6 (C)+TX1 (A+B), dinocton (C)+TX1 (A+B), dinopenton (C)+TX1 (A+B), dinosulfon (C)+TX1 (A+B), dinoterbon (C)+TX1 (A+B), dioxathion (C)+TX1 (A+B), diphenyl sulfone (C)+TX1 (A+B), disulfiram (C)+TX1 (A+B), DNOC (C)+TX1 (A+B), dofenapyn (C)+TX1 (A+B), doramectin (C)+TX1 (A+B), endothion (C)+TX1 (A+B), eprinomectin (C)+TX1 (A+B), ethoate-methyl (C)+TX1 (A+B), etrimfos (C)+TX1 (A+B), fenazaflor (C)+TX1 (A+B), fenbutatin oxide (C)+TX1 (A+B), fenothiocarb (C)+TX1 (A+B), fenpyrad (C)+TX1 (A+B), fenpyroximate (C)+TX1 (A+B), fenpyrazamine (C)+TX1 (A+B), fenson (C)+TX1 (A+B), fentrifanil (C)+TX1 (A+B), flubenzimine (C)+TX1 (A+B), flucycloxuron (C)+TX1 (A+B), fluenetil (C)+TX1 (A+B), fluorbenside (C)+TX1 (A+B), FMC 1137 (C)+TX1 (A+B), formetanate (C)+TX1 (A+B), formetanate hydrochloride (C)+TX1 (A+B), formparanate (C)+TX1 (A+B), gamma-HCH (C)+TX1 (A+B), glyodin (C)+TX1 (A+B), halfenprox (C)+TX1 (A+B), hexadecyl cyclopropanecarboxylate (C)+TX1 (A+B), isocarbophos (C)+TX1 (A+B), jasmolin I (C)+TX1 (A+B), jasmolin 11 (C)+TX1 (A+B), jodfenphos (C)+TX1 (A+B), lindane (C)+TX1 (A+B), malonoben (C)+TX1 (A+B), mecarbam (C)+TX1 (A+B), mephosfolan (C)+TX1 (A+B), mesulfen (C)+TX1 (A+B), methacrifos (C)+TX1 (A+B), methyl bromide (C)+TX1 (A+B), metolcarb (C)+TX1 (A+B), mexacarbate (C)+TX1 (A+B), milbemycin oxime (C)+TX1 (A+B), mipafox (C)+TX1 (A+B), monocrotophos (C)+TX1 (A+B), morphothion (C)+TX1 (A+B), moxidectin (C)+TX1 (A+B), naled (C)+TX1 (A+B), 4-chloro-2-(2-chloro-2-methyl-propyl)-5-[(6-iodo-3-pyridyl)methoxy]pyridazin-3-one (C)+TX1 (A+B), nifluridide (C)+TX1 (A+B), nikkomycins (C)+TX1 (A+B), nitrilacarb (C)+TX1 (A+B), nitrilacarb 1:1 zinc chloride complex (C)+TX1 (A+B), omethoate (C)+TX1 (A+B), oxydeprofos (C)+TX1 (A+B), oxydisulfoton (C)+TX1 (A+B), pp′-DDT (C)+TX1 (A+B), parathion (C)+TX1 (A+B), permethrin (C)+TX1 (A+B), phenkapton (C)+TX1 (A+B), phosalone (C)+TX1 (A+B), phosfolan (C)+TX1 (A+B), phosphamidon (C)+TX1 (A+B), polychloroterpenes (C)+TX1 (A+B), polynactins (C)+TX1 (A+B), proclonol (C)+TX1 (A+B), promacyl (C)+TX1 (A+B), propoxur (C)+TX1 (A+B), prothidathion (C)+TX1 (A+B), prothoate (C)+TX1 (A+B), pyrethrin I (C)+TX1 (A+B), pyrethrin 11 (C)+TX1 (A+B), pyrethrins (C)+TX1 (A+B), pyridaphenthion (C)+TX1 (A+B), pyrimitate (C)+TX1 (A+B), quinalphos (C)+TX1 (A+B), quintiofos (C)+TX1 (A+B), R-1492 (C)+TX1 (A+B), phosglycin (C)+TX1 (A+B), rotenone (C)+TX1 (A+B), schradan (C)+TX1 (A+B), sebufos (C)+TX1 (A+B), selamectin (C)+TX1 (A+B), sophamide (C)+TX1 (A+B), SSI-121 (C)+TX1 (A+B), sulfiram (C)+TX1 (A+B), sulfluramid (C)+TX1 (A+B), sulfotep (C)+TX1 (A+B), sulfur (C)+TX1 (A+B), diflovidazin (C)+TX1 (A+B), tau-fluvalinate (C)+TX1 (A+B), TEPP (C)+TX1 (A+B), terbam (C)+TX1 (A+B), tetradifon (C)+TX1 (A+B), tetrasul (C)+TX1 (A+B), thiafenox (C)+TX1 (A+B), thiocarboxime (C)+TX1 (A+B), thiofanox (C)+TX1 (A+B), thiometon (C)+TX1 (A+B), thioquinox (C)+TX1 (A+B), thuringiensin (C)+TX1 (A+B), triamiphos (C)+TX1 (A+B), triarathene (C)+TX1 (A+B), triazophos (C)+TX1 (A+B), triazuron (C)+TX1 (A+B), trifenofos (C)+TX1 (A+B), trinactin (C)+TX1 (A+B), vamidothion (C)+TX1 (A+B), vaniliprole (C)+TX1 (A+B), bethoxazin (C)+TX1 (A+B), copper dioctanoate (C)+TX1 (A+B), copper sulfate (C)+TX1 (A+B), cybutryne (C)+TX1 (A+B), dichlone (C)+TX1 (A+B), dichlorophen (C)+TX1 (A+B), endothal (C)+TX1 (A+B), fentin (C)+TX1 (A+B), hydrated lime (C)+TX1 (A+B), nabam (C)+TX1 (A+B), quinoclamine (C)+TX1 (A+B), quinonamid (C)+TX1 (A+B), simazine (C)+TX1 (A+B), triphenyltin acetate (C)+TX1 (A+B), triphenyltin hydroxide (C)+TX1 (A+B), crufomate (C)+TX1 (A+B), piperazine (C)+TX1 (A+B), thiophanate (C)+TX1 (A+B), chloralose (C)+TX1 (A+B), fenthion (C)+TX1 (A+B), pyridin-4-amine (C)+TX1 (A+B), strychnine (C)+TX1 (A+B), 1-hydroxy-1H-pyridine-2-thione (C)+TX1 (A+B), 4-(quinoxalin-2-ylamino)benzenesulfonamide (C)+TX1 (A+B), 8-hydroxyquinoline sulfate (C)+TX1 (A+B), bronopol (C)+TX1 (A+B), copper hydroxide (C)+TX1 (A+B), cresol (C)+TX1 (A+B), dipyrithione (C)+TX1 (A+B), dodicin (C)+TX1 (A+B), fenaminosulf (C)+TX1 (A+B), formaldehyde (C)+TX1 (A+B), hydrargaphen (C)+TX1 (A+B), kasugamycin (C)+TX1 (A+B), kasugamycin hydrochloride hydrate (C)+TX1 (A+B), nickel bis(dimethyldithiocarbamate) (C)+TX1 (A+B), nitrapyrin (C)+TX1 (A+B), octhilinone (C)+TX1 (A+B), oxolinic acid (C)+TX1 (A+B), oxytetracycline (C)+TX1 (A+B), potassium hydroxyquinoline sulfate (C)+TX1 (A+B), probenazole (C)+TX1 (A+B), streptomycin (C)+TX1 (A+B), streptomycin sesquisulfate (C)+TX1 (A+B), tecloftalam (C)+TX1 (A+B), thiomersal (C)+TX1 (A+B), Adoxophyes orana GV (C)+TX1 (A+B), Agrobacterium radiobacter (C)+TX1 (A+B), Amblyseius spp. (C)+TX1 (A+B), Anagrapha falcifera NPV (C)+TX1 (A+B), Anagrus atomus (C)+TX1 (A+B), Aphelinus abdominalis (C)+TX1 (A+B), Aphidius colemani (C)+TX1 (A+B), Aphidoletes aphidimyza (C)+TX1 (A+B), Autographa californica NPV (C)+TX1 (A+B), Bacillus sphaericus Neide (C)+TX1 (A+B), Beauveria brongniartii (C)+TX1 (A+B), Chrysoperla carnea (C)+TX1 (A+B), Cryptolaemus montrouzieri (C)+TX1 (A+B), Cydia pomonella GV (C)+TX1 (A+B), Dacnusa sibirica (C)+TX1 (A+B), Diglyphus isaea (C)+TX1 (A+B), Encarsia formosa (C)+TX1 (A+B), Eretmocerus eremicus (C)+TX1 (A+B), Heterorhabditis bacteriophora and H. megidis (C)+TX1 (A+B), Hippodamia convergens (C)+TX1 (A+B), Leptomastix dactylopii (C)+TX1 (A+B), Macrolophus caliginosus (C)+TX1 (A+B), Mamestra brassicae NPV (C)+TX1 (A+B), Metaphycus helvolus (C)+TX1 (A+B), Metarhizium anisopliae var. acridum (C)+TX1 (A+B), Metarhizium anisopliae var. anisopliae (C)+TX1 (A+B), Neodiprion sertifer NPV and N. lecontei NPV (C)+TX1 (A+B), Orius spp. (C)+TX1 (A+B), Paecilomyces fumosoroseus (C)+TX1 (A+B), Phytoseiulus persimilis (C)+TX1 (A+B), Steinernema bibionis (C)+TX1 (A+B), Steinernema carpocapsae (C)+TX1 (A+B), Steinernema feltiae (C)+TX1 (A+B), Steinernema glaseri (C)+TX1 (A+B), Steinernema riobrave (C)+TX1 (A+B), Steinernema riobravis (C)+TX1 (A+B), Steinernema scapterisci (C)+TX1 (A+B), Steinernema spp. (C)+TX1 (A+B), Trichogramma spp. (C)+TX1 (A+B), Typhlodromus occidentalis (C)+TX1 (A+B), Verticillium lecanii (C)+TX1 (A+B), apholate (C)+TX1 (A+B), bisazir (C)+TX1 (A+B), busulfan (C)+TX1 (A+B), dimatif (C)+TX1 (A+B), hemel (C)+TX1 (A+B), hempa (C)+TX1 (A+B), metepa (C)+TX1 (A+B), methiotepa (C)+TX1 (A+B), methyl apholate (C)+TX1 (A+B), morzid (C)+TX1 (A+B), penfluron (C)+TX1 (A+B), tepa (C)+TX1 (A+B), thiohempa (C)+TX1 (A+B), thiotepa (C)+TX1 (A+B), tretamine (C)+TX1 (A+B), uredepa (C)+TX1 (A+B), (E)-dec-5-en-1-yl acetate with (E)-dec-5-en-1-ol (C)+TX1 (A+B), (E)-tridec-4-en-1-yl acetate (C)+TX1 (A+B), (E)-6-methylhept-2-en-4-ol (C)+TX1 (A+B), (E,Z)-tetradeca-4,10-dien-1-yl acetate (C)+TX1 (A+B), (Z)-dodec-7-en-1-yl acetate (C)+TX1 (A+B), (Z)-hexadec-11-enal (C)+TX1 (A+B), (Z)-hexadec-11-en-1-yl acetate (C)+TX1 (A+B), (Z)-hexadec-13-en-11-yn-1-yl acetate (C)+TX1 (A+B), (Z)-icos-13-en-10-one (C)+TX1 (A+B), (Z)-tetradec-7-en-1-al (C)+TX1 (A+B), (Z)-tetradec-9-en-1-ol (C)+TX1 (A+B), (Z)-tetradec-9-en-1-yl acetate (C)+TX1 (A+B), (7E,9Z)-dodeca-7,9-dien-1-yl acetate (C)+TX1 (A+B), (9Z,11E)-tetradeca-9,11-dien-1-yl acetate (C)+TX1 (A+B), (9Z,12E)-tetradeca-9,12-dien-1-yl acetate (C)+TX1 (A+B), 14-methyloctadec-1-ene (C)+TX1 (A+B), 4-methylnonan-5-ol with 4-methylnonan-5-one (C)+TX1 (A+B), alpha-multistriatin (C)+TX1 (A+B), brevicomin (C)+TX1 (A+B), codlelure (C)+TX1 (A+B), codlemone (C)+TX1 (A+B), cuelure (C)+TX1 (A+B), disparlure (C)+TX1 (A+B), dodec-8-en-1-yl acetate (C)+TX1 (A+B), dodec-9-en-1-yl acetate (C)+TX1 (A+B), dodeca-8 (C)+TX1 (A+B), 10-dien-1-yl acetate (C)+TX1 (A+B), dominicalure (C)+TX1 (A+B), ethyl 4-methyloctanoate (C)+TX1 (A+B), eugenol (C)+TX1 (A+B), frontalin (C)+TX1 (A+B), grandlure (C)+TX1 (A+B), grandlure I (C)+TX1 (A+B), grandlure II (C)+TX1 (A+B), grandlure III (C)+TX1 (A+B), grandlure IV (C)+TX1 (A+B), hexalure (C)+TX1 (A+B), ipsdienol (C)+TX1 (A+B), ipsenol (C)+TX1 (A+B), japonilure (C)+TX1 (A+B), lineatin (C)+TX1 (A+B), litlure (C)+TX1 (A+B), looplure (C)+TX1 (A+B), medlure (C)+TX1 (A+B), megatomoic acid (C)+TX1 (A+B), methyl eugenol (C)+TX1 (A+B), muscalure (C)+TX1 (A+B), octadeca-2,13-dien-1-yl acetate (C)+TX1 (A+B), octadeca-3,13-dien-1-yl acetate (C)+TX1 (A+B), orfralure (C)+TX1 (A+B), oryctalure (C)+TX1 (A+B), ostramone (C)+TX1 (A+B), siglure (C)+TX1 (A+B), sordidin (C)+TX1 (A+B), sulcatol (C)+TX1 (A+B), tetradec-11-en-1-yl acetate (C)+TX1 (A+B), trimedlure (C)+TX1 (A+B), trimedlure A (C)+TX1 (A+B), trimedlure B₁ (C)+TX1 (A+B), trimedlure B₂ (C)+TX1 (A+B), trimedlure C (C)+TX1 (A+B), trunc-call (C)+TX1 (A+B), 2-(octylthio)ethanol (C)+TX1 (A+B), butopyronoxyl (C)+TX1 (A+B), butoxy(polypropylene glycol) (C)+TX1 (A+B), dibutyl adipate (C)+TX1 (A+B), dibutyl phthalate (C)+TX1 (A+B), dibutyl succinate (C)+TX1 (A+B), diethyltoluamide (C)+TX1 (A+B), dimethyl carbate (C)+TX1 (A+B), dimethyl phthalate (C)+TX1 (A+B), ethyl hexanediol (C)+TX1 (A+B), hexamide (C)+TX1 (A+B), methoquin-butyl (C)+TX1 (A+B), methylneodecanamide (C)+TX1 (A+B), oxamate (C)+TX1 (A+B), picaridin (C)+TX1 (A+B), 1-dichloro-1-nitroethane (C)+TX1 (A+B), 1,1-dichloro-2,2-bis(4-ethylphenyl)ethane (C)+TX1 (A+B), 1,2-dichloropropane with 1,3-dichloropropene (C)+TX1 (A+B), 1-bromo-2-chloroethane (C)+TX1 (A+B), 2,2,2-trichloro-1-(3,4-dichlorophenyl)ethyl acetate (C)+TX1 (A+B), 2,2-dichlorovinyl 2-ethylsulfinylethyl methyl phosphate (C)+TX1 (A+B), 2-(1,3-dithiolan-2-yl)phenyl dimethylcarbamate (C)+TX1 (A+B), 2-(2-butoxyethoxy)ethyl thiocyanate (C)+TX1 (A+B), 2-(4,5-dimethyl-1,3-dioxolan-2-yl)phenyl methylcarbamate (C)+TX1 (A+B), 2-(4-chloro-3,5-xylyloxy)ethanol (C)+TX1 (A+B), 2-chlorovinyl diethyl phosphate (C)+TX1 (A+B), 2-imidazolidone (C)+TX1 (A+B), 2-isovalerylindan-1,3-dione (C)+TX1 (A+B), 2-methyl(prop-2-ynyl)aminophenyl methylcarbamate (C)+TX1 (A+B), 2-thiocyanatoethyl laurate (C)+TX1 (A+B), 3-bromo-1-chloroprop-1-ene (C)+TX1 (A+B), 3-methyl-1-phenylpyrazol-5-yl dimethylcarbamate (C)+TX1 (A+B), 4-methyl(prop-2-ynyl)amino-3,5-xylyl methylcarbamate (C)+TX1 (A+B), 5,5-dimethyl-3-oxocyclohex-1-enyl dimethylcarbamate (C)+TX1 (A+B), acethion (C)+TX1 (A+B), acrylonitrile (C)+TX1 (A+B), aldrin (C)+TX1 (A+B), allosamidin (C)+TX1 (A+B), allyxycarb (C)+TX1 (A+B), alpha-ecdysone (C)+TX1 (A+B), aluminium phosphide (C)+TX1 (A+B), aminocarb (C)+TX1 (A+B), anabasine (C)+TX1 (A+B), athidathion (C)+TX1 (A+B), azamethiphos (C)+TX1 (A+B), Bacillus thuringiensis delta endotoxins (C)+TX1 (A+B), barium hexafluorosilicate (C)+TX1 (A+B), barium polysulfide (C)+TX1 (A+B), barthrin (C)+TX1 (A+B), Bayer 22/190 (C)+TX1 (A+B), Bayer 22408 (C)+TX1 (A+B), beta-cyfluthrin (C)+TX1 (A+B), beta-cypermethrin (C)+TX1 (A+B), bioethanomethrin (C)+TX1 (A+B), biopermethrin (C)+TX1 (A+B), bis(2-chloroethyl) ether (C)+TX1 (A+B), borax (C)+TX1 (A+B), bromfenvinfos (C)+TX1 (A+B), bromo-DDT (C)+TX1 (A+B), bufencarb (C)+TX1 (A+B), butacarb (C)+TX1 (A+B), butathiofos (C)+TX1 (A+B), butonate (C)+TX1 (A+B), calcium arsenate (C)+TX1 (A+B), calcium cyanide (C)+TX1 (A+B), carbon disulfide (C)+TX1 (A+B), carbon tetrachloride (C)+TX1 (A+B), cartap hydrochloride (C)+TX1 (A+B), cevadine (C)+TX1 (A+B), chlorbicyclen (C)+TX1 (A+B), chlordane (C)+TX1 (A+B), chlordecone (C)+TX1 (A+B), chloroform (C)+TX1 (A+B), chloropicrin (C)+TX1 (A+B), chlorphoxim (C)+TX1 (A+B), chlorprazophos (C)+TX1 (A+B), cis-resmethrin (C)+TX1 (A+B), cismethrin (C)+TX1 (A+B), clocythrin (C)+TX1 (A+B), copper acetoarsenite (C)+TX1 (A+B), copper arsenate (C)+TX1 (A+B), copper oleate (C)+TX1 (A+B), coumithoate (C)+TX1 (A+B), cryolite (C)+TX1 (A+B), CS 708 (C)+TX1 (A+B), cyanofenphos (C)+TX1 (A+B), cyanophos (C)+TX1 (A+B), cyclethrin (C)+TX1 (A+B), cythioate (C)+TX1 (A+B), d-tetramethrin (C)+TX1 (A+B), DAEP (C)+TX1 (A+B), dazomet (C)+TX1 (A+B), decarbofuran (C)+TX1 (A+B), diamidafos (C)+TX1 (A+B), dicapthon (C)+TX1 (A+B), dichlofenthion (C)+TX1 (A+B), dicresyl (C)+TX1 (A+B), dicyclanil (C)+TX1 (A+B), dieldrin (C)+TX1 (A+B), diethyl 5-methylpyrazol-3-yl phosphate (C)+TX1 (A+B), dilor (C)+TX1 (A+B), dimefluthrin (C)+TX1 (A+B), dimetan (C)+TX1 (A+B), dimethrin (C)+TX1 (A+B), dimethylvinphos (C)+TX1 (A+B), dimetilan (C)+TX1 (A+B), dinoprop (C)+TX1 (A+B), dinosam (C)+TX1 (A+B), dinoseb (C)+TX1 (A+B), diofenolan (C)+TX1 (A+B), dioxabenzofos (C)+TX1 (A+B), dithicrofos (C)+TX1 (A+B), DSP (C)+TX1 (A+B), ecdysterone (C)+TX1 (A+B), EI 1642 (C)+TX1 (A+B), EMPC (C)+TX1 (A+B), EPBP (C)+TX1 (A+B), etaphos (C)+TX1 (A+B), ethiofencarb (C)+TX1 (A+B), ethyl formate (C)+TX1 (A+B), ethylene dibromide (C)+TX1 (A+B), ethylene dichloride (C)+TX1 (A+B), ethylene oxide (C)+TX1 (A+B), EXD (C)+TX1 (A+B), fenchlorphos (C)+TX1 (A+B), fenethacarb (C)+TX1 (A+B), fenitrothion (C)+TX1 (A+B), fenoxacrim (C)+TX1 (A+B), fenpirithrin (C)+TX1 (A+B), fensulfothion (C)+TX1 (A+B), fenthion-ethyl (C)+TX1 (A+B), flucofuron (C)+TX1 (A+B), fosmethilan (C)+TX1 (A+B), fospirate (C)+TX1 (A+B), fosthietan (C)+TX1 (A+B), furathiocarb (C)+TX1 (A+B), furethrin (C)+TX1 (A+B), guazatine (C)+TX1 (A+B), guazatine acetates (C)+TX1 (A+B), sodium tetrathiocarbonate (C)+TX1 (A+B), halfenprox (C)+TX1 (A+B), HCH (C)+TX1 (A+B), HEOD (C)+TX1 (A+B), heptachlor (C)+TX1 (A+B), heterophos (C)+TX1 (A+B), HHDN (C)+TX1 (A+B), hydrogen cyanide (C)+TX1 (A+B), hyquincarb (C)+TX1 (A+B), IPSP (C)+TX1 (A+B), isazofos (C)+TX1 (A+B), isobenzan (C)+TX1 (A+B), isodrin (C)+TX1 (A+B), isofenphos (C)+TX1 (A+B), isolane (C)+TX1 (A+B), isoprothiolane (C)+TX1 (A+B), isoxathion (C)+TX1 (A+B), juvenile hormone I (C)+TX1 (A+B), juvenile hormone II (C)+TX1 (A+B), juvenile hormone III (C)+TX1 (A+B), kelevan (C)+TX1 (A+B), kinoprene (C)+TX1 (A+B), lead arsenate (C)+TX1 (A+B), leptophos (C)+TX1 (A+B), lirimfos (C)+TX1 (A+B), lythidathion (C)+TX1 (A+B), m-cumenyl methylcarbamate (C)+TX1 (A+B), magnesium phosphide (C)+TX1 (A+B), mazidox (C)+TX1 (A+B), mecarphon (C)+TX1 (A+B), menazon (C)+TX1 (A+B), mercurous chloride (C)+TX1 (A+B), mesulfenfos (C)+TX1 (A+B), metam (C)+TX1 (A+B), metam-potassium (C)+TX1 (A+B), metam-sodium (C)+TX1 (A+B), methanesulfonyl fluoride (C)+TX1 (A+B), methocrotophos (C)+TX1 (A+B), methoprene (C)+TX1 (A+B), methothrin (C)+TX1 (A+B), methoxychlor (C)+TX1 (A+B), methyl isothiocyanate (C)+TX1 (A+B), methylchloroform (C)+TX1 (A+B), methylene chloride (C)+TX1 (A+B), metoxadiazone (C)+TX1 (A+B), mirex (C)+TX1 (A+B), naftalofos (C)+TX1 (A+B), naphthalene (C)+TX1 (A+B), NC-170 (C)+TX1 (A+B), nicotine (C)+TX1 (A+B), nicotine sulfate (C)+TX1 (A+B), nithiazine (C)+TX1 (A+B), nornicotine (C)+TX1 (A+B), O-5-dichloro-4-iodophenyl O-ethyl ethylphosphonothioate (C)+TX1 (A+B), O,O-diethyl O-4-methyl-2-oxo-2H-chromen-7-yl phosphorothioate (C)+TX1 (A+B), O,O-diethyl O-6-methyl-2-propylpyrimidin-4-yl phosphorothioate (C)+TX1 (A+B), O,O,O′,O′-tetrapropyl dithiopyrophosphate (C)+TX1 (A+B), oleic acid (C)+TX1 (A+B), para-dichlorobenzene (C)+TX1 (A+B), parathion-methyl (C)+TX1 (A+B), pentachlorophenol (C)+TX1 (A+B), pentachlorophenyl laurate (C)+TX1 (A+B), PH 60-38 (C)+TX1 (A+B), phenkapton (C)+TX1 (A+B), phosnichlor (C)+TX1 (A+B), phosphine (C)+TX1 (A+B), phoxim-methyl (C)+TX1 (A+B), pirimetaphos (C)+TX1 (A+B), polychlorodicyclopentadiene isomers (C)+TX1 (A+B), potassium arsenite (C)+TX1 (A+B), potassium thiocyanate (C)+TX1 (A+B), precocene I (C)+TX1 (A+B), precocene 11 (C)+TX1 (A+B), precocene III (C)+TX1 (A+B), primidophos (C)+TX1 (A+B), profluthrin (C)+TX1 (A+B), promecarb (C)+TX1 (A+B), prothiofos (C)+TX1 (A+B), pyrazophos (C)+TX1 (A+B), pyresmethrin (C)+TX1 (A+B), Quassia (C)+TX1 (A+B), quinalphos-methyl (C)+TX1 (A+B), quinothion (C)+TX1 (A+B), rafoxanide (C)+TX1 (A+B), resmethrin (C)+TX1 (A+B), rotenone (C)+TX1 (A+B), kadethrin (C)+TX1 (A+B), ryania (C)+TX1 (A+B), ryanodine (C)+TX1 (A+B), sabadilla (C)+TX1 (A+B), schradan (C)+TX1 (A+B), sebufos (C)+TX1 (A+B), SI-0009 (C)+TX1 (A+B), thiapronil (C)+TX1 (A+B), sodium arsenite (C)+TX1 (A+B), sodium cyanide (C)+TX1 (A+B), sodium fluoride (C)+TX1 (A+B), sodium hexafluorosilicate (C)+TX1 (A+B), sodium pentachlorophenoxide (C)+TX1 (A+B), sodium selenate (C)+TX1 (A+B), sodium thiocyanate (C)+TX1 (A+B), sulcofuron (C)+TX1 (A+B), sulcofuron-sodium (C)+TX1 (A+B), sulfuryl fluoride (C)+TX1 (A+B), sulprofos (C)+TX1 (A+B), tar oils (C)+TX1 (A+B), tazimcarb (C)+TX1 (A+B), TDE (C)+TX1 (A+B), tebupirimfos (C)+TX1 (A+B), temephos (C)+TX1 (A+B), terallethrin (C)+TX1 (A+B), tetrachloroethane (C)+TX1 (A+B), thicrofos (C)+TX1 (A+B), thiocyclam (C)+TX1 (A+B), thiocyclam hydrogen oxalate (C)+TX1 (A+B), thionazin (C)+TX1 (A+B), thiosultap (C)+TX1 (A+B), thiosultap-sodium (C)+TX1 (A+B), tralomethrin (C)+TX1 (A+B), transpermethrin (C)+TX1 (A+B), triazamate (C)+TX1 (A+B), trichlormetaphos-3 (C)+TX1 (A+B), trichloronat (C)+TX1 (A+B), trimethacarb (C)+TX1 (A+B), tolprocarb (C)+TX1 (A+B), triclopyricarb (C)+TX1 (A+B), triprene (C)+TX1 (A+B), veratridine (C)+TX1 (A+B), veratrine (C)+TX1 (A+B), XMC (C)+TX1 (A+B), zetamethrin (C)+TX1 (A+B), zinc phosphide (C)+TX1 (A+B), zolaprofos (C)+TX1 (A+B), meperfluthrin (C)+TX1 (A+B), tetramethylfluthrin (C)+TX1 (A+B), bis(tributyltin) oxide (C)+TX1 (A+B), bromoacetamide (C)+TX1 (A+B), ferric phosphate (C)+TX1 (A+B), niclosamide-olamine (C)+TX1 (A+B), tributyltin oxide (C)+TX1 (A+B), pyrimorph (C)+TX1 (A+B), trifenmorph (C)+TX1 (A+B), 1,2-dibromo-3-chloropropane (C)+TX1 (A+B), 1,3-dichloropropene (C)+TX1 (A+B), 3,4-dichlorotetrahydrothiophene 1,1-dioxide (C)+TX1 (A+B), 3-(4-chlorophenyl)-5-methylrhodanine (C)+TX1 (A+B), 5-methyl-6-thioxo-1,3,5-thiadiazinan-3-ylacetic acid (C)+TX1 (A+B), 6-isopentenylaminopurine (C)+TX1 (A+B), anisiflupurin (C)+TX1 (A+B), benclothiaz (C)+TX1 (A+B), cytokinins (C)+TX1 (A+B), DCIP (C)+TX1 (A+B), furfural (C)+TX1 (A+B), isamidofos (C)+TX1 (A+B), kinetin (C)+TX1 (A+B), Myrothecium verrucaria composition (C)+TX1 (A+B), tetrachlorothiophene (C)+TX1 (A+B), xylenols (C)+TX1 (A+B), zeatin (C)+TX1 (A+B), potassium ethylxanthate (C)+TX1 (A+B), acibenzolar (C)+TX1 (A+B), acibenzolar-S-methyl (C)+TX1 (A+B), Reynoutria sachalinensis extract (C)+TX1 (A+B), alpha-chlorohydrin (C)+TX1 (A+B), antu (C)+TX1 (A+B), barium carbonate (C)+TX1 (A+B), bisthiosemi (C)+TX1 (A+B), brodifacoum (C)+TX1 (A+B), bromadiolone (C)+TX1 (A+B), bromethalin (C)+TX1 (A+B), chlorophacinone (C)+TX1 (A+B), cholecalciferol (C)+TX1 (A+B), coumachlor (C)+TX1 (A+B), coumafuryl (C)+TX1 (A+B), coumatetralyl (C)+TX1 (A+B), crimidine (C)+TX1 (A+B), difenacoum (C)+TX1 (A+B), difethialone (C)+TX1 (A+B), diphacinone (C)+TX1 (A+B), ergocalciferol (C)+TX1 (A+B), flocoumafen (C)+TX1 (A+B), fluoroacetamide (C)+TX1 (A+B), flupropadine (C)+TX1 (A+B), flupropadine hydrochloride (C)+TX1 (A+B), norbormide (C)+TX1 (A+B), phosacetim (C)+TX1 (A+B), phosphorus (C)+TX1 (A+B), pindone (C)+TX1 (A+B), pyrinuron (C)+TX1 (A+B), scilliroside (C)+TX1 (A+B), sodium fluoroacetate (C)+TX1 (A+B), thallium sulfate (C)+TX1 (A+B), warfarin (C)+TX1 (A+B), 2-(2-butoxyethoxy)ethyl piperonylate (C)+TX1 (A+B), 5-(1,3-benzodioxol-5-yl)-3-hexylcyclohex-2-enone (C)+TX1 (A+B), farnesol with nerolidol (C)+TX1 (A+B), verbutin (C)+TX1 (A+B), MGK 264 (C)+TX1 (A+B), piperonyl butoxide (C)+TX1 (A+B), piprotal (C)+TX1 (A+B), propyl isomer (C)+TX1 (A+B), S421 (C)+TX1 (A+B), sesamex (C)+TX1 (A+B), sesasmolin (C)+TX1 (A+B), sulfoxide (C)+TX1 (A+B), anthraquinone (C)+TX1 (A+B), copper naphthenate (C)+TX1 (A+B), copper oxychloride (C)+TX1 (A+B), dicyclopentadiene (C)+TX1 (A+B), thiram (C)+TX1 (A+B), zinc naphthenate (C)+TX1 (A+B), ziram (C)+TX1 (A+B), imanin (C)+TX1 (A+B), ribavirin (C)+TX1 (A+B), chloroinconazide (C)+TX1 (A+B), mercuric oxide (C)+TX1 (A+B), thiophanate-methyl (C)+TX1 (A+B), azaconazole (C)+TX1 (A+B), bitertanol (C)+TX1 (A+B), bromuconazole (C)+TX1 (A+B), cyproconazole (C)+TX1 (A+B), difenoconazole (C)+TX1 (A+B), diniconazole (C)+TX1 (A+B), epoxiconazole (C)+TX1 (A+B), fenbuconazole (C)+TX1 (A+B), fluquinconazole (C)+TX1 (A+B), flusilazole (C)+TX1 (A+B), flutriafol (C)+TX1 (A+B), furametpyr (C)+TX1 (A+B), hexaconazole (C)+TX1 (A+B), imazalil (C)+TX1 (A+B), imibenconazole (C)+TX1 (A+B), ipconazole (C)+TX1 (A+B), metconazole (C)+TX1 (A+B), myclobutanil (C)+TX1 (A+B), paclobutrazole (C)+TX1 (A+B), pefurazoate (C)+TX1 (A+B), penconazole (C)+TX1 (A+B), prothioconazole (C)+TX1 (A+B), pyrifenox (C)+TX1 (A+B), prochloraz (C)+TX1 (A+B), propiconazole (C)+TX1 (A+B), pyrisoxazole (C)+TX1 (A+B), simeconazole (C)+TX1 (A+B), tebuconazole (C)+TX1 (A+B), tetraconazole (C)+TX1 (A+B), triadimefon (C)+TX1 (A+B), triadimenol (C)+TX1 (A+B), triflumizole (C)+TX1 (A+B), triticonazole (C)+TX1 (A+B), ancymidol (C)+TX1 (A+B), fenarimol (C)+TX1 (A+B), nuarimol (C)+TX1 (A+B), bupirimate (C)+TX1 (A+B), dimethirimol (C)+TX1 (A+B), ethirimol (C)+TX1 (A+B), dodemorph (C)+TX1 (A+B), fenpropidin (C)+TX1 (A+B), fenpropimorph (C)+TX1 (A+B), spiroxamine (C)+TX1 (A+B), tridemorph (C)+TX1 (A+B), cyprodinil (C)+TX1 (A+B), mepanipyrim (C)+TX1 (A+B), pyrimethanil (C)+TX1 (A+B), fenpiclonil (C)+TX1 (A+B), fludioxonil (C)+TX1 (A+B), benalaxyl (C)+TX1 (A+B), furalaxyl (C)+TX1 (A+B), metalaxyl (C)+TX1 (A+B), R-metalaxyl (C)+TX1 (A+B), ofurace (C)+TX1 (A+B), oxadixyl (C)+TX1 (A+B), carbendazim (C)+TX1 (A+B), debacarb (C)+TX1 (A+B), fuberidazole (C)+TX1 (A+B), thiabendazole (C)+TX1 (A+B), chlozolinate (C)+TX1 (A+B), dichlozoline (C)+TX1 (A+B), myclozoline (C)+TX1 (A+B), procymidone (C)+TX1 (A+B), vinclozoline (C)+TX1 (A+B), boscalid (C)+TX1 (A+B), carboxin (C)+TX1 (A+B), fenfuram (C)+TX1 (A+B), flutolanil (C)+TX1 (A+B), mepronil (C)+TX1 (A+B), oxycarboxin (C)+TX1 (A+B), penthiopyrad (C)+TX1 (A+B), thifluzamide (C)+TX1 (A+B), dodine (C)+TX1 (A+B), iminoctadine (C)+TX1 (A+B), azoxystrobin (C)+TX1 (A+B), dimoxystrobin (C)+TX1 (A+B), enestroburin (C)+TX1 (A+B), fenaminstrobin (C)+TX1 (A+B), flufenoxystrobin (C)+TX1 (A+B), fluoxastrobin (C)+TX1 (A+B), kresoxim-methyl (C)+TX1 (A+B), metominostrobin (C)+TX1 (A+B), trifloxystrobin (C)+TX1 (A+B), orysastrobin (C)+TX1 (A+B), picoxystrobin (C)+TX1 (A+B), pyraclostrobin (C)+TX1 (A+B), pyrametostrobin (C)+TX1 (A+B), pyraoxystrobin (C)+TX1 (A+B), ferbam (C)+TX1 (A+B), mancozeb (C)+TX1 (A+B), maneb (C)+TX1 (A+B), metiram (C)+TX1 (A+B), propineb (C)+TX1 (A+B), zineb (C)+TX1 (A+B), captafol (C)+TX1 (A+B), captan (C)+TX1 (A+B), fluoroimide (C)+TX1 (A+B), folpet (C)+TX1 (A+B), tolylfluanid (C)+TX1 (A+B), bordeaux mixture (C)+TX1 (A+B), copper oxide (C)+TX1 (A+B), mancopper (C)+TX1 (A+B), oxine-copper (C)+TX1 (A+B), nitrothal-isopropyl (C)+TX1 (A+B), edifenphos (C)+TX1 (A+B), iprobenphos (C)+TX1 (A+B), phosdiphen (C)+TX1 (A+B), tolclofos-methyl (C)+TX1 (A+B), anilazine (C)+TX1 (A+B), benthiavalicarb (C)+TX1 (A+B), blasticidin-S(C)+TX1 (A+B), chloroneb (C)+TX1 (A+B), chlorothalonil (C)+TX1 (A+B), cyflufenamid (C)+TX1 (A+B), cymoxanil (C)+TX1 (A+B), cyclobutrifluram (C)+TX1 (A+B), diclocymet (C)+TX1 (A+B), diclomezine (C)+TX1 (A+B), dicloran (C)+TX1 (A+B), diethofencarb (C)+TX1 (A+B), dimethomorph (C)+TX1 (A+B), flumorph (C)+TX1 (A+B), dithianon (C)+TX1 (A+B), ethaboxam (C)+TX1 (A+B), etridiazole (C)+TX1 (A+B), famoxadone (C)+TX1 (A+B), fenamidone (C)+TX1 (A+B), fenoxanil (C)+TX1 (A+B), ferimzone (C)+TX1 (A+B), fluazinam (C)+TX1 (A+B), flumetylsulforim (C)+TX1 (A+B), fluopicolide (C)+TX1 (A+B), fluoxytioconazole (C)+TX1 (A+B), flusulfamide (C)+TX1 (A+B), fluxapyroxad (C)+TX1 (A+B), fenhexamid (C)+TX1 (A+B), fosetyl-aluminium (C)+TX1 (A+B), hymexazol (C)+TX1 (A+B), iprovalicarb (C)+TX1 (A+B), cyazofamid (C)+TX1 (A+B), methasulfocarb (C)+TX1 (A+B), metrafenone (C)+TX1 (A+B), pencycuron (C)+TX1 (A+B), phthalide (C)+TX1 (A+B), polyoxins (C)+TX1 (A+B), propamocarb (C)+TX1 (A+B), pyribencarb (C)+TX1 (A+B), proquinazid (C)+TX1 (A+B), pyroquilon (C)+TX1 (A+B), pyriofenone (C)+TX1 (A+B), quinoxyfen (C)+TX1 (A+B), quintozene (C)+TX1 (A+B), tiadinil (C)+TX1 (A+B), triazoxide (C)+TX1 (A+B), tricyclazole (C)+TX1 (A+B), triforine (C)+TX1 (A+B), validamycin (C)+TX1 (A+B), valifenalate (C)+TX1 (A+B), silthiofam (C)+TX1 (A+B), zoxamide (C)+TX1 (A+B), mandipropamid (C)+TX1 (A+B), flubeneteram (C)+TX1 (A+B), isopyrazam (C)+TX1 (A+B), sedaxane (C)+TX1 (A+B), benzovindiflupyr (C)+TX1 (A+B), pydiflumetofen (C)+TX1 (A+B), 3-difluoromethyl-1-methyl-1H-pyrazole-4-carboxylic acid (3′,4′,5′-trifluoro-biphenyl-2-yl)-amide (C)+TX1 (A+B), isoflucypram (C)+TX1 (A+B), isotianil (C)+TX1 (A+B), dipymetitrone (C)+TX1 (A+B), 6-ethyl-5,7-dioxo-pyrrolo[4,5][1,4]dithiino[1,2-c]isothiazole-3-carbonitrile (C)+TX1 (A+B), 2-(difluoromethyl)-N-[3-ethyl-1,1-dimethyl-indan-4-yl]pyridine-3-carboxamide (C)+TX1 (A+B), 4-(2,6-difluorophenyl)-6-methyl-5-phenyl-pyridazine-3-carbonitrile (C)+TX1 (A+B), (R)-3-(difluoromethyl)-1-methyl-N-[1,1,3-trimethylindan-4-yl]pyrazole-4-carboxamide (C)+TX1 (A+B), 4-(2-bromo-4-fluoro-phenyl)-N-(2-chloro-6-fluoro-phenyl)-2,5-dimethyl-pyrazol-3-amine (C)+TX1 (A+B), 4-(2-bromo-4-fluorophenyl)-N-(2-chloro-6-fluorophenyl)-1, 3-dimethyl-1H-pyrazol-5-amine (C)+TX1 (A+B), fluindapyr (C)+TX1 (A+B), coumethoxystrobin (jiaxiangjunzhi) (C)+TX1 (A+B), Ivbenmixianan (C)+TX1 (A+B), dichlobentiazox (C)+TX1 (A+B), mandestrobin (C)+TX1 (A+B), 3-(4,4-difluoro-3,4-dihydro-3,3-dimethylisoquinolin-1-yl)quinolone (C)+TX1 (A+B), 2-[2-fluoro-6-[(8-fluoro-2-methyl-3-quinolyl)oxy]phenyl]propan-2-ol (C)+TX1 (A+B), oxathiapiprolin (C)+TX1 (A+B), tert-butyl N-[6-[[[(1-methyltetrazol-5-yl)-phenyl-methylene]amino]oxymethyl]-2-pyridyl]carbamate (C)+TX1 (A+B), pyraziflumid (C)+TX1 (A+B), inpyrfluxam (C)+TX1 (A+B), trolprocarb (C)+TX1 (A+B), mefentrifluconazole (C)+TX1 (A+B), ipfentrifluconazole(C)+TX1 (A+B), 2-(difluoromethyl)-N-[(3R)-3-ethyl-1,1-dimethyl-indan-4-yl]pyridine-3-carboxamide (C)+TX1 (A+B), N′-(2,5-dimethyl-4-phenoxy-phenyl)-N-ethyl-N-methyl-formamidine (C)+TX1 (A+B), N′-[4-(4,5-dichlorothiazol-2-yl)oxy-2,5-dimethyl-phenyl]-N-ethyl-N-methyl-formamidine (C)+TX1 (A+B), [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl]methanesulfonate (C)+TX1 (A+B), but-3-ynyl N-[6-[[(Z)-[(1-methyltetrazol-5-yl)-phenyl-methylene]amino]oxymethyl]-2-pyridyl]carbamate (C)+TX1 (A+B), methyl N-[[5-[4-(2,4-dimethylphenyl)triazol-2-yl]-2-methyl-phenyl]methyl]carbamate (C)+TX1 (A+B), 3-chloro-6-methyl-5-phenyl-4-(2,4,6-trifluorophenyl)pyridazine (C)+TX1 (A+B), pyridachlometyl (C)+TX1 (A+B), 3-(difluoromethyl)-1-methyl-N-[1,1,3-trimethylindan-4-yl]pyrazole-4-carboxamide (C)+TX1 (A+B), 1-[2-[[1-(4-chlorophenyl)pyrazol-3-yl]oxymethyl]-3-methyl-phenyl]-4-methyl-tetrazol-5-one (C)+TX1 (A+B), 1-methyl-4-[3-methyl-2-[[2-methyl-4-(3,4,5-trimethylpyrazol-1-yl)phenoxy]methyl]phenyl]tetrazol-5-one (C)+TX1 (A+B), aminopyrifen (C)+TX1 (A+B), ametoctradin (C)+TX1 (A+B), amisulbrom (C)+TX1 (A+B), penflufen (C)+TX1 (A+B), (Z,2E)-5-[1-(4-chlorophenyl)pyrazol-3-yl]oxy-2-methoxyimino-N,3-dimethyl-pent-3-enamide (C)+TX1 (A+B), florylpicoxamid (C)+TX1 (A+B), fenpicoxamid (C)+TX1 (A+B), metarylpicoxamid (C)+TX1 (A+B), tebufloquin (C)+TX1 (A+B), ipflufenoquin (C)+TX1 (A+B), quinofumelin (C)+TX1 (A+B), isofetamid (C)+TX1 (A+B), ethyl 1-[[4-[[2-(trifluoromethyl)-1,3-dioxolan-2-yl]methoxy]phenyl]methyl]pyrazole-3-carboxylate (C)+TX1 (A+B) (may be prepared from the methods described in WO 2020/056090), ethyl 1-[[4-[(Z)-2-ethoxy-3,3,3-trifluoro-prop-1-enoxy]phenyl]methyl]pyrazole-3-carboxylate (C)+TX1 (A+B) (may be prepared from the methods described in WO 2020/056090), methyl N-[[4-[1-(4-cyclopropyl-2,6-difluoro-phenyl)pyrazol-4-yl]-2-methyl-phenyl]methyl]carbamate (C)+TX1 (A+B) (may be prepared from the methods described in WO 2020/097012), methyl N-[[4-[1-(2,6-difluoro-4-isopropyl-phenyl)pyrazol-4-yl]-2-methyl-phenyl]methyl]carbamate (C)+TX1 (A+B) (may be prepared from the methods described in WO 2020/097012), 6-chloro-3-(3-cyclopropyl-2-fluoro-phenoxy)-N-[2-(2,4-dimethylphenyl)-2,2-difluoro-ethyl]-5-methyl-pyridazine-4-carboxamide (C)+TX1 (A+B) (may be prepared from the methods described in WO 2020/109391), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide (C)+TX1 (A+B) (may be prepared from the methods described in WO 2020/109391), 6-chloro-3-(3-cyclopropyl-2-fluoro-phenoxy)-N-[2-(3,4-dimethylphenyl)-2,2-difluoro-ethyl]-5-methyl-pyridazine-4-carboxamide (C)+TX1 (A+B) (may be prepared from the methods described in WO 2020/109391), N-[2-[2,4-dichloro-phenoxy]phenyl]-3-(difluoromethyl)-1-methyl-pyrazole-4-carboxamide (C)+TX1 (A+B), N-[2-[2-chloro-4-(trifluoromethyl)phenoxy]phenyl]-3-(difluoromethyl)-1-methyl-pyrazole-4-carboxamide (C)+TX1 (A+B), benzothiostrobin (C)+TX1 (A+B), phenamacril (C)+TX1 (A+B), 5-amino-1,3,4-thiadiazole-2-thiol zinc salt (2:1) (C)+TX1 (A+B), fluopyram (C)+TX1 (A+B), flufenoxadiazam (C)+TX1 (A+B), flutianil (C)+TX1 (A+B), fluopimomide (C)+TX1 (A+B), pyrapropoyne (C)+TX1 (A+B), picarbutrazox (C)+TX1 (A+B), 2-(difluoromethyl)-N-(3-ethyl-1,1-dimethyl-indan-4-yl)pyridine-3-carboxamide (C)+TX1 (A+B), 2-(difluoromethyl)-N-((3R)-1, 1, 3-trimethylindan-4-yl) pyridine-3-carboxamide (C)+TX1 (A+B), 4-[[6-[2-(2,4-difluorophenyl)-1,1-difluoro-2-hydroxy-3-(1,2,4-triazol-1-yl)propyl]-3-pyridyl]oxy]benzonitrile (C)+TX1 (A+B), metyltetraprole (C)+TX1 (A+B), 2-(difluoromethyl)-N-((3R)-1, 1, 3-trimethylindan-4-yl) pyridine-3-carboxamide (C)+TX1 (A+B), α-(1, 1-dimethylethyl)-α-[4′-(trifluoromethoxy) [1,1′-biphenyl]-4-yl]-5-pyrimidinemethanol (C)+TX1 (A+B), fluoxapiprolin (C)+TX1 (A+B), enoxastrobin (C)+TX1 (A+B), 4-[[6-[2-(2,4-difluorophenyl)-1,1-difluoro-2-hydroxy-3-(1,2,4-triazol-1-yl)propyl]-3-pyridyl]oxy]benzonitrile (C)+TX1 (A+B), 4-[[6-[2-(2,4-difluorophenyl)-1,1-difluoro-2-hydroxy-3-(5-sulfanyl-1,2,4-triazol-1-yl)propyl]-3-pyridyl]oxy]benzonitrile (C)+TX1 (A+B), 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile (C)+TX1 (A+B), trinexapac (C)+TX1 (A+B), coumoxystrobin (C)+TX1 (A+B), zhongshengmycin (C)+TX1 (A+B), thiodiazole copper (C)+TX1 (A+B), zinc thiazole (C)+TX1 (A+B), amectotractin (C)+TX1 (A+B), iprodione (C)+TX1 (A+B), seboctylamine (C)+TX1 (A+B); N′-[5-bromo-2-methyl-6-[(1S)-1-methyl-2-propoxy-ethoxy]-3-pyridyl]-N-ethyl-N-methyl-formamidine (C)+TX1 (A+B), N′-[5-bromo-2-methyl-6-[(1R)-1-methyl-2-propoxy-ethoxy]-3-pyridyl]-N-ethyl-N-methyl-formamidine (C)+TX1 (A+B), N′-[5-bromo-2-methyl-6-(1-methyl-2-propoxy-ethoxy)-3-pyridyl]-N-ethyl-N-methyl-formamidine (C)+TX1 (A+B), N′-[5-chloro-2-methyl-6-(1-methyl-2-propoxy-ethoxy)-3-pyridyl]-N-ethyl-N-methyl-formamidine (C)+TX1 (A+B), N′-[5-bromo-2-methyl-6-(1-methyl-2-propoxy-ethoxy)-3-pyridyl]-N-isopropyl-N-methyl-formamidine (C)+TX1 (A+B) (these compounds may be prepared from the methods described in WO2015/155075); N′-[5-bromo-2-methyl-6-(2-propoxypropoxy)-3-pyridyl]-N-ethyl-N-methyl-formamidine (C)+TX1 (A+B) (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine(C)+TX1 (A+B), N′-[4-(1-cyclopropyl-2,2,2-trifluoro-1-hydroxy-ethyl)-5-methoxy-2-methyl-phenyl]-N-isopropyl-N-methyl-formamidine (C)+TX1 (A+B) (these compounds may be prepared from the methods described in WO2018/228896); N-ethyl-N′-[5-methoxy-2-methyl-4-[(2-trifluoromethyl)oxetan-2-yl]phenyl]-N-methyl-formamidine (C)+TX1 (A+B), N-ethyl-N′-[5-methoxy-2-methyl-4-[(2-trifuoromethyl)tetrahydrofuran-2-yl]phenyl]-N-methyl-formamidine (C)+TX1 (A+B) (these compounds may be prepared from the methods described in WO2019/110427); N-[(1R)-1-benzyl-3-chloro-1-methyl-but-3-enyl]-8-fluoro-quinoline-3-carboxamide (C)+TX1 (A+B), N-[(1S)-1-benzyl-3-chloro-1-methyl-but-3-enyl]-8-fluoro-quinoline-3-carboxamide (C)+TX1 (A+B), N-[(1R)-1-benzyl-3,3,3-trifluoro-1-methyl-propyl]-8-fluoro-quinoline-3-carboxamide (C)+TX1 (A+B), N-[(1S)-1-benzyl-3,3,3-trifluoro-1-methyl-propyl]-8-fluoro-quinoline-3-carboxamide (C)+TX1 (A+B), N-[(1R)-1-benzyl-1,3-dimethyl-butyl]-7,8-difluoro-quinoline-3-carboxamide (C)+TX1 (A+B), N-[(1S)-1-benzyl-1,3-dimethyl-butyl]-7,8-difluoro-quinoline-3-carboxamide (C)+TX1 (A+B), 8-fluoro-N-[(1R)-1-[(3-fluorophenyl)methyl]-1,3-dimethyl-butyl]quinoline-3-carboxamide (C)+TX1 (A+B), 8-fluoro-N-[(1S)-1-[(3-fluorophenyl)methyl]-1,3-dimethyl-butyl]quinoline-3-carboxamide (C)+TX1 (A+B), N-[(1R)-1-benzyl-1,3-dimethyl-butyl]-8-fluoro-quinoline-3-carboxamide (C)+TX1 (A+B), N-[(1S)-1-benzyl-1,3-dimethyl-butyl]-8-fluoro-quinoline-3-carboxamide (C)+TX1 (A+B), N-((1R)-1-benzyl-3-chloro-1-methyl-but-3-enyl)-8-fluoro-quinoline-3-carboxamide (C)+TX1 (A+B), N-((1S)-1-benzyl-3-chloro-1-methyl-but-3-enyl)-8-fluoro-quinoline-3-carboxamide (C)+TX1 (A+B) (these compounds may be prepared from the methods described in WO2017/153380); 1-(6,7-dimethylpyrazolo[1,5-a]pyridin-3-yl)-4,4,5-trifluoro-3,3-dimethyl-isoquinoline (C)+TX1 (A+B), 1-(6,7-dimethylpyrazolo[1,5-a]pyridin-3-yl)-4,4,6-trifluoro-3,3-dimethyl-isoquinoline (C)+TX1 (A+B), 4,4-difluoro-3,3-dimethyl-1-(6-methylpyrazolo[1,5-a]pyridin-3-yl)isoquinoline (C)+TX1 (A+B), 4,4-difluoro-3,3-dimethyl-1-(7-methylpyrazolo[1,5-a]pyridin-3-yl)isoquinoline (C)+TX1 (A+B), 1-(6-chloro-7-methyl-pyrazolo[1,5-a]pyridin-3-yl)-4,4-difluoro-3,3-dimethyl-isoquinoline (C)+TX1 (A+B) (these compounds may be prepared from the methods described in WO2017/025510); 1-(4,5-dimethylbenzimidazol-1-yl)-4,4,5-trifluoro-3,3-dimethyl-isoquinoline (C)+TX1 (A+B), 1-(4,5-dimethylbenzimidazol-1-yl)-4,4-difluoro-3,3-dimethyl-isoquinoline (C)+TX1 (A+B), 6-chloro-4,4-difluoro-3,3-dimethyl-1-(4-methylbenzimidazol-1-yl)isoquinoline (C)+TX1 (A+B), 4,4-difluoro-1-(5-fluoro-4-methyl-benzimidazol-1-yl)-3,3-dimethyl-isoquinoline (C)+TX1 (A+B), 3-(4,4-difluoro-3,3-dimethyl-1-isoquinolyl)-7,8-dihydro-6H-cyclopenta[e]benzimidazole (C)+TX1 (A+B) (these compounds may be prepared from the methods described in WO2016/156085); N-methoxy-N-[[4-[5-(trifluoromethyl)-1,2,4-oxadiazol-3-yl]phenyl]methyl]cyclopropanecarboxamide (C)+TX1 (A+B), N,2-dimethoxy-N-[[4-[5-(trifluoromethyl)-1,2,4-oxadiazol-3-yl]phenyl]methyl]propanamide (C)+TX1 (A+B), N-ethyl-2-methyl-N-[[4-[5-(trifluoromethyl)-1,2,4-oxadiazol-3-yl]phenyl]methyl]propanamide (C)+TX1 (A+B), 1-methoxy-3-methyl-1-[[4-[5-(trifluoromethyl)-1,2,4-oxadiazol-3-yl]phenyl]methyl]urea (C)+TX1 (A+B), 1,3-dimethoxy-1-[[4-[5-(trifluoromethyl)-1,2,4-oxadiazol-3-yl]phenyl]methyl]urea (C)+TX1 (A+B), 3-ethyl-1-methoxy-1-[[4-[5-(trifluoromethyl)-1,2,4-oxadiazol-3-yl]phenyl]methyl]urea (C)+TX1 (A+B), N-[[4-[5-(trifluoromethyl)-1,2,4-oxadiazol-3-yl]phenyl]methyl]propanamide (C)+TX1 (A+B), 4,4-dimethyl-2-[[4-[5-(trifluoromethyl)-1,2,4-oxadiazol-3-yl]phenyl]methyl]isoxazolidin-3-one (C)+TX1 (A+B), 5,5-dimethyl-2-[[4-[5-(trifluoromethyl)-1,2,4-oxadiazol-3-yl]phenyl]methyl]isoxazolidin-3-one (C)+TX1 (A+B), ethyl 1-[[4-[5-(trifluoromethyl)-1,2,4-oxadiazol-3-yl]phenyl]methyl]pyrazole-4-carboxylate (C)+TX1 (A+B), N,N-dimethyl-1-[[4-[5-(trifluoromethyl)-1,2,4-oxadiazol-3-yl]phenyl]methyl]-1,2,4-triazol-3-amine (C)+TX1 (A+B). The compounds in this paragraph may be prepared from the methods described in WO 2017/055473, WO 2017/055469, WO 2017/093348 and WO 2017/118689; 2-[6-(4-chlorophenoxy)-2-(trifluoromethyl)-3-pyridyl]-1-(1,2,4-triazol-1-yl)propan-2-ol (C)+TX1 (A+B) (this compound may be prepared from the methods described in WO 2017/029179); 2-[6-(4-bromophenoxy)-2-(trifluoromethyl)-3-pyridyl]-1-(1,2,4-triazol-1-yl)propan-2-ol (C)+TX1 (A+B) (this compound may be prepared from the methods described in WO 2017/029179); 3-[2-(1-chlorocyclopropyl)-3-(2-fluorophenyl)-2-hydroxy-propyl]imidazole-4-carbonitrile (C)+TX1 (A+B) (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile (C)+TX1 (A+B) (this compound may be prepared from the methods described in WO 2016/156290); (4-phenoxyphenyl)methyl 2-amino-6-methyl-pyridine-3-carboxylate (C)+TX1 (A+B) (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone (C)+TX1 (A+B) (this compound may be prepared from the methods described in WO 2011/138281); N-methyl-4-[5-(trifluoromethyl)-1,2,4-oxadiazol-3-yl]benzenecarbothioamide (C)+TX1 (A+B); N-methyl-4-[5-(trifluoromethyl)-1,2,4-oxadiazol-3-yl]benzamide (C)+TX1 (A+B); (Z,2E)-5-[1-(2,4-dichlorophenyl)pyrazol-3-yl]oxy-2-methoxyimino-N,3-dimethyl-pent-3-enamide (C)+TX1 (A+B) (this compound may be prepared from the methods described in WO 2018/153707); N′-(2-chloro-5-methyl-4-phenoxy-phenyl)-N-ethyl-N-methyl-formamidine (C)+TX1 (A+B); N′-[2-chloro-4-(2-fluorophenoxy)-5-methyl-phenyl]-N-ethyl-N-methyl-formamidine (C)+TX1 (A+B) (this compound may be prepared from the methods described in WO 2016/202742); 2-(difluoromethyl)-N-[(3S)-3-ethyl-1,1-dimethyl-indan-4-yl]pyridine-3-carboxamide (C)+TX1 (A+B) (this compound may be prepared from the methods described in WO 2014/095675); (5-methyl-2-pyridyl)-[4-[5-(trifluoromethyl)-1,2,4-oxadiazol-3-yl]phenyl]methanone (C)+TX1 (A+B), (3-methylisoxazol-5-yl)-[4-[5-(trifluoromethyl)-1,2,4-oxadiazol-3-yl]phenyl]methanone (C)+TX1 (A+B) (these compounds may be prepared from the methods described in WO 2017/220485); 2-oxo-N-propyl-2-[4-[5-(trifluoromethyl)-1,2,4-oxadiazol-3-yl]phenyl]acetamide (C)+TX1 (A+B) (this compound may be prepared from the methods described in WO 2018/065414); ethyl 1-[[5-[5-(trifluoromethyl)-1,2,4-oxadiazol-3-yl]-2-thienyl]methyl]pyrazole-4-carboxylate (C)+TX1 (A+B) (this compound may be prepared from the methods described in WO 2018/158365); 2,2-difluoro-N-methyl-2-[4-[5-(trifluoromethyl)-1,2,4-oxadiazol-3-yl]phenyl]acetamide (C)+TX1 (A+B), N-[(E)-methoxyiminomethyl]-4-[5-(trifluoromethyl)-1,2,4-oxadiazol-3-yl]benzamide (C)+TX1 (A+B), N-[(Z)-methoxyiminomethyl]-4-[5-(trifluoromethyl)-1,2,4-oxadiazol-3-yl]benzamide (C)+TX1 (A+B), N-[N-methoxy-C-methyl-carbonimidoyl]-4-[5-(trifluoromethyl)-1,2,4-oxadiazol-3-yl]benzamide (C)+TX1 (A+B) (these compounds may be prepared from the methods described in WO 2018/202428).

In one set of embodiments particularly preferred three-way compositions of the invention will comprise, and more preferably consist of the composition N1.001 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.002 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.003 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.004 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.005 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.006 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.007 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.008 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.009 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.010 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.011 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.012 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.013 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.014 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.015 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.016 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.017 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.018 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.019 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.020 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.021 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.022 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.023 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.024 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.025 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.026 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.027 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.028 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.029 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.030 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.031 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.032 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.033 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.034 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.035 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.036 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.037 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N1.038 (disclosed in table N1) as component (A) and component (B) (represented by the term “TX1”) in any of the three-way combinations described directly above.

In one set of embodiments particularly preferred three-way compositions of the invention will comprise, and more preferably consist of the composition N2.001 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.002 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.003 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.004 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.005 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.006 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.007 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.008 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.009 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.010 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.011 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.012 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.013 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.014 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.015 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.016 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.017 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.018 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.019 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.020 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.021 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.022 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.023 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.024 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.025 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.026 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.027 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.028 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.029 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.030 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.031 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.032 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.033 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.034 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.035 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.036 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.037 (disclosed in table N1) as component (A) and component (B) (represented by the term “TX1”) in any of the three-way combinations described directly above.

In another set of embodiments particularly preferred three-way compositions of the invention will comprise, and more preferably consist of the composition N2.038 (disclosed in table N1) as component (A) and component (B) (represented by the term “TX1”) in any of the three-way combinations described directly above.

Further examples of four-way mixture compositions according to the invention are as follows (wherein the nature of the component, for example component (A), component (B), component (C) or component (D) is indicated in parenthesis), wherein the term “TX1” represents a composition (according to the definition of component (A) and component (B) as defined in table N1 above) selected from the group consisting of N1.001 to N1.038 and N2.001 to N2.038, provided that the compositions wherein component (B) is identical to component (C) are excluded: a compound selected from the group of substances consisting of petroleum oils (C)+TX1 (A+B)+mancozeb (D), 1,1-bis(4-chlorophenyl)-2-ethoxyethanol (C)+TX1 (A+B)+mancozeb (D), 2,4-dichlorophenyl benzenesulfonate (C)+TX1 (A+B)+mancozeb (D), 2-fluoro-N-methyl-N-1-naphthylacetamide (C)+TX1 (A+B)+mancozeb (D), 4-chlorophenyl phenyl sulfone (C)+TX1 (A+B)+mancozeb (D), acetoprole (C)+TX1 (A+B)+mancozeb (D), aldoxycarb (C)+TX1 (A+B)+mancozeb (D), amidithion (C)+TX1 (A+B)+mancozeb (D), amidothioate (C)+TX1 (A+B)+mancozeb (D), amiton (C)+TX1 (A+B)+mancozeb (D), amiton hydrogen oxalate (C)+TX1 (A+B)+mancozeb (D), amitraz (C)+TX1 (A+B)+mancozeb (D), aramite (C)+TX1 (A+B)+mancozeb (D), arsenous oxide (C)+TX1 (A+B)+mancozeb (D), azobenzene (C)+TX1 (A+B)+mancozeb (D), azothoate (C)+TX1 (A+B)+mancozeb (D), benomyl (C)+TX1 (A+B)+mancozeb (D), benoxafos (C)+TX1 (A+B)+mancozeb (D), benzyl benzoate (C)+TX1 (A+B)+mancozeb (D), bixafen (C)+TX1 (A+B)+mancozeb (D), brofenvalerate (C)+TX1 (A+B)+mancozeb (D), bromocyclen (C)+TX1 (A+B)+mancozeb (D), bromophos (C)+TX1 (A+B)+mancozeb (D), bromopropylate (C)+TX1 (A+B)+mancozeb (D), buprofezin (C)+TX1 (A+B)+mancozeb (D), butocarboxim (C)+TX1 (A+B)+mancozeb (D), butoxycarboxim (C)+TX1 (A+B)+mancozeb (D), butylpyridaben (C)+TX1 (A+B)+mancozeb (D), calcium polysulfide (C)+TX1 (A+B)+mancozeb (D), camphechlor (C)+TX1 (A+B)+mancozeb (D), carbanolate (C)+TX1 (A+B)+mancozeb (D), carbophenothion (C)+TX1 (A+B)+mancozeb (D), cymiazole (C)+TX1 (A+B)+mancozeb (D), chinomethionat (C)+TX1 (A+B)+mancozeb (D), chlorbenside (C)+TX1 (A+B)+mancozeb (D), chlordimeform (C)+TX1 (A+B)+mancozeb (D), chlordimeform hydrochloride (C)+TX1 (A+B)+mancozeb (D), chlorfenethol (C)+TX1 (A+B)+mancozeb (D), chlorfenson (C)+TX1 (A+B)+mancozeb (D), chlorfensulfide (C)+TX1 (A+B)+mancozeb (D), chlorobenzilate (C)+TX1 (A+B)+mancozeb (D), chloromebuform (C)+TX1 (A+B)+mancozeb (D), chloromethiuron (C)+TX1 (A+B)+mancozeb (D), chloropropylate (C)+TX1 (A+B)+mancozeb (D), chlorthiophos (C)+TX1 (A+B)+mancozeb (D), cinerin I (C)+TX1 (A+B)+mancozeb (D), cinerin II (C)+TX1 (A+B)+mancozeb (D), cinerins (C)+TX1 (A+B)+mancozeb (D), closantel (C)+TX1 (A+B)+mancozeb (D), coumaphos (C)+TX1 (A+B)+mancozeb (D), crotamiton (C)+TX1 (A+B)+mancozeb (D), crotoxyphos (C)+TX1 (A+B)+mancozeb (D), cufraneb (C)+TX1 (A+B)+mancozeb (D), cyanthoate (C)+TX1 (A+B)+mancozeb (D), DCPM (C)+TX1 (A+B)+mancozeb (D), DDT (C)+TX1 (A+B)+mancozeb (D), demephion (C)+TX1 (A+B)+mancozeb (D), demephion-O (C)+TX1 (A+B)+mancozeb (D), demephion-S(C)+TX1 (A+B)+mancozeb (D), demeton-methyl (C)+TX1 (A+B)+mancozeb (D), demeton-O (C)+TX1 (A+B)+mancozeb (D), demeton-O-methyl (C)+TX1 (A+B)+mancozeb (D), demeton-S(C)+TX1 (A+B)+mancozeb (D), demeton-S-methyl (C)+TX1 (A+B)+mancozeb (D), demeton-S-methylsulfon (C)+TX1 (A+B)+mancozeb (D), dichlofluanid (C)+TX1 (A+B)+mancozeb (D), dichlorvos (C)+TX1 (A+B)+mancozeb (D), dicliphos (C)+TX1 (A+B)+mancozeb (D), dienochlor (C)+TX1 (A+B)+mancozeb (D), dimefox (C)+TX1 (A+B)+mancozeb (D), dinex (C)+TX1 (A+B)+mancozeb (D), dinex-diclexine (C)+TX1 (A+B)+mancozeb (D), dinocap-4 (C)+TX1 (A+B)+mancozeb (D), dinocap-6 (C)+TX1 (A+B)+mancozeb (D), dinocton (C)+TX1 (A+B)+mancozeb (D), dinopenton (C)+TX1 (A+B)+mancozeb (D), dinosulfon (C)+TX1 (A+B)+mancozeb (D), dinoterbon (C)+TX1 (A+B)+mancozeb (D), dioxathion (C)+TX1 (A+B)+mancozeb (D), diphenyl sulfone (C)+TX1 (A+B)+mancozeb (D), disulfiram (C)+TX1 (A+B)+mancozeb (D), DNOC (C)+TX1 (A+B)+mancozeb (D), dofenapyn (C)+TX1 (A+B)+mancozeb (D), doramectin (C)+TX1 (A+B)+mancozeb (D), endothion (C)+TX1 (A+B)+mancozeb (D), eprinomectin (C)+TX1 (A+B)+mancozeb (D), ethoate-methyl (C)+TX1 (A+B)+mancozeb (D), etrimfos (C)+TX1 (A+B)+mancozeb (D), fenazaflor (C)+TX1 (A+B)+mancozeb (D), fenbutatin oxide (C)+TX1 (A+B)+mancozeb (D), fenothiocarb (C)+TX1 (A+B)+mancozeb (D), fenpyrad (C)+TX1 (A+B)+mancozeb (D), fenpyroximate (C)+TX1 (A+B)+mancozeb (D), fenpyrazamine (C)+TX1 (A+B)+mancozeb (D), fenson (C)+TX1 (A+B)+mancozeb (D), fentrifanil (C)+TX1 (A+B)+mancozeb (D), flubenzimine (C)+TX1 (A+B)+mancozeb (D), flucycloxuron (C)+TX1 (A+B)+mancozeb (D), fluenetil (C)+TX1 (A+B)+mancozeb (D), fluorbenside (C)+TX1 (A+B)+mancozeb (D), FMC 1137 (C)+TX1 (A+B)+mancozeb (D), formetanate (C)+TX1 (A+B)+mancozeb (D), formetanate hydrochloride (C)+TX1 (A+B)+mancozeb (D), formparanate (C)+TX1 (A+B)+mancozeb (D), gamma-HCH (C)+TX1 (A+B)+mancozeb (D), glyodin (C)+TX1 (A+B)+mancozeb (D), halfenprox (C)+TX1 (A+B)+mancozeb (D), hexadecyl cyclopropanecarboxylate (C)+TX1 (A+B)+mancozeb (D), isocarbophos (C)+TX1 (A+B)+mancozeb (D), jasmolin I (C)+TX1 (A+B)+mancozeb (D), jasmolin 11 (C)+TX1 (A+B)+mancozeb (D), jodfenphos (C)+TX1 (A+B)+mancozeb (D), lindane (C)+TX1 (A+B)+mancozeb (D), malonoben (C)+TX1 (A+B)+mancozeb (D), mecarbam (C)+TX1 (A+B)+mancozeb (D), mephosfolan (C)+TX1 (A+B)+mancozeb (D), mesulfen (C)+TX1 (A+B)+mancozeb (D), methacrifos (C)+TX1 (A+B)+mancozeb (D), methyl bromide (C)+TX1 (A+B)+mancozeb (D), metolcarb (C)+TX1 (A+B)+mancozeb (D), mexacarbate (C)+TX1 (A+B)+mancozeb (D), milbemycin oxime (C)+TX1 (A+B)+mancozeb (D), mipafox (C)+TX1 (A+B)+mancozeb (D), monocrotophos (C)+TX1 (A+B)+mancozeb (D), morphothion (C)+TX1 (A+B)+mancozeb (D), moxidectin (C)+TX1 (A+B)+mancozeb (D), naled (C)+TX1 (A+B)+mancozeb (D), 4-chloro-2-(2-chloro-2-methyl-propyl)-5-[(6-iodo-3-pyridyl)methoxy]pyridazin-3-one (C)+TX1 (A+B)+mancozeb (D), nifluridide (C)+TX1 (A+B)+mancozeb (D), nikkomycins (C)+TX1 (A+B)+mancozeb (D), nitrilacarb (C)+TX1 (A+B)+mancozeb (D), nitrilacarb 1:1 zinc chloride complex (C)+TX1 (A+B)+mancozeb (D), omethoate (C)+TX1 (A+B)+mancozeb (D), oxydeprofos (C)+TX1 (A+B)+mancozeb (D), oxydisulfoton (C)+TX1 (A+B)+mancozeb (D), pp′-DDT (C)+TX1 (A+B)+mancozeb (D), parathion (C)+TX1 (A+B)+mancozeb (D), permethrin (C)+TX1 (A+B)+mancozeb (D), phenkapton (C)+TX1 (A+B)+mancozeb (D), phosalone (C)+TX1 (A+B)+mancozeb (D), phosfolan (C)+TX1 (A+B)+mancozeb (D), phosphamidon (C)+TX1 (A+B)+mancozeb (D), polychloroterpenes (C)+TX1 (A+B)+mancozeb (D), polynactins (C)+TX1 (A+B)+mancozeb (D), proclonol (C)+TX1 (A+B)+mancozeb (D), promacyl (C)+TX1 (A+B)+mancozeb (D), propoxur (C)+TX1 (A+B)+mancozeb (D), prothidathion (C)+TX1 (A+B)+mancozeb (D), prothoate (C)+TX1 (A+B)+mancozeb (D), pyrethrin I (C)+TX1 (A+B)+mancozeb (D), pyrethrin II (C)+TX1 (A+B)+mancozeb (D), pyrethrins (C)+TX1 (A+B)+mancozeb (D), pyridaphenthion (C)+TX1 (A+B)+mancozeb (D), pyrimitate (C)+TX1 (A+B)+mancozeb (D), quinalphos (C)+TX1 (A+B)+mancozeb (D), quintiofos (C)+TX1 (A+B)+mancozeb (D), R-1492 (C)+TX1 (A+B)+mancozeb (D), phosglycin (C)+TX1 (A+B)+mancozeb (D), rotenone (C)+TX1 (A+B)+mancozeb (D), schradan (C)+TX1 (A+B)+mancozeb (D), sebufos (C)+TX1 (A+B)+mancozeb (D), selamectin (C)+TX1 (A+B)+mancozeb (D), sophamide (C)+TX1 (A+B)+mancozeb (D), SSI-121 (C)+TX1 (A+B)+mancozeb (D), sulfiram (C)+TX1 (A+B)+mancozeb (D), sulfluramid (C)+TX1 (A+B)+mancozeb (D), sulfotep (C)+TX1 (A+B)+mancozeb (D), sulfur (C)+TX1 (A+B)+mancozeb (D), diflovidazin (C)+TX1 (A+B)+mancozeb (D), tau-fluvalinate (C)+TX1 (A+B)+mancozeb (D), TEPP (C)+TX1 (A+B)+mancozeb (D), terbam (C)+TX1 (A+B)+mancozeb (D), tetradifon (C)+TX1 (A+B)+mancozeb (D), tetrasul (C)+TX1 (A+B)+mancozeb (D), thiafenox (C)+TX1 (A+B)+mancozeb (D), thiocarboxime (C)+TX1 (A+B)+mancozeb (D), thiofanox (C)+TX1 (A+B)+mancozeb (D), thiometon (C)+TX1 (A+B)+mancozeb (D), thioquinox (C)+TX1 (A+B)+mancozeb (D), thuringiensin (C)+TX1 (A+B)+mancozeb (D), triamiphos (C)+TX1 (A+B)+mancozeb (D), triarathene (C)+TX1 (A+B)+mancozeb (D), triazophos (C)+TX1 (A+B)+mancozeb (D), triazuron (C)+TX1 (A+B)+mancozeb (D), trifenofos (C)+TX1 (A+B)+mancozeb (D), trinactin (C)+TX1 (A+B)+mancozeb (D), vamidothion (C)+TX1 (A+B)+mancozeb (D), vaniliprole (C)+TX1 (A+B)+mancozeb (D), bethoxazin (C)+TX1 (A+B)+mancozeb (D), copper dioctanoate (C)+TX1 (A+B)+mancozeb (D), copper sulfate (C)+TX1 (A+B)+mancozeb (D), cybutryne (C)+TX1 (A+B)+mancozeb (D), dichlone (C)+TX1 (A+B)+mancozeb (D), dichlorophen (C)+TX1 (A+B)+mancozeb (D), endothal (C)+TX1 (A+B)+mancozeb (D), fentin (C)+TX1 (A+B)+mancozeb (D), hydrated lime (C)+TX1 (A+B)+mancozeb (D), nabam (C)+TX1 (A+B)+mancozeb (D), quinoclamine (C)+TX1 (A+B)+mancozeb (D), quinonamid (C)+TX1 (A+B)+mancozeb (D), simazine (C)+TX1 (A+B)+mancozeb (D), triphenyltin acetate (C)+TX1 (A+B)+mancozeb (D), triphenyltin hydroxide (C)+TX1 (A+B)+mancozeb (D), crufomate (C)+TX1 (A+B)+mancozeb (D), piperazine (C)+TX1 (A+B)+mancozeb (D), thiophanate (C)+TX1 (A+B)+mancozeb (D), chloralose (C)+TX1 (A+B)+mancozeb (D), fenthion (C)+TX1 (A+B)+mancozeb (D), pyridin-4-amine (C)+TX1 (A+B)+mancozeb (D), strychnine (C)+TX1 (A+B)+mancozeb (D), 1-hydroxy-1H-pyridine-2-thione (C)+TX1 (A+B)+mancozeb (D), 4-(quinoxalin-2-ylamino)benzenesulfonamide (C)+TX1 (A+B)+mancozeb (D), 8-hydroxyquinoline sulfate (C)+TX1 (A+B)+mancozeb (D), bronopol (C)+TX1 (A+B)+mancozeb (D), copper hydroxide (C)+TX1 (A+B)+mancozeb (D), cresol (C)+TX1 (A+B)+mancozeb (D), dipyrithione (C)+TX1 (A+B)+mancozeb (D), dodicin (C)+TX1 (A+B)+mancozeb (D), fenaminosulf (C)+TX1 (A+B)+mancozeb (D), formaldehyde (C)+TX1 (A+B)+mancozeb (D), hydrargaphen (C)+TX1 (A+B)+mancozeb (D), kasugamycin (C)+TX1 (A+B)+mancozeb (D), kasugamycin hydrochloride hydrate (C)+TX1 (A+B)+mancozeb (D), nickel bis(dimethyldithiocarbamate) (C)+TX1 (A+B)+mancozeb (D), nitrapyrin (C)+TX1 (A+B)+mancozeb (D), octhilinone (C)+TX1 (A+B)+mancozeb (D), oxolinic acid (C)+TX1 (A+B)+mancozeb (D), oxytetracycline (C)+TX1 (A+B)+mancozeb (D), potassium hydroxyquinoline sulfate (C)+TX1 (A+B)+mancozeb (D), probenazole (C)+TX1 (A+B)+mancozeb (D), streptomycin (C)+TX1 (A+B)+mancozeb (D), streptomycin sesquisulfate (C)+TX1 (A+B)+mancozeb (D), tecloftalam (C)+TX1 (A+B)+mancozeb (D), thiomersal (C)+TX1 (A+B)+mancozeb (D), Adoxophyes orana GV (C)+TX1 (A+B)+mancozeb (D), Agrobacterium radiobacter (C)+TX1 (A+B)+mancozeb (D), Amblyseius spp. (C)+TX1 (A+B)+mancozeb (D), Anagrapha falcifera NPV (C)+TX1 (A+B)+mancozeb (D), Anagrus atomus (C)+TX1 (A+B)+mancozeb (D), Aphelinus abdominalis (C)+TX1 (A+B)+mancozeb (D), Aphidius colemani (C)+TX1 (A+B)+mancozeb (D), Aphidoletes aphidimyza (C)+TX1 (A+B)+mancozeb (D), Autographa californica NPV (C)+TX1 (A+B)+mancozeb (D), Bacillus sphaericus Neide (C)+TX1 (A+B)+mancozeb (D), Beauveria brongniartii (C)+TX1 (A+B)+mancozeb (D), Chrysoperla carnea (C)+TX1 (A+B)+mancozeb (D), Cryptolaemus montrouzieri (C)+TX1 (A+B)+mancozeb (D), Cydia pomonella GV (C)+TX1 (A+B)+mancozeb (D), Dacnusa sibirica (C)+TX1 (A+B)+mancozeb (D), Diglyphus isaea (C)+TX1 (A+B)+mancozeb (D), Encarsia formosa (C)+TX1 (A+B)+mancozeb (D), Eretmocerus eremicus (C)+TX1 (A+B)+mancozeb (D), Heterorhabditis bacteriophora and H. megidis (C)+TX1 (A+B)+mancozeb (D), Hippodamia convergens (C)+TX1 (A+B)+mancozeb (D), Leptomastix dactylopii (C)+TX1 (A+B)+mancozeb (D), Macrolophus caliginosus (C)+TX1 (A+B)+mancozeb (D), Mamestra brassicae NPV (C)+TX1 (A+B)+mancozeb (D), Metaphycus helvolus (C)+TX1 (A+B)+mancozeb (D), Metarhizium anisopliae var. acridum (C)+TX1 (A+B)+mancozeb (D), Metarhizium anisopliae var. anisopliae (C)+TX1 (A+B)+mancozeb (D), Neodiprion sertifer NPV and N. lecontei NPV (C)+TX1 (A+B)+mancozeb (D), Orius spp. (C)+TX1 (A+B)+mancozeb (D), Paecilomyces fumosoroseus (C)+TX1 (A+B)+mancozeb (D), Phytoseiulus persimilis (C)+TX1 (A+B)+mancozeb (D), Steinernema bibionis (C)+TX1 (A+B)+mancozeb (D), Steinernema carpocapsae (C)+TX1 (A+B)+mancozeb (D), Steinernema feltiae (C)+TX1 (A+B)+mancozeb (D), Steinernema glaseri (C)+TX1 (A+B)+mancozeb (D), Steinernema riobrave (C)+TX1 (A+B)+mancozeb (D), Steinernema riobravis (C)+TX1 (A+B)+mancozeb (D), Steinernema scapterisci (C)+TX1 (A+B)+mancozeb (D), Steinernema spp. (C)+TX1 (A+B)+mancozeb (D), Trichogramma spp. (C)+TX1 (A+B)+mancozeb (D), Typhlodromus occidentalis (C)+TX1 (A+B)+mancozeb (D), Verticillium lecanii (C)+TX1 (A+B)+mancozeb (D), apholate (C)+TX1 (A+B)+mancozeb (D), bisazir (C)+TX1 (A+B)+mancozeb (D), busulfan (C)+TX1 (A+B)+mancozeb (D), dimatif (C)+TX1 (A+B)+mancozeb (D), hemel (C)+TX1 (A+B)+mancozeb (D), hempa (C)+TX1 (A+B)+mancozeb (D), metepa (C)+TX1 (A+B)+mancozeb (D), methiotepa (C)+TX1 (A+B)+mancozeb (D), methyl apholate (C)+TX1 (A+B)+mancozeb (D), morzid (C)+TX1 (A+B)+mancozeb (D), penfluron (C)+TX1 (A+B)+mancozeb (D), tepa (C)+TX1 (A+B)+mancozeb (D), thiohempa (C)+TX1 (A+B)+mancozeb (D), thiotepa (C)+TX1 (A+B)+mancozeb (D), tretamine (C)+TX1 (A+B)+mancozeb (D), uredepa (C)+TX1 (A+B)+mancozeb (D), (E)-dec-5-en-1-yl acetate with (E)-dec-5-en-1-ol (C)+TX1 (A+B)+mancozeb (D), (E)-tridec-4-en-1-yl acetate (C)+TX1 (A+B)+mancozeb (D), (E)-6-methylhept-2-en-4-ol (C)+TX1 (A+B)+mancozeb (D), (E,Z)-tetradeca-4,10-dien-1-yl acetate (C)+TX1 (A+B)+mancozeb (D), (Z)-dodec-7-en-1-yl acetate (C)+TX1 (A+B)+mancozeb (D), (Z)-hexadec-11-enal (C)+TX1 (A+B)+mancozeb (D), (Z)-hexadec-11-en-1-yl acetate (C)+TX1 (A+B)+mancozeb (D), (Z)-hexadec-13-en-11-yn-1-yl acetate (C)+TX1 (A+B)+mancozeb (D), (Z)-icos-13-en-10-one (C)+TX1 (A+B)+mancozeb (D), (Z)-tetradec-7-en-1-al (C)+TX1 (A+B)+mancozeb (D), (Z)-tetradec-9-en-1-ol (C)+TX1 (A+B)+mancozeb (D), (Z)-tetradec-9-en-1-yl acetate (C)+TX1 (A+B)+mancozeb (D), (7E,9Z)-dodeca-7,9-dien-1-yl acetate (C)+TX1 (A+B)+mancozeb (D), (9Z,11E)-tetradeca-9,11-dien-1-yl acetate (C)+TX1 (A+B)+mancozeb (D), (9Z,12E)-tetradeca-9,12-dien-1-yl acetate (C)+TX1 (A+B)+mancozeb (D), 14-methyloctadec-1-ene (C)+TX1 (A+B)+mancozeb (D), 4-methylnonan-5-ol with 4-methylnonan-5-one (C)+TX1 (A+B)+mancozeb (D), alpha-multistriatin (C)+TX1 (A+B)+mancozeb (D), brevicomin (C)+TX1 (A+B)+mancozeb (D), codlelure (C)+TX1 (A+B)+mancozeb (D), codlemone (C)+TX1 (A+B)+mancozeb (D), cuelure (C)+TX1 (A+B)+mancozeb (D), disparlure (C)+TX1 (A+B)+mancozeb (D), dodec-8-en-1-yl acetate (C)+TX1 (A+B)+mancozeb (D), dodec-9-en-1-yl acetate (C)+TX1 (A+B)+mancozeb (D), dodeca-8 (C)+TX1 (A+B)+mancozeb (D), 10-dien-1-yl acetate (C)+TX1 (A+B)+mancozeb (D), dominicalure (C)+TX1 (A+B)+mancozeb (D), ethyl 4-methyloctanoate (C)+TX1 (A+B)+mancozeb (D), eugenol (C)+TX1 (A+B)+mancozeb (D), frontalin (C)+TX1 (A+B)+mancozeb (D), grandlure (C)+TX1 (A+B)+mancozeb (D), grandlure I (C)+TX1 (A+B)+mancozeb (D), grandlure 11 (C)+TX1 (A+B)+mancozeb (D), grandlure III (C)+TX1 (A+B)+mancozeb (D), grandlure IV (C)+TX1 (A+B)+mancozeb (D), hexalure (C)+TX1 (A+B)+mancozeb (D), ipsdienol (C)+TX1 (A+B)+mancozeb (D), ipsenol (C)+TX1 (A+B)+mancozeb (D), japonilure (C)+TX1 (A+B)+mancozeb (D), lineatin (C)+TX1 (A+B)+mancozeb (D), litlure (C)+TX1 (A+B)+mancozeb (D), looplure (C)+TX1 (A+B)+mancozeb (D), medlure (C)+TX1 (A+B)+mancozeb (D), megatomoic acid (C)+TX1 (A+B)+mancozeb (D), methyl eugenol (C)+TX1 (A+B)+mancozeb (D), muscalure (C)+TX1 (A+B)+mancozeb (D), octadeca-2,13-dien-1-yl acetate (C)+TX1 (A+B)+mancozeb (D), octadeca-3,13-dien-1-yl acetate (C)+TX1 (A+B)+mancozeb (D), orfralure (C)+TX1 (A+B)+mancozeb (D), oryctalure (C)+TX1 (A+B)+mancozeb (D), ostramone (C)+TX1 (A+B)+mancozeb (D), siglure (C)+TX1 (A+B)+mancozeb (D), sordidin (C)+TX1 (A+B)+mancozeb (D), sulcatol (C)+TX1 (A+B)+mancozeb (D), tetradec-11-en-1-yl acetate (C)+TX1 (A+B)+mancozeb (D), trimedlure (C)+TX1 (A+B)+mancozeb (D), trimedlure A (C)+TX1 (A+B)+mancozeb (D), trimedlure B₁ (C)+TX1 (A+B)+mancozeb (D), trimedlure B₂ (C)+TX1 (A+B)+mancozeb (D), trimedlure C (C)+TX1 (A+B)+mancozeb (D), trunc-call (C)+TX1 (A+B)+mancozeb (D), 2-(octylthio)ethanol (C)+TX1 (A+B)+mancozeb (D), butopyronoxyl (C)+TX1 (A+B)+mancozeb (D), butoxy(polypropylene glycol) (C)+TX1 (A+B)+mancozeb (D), dibutyl adipate (C)+TX1 (A+B)+mancozeb (D), dibutyl phthalate (C)+TX1 (A+B)+mancozeb (D), dibutyl succinate (C)+TX1 (A+B)+mancozeb (D), diethyltoluamide (C)+TX1 (A+B)+mancozeb (D), dimethyl carbate (C)+TX1 (A+B)+mancozeb (D), dimethyl phthalate (C)+TX1 (A+B)+mancozeb (D), ethyl hexanediol (C)+TX1 (A+B)+mancozeb (D), hexamide (C)+TX1 (A+B)+mancozeb (D), methoquin-butyl (C)+TX1 (A+B)+mancozeb (D), methylneodecanamide (C)+TX1 (A+B)+mancozeb (D), oxamate (C)+TX1 (A+B)+mancozeb (D), picaridin (C)+TX1 (A+B)+mancozeb (D), 1-dichloro-1-nitroethane (C)+TX1 (A+B)+mancozeb (D), 1,1-dichloro-2,2-bis(4-ethylphenyl)ethane (C)+TX1 (A+B)+mancozeb (D), 1,2-dichloropropane with 1,3-dichloropropene (C)+TX1 (A+B)+mancozeb (D), 1-bromo-2-chloroethane (C)+TX1 (A+B)+mancozeb (D), 2,2,2-trichloro-1-(3,4-dichlorophenyl)ethyl acetate (C)+TX1 (A+B)+mancozeb (D), 2,2-dichlorovinyl 2-ethylsulfinylethyl methyl phosphate (C)+TX1 (A+B)+mancozeb (D), 2-(1,3-dithiolan-2-yl)phenyl dimethylcarbamate (C)+TX1 (A+B)+mancozeb (D), 2-(2-butoxyethoxy)ethyl thiocyanate (C)+TX1 (A+B)+mancozeb (D), 2-(4,5-dimethyl-1,3-dioxolan-2-yl)phenyl methylcarbamate (C)+TX1 (A+B)+mancozeb (D), 2-(4-chloro-3,5-xylyloxy)ethanol (C)+TX1 (A+B)+mancozeb (D), 2-chlorovinyl diethyl phosphate (C)+TX1 (A+B)+mancozeb (D), 2-imidazolidone (C)+TX1 (A+B)+mancozeb (D), 2-isovalerylindan-1,3-dione (C)+TX1 (A+B)+mancozeb (D), 2-methyl(prop-2-ynyl)aminophenyl methylcarbamate (C)+TX1 (A+B)+mancozeb (D), 2-thiocyanatoethyl laurate (C)+TX1 (A+B)+mancozeb (D), 3-bromo-1-chloroprop-1-ene (C)+TX1 (A+B)+mancozeb (D), 3-methyl-1-phenylpyrazol-5-yl dimethylcarbamate (C)+TX1 (A+B)+mancozeb (D), 4-methyl(prop-2-ynyl)amino-3,5-xylyl methylcarbamate (C)+TX1 (A+B)+mancozeb (D), 5,5-dimethyl-3-oxocyclohex-1-enyl dimethylcarbamate (C)+TX1 (A+B)+mancozeb (D), acethion (C)+TX1 (A+B)+mancozeb (D), acrylonitrile (C)+TX1 (A+B)+mancozeb (D), aldrin (C)+TX1 (A+B)+mancozeb (D), allosamidin (C)+TX1 (A+B)+mancozeb (D), allyxycarb (C)+TX1 (A+B)+mancozeb (D), alpha-ecdysone (C)+TX1 (A+B)+mancozeb (D), aluminium phosphide (C)+TX1 (A+B)+mancozeb (D), aminocarb (C)+TX1 (A+B)+mancozeb (D), anabasine (C)+TX1 (A+B)+mancozeb (D), athidathion (C)+TX1 (A+B)+mancozeb (D), azamethiphos (C)+TX1 (A+B)+mancozeb (D), Bacillus thuringiensis delta endotoxins (C)+TX1 (A+B)+mancozeb (D), barium hexafluorosilicate (C)+TX1 (A+B)+mancozeb (D), barium polysulfide (C)+TX1 (A+B)+mancozeb (D), barthrin (C)+TX1 (A+B)+mancozeb (D), Bayer 22/190 (C)+TX1 (A+B)+mancozeb (D), Bayer 22408 (C)+TX1 (A+B)+mancozeb (D), beta-cyfluthrin (C)+TX1 (A+B)+mancozeb (D), beta-cypermethrin (C)+TX1 (A+B)+mancozeb (D), bioethanomethrin (C)+TX1 (A+B)+mancozeb (D), biopermethrin (C)+TX1 (A+B)+mancozeb (D), bis(2-chloroethyl) ether (C)+TX1 (A+B)+mancozeb (D), borax (C)+TX1 (A+B)+mancozeb (D), bromfenvinfos (C)+TX1 (A+B)+mancozeb (D), bromo-DDT (C)+TX1 (A+B)+mancozeb (D), bufencarb (C)+TX1 (A+B)+mancozeb (D), butacarb (C)+TX1 (A+B)+mancozeb (D), butathiofos (C)+TX1 (A+B)+mancozeb (D), butonate (C)+TX1 (A+B)+mancozeb (D), calcium arsenate (C)+TX1 (A+B)+mancozeb (D), calcium cyanide (C)+TX1 (A+B)+mancozeb (D), carbon disulfide (C)+TX1 (A+B)+mancozeb (D), carbon tetrachloride (C)+TX1 (A+B)+mancozeb (D), cartap hydrochloride (C)+TX1 (A+B)+mancozeb (D), cevadine (C)+TX1 (A+B)+mancozeb (D), chlorbicyclen (C)+TX1 (A+B)+mancozeb (D), chlordane (C)+TX1 (A+B)+mancozeb (D), chlordecone (C)+TX1 (A+B)+mancozeb (D), chloroform (C)+TX1 (A+B)+mancozeb (D), chloropicrin (C)+TX1 (A+B)+mancozeb (D), chlorphoxim (C)+TX1 (A+B)+mancozeb (D), chlorprazophos (C)+TX1 (A+B)+mancozeb (D), cis-resmethrin (C)+TX1 (A+B)+mancozeb (D), cismethrin (C)+TX1 (A+B)+mancozeb (D), clocythrin (C)+TX1 (A+B)+mancozeb (D), copper acetoarsenite (C)+TX1 (A+B)+mancozeb (D), copper arsenate (C)+TX1 (A+B)+mancozeb (D), copper oleate (C)+TX1 (A+B)+mancozeb (D), coumithoate (C)+TX1 (A+B)+mancozeb (D), cryolite (C)+TX1 (A+B)+mancozeb (D), CS 708 (C)+TX1 (A+B)+mancozeb (D), cyanofenphos (C)+TX1 (A+B)+mancozeb (D), cyanophos (C)+TX1 (A+B)+mancozeb (D), cyclethrin (C)+TX1 (A+B)+mancozeb (D), cythioate (C)+TX1 (A+B)+mancozeb (D), d-tetramethrin (C)+TX1 (A+B)+mancozeb (D), DAEP (C)+TX1 (A+B)+mancozeb (D), dazomet (C)+TX1 (A+B)+mancozeb (D), decarbofuran (C)+TX1 (A+B)+mancozeb (D), diamidafos (C)+TX1 (A+B)+mancozeb (D), dicapthon (C)+TX1 (A+B)+mancozeb (D), dichlofenthion (C)+TX1 (A+B)+mancozeb (D), dicresyl (C)+TX1 (A+B)+mancozeb (D), dicyclanil (C)+TX1 (A+B)+mancozeb (D), dieldrin (C)+TX1 (A+B)+mancozeb (D), diethyl 5-methylpyrazol-3-yl phosphate (C)+TX1 (A+B)+mancozeb (D), dilor (C)+TX1 (A+B)+mancozeb (D), dimefluthrin (C)+TX1 (A+B)+mancozeb (D), dimetan (C)+TX1 (A+B)+mancozeb (D), dimethrin (C)+TX1 (A+B)+mancozeb (D), dimethylvinphos (C)+TX1 (A+B)+mancozeb (D), dimetilan (C)+TX1 (A+B)+mancozeb (D), dinoprop (C)+TX1 (A+B)+mancozeb (D), dinosam (C)+TX1 (A+B)+mancozeb (D), dinoseb (C)+TX1 (A+B)+mancozeb (D), diofenolan (C)+TX1 (A+B)+mancozeb (D), dioxabenzofos (C)+TX1 (A+B)+mancozeb (D), dithicrofos (C)+TX1 (A+B)+mancozeb (D), DSP (C)+TX1 (A+B)+mancozeb (D), ecdysterone (C)+TX1 (A+B)+mancozeb (D), EI 1642 (C)+TX1 (A+B)+mancozeb (D), EMPC (C)+TX1 (A+B)+mancozeb (D), EPBP (C)+TX1 (A+B)+mancozeb (D), etaphos (C)+TX1 (A+B)+mancozeb (D), ethiofencarb (C)+TX1 (A+B)+mancozeb (D), ethyl formate (C)+TX1 (A+B)+mancozeb (D), ethylene dibromide (C)+TX1 (A+B)+mancozeb (D), ethylene dichloride (C)+TX1 (A+B)+mancozeb (D), ethylene oxide (C)+TX1 (A+B)+mancozeb (D), EXD (C)+TX1 (A+B)+mancozeb (D), fenchlorphos (C)+TX1 (A+B)+mancozeb (D), fenethacarb (C)+TX1 (A+B)+mancozeb (D), fenitrothion (C)+TX1 (A+B)+mancozeb (D), fenoxacrim (C)+TX1 (A+B)+mancozeb (D), fenpirithrin (C)+TX1 (A+B)+mancozeb (D), fensulfothion (C)+TX1 (A+B)+mancozeb (D), fenthion-ethyl (C)+TX1 (A+B)+mancozeb (D), flucofuron (C)+TX1 (A+B)+mancozeb (D), fosmethilan (C)+TX1 (A+B)+mancozeb (D), fospirate (C)+TX1 (A+B)+mancozeb (D), fosthietan (C)+TX1 (A+B)+mancozeb (D), furathiocarb (C)+TX1 (A+B)+mancozeb (D), furethrin (C)+TX1 (A+B)+mancozeb (D), guazatine (C)+TX1 (A+B)+mancozeb (D), guazatine acetates (C)+TX1 (A+B)+mancozeb (D), sodium tetrathiocarbonate (C)+TX1 (A+B)+mancozeb (D), halfenprox (C)+TX1 (A+B)+mancozeb (D), HCH (C)+TX1 (A+B)+mancozeb (D), HEOD (C)+TX1 (A+B)+mancozeb (D), heptachlor (C)+TX1 (A+B)+mancozeb (D), heterophos (C)+TX1 (A+B)+mancozeb (D), HHDN (C)+TX1 (A+B)+mancozeb (D), hydrogen cyanide (C)+TX1 (A+B)+mancozeb (D), hyquincarb (C)+TX1 (A+B)+mancozeb (D), IPSP (C)+TX1 (A+B)+mancozeb (D), isazofos (C)+TX1 (A+B)+mancozeb (D), isobenzan (C)+TX1 (A+B)+mancozeb (D), isodrin (C)+TX1 (A+B)+mancozeb (D), isofenphos (C)+TX1 (A+B)+mancozeb (D), isolane (C)+TX1 (A+B)+mancozeb (D), isoprothiolane (C)+TX1 (A+B)+mancozeb (D), isoxathion (C)+TX1 (A+B)+mancozeb (D), juvenile hormone I (C)+TX1 (A+B)+mancozeb (D), juvenile hormone II (C)+TX1 (A+B)+mancozeb (D), juvenile hormone III (C)+TX1 (A+B)+mancozeb (D), kelevan (C)+TX1 (A+B)+mancozeb (D), kinoprene (C)+TX1 (A+B)+mancozeb (D), lead arsenate (C)+TX1 (A+B)+mancozeb (D), leptophos (C)+TX1 (A+B)+mancozeb (D), lirimfos (C)+TX1 (A+B)+mancozeb (D), lythidathion (C)+TX1 (A+B)+mancozeb (D), m-cumenyl methylcarbamate (C)+TX1 (A+B)+mancozeb (D), magnesium phosphide (C)+TX1 (A+B)+mancozeb (D), mazidox (C)+TX1 (A+B)+mancozeb (D), mecarphon (C)+TX1 (A+B)+mancozeb (D), menazon (C)+TX1 (A+B)+mancozeb (D), mercurous chloride (C)+TX1 (A+B)+mancozeb (D), mesulfenfos (C)+TX1 (A+B)+mancozeb (D), metam (C)+TX1 (A+B)+mancozeb (D), metam-potassium (C)+TX1 (A+B)+mancozeb (D), metam-sodium (C)+TX1 (A+B)+mancozeb (D), methanesulfonyl fluoride (C)+TX1 (A+B)+mancozeb (D), methocrotophos (C)+TX1 (A+B)+mancozeb (D), methoprene (C)+TX1 (A+B)+mancozeb (D), methothrin (C)+TX1 (A+B)+mancozeb (D), methoxychlor (C)+TX1 (A+B)+mancozeb (D), methyl isothiocyanate (C)+TX1 (A+B)+mancozeb (D), methylchloroform (C)+TX1 (A+B)+mancozeb (D), methylene chloride (C)+TX1 (A+B)+mancozeb (D), metoxadiazone (C)+TX1 (A+B)+mancozeb (D), mirex (C)+TX1 (A+B)+mancozeb (D), naftalofos (C)+TX1 (A+B)+mancozeb (D), naphthalene (C)+TX1 (A+B)+mancozeb (D), NC-170 (C)+TX1 (A+B)+mancozeb (D), nicotine (C)+TX1 (A+B)+mancozeb (D), nicotine sulfate (C)+TX1 (A+B)+mancozeb (D), nithiazine (C)+TX1 (A+B)+mancozeb (D), nornicotine (C)+TX1 (A+B)+mancozeb (D), O-5-dichloro-4-iodophenyl O-ethyl ethylphosphonothioate (C)+TX1 (A+B)+mancozeb (D), O,O-diethyl O-4-methyl-2-oxo-2H-chromen-7-yl phosphorothioate (C)+TX1 (A+B)+mancozeb (D), O,O-diethyl O-6-methyl-2-propylpyrimidin-4-yl phosphorothioate (C)+TX1 (A+B)+mancozeb (D), O,O,O′,O′-tetrapropyl dithiopyrophosphate (C)+TX1 (A+B)+mancozeb (D), oleic acid (C)+TX1 (A+B)+mancozeb (D), para-dichlorobenzene (C)+TX1 (A+B)+mancozeb (D), parathion-methyl (C)+TX1 (A+B)+mancozeb (D), pentachlorophenol (C)+TX1 (A+B)+mancozeb (D), pentachlorophenyl laurate (C)+TX1 (A+B)+mancozeb (D), PH 60-38 (C)+TX1 (A+B)+mancozeb (D), phenkapton (C)+TX1 (A+B)+mancozeb (D), phosnichlor (C)+TX1 (A+B)+mancozeb (D), phosphine (C)+TX1 (A+B)+mancozeb (D), phoxim-methyl (C)+TX1 (A+B)+mancozeb (D), pirimetaphos (C)+TX1 (A+B)+mancozeb (D), polychlorodicyclopentadiene isomers (C)+TX1 (A+B)+mancozeb (D), potassium arsenite (C)+TX1 (A+B)+mancozeb (D), potassium thiocyanate (C)+TX1 (A+B)+mancozeb (D), precocene I (C)+TX1 (A+B)+mancozeb (D), precocene 11 (C)+TX1 (A+B)+mancozeb (D), precocene III (C)+TX1 (A+B)+mancozeb (D), primidophos (C)+TX1 (A+B)+mancozeb (D), profluthrin (C)+TX1 (A+B)+mancozeb (D), promecarb (C)+TX1 (A+B)+mancozeb (D), prothiofos (C)+TX1 (A+B)+mancozeb (D), pyrazophos (C)+TX1 (A+B)+mancozeb (D), pyresmethrin (C)+TX1 (A+B)+mancozeb (D), Quassia (C)+TX1 (A+B)+mancozeb (D), quinalphos-methyl (C)+TX1 (A+B)+mancozeb (D), quinothion (C)+TX1 (A+B)+mancozeb (D), rafoxanide (C)+TX1 (A+B)+mancozeb (D), resmethrin (C)+TX1 (A+B)+mancozeb (D), rotenone (C)+TX1 (A+B)+mancozeb (D), kadethrin (C)+TX1 (A+B)+mancozeb (D), ryania (C)+TX1 (A+B)+mancozeb (D), ryanodine (C)+TX1 (A+B)+mancozeb (D), sabadilla (C)+TX1 (A+B)+mancozeb (D), schradan (C)+TX1 (A+B)+mancozeb (D), sebufos (C)+TX1 (A+B)+mancozeb (D), SI-0009 (C)+TX1 (A+B)+mancozeb (D), thiapronil (C)+TX1 (A+B)+mancozeb (D), sodium arsenite (C)+TX1 (A+B)+mancozeb (D), sodium cyanide (C)+TX1 (A+B)+mancozeb (D), sodium fluoride (C)+TX1 (A+B)+mancozeb (D), sodium hexafluorosilicate (C)+TX1 (A+B)+mancozeb (D), sodium pentachlorophenoxide (C)+TX1 (A+B)+mancozeb (D), sodium selenate (C)+TX1 (A+B)+mancozeb (D), sodium thiocyanate (C)+TX1 (A+B)+mancozeb (D), sulcofuron (C)+TX1 (A+B)+mancozeb (D), sulcofuron-sodium (C)+TX1 (A+B)+mancozeb (D), sulfuryl fluoride (C)+TX1 (A+B)+mancozeb (D), sulprofos (C)+TX1 (A+B)+mancozeb (D), tar oils (C)+TX1 (A+B)+mancozeb (D), tazimcarb (C)+TX1 (A+B)+mancozeb (D), TDE (C)+TX1 (A+B)+mancozeb (D), tebupirimfos (C)+TX1 (A+B)+mancozeb (D), temephos (C)+TX1 (A+B)+mancozeb (D), terallethrin (C)+TX1 (A+B)+mancozeb (D), tetrachloroethane (C)+TX1 (A+B)+mancozeb (D), thicrofos (C)+TX1 (A+B)+mancozeb (D), thiocyclam (C)+TX1 (A+B)+mancozeb (D), thiocyclam hydrogen oxalate (C)+TX1 (A+B)+mancozeb (D), thionazin (C)+TX1 (A+B)+mancozeb (D), thiosultap (C)+TX1 (A+B)+mancozeb (D), thiosultap-sodium (C)+TX1 (A+B)+mancozeb (D), tralomethrin (C)+TX1 (A+B)+mancozeb (D), transpermethrin (C)+TX1 (A+B)+mancozeb (D), triazamate (C)+TX1 (A+B)+mancozeb (D), trichlormetaphos-3 (C)+TX1 (A+B)+mancozeb (D), trichloronat (C)+TX1 (A+B)+mancozeb (D), trimethacarb (C)+TX1 (A+B)+mancozeb (D), tolprocarb (C)+TX1 (A+B)+mancozeb (D), triclopyricarb (C)+TX1 (A+B)+mancozeb (D), triprene (C)+TX1 (A+B)+mancozeb (D), veratridine (C)+TX1 (A+B)+mancozeb (D), veratrine (C)+TX1 (A+B)+mancozeb (D), XMC (C)+TX1 (A+B)+mancozeb (D), zetamethrin (C)+TX1 (A+B)+mancozeb (D), zinc phosphide (C)+TX1 (A+B)+mancozeb (D), zolaprofos (C)+TX1 (A+B)+mancozeb (D), meperfluthrin (C)+TX1 (A+B)+mancozeb (D), tetramethylfluthrin (C)+TX1 (A+B)+mancozeb (D), bis(tributyltin) oxide (C)+TX1 (A+B)+mancozeb (D), bromoacetamide (C)+TX1 (A+B)+mancozeb (D), ferric phosphate (C)+TX1 (A+B)+mancozeb (D), niclosamide-olamine (C)+TX1 (A+B)+mancozeb (D), tributyltin oxide (C)+TX1 (A+B)+mancozeb (D), pyrimorph (C)+TX1 (A+B)+mancozeb (D), trifenmorph (C)+TX1 (A+B)+mancozeb (D), 1,2-dibromo-3-chloropropane (C)+TX1 (A+B)+mancozeb (D), 1,3-dichloropropene (C)+TX1 (A+B)+mancozeb (D), 3,4-dichlorotetrahydrothiophene 1,1-dioxide (C)+TX1 (A+B)+mancozeb (D), 3-(4-chlorophenyl)-5-methylrhodanine (C)+TX1 (A+B)+mancozeb (D), 5-methyl-6-thioxo-1,3,5-thiadiazinan-3-ylacetic acid (C)+TX1 (A+B)+mancozeb (D), 6-isopentenylaminopurine (C)+TX1 (A+B)+mancozeb (D), anisiflupurin (C)+TX1 (A+B)+mancozeb (D), benclothiaz (C)+TX1 (A+B)+mancozeb (D), cytokinins (C)+TX1 (A+B)+mancozeb (D), DCIP (C)+TX1 (A+B)+mancozeb (D), furfural (C)+TX1 (A+B)+mancozeb (D), isamidofos (C)+TX1 (A+B)+mancozeb (D), kinetin (C)+TX1 (A+B)+mancozeb (D), Myrothecium verrucaria composition (C)+TX1 (A+B)+mancozeb (D), tetrachlorothiophene (C)+TX1 (A+B)+mancozeb (D), xylenols (C)+TX1 (A+B)+mancozeb (D), zeatin (C)+TX1 (A+B)+mancozeb (D), potassium ethylxanthate (C)+TX1 (A+B)+mancozeb (D), acibenzolar (C)+TX1 (A+B)+mancozeb (D), acibenzolar-S-methyl (C)+TX1 (A+B)+mancozeb (D), Reynoutria sachalinensis extract (C)+TX1 (A+B)+mancozeb (D), alpha-chlorohydrin (C)+TX1 (A+B)+mancozeb (D), antu (C)+TX1 (A+B)+mancozeb (D), barium carbonate (C)+TX1 (A+B)+mancozeb (D), bisthiosemi (C)+TX1 (A+B)+mancozeb (D), brodifacoum (C)+TX1 (A+B)+mancozeb (D), bromadiolone (C)+TX1 (A+B)+mancozeb (D), bromethalin (C)+TX1 (A+B)+mancozeb (D), chlorophacinone (C)+TX1 (A+B)+mancozeb (D), cholecalciferol (C)+TX1 (A+B)+mancozeb (D), coumachlor (C)+TX1 (A+B)+mancozeb (D), coumafuryl (C)+TX1 (A+B)+mancozeb (D), coumatetralyl (C)+TX1 (A+B)+mancozeb (D), crimidine (C)+TX1 (A+B)+mancozeb (D), difenacoum (C)+TX1 (A+B)+mancozeb (D), difethialone (C)+TX1 (A+B)+mancozeb (D), diphacinone (C)+TX1 (A+B)+mancozeb (D), ergocalciferol (C)+TX1 (A+B)+mancozeb (D), flocoumafen (C)+TX1 (A+B)+mancozeb (D), fluoroacetamide (C)+TX1 (A+B)+mancozeb (D), flupropadine (C)+TX1 (A+B)+mancozeb (D), flupropadine hydrochloride (C)+TX1 (A+B)+mancozeb (D), norbormide (C)+TX1 (A+B)+mancozeb (D), phosacetim (C)+TX1 (A+B)+mancozeb (D), phosphorus (C)+TX1 (A+B)+mancozeb (D), pindone (C)+TX1 (A+B)+mancozeb (D), pyrinuron (C)+TX1 (A+B)+mancozeb (D), scilliroside (C)+TX1 (A+B)+mancozeb (D), sodium fluoroacetate (C)+TX1 (A+B)+mancozeb (D), thallium sulfate (C)+TX1 (A+B)+mancozeb (D), warfarin (C)+TX1 (A+B)+mancozeb (D), 2-(2-butoxyethoxy)ethyl piperonylate (C)+TX1 (A+B)+mancozeb (D), 5-(1,3-benzodioxol-5-yl)-3-hexylcyclohex-2-enone (C)+TX1 (A+B)+mancozeb (D), farnesol with nerolidol (C)+TX1 (A+B)+mancozeb (D), verbutin (C)+TX1 (A+B)+mancozeb (D), MGK 264 (C)+TX1 (A+B)+mancozeb (D), piperonyl butoxide (C)+TX1 (A+B)+mancozeb (D), piprotal (C)+TX1 (A+B)+mancozeb (D), propyl isomer (C)+TX1 (A+B)+mancozeb (D), S421 (C)+TX1 (A+B)+mancozeb (D), sesamex (C)+TX1 (A+B)+mancozeb (D), sesasmolin (C)+TX1 (A+B)+mancozeb (D), sulfoxide (C)+TX1 (A+B)+mancozeb (D), anthraquinone (C)+TX1 (A+B)+mancozeb (D), copper naphthenate (C)+TX1 (A+B)+mancozeb (D), copper oxychloride (C)+TX1 (A+B)+mancozeb (D), dicyclopentadiene (C)+TX1 (A+B)+mancozeb (D), thiram (C)+TX1 (A+B)+mancozeb (D), zinc naphthenate (C)+TX1 (A+B)+mancozeb (D), ziram (C)+TX1 (A+B)+mancozeb (D), imanin (C)+TX1 (A+B)+mancozeb (D), ribavirin (C)+TX1 (A+B)+mancozeb (D), chloroinconazide (C)+TX1 (A+B)+mancozeb (D), mercuric oxide (C)+TX1 (A+B)+mancozeb (D), thiophanate-methyl (C)+TX1 (A+B)+mancozeb (D), azaconazole (C)+TX1 (A+B)+mancozeb (D), bitertanol (C)+TX1 (A+B)+mancozeb (D), bromuconazole (C)+TX1 (A+B)+mancozeb (D), cyproconazole (C)+TX1 (A+B)+mancozeb (D), difenoconazole (C)+TX1 (A+B)+mancozeb (D), diniconazole (C)+TX1 (A+B)+mancozeb (D), epoxiconazole (C)+TX1 (A+B)+mancozeb (D), fenbuconazole (C)+TX1 (A+B)+mancozeb (D), fluquinconazole (C)+TX1 (A+B)+mancozeb (D), flusilazole (C)+TX1 (A+B)+mancozeb (D), flutriafol (C)+TX1 (A+B)+mancozeb (D), furametpyr (C)+TX1 (A+B)+mancozeb (D), hexaconazole (C)+TX1 (A+B)+mancozeb (D), imazalil (C)+TX1 (A+B)+mancozeb (D), imibenconazole (C)+TX1 (A+B)+mancozeb (D), ipconazole (C)+TX1 (A+B)+mancozeb (D), metconazole (C)+TX1 (A+B)+mancozeb (D), myclobutanil (C)+TX1 (A+B)+mancozeb (D), paclobutrazole (C)+TX1 (A+B)+mancozeb (D), pefurazoate (C)+TX1 (A+B)+mancozeb (D), penconazole (C)+TX1 (A+B)+mancozeb (D), prothioconazole (C)+TX1 (A+B)+mancozeb (D), pyrifenox (C)+TX1 (A+B)+mancozeb (D), prochloraz (C)+TX1 (A+B)+mancozeb (D), propiconazole (C)+TX1 (A+B)+mancozeb (D), pyrisoxazole (C)+TX1 (A+B)+mancozeb (D), simeconazole (C)+TX1 (A+B)+mancozeb (D), tebuconazole (C)+TX1 (A+B)+mancozeb (D), tetraconazole (C)+TX1 (A+B)+mancozeb (D), triadimefon (C)+TX1 (A+B)+mancozeb (D), triadimenol (C)+TX1 (A+B)+mancozeb (D), triflumizole (C)+TX1 (A+B)+mancozeb (D), triticonazole (C)+TX1 (A+B)+mancozeb (D), ancymidol (C)+TX1 (A+B)+mancozeb (D), fenarimol (C)+TX1 (A+B)+mancozeb (D), nuarimol (C)+TX1 (A+B)+mancozeb (D), bupirimate (C)+TX1 (A+B)+mancozeb (D), dimethirimol (C)+TX1 (A+B)+mancozeb (D), ethirimol (C)+TX1 (A+B)+mancozeb (D), dodemorph (C)+TX1 (A+B)+mancozeb (D), fenpropidin (C)+TX1 (A+B)+mancozeb (D), fenpropimorph (C)+TX1 (A+B)+mancozeb (D), spiroxamine (C)+TX1 (A+B)+mancozeb (D), tridemorph (C)+TX1 (A+B)+mancozeb (D), cyprodinil (C)+TX1 (A+B)+mancozeb (D), mepanipyrim (C)+TX1 (A+B)+mancozeb (D), pyrimethanil (C)+TX1 (A+B)+mancozeb (D), fenpiclonil (C)+TX1 (A+B)+mancozeb (D), fludioxonil (C)+TX1 (A+B)+mancozeb (D), benalaxyl (C)+TX1 (A+B)+mancozeb (D), furalaxyl (C)+TX1 (A+B)+mancozeb (D), metalaxyl (C)+TX1 (A+B)+mancozeb (D), R-metalaxyl (C)+TX1 (A+B)+mancozeb (D), ofurace (C)+TX1 (A+B)+mancozeb (D), oxadixyl (C)+TX1 (A+B)+mancozeb (D), carbendazim (C)+TX1 (A+B)+mancozeb (D), debacarb (C)+TX1 (A+B)+mancozeb (D), fuberidazole (C)+TX1 (A+B)+mancozeb (D), thiabendazole (C)+TX1 (A+B)+mancozeb (D), chlozolinate (C)+TX1 (A+B)+mancozeb (D), dichlozoline (C)+TX1 (A+B)+mancozeb (D), myclozoline (C)+TX1 (A+B)+mancozeb (D), procymidone (C)+TX1 (A+B)+mancozeb (D), vinclozoline (C)+TX1 (A+B)+mancozeb (D), boscalid (C)+TX1 (A+B)+mancozeb (D), carboxin (C)+TX1 (A+B)+mancozeb (D), fenfuram (C)+TX1 (A+B)+mancozeb (D), flutolanil (C)+TX1 (A+B)+mancozeb (D), mepronil (C)+TX1 (A+B)+mancozeb (D), oxycarboxin (C)+TX1 (A+B)+mancozeb (D), penthiopyrad (C)+TX1 (A+B)+mancozeb (D), thifluzamide (C)+TX1 (A+B)+mancozeb (D), dodine (C)+TX1 (A+B)+mancozeb (D), iminoctadine (C)+TX1 (A+B)+mancozeb (D), azoxystrobin (C)+TX1 (A+B)+mancozeb (D), dimoxystrobin (C)+TX1 (A+B)+mancozeb (D), enestroburin (C)+TX1 (A+B)+mancozeb (D), fenaminstrobin (C)+TX1 (A+B)+mancozeb (D), flufenoxystrobin (C)+TX1 (A+B)+mancozeb (D), fluoxastrobin (C)+TX1 (A+B)+mancozeb (D), kresoxim-methyl (C)+TX1 (A+B)+mancozeb (D), metominostrobin (C)+TX1 (A+B)+mancozeb (D), trifloxystrobin (C)+TX1 (A+B)+mancozeb (D), orysastrobin (C)+TX1 (A+B)+mancozeb (D), picoxystrobin (C)+TX1 (A+B)+mancozeb (D), pyraclostrobin (C)+TX1 (A+B)+mancozeb (D), pyrametostrobin (C)+TX1 (A+B)+mancozeb (D), pyraoxystrobin (C)+TX1 (A+B)+mancozeb (D), ferbam (C)+TX1 (A+B)+mancozeb (D), mancozeb (C)+TX1 (A+B)+mancozeb (D), maneb (C)+TX1 (A+B)+mancozeb (D), metiram (C)+TX1 (A+B)+mancozeb (D), propineb (C)+TX1 (A+B)+mancozeb (D), zineb (C)+TX1 (A+B)+mancozeb (D), captafol (C)+TX1 (A+B)+mancozeb (D), captan (C)+TX1 (A+B)+mancozeb (D), fluoroimide (C)+TX1 (A+B)+mancozeb (D), folpet (C)+TX1 (A+B)+mancozeb (D), tolylfluanid (C)+TX1 (A+B)+mancozeb (D), bordeaux mixture (C)+TX1 (A+B)+mancozeb (D), copper oxide (C)+TX1 (A+B)+mancozeb (D), mancopper (C)+TX1 (A+B)+mancozeb (D), oxine-copper (C)+TX1 (A+B)+mancozeb (D), nitrothal-isopropyl (C)+TX1 (A+B)+mancozeb (D), edifenphos (C)+TX1 (A+B)+mancozeb (D), iprobenphos (C)+TX1 (A+B)+mancozeb (D), phosdiphen (C)+TX1 (A+B)+mancozeb (D), tolclofos-methyl (C)+TX1 (A+B)+mancozeb (D), anilazine (C)+TX1 (A+B)+mancozeb (D), benthiavalicarb (C)+TX1 (A+B)+mancozeb (D), blasticidin-S(C)+TX1 (A+B)+mancozeb (D), chloroneb (C)+TX1 (A+B)+mancozeb (D), chlorothalonil (C)+TX1 (A+B)+mancozeb (D), cyflufenamid (C)+TX1 (A+B)+mancozeb (D), cymoxanil (C)+TX1 (A+B)+mancozeb (D), cyclobutrifluram (C)+TX1 (A+B)+mancozeb (D), diclocymet (C)+TX1 (A+B)+mancozeb (D), diclomezine (C)+TX1 (A+B)+mancozeb (D), dicloran (C)+TX1 (A+B)+mancozeb (D), diethofencarb (C)+TX1 (A+B)+mancozeb (D), dimethomorph (C)+TX1 (A+B)+mancozeb (D), flumorph (C)+TX1 (A+B)+mancozeb (D), dithianon (C)+TX1 (A+B)+mancozeb (D), ethaboxam (C)+TX1 (A+B)+mancozeb (D), etridiazole (C)+TX1 (A+B)+mancozeb (D), famoxadone (C)+TX1 (A+B)+mancozeb (D), fenamidone (C)+TX1 (A+B)+mancozeb (D), fenoxanil (C)+TX1 (A+B)+mancozeb (D), ferimzone (C)+TX1 (A+B)+mancozeb (D), fluazinam (C)+TX1 (A+B)+mancozeb (D), flumetylsulforim (C)+TX1 (A+B)+mancozeb (D), fluopicolide (C)+TX1 (A+B)+mancozeb (D), fluoxytioconazole (C)+TX1 (A+B)+mancozeb (D), flusulfamide (C)+TX1 (A+B)+mancozeb (D), fluxapyroxad (C)+TX1 (A+B)+mancozeb (D), fenhexamid (C)+TX1 (A+B)+mancozeb (D), fosetyl-aluminium (C)+TX1 (A+B)+mancozeb (D), hymexazol (C)+TX1 (A+B)+mancozeb (D), iprovalicarb (C)+TX1 (A+B)+mancozeb (D), cyazofamid (C)+TX1 (A+B)+mancozeb (D), methasulfocarb (C)+TX1 (A+B)+mancozeb (D), metrafenone (C)+TX1 (A+B)+mancozeb (D), pencycuron (C)+TX1 (A+B)+mancozeb (D), phthalide (C)+TX1 (A+B)+mancozeb (D), polyoxins (C)+TX1 (A+B)+mancozeb (D), propamocarb (C)+TX1 (A+B)+mancozeb (D), pyribencarb (C)+TX1 (A+B)+mancozeb (D), proquinazid (C)+TX1 (A+B)+mancozeb (D), pyroquilon (C)+TX1 (A+B)+mancozeb (D), pyriofenone (C)+TX1 (A+B)+mancozeb (D), quinoxyfen (C)+TX1 (A+B)+mancozeb (D), quintozene (C)+TX1 (A+B)+mancozeb (D), tiadinil (C)+TX1 (A+B)+mancozeb (D), triazoxide (C)+TX1 (A+B)+mancozeb (D), tricyclazole (C)+TX1 (A+B)+mancozeb (D), triforine (C)+TX1 (A+B)+mancozeb (D), validamycin (C)+TX1 (A+B)+mancozeb (D), valifenalate (C)+TX1 (A+B)+mancozeb (D), silthiofam (C)+TX1 (A+B)+mancozeb (D), zoxamide (C)+TX1 (A+B)+mancozeb (D), mandipropamid (C)+TX1 (A+B)+mancozeb (D), flubeneteram (C)+TX1 (A+B)+mancozeb (D), isopyrazam (C)+TX1 (A+B)+mancozeb (D), sedaxane (C)+TX1 (A+B)+mancozeb (D), benzovindiflupyr (C)+TX1 (A+B)+mancozeb (D), pydiflumetofen (C)+TX1 (A+B)+mancozeb (D), 3-difluoromethyl-1-methyl-1H-pyrazole-4-carboxylic acid (3′,4′,5′-trifluoro-biphenyl-2-yl)-amide (C)+TX1 (A+B)+mancozeb (D), isoflucypram (C)+TX1 (A+B)+mancozeb (D), isotianil (C)+TX1 (A+B)+mancozeb (D), dipymetitrone (C)+TX1 (A+B)+mancozeb (D), 6-ethyl-5,7-dioxo-pyrrolo[4,5][1,4]dithiino[1,2-c]isothiazole-3-carbonitrile (C)+TX1 (A+B)+mancozeb (D), 2-(difluoromethyl)-N-[3-ethyl-1,1-dimethyl-indan-4-yl]pyridine-3-carboxamide (C)+TX1 (A+B)+mancozeb (D), 4-(2,6-difluorophenyl)-6-methyl-5-phenyl-pyridazine-3-carbonitrile (C)+TX1 (A+B)+mancozeb (D), (R)-3-(difluoromethyl)-1-methyl-N-[1,1,3-trimethylindan-4-yl]pyrazole-4-carboxamide (C)+TX1 (A+B)+mancozeb (D), 4-(2-bromo-4-fluoro-phenyl)-N-(2-chloro-6-fluoro-phenyl)-2,5-dimethyl-pyrazol-3-amine (C)+TX1 (A+B)+mancozeb (D), 4-(2-bromo-4-fluorophenyl) N-(2-chloro-6-fluorophenyl)-1, 3-dimethyl-1H-pyrazol-5-amine (C)+TX1 (A+B)+mancozeb (D), fluindapyr (C)+TX1 (A+B)+mancozeb (D), coumethoxystrobin (jiaxiangjunzhi) (C)+TX1 (A+B)+mancozeb (D), Ivbenmixianan (C)+TX1 (A+B)+mancozeb (D), dichlobentiazox (C)+TX1 (A+B)+mancozeb (D), mandestrobin (C)+TX1 (A+B)+mancozeb (D), 3-(4,4-difluoro-3,4-dihydro-3,3-dimethylisoquinolin-1-yl)quinolone (C)+TX1 (A+B)+mancozeb (D), 2-[2-fluoro-6-[(8-fluoro-2-methyl-3-quinolyl)oxy]phenyl]propan-2-ol (C)+TX1 (A+B)+mancozeb (D), oxathiapiprolin (C)+TX1 (A+B)+mancozeb (D), tert-butyl N-[6-[[[(1-methyltetrazol-5-yl)-phenyl-methylene]amino]oxymethyl]-2-pyridyl]carbamate (C)+TX1 (A+B)+mancozeb (D), pyraziflumid (C)+TX1 (A+B)+mancozeb (D), inpyrfluxam (C)+TX1 (A+B)+mancozeb (D), trolprocarb (C)+TX1 (A+B)+mancozeb (D), mefentrifluconazole (C)+TX1 (A+B)+mancozeb (D), ipfentrifluconazole(C)+TX1 (A+B)+mancozeb (D), 2-(difluoromethyl)-N-[(3R)-3-ethyl-1,1-dimethyl-indan-4-yl]pyridine-3-carboxamide (C)+TX1 (A+B)+mancozeb (D), N′-(2,5-dimethyl-4-phenoxy-phenyl)-N-ethyl-N-methyl-formamidine (C)+TX1 (A+B)+mancozeb (D), N′-[4-(4,5-dichlorothiazol-2-yl)oxy-2,5-dimethyl-phenyl]-N-ethyl-N-methyl-formamidine (C)+TX1 (A+B)+mancozeb (D), [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl]methanesulfonate (C)+TX1 (A+B)+mancozeb (D), but-3-ynyl N-[6-[[(Z)-[(1-methyltetrazol-5-yl)-phenyl-methylene]amino]oxymethyl]-2-pyridyl]carbamate (C)+TX1 (A+B)+mancozeb (D), methyl N-[[5-[4-(2,4-dimethylphenyl)triazol-2-yl]-2-methyl-phenyl]methyl]carbamate (C)+TX1 (A+B)+mancozeb (D), 3-chloro-6-methyl-5-phenyl-4-(2,4,6-trifluorophenyl)pyridazine (C)+TX1 (A+B)+mancozeb (D), pyridachlometyl (C)+TX1 (A+B)+mancozeb (D), 3-(difluoromethyl)-1-methyl-N-[1,1,3-trimethylindan-4-yl]pyrazole-4-carboxamide (C)+TX1 (A+B)+mancozeb (D), 1-[2-[[1-(4-chlorophenyl)pyrazol-3-yl]oxymethyl]-3-methyl-phenyl]-4-methyl-tetrazol-5-one (C)+TX1 (A+B)+mancozeb (D), 1-methyl-4-[3-methyl-2-[[2-methyl-4-(3,4,5-trimethylpyrazol-1-yl)phenoxy]methyl]phenyl]tetrazol-5-one (C)+TX1 (A+B)+mancozeb (D), aminopyrifen (C)+TX1 (A+B)+mancozeb (D), ametoctradin (C)+TX1 (A+B)+mancozeb (D), amisulbrom (C)+TX1 (A+B)+mancozeb (D), penflufen (C)+TX1 (A+B)+mancozeb (D), (Z,2E)-5-[1-(4-chlorophenyl)pyrazol-3-yl]oxy-2-methoxyimino-N,3-dimethyl-pent-3-enamide (C)+TX1 (A+B)+mancozeb (D), florylpicoxamid (C)+TX1 (A+B)+mancozeb (D), fenpicoxamid (C)+TX1 (A+B)+mancozeb (D), metarylpicoxamid (C)+TX1 (A+B)+mancozeb (D), tebufloquin (C)+TX1 (A+B)+mancozeb (D), ipflufenoquin (C)+TX1 (A+B)+mancozeb (D), quinofumelin (C)+TX1 (A+B)+mancozeb (D), isofetamid (C)+TX1 (A+B)+mancozeb (D), ethyl 1-[[4-[[2-(trifluoromethyl)-1,3-dioxolan-2-yl]methoxy]phenyl]methyl]pyrazole-3-carboxylate (C)+TX1 (A+B)+mancozeb (D) (may be prepared from the methods described in WO 2020/056090), ethyl 1-[[4-[(Z)-2-ethoxy-3,3,3-trifluoro-prop-1-enoxy]phenyl]methyl]pyrazole-3-carboxylate (C)+TX1 (A+B)+mancozeb (D) (may be prepared from the methods described in WO 2020/056090), methyl N-[[4-[1-(4-cyclopropyl-2,6-difluoro-phenyl)pyrazol-4-yl]-2-methyl-phenyl]methyl]carbamate (C)+TX1 (A+B)+mancozeb (D) (may be prepared from the methods described in WO 2020/097012), methyl N-[[4-[1-(2,6-difluoro-4-isopropyl-phenyl)pyrazol-4-yl]-2-methyl-phenyl]methyl]carbamate (C)+TX1 (A+B)+mancozeb (D) (may be prepared from the methods described in WO 2020/097012), 6-chloro-3-(3-cyclopropyl-2-fluoro-phenoxy)-N-[2-(2,4-dimethylphenyl)-2,2-difluoro-ethyl]-5-methyl-pyridazine-4-carboxamide (C)+TX1 (A+B)+mancozeb (D) (may be prepared from the methods described in WO 2020/109391), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide (C)+TX1 (A+B)+mancozeb (D) (may be prepared from the methods described in WO 2020/109391), 6-chloro-3-(3-cyclopropyl-2-fluoro-phenoxy)-N-[2-(3,4-dimethylphenyl)-2,2-difluoro-ethyl]-5-methyl-pyridazine-4-carboxamide (C)+TX1 (A+B)+mancozeb (D) (may be prepared from the methods described in WO 2020/109391), N-[2-[2,4-dichloro-phenoxy]phenyl]-3-(difluoromethyl)-1-methyl-pyrazole-4-carboxamide (C)+TX1 (A+B)+mancozeb (D), N-[2-[2-chloro-4-(trifluoromethyl)phenoxy]phenyl]-3-(difluoromethyl)-1-methyl-pyrazole-4-carboxamide (C)+TX1 (A+B)+mancozeb (D), benzothiostrobin (C)+TX1 (A+B)+mancozeb (D), phenamacril (C)+TX1 (A+B)+mancozeb (D), 5-amino-1,3,4-thiadiazole-2-thiol zinc salt (2:1) (C)+TX1 (A+B)+mancozeb (D), fluopyram (C)+TX1 (A+B)+mancozeb (D), flufenoxadiazam (C)+TX1 (A+B)+mancozeb (D), flutianil (C)+TX1 (A+B)+mancozeb (D), fluopimomide (C)+TX1 (A+B)+mancozeb (D), pyrapropoyne (C)+TX1 (A+B)+mancozeb (D), picarbutrazox (C)+TX1 (A+B)+mancozeb (D), 2-(difluoromethyl)-N-(3-ethyl-1,1-dimethyl-indan-4-yl)pyridine-3-carboxamide (C)+TX1 (A+B)+mancozeb (D), 2-(difluoromethyl)-N-((3R)-1, 1, 3-trimethylindan-4-yl) pyridine-3-carboxamide (C)+TX1 (A+B)+mancozeb (D), 4-[[6-[2-(2,4-difluorophenyl)-1,1-difluoro-2-hydroxy-3-(1,2,4-triazol-1-yl)propyl]-3-pyridyl]oxy]benzonitrile (C)+TX1 (A+B)+mancozeb (D), metyltetraprole (C)+TX1 (A+B)+mancozeb (D), 2-(difluoromethyl)-N-((3R)-1, 1, 3-trimethylindan-4-yl) pyridine-3-carboxamide (C)+TX1 (A+B)+mancozeb (0), α-(1, 1-dimethylethyl)-α-[4′-(trifluoromethoxy) [1, 1′-biphenyl]-4-yl]-5-pyrimidinemethanol (C)+TX1 (A+B)+mancozeb (0), fluoxapiprolin (C)+TX1 (A+B)+mancozeb (D), enoxastrobin (C)+TX1 (A+B)+mancozeb (D), 4-[[6-[2-(2,4-difluorophenyl)-1,1-difluoro-2-hydroxy-3-(1,2,4-triazol-1-yl)propyl]-3-pyridyl]oxy]benzonitrile (C)+TX1 (A+B)+mancozeb (D), 4-[[6-[2-(2,4-difluorophenyl)-1,1-difluoro-2-hydroxy-3-(5-sulfanyl-1,2,4-triazol-1-yl)propyl]-3-pyridyl]oxy]benzonitrile (C)+TX1 (A+B)+mancozeb (D), 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile (C)+TX1 (A+B)+mancozeb (D), trinexapac (C)+TX1 (A+B)+mancozeb (D), coumoxystrobin (C)+TX1 (A+B)+mancozeb (D), zhongshengmycin (C)+TX1 (A+B)+mancozeb (D), thiodiazole copper (C)+TX1 (A+B)+mancozeb (D), zinc thiazole (C)+TX1 (A+B)+mancozeb (D), amectotractin (C)+TX1 (A+B)+mancozeb (D), iprodione (C)+TX1 (A+B)+mancozeb (D), seboctylamine (C)+TX1 (A+B)+mancozeb (D); N′-[5-bromo-2-methyl-6-[(1S)-1-methyl-2-propoxy-ethoxy]-3-pyridyl]-N-ethyl-N-methyl-formamidine (C)+TX1 (A+B)+mancozeb (D), N′-[5-bromo-2-methyl-6-[(1R)-1-methyl-2-propoxy-ethoxy]-3-pyridyl]-N-ethyl-N-methyl-formamidine (C)+TX1 (A+B)+mancozeb (D), N′-[5-bromo-2-methyl-6-(1-methyl-2-propoxy-ethoxy)-3-pyridyl]-N-ethyl-N-methyl-formamidine (C)+TX1 (A+B)+mancozeb (D), N′-[5-chloro-2-methyl-6-(1-methyl-2-propoxy-ethoxy)-3-pyridyl]-N-ethyl-N-methyl-formamidine (C)+TX1 (A+B)+mancozeb (D), N′-[5-bromo-2-methyl-6-(1-methyl-2-propoxy-ethoxy)-3-pyridyl]-N-isopropyl-N-methyl-formamidine (C)+TX1 (A+B)+mancozeb (D) (these compounds may be prepared from the methods described in WO2015/155075); N′-[5-bromo-2-methyl-6-(2-propoxypropoxy)-3-pyridyl]-N-ethyl-N-methyl-formamidine (C)+TX1 (A+B)+mancozeb (D) (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine(C)+TX1 (A+B)+mancozeb (D), N′-[4-(1-cyclopropyl-2,2,2-trifluoro-1-hydroxy-ethyl)-5-methoxy-2-methyl-phenyl]-N-isopropyl-N-methyl-formamidine (C)+TX1 (A+B)+mancozeb (D) (these compounds may be prepared from the methods described in WO2018/228896); N-ethyl-N′-[5-methoxy-2-methyl-4-[(2-trifluoromethyl)oxetan-2-yl]phenyl]-N-methyl-formamidine (C)+TX1 (A+B)+mancozeb (D), N-ethyl-N′-[5-methoxy-2-methyl-4-[(2-trifuoromethyl)tetrahydrofuran-2-yl]phenyl]-N-methyl-formamidine (C)+TX1 (A+B)+mancozeb (D) (these compounds may be prepared from the methods described in WO2019/110427); N-[(1R)-1-benzyl-3-chloro-1-methyl-but-3-enyl]-8-fluoro-quinoline-3-carboxamide (C)+TX1 (A+B)+mancozeb (D), N-[(1S)-1-benzyl-3-chloro-1-methyl-but-3-enyl]-8-fluoro-quinoline-3-carboxamide (C)+TX1 (A+B)+mancozeb (D), N-[(1R)-1-benzyl-3,3,3-trifluoro-1-methyl-propyl]-8-fluoro-quinoline-3-carboxamide (C)+TX1 (A+B)+mancozeb (D), N-[(1S)-1-benzyl-3,3,3-trifluoro-1-methyl-propyl]-8-fluoro-quinoline-3-carboxamide (C)+TX1 (A+B)+mancozeb (D), N-[(1R)-1-benzyl-1,3-dimethyl-butyl]-7,8-difluoro-quinoline-3-carboxamide (C)+TX1 (A+B)+mancozeb (D), N-[(1S)-1-benzyl-1,3-dimethyl-butyl]-7,8-difluoro-quinoline-3-carboxamide (C)+TX1 (A+B)+mancozeb (D), 8-fluoro-N-[(1R)-1-[(3-fluorophenyl)methyl]-1,3-dimethyl-butyl]quinoline-3-carboxamide (C)+TX1 (A+B)+mancozeb (D), 8-fluoro-N-[(1S)-1-[(3-fluorophenyl)methyl]-1,3-dimethyl-butyl]quinoline-3-carboxamide (C)+TX1 (A+B)+mancozeb (D), N-[(1R)-1-benzyl-1,3-dimethyl-butyl]-8-fluoro-quinoline-3-carboxamide (C)+TX1 (A+B)+mancozeb (D), N-[(1S)-1-benzyl-1,3-dimethyl-butyl]-8-fluoro-quinoline-3-carboxamide (C)+TX1 (A+B)+mancozeb (D), N-((1R)-1-benzyl-3-chloro-1-methyl-but-3-enyl)-8-fluoro-quinoline-3-carboxamide (C)+TX1 (A+B)+mancozeb (D), N-((1S)-1-benzyl-3-chloro-1-methyl-but-3-enyl)-8-fluoro-quinoline-3-carboxamide (C)+TX1 (A+B)+mancozeb (D) (these compounds may be prepared from the methods described in WO2017/153380); 1-(6,7-dimethylpyrazolo[1,5-a]pyridin-3-yl)-4,4,5-trifluoro-3,3-dimethyl-isoquinoline (C)+TX1 (A+B)+mancozeb (D), 1-(6,7-dimethylpyrazolo[1,5-a]pyridin-3-yl)-4,4,6-trifluoro-3,3-dimethyl-isoquinoline (C)+TX1 (A+B)+mancozeb (D), 4,4-difluoro-3,3-dimethyl-1-(6-methylpyrazolo[1,5-a]pyridin-3-yl)isoquinoline (C)+TX1 (A+B)+mancozeb (D), 4,4-difluoro-3,3-dimethyl-1-(7-methylpyrazolo[1,5-a]pyridin-3-yl)isoquinoline (C)+TX1 (A+B)+mancozeb (D), 1-(6-chloro-7-methyl-pyrazolo[1,5-a]pyridin-3-yl)-4,4-difluoro-3,3-dimethyl-isoquinoline (C)+TX1 (A+B)+mancozeb (D) (these compounds may be prepared from the methods described in WO2017/025510); 1-(4,5-dimethylbenzimidazol-1-yl)-4,4,5-trifluoro-3,3-dimethyl-isoquinoline (C)+TX1 (A+B)+mancozeb (D), 1-(4,5-dimethylbenzimidazol-1-yl)-4,4-difluoro-3,3-dimethyl-isoquinoline (C)+TX1 (A+B)+mancozeb (D), 6-chloro-4,4-difluoro-3,3-dimethyl-1-(4-methylbenzimidazol-1-yl)isoquinoline (C)+TX1 (A+B)+mancozeb (D), 4,4-difluoro-1-(5-fluoro-4-methyl-benzimidazol-1-yl)-3,3-dimethyl-isoquinoline (C)+TX1 (A+B)+mancozeb (D), 3-(4,4-difluoro-3,3-dimethyl-1-isoquinolyl)-7,8-dihydro-6H-cyclopenta[e]benzimidazole (C)+TX1 (A+B)+mancozeb (D) (these compounds may be prepared from the methods described in WO2016/156085); N-methoxy-N-[[4-[5-(trifluoromethyl)-1,2,4-oxadiazol-3-yl]phenyl]methyl]cyclopropanecarboxamide (C)+TX1 (A+B)+mancozeb (D), N,2-dimethoxy-N-[[4-[5-(trifluoromethyl)-1,2,4-oxadiazol-3-yl]phenyl]methyl]propanamide (C)+TX1 (A+B)+mancozeb (D), N-ethyl-2-methyl-N-[[4-[5-(trifluoromethyl)-1,2,4-oxadiazol-3-yl]phenyl]methyl]propanamide (C)+TX1 (A+B)+mancozeb (D), 1-methoxy-3-methyl-1-[[4-[5-(trifluoromethyl)-1,2,4-oxadiazol-3-yl]phenyl]methyl]urea (C)+TX1 (A+B)+mancozeb (D), 1,3-dimethoxy-1-[[4-[5-(trifluoromethyl)-1,2,4-oxadiazol-3-yl]phenyl]methyl]urea (C)+TX1 (A+B)+mancozeb (D), 3-ethyl-1-methoxy-1-[[4-[5-(trifluoromethyl)-1,2,4-oxadiazol-3-yl]phenyl]methyl]urea (C)+TX1 (A+B)+mancozeb (D), N-[[4-[5-(trifluoromethyl)-1,2,4-oxadiazol-3-yl]phenyl]methyl]propanamide (C)+TX1 (A+B)+mancozeb (D), 4,4-dimethyl-2-[[4-[5-(trifluoromethyl)-1,2,4-oxadiazol-3-yl]phenyl]methyl]isoxazolidin-3-one (C)+TX1 (A+B)+mancozeb (D), 5,5-dimethyl-2-[[4-[5-(trifluoromethyl)-1,2,4-oxadiazol-3-yl]phenyl]methyl]isoxazolidin-3-one (C)+TX1 (A+B)+mancozeb (D), ethyl 1-[[4-[5-(trifluoromethyl)-1,2,4-oxadiazol-3-yl]phenyl]methyl]pyrazole-4-carboxylate (C)+TX1 (A+B)+mancozeb (D), N,N-dimethyl-1-[[4-[5-(trifluoromethyl)-1,2,4-oxadiazol-3-yl]phenyl]methyl]-1,2,4-triazol-3-amine (C)+TX1 (A+B)+mancozeb (D). The compounds in this paragraph may be prepared from the methods described in WO 2017/055473, WO 2017/055469, WO 2017/093348 and WO 2017/118689; 2-[6-(4-chlorophenoxy)-2-(trifluoromethyl)-3-pyridyl]-1-(1,2,4-triazol-1-yl)propan-2-ol (C)+TX1 (A+B)+mancozeb (D) (this compound may be prepared from the methods described in WO 2017/029179); 2-[6-(4-bromophenoxy)-2-(trifluoromethyl)-3-pyridyl]-1-(1,2,4-triazol-1-yl)propan-2-ol (C)+TX1 (A+B)+mancozeb (D) (this compound may be prepared from the methods described in WO 2017/029179); 3-[2-(1-chlorocyclopropyl)-3-(2-fluorophenyl)-2-hydroxy-propyl]imidazole-4-carbonitrile (C)+TX1 (A+B)+mancozeb (D) (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile (C)+TX1 (A+B)+mancozeb (D) (this compound may be prepared from the methods described in WO 2016/156290); (4-phenoxyphenyl)methyl 2-amino-6-methyl-pyridine-3-carboxylate (C)+TX1 (A+B)+mancozeb (D) (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone (C)+TX1 (A+B)+mancozeb (D) (this compound may be prepared from the methods described in WO 2011/138281); N-methyl-4-[5-(trifluoromethyl)-1,2,4-oxadiazol-3-yl]benzenecarbothioamide (C)+TX1 (A+B)+mancozeb (D); N-methyl-4-[5-(trifluoromethyl)-1,2,4-oxadiazol-3-yl]benzamide (C)+TX1 (A+B)+mancozeb (D); (Z,2E)-5-[1-(2,4-dichlorophenyl)pyrazol-3-yl]oxy-2-methoxyimino-N,3-dimethyl-pent-3-enamide (C)+TX1 (A+B)+mancozeb (D) (this compound may be prepared from the methods described in WO 2018/153707); N′-(2-chloro-5-methyl-4-phenoxy-phenyl)-N-ethyl-N-methyl-formamidine (C)+TX1 (A+B)+mancozeb (D); N′-[2-chloro-4-(2-fluorophenoxy)-5-methyl-phenyl]-N-ethyl-N-methyl-formamidine (C)+TX1 (A+B)+mancozeb (D) (this compound may be prepared from the methods described in WO 2016/202742); 2-(difluoromethyl)-N-[(3S)-3-ethyl-1,1-dimethyl-indan-4-yl]pyridine-3-carboxamide (C)+TX1 (A+B)+mancozeb (D) (this compound may be prepared from the methods described in WO 2014/095675); (5-methyl-2-pyridyl)-[4-[5-(trifluoromethyl)-1,2,4-oxadiazol-3-yl]phenyl]methanone (C)+TX1 (A+B)+mancozeb (D), (3-methylisoxazol-5-yl)-[4-[5-(trifluoromethyl)-1,2,4-oxadiazol-3-yl]phenyl]methanone (C)+TX1 (A+B)+mancozeb (D) (these compounds may be prepared from the methods described in WO 2017/220485); 2-oxo-N-propyl-2-[4-[5-(trifluoromethyl)-1,2,4-oxadiazol-3-yl]phenyl]acetamide (C)+TX1 (A+B)+mancozeb (D) (this compound may be prepared from the methods described in WO 2018/065414); ethyl 1-[[5-[5-(trifluoromethyl)-1,2,4-oxadiazol-3-yl]-2-thienyl]methyl]pyrazole-4-carboxylate (C)+TX1 (A+B)+mancozeb (D) (this compound may be prepared from the methods described in WO 2018/158365); 2,2-difluoro-N-methyl-2-[4-[5-(trifluoromethyl)-1,2,4-oxadiazol-3-yl]phenyl]acetamide (C)+TX1 (A+B)+mancozeb (D), N-[(E)-methoxyiminomethyl]-4-[5-(trifluoromethyl)-1,2,4-oxadiazol-3-yl]benzamide (C)+TX1 (A+B)+mancozeb (D), N-[(Z)-methoxyiminomethyl]-4-[5-(trifluoromethyl)-1,2,4-oxadiazol-3-yl]benzamide (C)+TX1 (A+B)+mancozeb (D), N-[N-methoxy-C-methyl-carbonimidoyl]-4-[5-(trifluoromethyl)-1,2,4-oxadiazol-3-yl]benzamide (C)+TX1 (A+B)+mancozeb (D) (these compounds may be prepared from the methods described in WO 2018/202428).

Further examples of four-way mixture compositions according to the invention are as follows (wherein the nature of the component, for example component (A), component (B), component (C) or component (D) is indicated in parenthesis), wherein the term “TX1” represents a composition (according to the definition of component (A) and component (B) as defined in table N1 above) selected from the group consisting of N1.001 to N1.038 and N2.001 to N2.038, provided that the compositions wherein component (B) is identical to component (C) are excluded: a compound selected from the group of substances consisting of petroleum oils (C)+TX1 (A+B)+chlorothalonil (D), 1,1-bis(4-chlorophenyl)-2-ethoxyethanol (C)+TX1 (A+B)+chlorothalonil (D), 2,4-dichlorophenyl benzenesulfonate (C)+TX1 (A+B)+chlorothalonil (D), 2-fluoro-N-methyl-N-1-naphthylacetamide (C)+TX1 (A+B)+chlorothalonil (D), 4-chlorophenyl phenyl sulfone (C)+TX1 (A+B)+chlorothalonil (D), acetoprole (C)+TX1 (A+B)+chlorothalonil (D), aldoxycarb (C)+TX1 (A+B)+chlorothalonil (D), amidithion (C)+TX1 (A+B)+chlorothalonil (D), amidothioate (C)+TX1 (A+B)+chlorothalonil (D), amiton (C)+TX1 (A+B)+chlorothalonil (D), amiton hydrogen oxalate (C)+TX1 (A+B)+chlorothalonil (D), amitraz (C)+TX1 (A+B)+chlorothalonil (D), aramite (C)+TX1 (A+B)+chlorothalonil (D), arsenous oxide (C)+TX1 (A+B)+chlorothalonil (D), azobenzene (C)+TX1 (A+B)+chlorothalonil (D), azothoate (C)+TX1 (A+B)+chlorothalonil (D), benomyl (C)+TX1 (A+B)+chlorothalonil (D), benoxafos (C)+TX1 (A+B)+chlorothalonil (D), benzyl benzoate (C)+TX1 (A+B)+chlorothalonil (D), bixafen (C)+TX1 (A+B)+chlorothalonil (D), brofenvalerate (C)+TX1 (A+B)+chlorothalonil (D), bromocyclen (C)+TX1 (A+B)+chlorothalonil (D), bromophos (C)+TX1 (A+B)+chlorothalonil (D), bromopropylate (C)+TX1 (A+B)+chlorothalonil (D), buprofezin (C)+TX1 (A+B)+chlorothalonil (D), butocarboxim (C)+TX1 (A+B)+chlorothalonil (D), butoxycarboxim (C)+TX1 (A+B)+chlorothalonil (D), butylpyridaben (C)+TX1 (A+B)+chlorothalonil (D), calcium polysulfide (C)+TX1 (A+B)+chlorothalonil (D), camphechlor (C)+TX1 (A+B)+chlorothalonil (D), carbanolate (C)+TX1 (A+B)+chlorothalonil (D), carbophenothion (C)+TX1 (A+B)+chlorothalonil (D), cymiazole (C)+TX1 (A+B)+chlorothalonil (D), chinomethionat (C)+TX1 (A+B)+chlorothalonil (D), chlorbenside (C)+TX1 (A+B)+chlorothalonil (D), chlordimeform (C)+TX1 (A+B)+chlorothalonil (D), chlordimeform hydrochloride (C)+TX1 (A+B)+chlorothalonil (D), chlorfenethol (C)+TX1 (A+B)+chlorothalonil (D), chlorfenson (C)+TX1 (A+B)+chlorothalonil (D), chlorfensulfide (C)+TX1 (A+B)+chlorothalonil (D), chlorobenzilate (C)+TX1 (A+B)+chlorothalonil (D), chloromebuform (C)+TX1 (A+B)+chlorothalonil (D), chloromethiuron (C)+TX1 (A+B)+chlorothalonil (D), chloropropylate (C)+TX1 (A+B)+chlorothalonil (D), chlorthiophos (C)+TX1 (A+B)+chlorothalonil (D), cinerin I (C)+TX1 (A+B)+chlorothalonil (D), cinerin II (C)+TX1 (A+B)+chlorothalonil (D), cinerins (C)+TX1 (A+B)+chlorothalonil (D), closantel (C)+TX1 (A+B)+chlorothalonil (D), coumaphos (C)+TX1 (A+B)+chlorothalonil (D), crotamiton (C)+TX1 (A+B)+chlorothalonil (D), crotoxyphos (C)+TX1 (A+B)+chlorothalonil (D), cufraneb (C)+TX1 (A+B)+chlorothalonil (D), cyanthoate (C)+TX1 (A+B)+chlorothalonil (D), DCPM (C)+TX1 (A+B)+chlorothalonil (D), DDT (C)+TX1 (A+B)+chlorothalonil (D), demephion (C)+TX1 (A+B)+chlorothalonil (D), demephion-O (C)+TX1 (A+B)+chlorothalonil (D), demephion-S(C)+TX1 (A+B)+chlorothalonil (D), demeton-methyl (C)+TX1 (A+B)+chlorothalonil (D), demeton-O (C)+TX1 (A+B)+chlorothalonil (D), demeton-O-methyl (C)+TX1 (A+B)+chlorothalonil (D), demeton-S(C)+TX1 (A+B)+chlorothalonil (D), demeton-S-methyl (C)+TX1 (A+B)+chlorothalonil (D), demeton-S-methylsulfon (C)+TX1 (A+B)+chlorothalonil (D), dichlofluanid (C)+TX1 (A+B)+chlorothalonil (D), dichlorvos (C)+TX1 (A+B)+chlorothalonil (D), dicliphos (C)+TX1 (A+B)+chlorothalonil (D), dienochlor (C)+TX1 (A+B)+chlorothalonil (D), dimefox (C)+TX1 (A+B)+chlorothalonil (D), dinex (C)+TX1 (A+B)+chlorothalonil (D), dinex-diclexine (C)+TX1 (A+B)+chlorothalonil (D), dinocap-4 (C)+TX1 (A+B)+chlorothalonil (D), dinocap-6 (C)+TX1 (A+B)+chlorothalonil (D), dinocton (C)+TX1 (A+B)+chlorothalonil (D), dinopenton (C)+TX1 (A+B)+chlorothalonil (D), dinosulfon (C)+TX1 (A+B)+chlorothalonil (D), dinoterbon (C)+TX1 (A+B)+chlorothalonil (D), dioxathion (C)+TX1 (A+B)+chlorothalonil (D), diphenyl sulfone (C)+TX1 (A+B)+chlorothalonil (D), disulfiram (C)+TX1 (A+B)+chlorothalonil (D), DNOC (C)+TX1 (A+B)+chlorothalonil (D), dofenapyn (C)+TX1 (A+B)+chlorothalonil (D), doramectin (C)+TX1 (A+B)+chlorothalonil (D), endothion (C)+TX1 (A+B)+chlorothalonil (D), eprinomectin (C)+TX1 (A+B)+chlorothalonil (D), ethoate-methyl (C)+TX1 (A+B)+chlorothalonil (D), etrimfos (C)+TX1 (A+B)+chlorothalonil (D), fenazaflor (C)+TX1 (A+B)+chlorothalonil (D), fenbutatin oxide (C)+TX1 (A+B)+chlorothalonil (D), fenothiocarb (C)+TX1 (A+B)+chlorothalonil (D), fenpyrad (C)+TX1 (A+B)+chlorothalonil (D), fenpyroximate (C)+TX1 (A+B)+chlorothalonil (D), fenpyrazamine (C)+TX1 (A+B)+chlorothalonil (D), fenson (C)+TX1 (A+B)+chlorothalonil (D), fentrifanil (C)+TX1 (A+B)+chlorothalonil (D), flubenzimine (C)+TX1 (A+B)+chlorothalonil (D), flucycloxuron (C)+TX1 (A+B)+chlorothalonil (D), fluenetil (C)+TX1 (A+B)+chlorothalonil (D), fluorbenside (C)+TX1 (A+B)+chlorothalonil (D), FMC 1137 (C)+TX1 (A+B)+chlorothalonil (D), formetanate (C)+TX1 (A+B)+chlorothalonil (D), formetanate hydrochloride (C)+TX1 (A+B)+chlorothalonil (D), formparanate (C)+TX1 (A+B)+chlorothalonil (D), gamma-HCH (C)+TX1 (A+B)+chlorothalonil (D), glyodin (C)+TX1 (A+B)+chlorothalonil (D), halfenprox (C)+TX1 (A+B)+chlorothalonil (D), hexadecyl cyclopropanecarboxylate (C)+TX1 (A+B)+chlorothalonil (D), isocarbophos (C)+TX1 (A+B)+chlorothalonil (D), jasmolin I (C)+TX1 (A+B)+chlorothalonil (D), jasmolin 11 (C)+TX1 (A+B)+chlorothalonil (D), jodfenphos (C)+TX1 (A+B)+chlorothalonil (D), lindane (C)+TX1 (A+B)+chlorothalonil (D), malonoben (C)+TX1 (A+B)+chlorothalonil (D), mecarbam (C)+TX1 (A+B)+chlorothalonil (D), mephosfolan (C)+TX1 (A+B)+chlorothalonil (D), mesulfen (C)+TX1 (A+B)+chlorothalonil (D), methacrifos (C)+TX1 (A+B)+chlorothalonil (D), methyl bromide (C)+TX1 (A+B)+chlorothalonil (D), metolcarb (C)+TX1 (A+B)+chlorothalonil (D), mexacarbate (C)+TX1 (A+B)+chlorothalonil (D), milbemycin oxime (C)+TX1 (A+B)+chlorothalonil (D), mipafox (C)+TX1 (A+B)+chlorothalonil (D), monocrotophos (C)+TX1 (A+B)+chlorothalonil (D), morphothion (C)+TX1 (A+B)+chlorothalonil (D), moxidectin (C)+TX1 (A+B)+chlorothalonil (D), naled (C)+TX1 (A+B)+chlorothalonil (D), 4-chloro-2-(2-chloro-2-methyl-propyl)-5-[(6-iodo-3-pyridyl)methoxy]pyridazin-3-one (C)+TX1 (A+B)+chlorothalonil (D), nifluridide (C)+TX1 (A+B)+chlorothalonil (D), nikkomycins (C)+TX1 (A+B)+chlorothalonil (D), nitrilacarb (C)+TX1 (A+B)+chlorothalonil (D), nitrilacarb 1:1 zinc chloride complex (C)+TX1 (A+B)+chlorothalonil (D), omethoate (C)+TX1 (A+B)+chlorothalonil (D), oxydeprofos (C)+TX1 (A+B)+chlorothalonil (D), oxydisulfoton (C)+TX1 (A+B)+chlorothalonil (D), pp′-DDT (C)+TX1 (A+B)+chlorothalonil (D), parathion (C)+TX1 (A+B)+chlorothalonil (D), permethrin (C)+TX1 (A+B)+chlorothalonil (D), phenkapton (C)+TX1 (A+B)+chlorothalonil (D), phosalone (C)+TX1 (A+B)+chlorothalonil (D), phosfolan (C)+TX1 (A+B)+chlorothalonil (D), phosphamidon (C)+TX1 (A+B)+chlorothalonil (D), polychloroterpenes (C)+TX1 (A+B)+chlorothalonil (D), polynactins (C)+TX1 (A+B)+chlorothalonil (D), proclonol (C)+TX1 (A+B)+chlorothalonil (D), promacyl (C)+TX1 (A+B)+chlorothalonil (D), propoxur (C)+TX1 (A+B)+chlorothalonil (D), prothidathion (C)+TX1 (A+B)+chlorothalonil (D), prothoate (C)+TX1 (A+B)+chlorothalonil (D), pyrethrin I (C)+TX1 (A+B)+chlorothalonil (D), pyrethrin 11 (C)+TX1 (A+B)+chlorothalonil (D), pyrethrins (C)+TX1 (A+B)+chlorothalonil (D), pyridaphenthion (C)+TX1 (A+B)+chlorothalonil (D), pyrimitate (C)+TX1 (A+B)+chlorothalonil (D), quinalphos (C)+TX1 (A+B)+chlorothalonil (D), quintiofos (C)+TX1 (A+B)+chlorothalonil (D), R-1492 (C)+TX1 (A+B)+chlorothalonil (D), phosglycin (C)+TX1 (A+B)+chlorothalonil (D), rotenone (C)+TX1 (A+B)+chlorothalonil (D), schradan (C)+TX1 (A+B)+chlorothalonil (D), sebufos (C)+TX1 (A+B)+chlorothalonil (D), selamectin (C)+TX1 (A+B)+chlorothalonil (D), sophamide (C)+TX1 (A+B)+chlorothalonil (D), SSI-121 (C)+TX1 (A+B)+chlorothalonil (D), sulfiram (C)+TX1 (A+B)+chlorothalonil (D), sulfluramid (C)+TX1 (A+B)+chlorothalonil (D), sulfotep (C)+TX1 (A+B)+chlorothalonil (D), sulfur (C)+TX1 (A+B)+chlorothalonil (D), diflovidazin (C)+TX1 (A+B)+chlorothalonil (D), tau-fluvalinate (C)+TX1 (A+B)+chlorothalonil (D), TEPP (C)+TX1 (A+B)+chlorothalonil (D), terbam (C)+TX1 (A+B)+chlorothalonil (D), tetradifon (C)+TX1 (A+B)+chlorothalonil (D), tetrasul (C)+TX1 (A+B)+chlorothalonil (D), thiafenox (C)+TX1 (A+B)+chlorothalonil (D), thiocarboxime (C)+TX1 (A+B)+chlorothalonil (D), thiofanox (C)+TX1 (A+B)+chlorothalonil (D), thiometon (C)+TX1 (A+B)+chlorothalonil (D), thioquinox (C)+TX1 (A+B)+chlorothalonil (D), thuringiensin (C)+TX1 (A+B)+chlorothalonil (D), triamiphos (C)+TX1 (A+B)+chlorothalonil (D), triarathene (C)+TX1 (A+B)+chlorothalonil (D), triazophos (C)+TX1 (A+B)+chlorothalonil (D), triazuron (C)+TX1 (A+B)+chlorothalonil (D), trifenofos (C)+TX1 (A+B)+chlorothalonil (D), trinactin (C)+TX1 (A+B)+chlorothalonil (D), vamidothion (C)+TX1 (A+B)+chlorothalonil (D), vaniliprole (C)+TX1 (A+B)+chlorothalonil (D), bethoxazin (C)+TX1 (A+B)+chlorothalonil (D), copper dioctanoate (C)+TX1 (A+B)+chlorothalonil (D), copper sulfate (C)+TX1 (A+B)+chlorothalonil (D), cybutryne (C)+TX1 (A+B)+chlorothalonil (D), dichlone (C)+TX1 (A+B)+chlorothalonil (D), dichlorophen (C)+TX1 (A+B)+chlorothalonil (D), endothal (C)+TX1 (A+B)+chlorothalonil (D), fentin (C)+TX1 (A+B)+chlorothalonil (D), hydrated lime (C)+TX1 (A+B)+chlorothalonil (D), nabam (C)+TX1 (A+B)+chlorothalonil (D), quinoclamine (C)+TX1 (A+B)+chlorothalonil (D), quinonamid (C)+TX1 (A+B)+chlorothalonil (D), simazine (C)+TX1 (A+B)+chlorothalonil (D), triphenyltin acetate (C)+TX1 (A+B)+chlorothalonil (D), triphenyltin hydroxide (C)+TX1 (A+B)+chlorothalonil (D), crufomate (C)+TX1 (A+B)+chlorothalonil (D), piperazine (C)+TX1 (A+B)+chlorothalonil (D), thiophanate (C)+TX1 (A+B)+chlorothalonil (D), chloralose (C)+TX1 (A+B)+chlorothalonil (D), fenthion (C)+TX1 (A+B)+chlorothalonil (D), pyridin-4-amine (C)+TX1 (A+B)+chlorothalonil (D), strychnine (C)+TX1 (A+B)+chlorothalonil (D), 1-hydroxy-1H-pyridine-2-thione (C)+TX1 (A+B)+chlorothalonil (D), 4-(quinoxalin-2-ylamino)benzenesulfonamide (C)+TX1 (A+B)+chlorothalonil (D), 8-hydroxyquinoline sulfate (C)+TX1 (A+B)+chlorothalonil (D), bronopol (C)+TX1 (A+B)+chlorothalonil (D), copper hydroxide (C)+TX1 (A+B)+chlorothalonil (D), cresol (C)+TX1 (A+B)+chlorothalonil (D), dipyrithione (C)+TX1 (A+B)+chlorothalonil (D), dodicin (C)+TX1 (A+B)+chlorothalonil (D), fenaminosulf (C)+TX1 (A+B)+chlorothalonil (D), formaldehyde (C)+TX1 (A+B)+chlorothalonil (D), hydrargaphen (C)+TX1 (A+B)+chlorothalonil (D), kasugamycin (C)+TX1 (A+B)+chlorothalonil (D), kasugamycin hydrochloride hydrate (C)+TX1 (A+B)+chlorothalonil (D), nickel bis(dimethyldithiocarbamate) (C)+TX1 (A+B)+chlorothalonil (D), nitrapyrin (C)+TX1 (A+B)+chlorothalonil (D), octhilinone (C)+TX1 (A+B)+chlorothalonil (D), oxolinic acid (C)+TX1 (A+B)+chlorothalonil (D), oxytetracycline (C)+TX1 (A+B)+chlorothalonil (D), potassium hydroxyquinoline sulfate (C)+TX1 (A+B)+chlorothalonil (D), probenazole (C)+TX1 (A+B)+chlorothalonil (D), streptomycin (C)+TX1 (A+B)+chlorothalonil (D), streptomycin sesquisulfate (C)+TX1 (A+B)+chlorothalonil (D), tecloftalam (C)+TX1 (A+B)+chlorothalonil (D), thiomersal (C)+TX1 (A+B)+chlorothalonil (D), Adoxophyes orana GV (C)+TX1 (A+B)+chlorothalonil (D), Agrobacterium radiobacter (C)+TX1 (A+B)+chlorothalonil (D), Amblyseius spp. (C)+TX1 (A+B)+chlorothalonil (D), Anagrapha falcifera NPV (C)+TX1 (A+B)+chlorothalonil (D), Anagrus atomus (C)+TX1 (A+B)+chlorothalonil (D), Aphelinus abdominalis (C)+TX1 (A+B)+chlorothalonil (D), Aphidius colemani (C)+TX1 (A+B)+chlorothalonil (D), Aphidoletes aphidimyza (C)+TX1 (A+B)+chlorothalonil (D), Autographa californica NPV (C)+TX1 (A+B)+chlorothalonil (D), Bacillus sphaericus Neide (C)+TX1 (A+B)+chlorothalonil (D), Beauveria brongniartii (C)+TX1 (A+B)+chlorothalonil (D), Chrysoperla carnea (C)+TX1 (A+B)+chlorothalonil (D), Cryptolaemus montrouzieri (C)+TX1 (A+B)+chlorothalonil (D), Cydia pomonella GV (C)+TX1 (A+B)+chlorothalonil (D), Dacnusa sibirica (C)+TX1 (A+B)+chlorothalonil (D), Diglyphus isaea (C)+TX1 (A+B)+chlorothalonil (D), Encarsia formosa (C)+TX1 (A+B)+chlorothalonil (D), Eretmocerus eremicus (C)+TX1 (A+B)+chlorothalonil (D), Heterorhabditis bacteriophora and H. megidis (C)+TX1 (A+B)+chlorothalonil (D), Hippodamia convergens (C)+TX1 (A+B)+chlorothalonil (D), Leptomastix dactylopii (C)+TX1 (A+B)+chlorothalonil (D), Macrolophus caliginosus (C)+TX1 (A+B)+chlorothalonil (D), Mamestra brassicae NPV (C)+TX1 (A+B)+chlorothalonil (D), Metaphycus helvolus (C)+TX1 (A+B)+chlorothalonil (D), Metarhizium anisopliae var. acridum (C)+TX1 (A+B)+chlorothalonil (D), Metarhizium anisopliae var. anisopliae (C)+TX1 (A+B)+chlorothalonil (D), Neodiprion sertifer NPV and N. lecontei NPV (C)+TX1 (A+B)+chlorothalonil (D), Orius spp. (C)+TX1 (A+B)+chlorothalonil (D), Paecilomyces fumosoroseus (C)+TX1 (A+B)+chlorothalonil (D), Phytoseiulus persimilis (C)+TX1 (A+B)+chlorothalonil (D), Steinernema bibionis (C)+TX1 (A+B)+chlorothalonil (D), Steinernema carpocapsae (C)+TX1 (A+B)+chlorothalonil (D), Steinernema feltiae (C)+TX1 (A+B)+chlorothalonil (D), Steinernema glaseri (C)+TX1 (A+B)+chlorothalonil (D), Steinernema riobrave (C)+TX1 (A+B)+chlorothalonil (D), Steinernema riobravis (C)+TX1 (A+B)+chlorothalonil (D), Steinernema scapterisci (C)+TX1 (A+B)+chlorothalonil (D), Steinernema spp. (C)+TX1 (A+B)+chlorothalonil (D), Trichogramma spp. (C)+TX1 (A+B)+chlorothalonil (D), Typhlodromus occidentalis (C)+TX1 (A+B)+chlorothalonil (D), Verticillium lecanii (C)+TX1 (A+B)+chlorothalonil (D), apholate (C)+TX1 (A+B)+chlorothalonil (D), bisazir (C)+TX1 (A+B)+chlorothalonil (D), busulfan (C)+TX1 (A+B)+chlorothalonil (D), dimatif (C)+TX1 (A+B)+chlorothalonil (D), hemel (C)+TX1 (A+B)+chlorothalonil (D), hempa (C)+TX1 (A+B)+chlorothalonil (D), metepa (C)+TX1 (A+B)+chlorothalonil (D), methiotepa (C)+TX1 (A+B)+chlorothalonil (D), methyl apholate (C)+TX1 (A+B)+chlorothalonil (D), morzid (C)+TX1 (A+B)+chlorothalonil (D), penfluron (C)+TX1 (A+B)+chlorothalonil (D), tepa (C)+TX1 (A+B)+chlorothalonil (D), thiohempa (C)+TX1 (A+B)+chlorothalonil (D), thiotepa (C)+TX1 (A+B)+chlorothalonil (D), tretamine (C)+TX1 (A+B)+chlorothalonil (D), uredepa (C)+TX1 (A+B)+chlorothalonil (D), (E)-dec-5-en-1-yl acetate with (E)-dec-5-en-1-ol (C)+TX1 (A+B)+chlorothalonil (D), (E)-tridec-4-en-1-yl acetate (C)+TX1 (A+B)+chlorothalonil (D), (E)-6-methylhept-2-en-4-ol (C)+TX1 (A+B)+chlorothalonil (D), (E,Z)-tetradeca-4,10-dien-1-yl acetate (C)+TX1 (A+B)+chlorothalonil (D), (Z)-dodec-7-en-1-yl acetate (C)+TX1 (A+B)+chlorothalonil (D), (Z)-hexadec-11-enal (C)+TX1 (A+B)+chlorothalonil (D), (Z)-hexadec-11-en-1-yl acetate (C)+TX1 (A+B)+chlorothalonil (D), (Z)-hexadec-13-en-11-yn-1-yl acetate (C)+TX1 (A+B)+chlorothalonil (D), (Z)-icos-13-en-10-one (C)+TX1 (A+B)+chlorothalonil (D), (Z)-tetradec-7-en-1-al (C)+TX1 (A+B)+chlorothalonil (D), (Z)-tetradec-9-en-1-ol (C)+TX1 (A+B)+chlorothalonil (D), (Z)-tetradec-9-en-1-yl acetate (C)+TX1 (A+B)+chlorothalonil (D), (7E,9Z)-dodeca-7,9-dien-1-yl acetate (C)+TX1 (A+B)+chlorothalonil (D), (9Z,11E)-tetradeca-9,11-dien-1-yl acetate (C)+TX1 (A+B)+chlorothalonil (D), (9Z,12E)-tetradeca-9,12-dien-1-yl acetate (C)+TX1 (A+B)+chlorothalonil (D), 14-methyloctadec-1-ene (C)+TX1 (A+B)+chlorothalonil (D), 4-methylnonan-5-ol with 4-methylnonan-5-one (C)+TX1 (A+B)+chlorothalonil (D), alpha-multistriatin (C)+TX1 (A+B)+chlorothalonil (D), brevicomin (C)+TX1 (A+B)+chlorothalonil (D), codlelure (C)+TX1 (A+B)+chlorothalonil (D), codlemone (C)+TX1 (A+B)+chlorothalonil (D), cuelure (C)+TX1 (A+B)+chlorothalonil (D), disparlure (C)+TX1 (A+B)+chlorothalonil (D), dodec-8-en-1-yl acetate (C)+TX1 (A+B)+chlorothalonil (D), dodec-9-en-1-yl acetate (C)+TX1 (A+B)+chlorothalonil (D), dodeca-8 (C)+TX1 (A+B)+chlorothalonil (D), 10-dien-1-yl acetate (C)+TX1 (A+B)+chlorothalonil (D), dominicalure (C)+TX1 (A+B)+chlorothalonil (D), ethyl 4-methyloctanoate (C)+TX1 (A+B)+chlorothalonil (D), eugenol (C)+TX1 (A+B)+chlorothalonil (D), frontalin (C)+TX1 (A+B)+chlorothalonil (D), grandlure (C)+TX1 (A+B)+chlorothalonil (D), grandlure I (C)+TX1 (A+B)+chlorothalonil (D), grandlure 11 (C)+TX1 (A+B)+chlorothalonil (D), grandlure III (C)+TX1 (A+B)+chlorothalonil (D), grandlure IV (C)+TX1 (A+B)+chlorothalonil (D), hexalure (C)+TX1 (A+B)+chlorothalonil (D), ipsdienol (C)+TX1 (A+B)+chlorothalonil (D), ipsenol (C)+TX1 (A+B)+chlorothalonil (D), japonilure (C)+TX1 (A+B)+chlorothalonil (D), lineatin (C)+TX1 (A+B)+chlorothalonil (D), litlure (C)+TX1 (A+B)+chlorothalonil (D), looplure (C)+TX1 (A+B)+chlorothalonil (D), medlure (C)+TX1 (A+B)+chlorothalonil (D), megatomoic acid (C)+TX1 (A+B)+chlorothalonil (D), methyl eugenol (C)+TX1 (A+B)+chlorothalonil (D), muscalure (C)+TX1 (A+B)+chlorothalonil (D), octadeca-2,13-dien-1-yl acetate (C)+TX1 (A+B)+chlorothalonil (D), octadeca-3,13-dien-1-yl acetate (C)+TX1 (A+B)+chlorothalonil (D), orfralure (C)+TX1 (A+B)+chlorothalonil (D), oryctalure (C)+TX1 (A+B)+chlorothalonil (D), ostramone (C)+TX1 (A+B)+chlorothalonil (D), siglure (C)+TX1 (A+B)+chlorothalonil (D), sordidin (C)+TX1 (A+B)+chlorothalonil (D), sulcatol (C)+TX1 (A+B)+chlorothalonil (D), tetradec-11-en-1-yl acetate (C)+TX1 (A+B)+chlorothalonil (D), trimedlure (C)+TX1 (A+B)+chlorothalonil (D), trimedlure A (C)+TX1 (A+B)+chlorothalonil (D), trimedlure B₁ (C)+TX1 (A+B)+chlorothalonil (D), trimedlure B₂ (C)+TX1 (A+B)+chlorothalonil (D), trimedlure C (C)+TX1 (A+B)+chlorothalonil (D), trunc-call (C)+TX1 (A+B)+chlorothalonil (D), 2-(octylthio)ethanol (C)+TX1 (A+B)+chlorothalonil (D), butopyronoxyl (C)+TX1 (A+B)+chlorothalonil (D), butoxy(polypropylene glycol) (C)+TX1 (A+B)+chlorothalonil (D), dibutyl adipate (C)+TX1 (A+B)+chlorothalonil (D), dibutyl phthalate (C)+TX1 (A+B)+chlorothalonil (D), dibutyl succinate (C)+TX1 (A+B)+chlorothalonil (D), diethyltoluamide (C)+TX1 (A+B)+chlorothalonil (D), dimethyl carbate (C)+TX1 (A+B)+chlorothalonil (D), dimethyl phthalate (C)+TX1 (A+B)+chlorothalonil (D), ethyl hexanediol (C)+TX1 (A+B)+chlorothalonil (D), hexamide (C)+TX1 (A+B)+chlorothalonil (D), methoquin-butyl (C)+TX1 (A+B)+chlorothalonil (D), methylneodecanamide (C)+TX1 (A+B)+chlorothalonil (D), oxamate (C)+TX1 (A+B)+chlorothalonil (D), picaridin (C)+TX1 (A+B)+chlorothalonil (D), 1-dichloro-1-nitroethane (C)+TX1 (A+B)+chlorothalonil (D), 1,1-dichloro-2,2-bis(4-ethylphenyl)ethane (C)+TX1 (A+B)+chlorothalonil (D), 1,2-dichloropropane with 1,3-dichloropropene (C)+TX1 (A+B)+chlorothalonil (D), 1-bromo-2-chloroethane (C)+TX1 (A+B)+chlorothalonil (D), 2,2,2-trichloro-1-(3,4-dichlorophenyl)ethyl acetate (C)+TX1 (A+B)+chlorothalonil (D), 2,2-dichlorovinyl 2-ethylsulfinylethyl methyl phosphate (C)+TX1 (A+B)+chlorothalonil (D), 2-(1,3-dithiolan-2-yl)phenyl dimethylcarbamate (C)+TX1 (A+B)+chlorothalonil (D), 2-(2-butoxyethoxy)ethyl thiocyanate (C)+TX1 (A+B)+chlorothalonil (D), 2-(4,5-dimethyl-1,3-dioxolan-2-yl)phenyl methylcarbamate (C)+TX1 (A+B)+chlorothalonil (D), 2-(4-chloro-3,5-xylyloxy)ethanol (C)+TX1 (A+B)+chlorothalonil (D), 2-chlorovinyl diethyl phosphate (C)+TX1 (A+B)+chlorothalonil (D), 2-imidazolidone (C)+TX1 (A+B)+chlorothalonil (D), 2-isovalerylindan-1,3-dione (C)+TX1 (A+B)+chlorothalonil (D), 2-methyl(prop-2-ynyl)aminophenyl methylcarbamate (C)+TX1 (A+B)+chlorothalonil (D), 2-thiocyanatoethyl laurate (C)+TX1 (A+B)+chlorothalonil (D), 3-bromo-1-chloroprop-1-ene (C)+TX1 (A+B)+chlorothalonil (D), 3-methyl-1-phenylpyrazol-5-yl dimethylcarbamate (C)+TX1 (A+B)+chlorothalonil (D), 4-methyl(prop-2-ynyl)amino-3,5-xylyl methylcarbamate (C)+TX1 (A+B)+chlorothalonil (D), 5,5-dimethyl-3-oxocyclohex-1-enyl dimethylcarbamate (C)+TX1 (A+B)+chlorothalonil (D), acethion (C)+TX1 (A+B)+chlorothalonil (D), acrylonitrile (C)+TX1 (A+B)+chlorothalonil (D), aldrin (C)+TX1 (A+B)+chlorothalonil (D), allosamidin (C)+TX1 (A+B)+chlorothalonil (D), allyxycarb (C)+TX1 (A+B)+chlorothalonil (D), alpha-ecdysone (C)+TX1 (A+B)+chlorothalonil (D), aluminium phosphide (C)+TX1 (A+B)+chlorothalonil (D), aminocarb (C)+TX1 (A+B)+chlorothalonil (D), anabasine (C)+TX1 (A+B)+chlorothalonil (D), athidathion (C)+TX1 (A+B)+chlorothalonil (D), azamethiphos (C)+TX1 (A+B)+chlorothalonil (D), Bacillus thuringiensis delta endotoxins (C)+TX1 (A+B)+chlorothalonil (D), barium hexafluorosilicate (C)+TX1 (A+B)+chlorothalonil (D), barium polysulfide (C)+TX1 (A+B)+chlorothalonil (D), barthrin (C)+TX1 (A+B)+chlorothalonil (D), Bayer 22/190 (C)+TX1 (A+B)+chlorothalonil (D), Bayer 22408 (C)+TX1 (A+B)+chlorothalonil (D), beta-cyfluthrin (C)+TX1 (A+B)+chlorothalonil (D), beta-cypermethrin (C)+TX1 (A+B)+chlorothalonil (D), bioethanomethrin (C)+TX1 (A+B)+chlorothalonil (D), biopermethrin (C)+TX1 (A+B)+chlorothalonil (D), bis(2-chloroethyl) ether (C)+TX1 (A+B)+chlorothalonil (D), borax (C)+TX1 (A+B)+chlorothalonil (D), bromfenvinfos (C)+TX1 (A+B)+chlorothalonil (D), bromo-DDT (C)+TX1 (A+B)+chlorothalonil (D), bufencarb (C)+TX1 (A+B)+chlorothalonil (D), butacarb (C)+TX1 (A+B)+chlorothalonil (D), butathiofos (C)+TX1 (A+B)+chlorothalonil (D), butonate (C)+TX1 (A+B)+chlorothalonil (D), calcium arsenate (C)+TX1 (A+B)+chlorothalonil (D), calcium cyanide (C)+TX1 (A+B)+chlorothalonil (D), carbon disulfide (C)+TX1 (A+B)+chlorothalonil (D), carbon tetrachloride (C)+TX1 (A+B)+chlorothalonil (D), cartap hydrochloride (C)+TX1 (A+B)+chlorothalonil (D), cevadine (C)+TX1 (A+B)+chlorothalonil (D), chlorbicyclen (C)+TX1 (A+B)+chlorothalonil (D), chlordane (C)+TX1 (A+B)+chlorothalonil (D), chlordecone (C)+TX1 (A+B)+chlorothalonil (D), chloroform (C)+TX1 (A+B)+chlorothalonil (D), chloropicrin (C)+TX1 (A+B)+chlorothalonil (D), chlorphoxim (C)+TX1 (A+B)+chlorothalonil (D), chlorprazophos (C)+TX1 (A+B)+chlorothalonil (D), cis-resmethrin (C)+TX1 (A+B)+chlorothalonil (D), cismethrin (C)+TX1 (A+B)+chlorothalonil (D), clocythrin (C)+TX1 (A+B)+chlorothalonil (D), copper acetoarsenite (C)+TX1 (A+B)+chlorothalonil (D), copper arsenate (C)+TX1 (A+B)+chlorothalonil (D), copper oleate (C)+TX1 (A+B)+chlorothalonil (D), coumithoate (C)+TX1 (A+B)+chlorothalonil (D), cryolite (C)+TX1 (A+B)+chlorothalonil (D), CS 708 (C)+TX1 (A+B)+chlorothalonil (D), cyanofenphos (C)+TX1 (A+B)+chlorothalonil (D), cyanophos (C)+TX1 (A+B)+chlorothalonil (D), cyclethrin (C)+TX1 (A+B)+chlorothalonil (D), cythioate (C)+TX1 (A+B)+chlorothalonil (D), d-tetramethrin (C)+TX1 (A+B)+chlorothalonil (D), DAEP (C)+TX1 (A+B)+chlorothalonil (D), dazomet (C)+TX1 (A+B)+chlorothalonil (D), decarbofuran (C)+TX1 (A+B)+chlorothalonil (D), diamidafos (C)+TX1 (A+B)+chlorothalonil (D), dicapthon (C)+TX1 (A+B)+chlorothalonil (D), dichlofenthion (C)+TX1 (A+B)+chlorothalonil (D), dicresyl (C)+TX1 (A+B)+chlorothalonil (D), dicyclanil (C)+TX1 (A+B)+chlorothalonil (D), dieldrin (C)+TX1 (A+B)+chlorothalonil (D), diethyl 5-methylpyrazol-3-yl phosphate (C)+TX1 (A+B)+chlorothalonil (D), dilor (C)+TX1 (A+B)+chlorothalonil (D), dimefluthrin (C)+TX1 (A+B)+chlorothalonil (D), dimetan (C)+TX1 (A+B)+chlorothalonil (D), dimethrin (C)+TX1 (A+B)+chlorothalonil (D), dimethylvinphos (C)+TX1 (A+B)+chlorothalonil (D), dimetilan (C)+TX1 (A+B)+chlorothalonil (D), dinoprop (C)+TX1 (A+B)+chlorothalonil (D), dinosam (C)+TX1 (A+B)+chlorothalonil (D), dinoseb (C)+TX1 (A+B)+chlorothalonil (D), diofenolan (C)+TX1 (A+B)+chlorothalonil (D), dioxabenzofos (C)+TX1 (A+B)+chlorothalonil (D), dithicrofos (C)+TX1 (A+B)+chlorothalonil (D), DSP (C)+TX1 (A+B)+chlorothalonil (D), ecdysterone (C)+TX1 (A+B)+chlorothalonil (D), EI 1642 (C)+TX1 (A+B)+chlorothalonil (D), EMPC (C)+TX1 (A+B)+chlorothalonil (D), EPBP (C)+TX1 (A+B)+chlorothalonil (D), etaphos (C)+TX1 (A+B)+chlorothalonil (D), ethiofencarb (C)+TX1 (A+B)+chlorothalonil (D), ethyl formate (C)+TX1 (A+B)+chlorothalonil (D), ethylene dibromide (C)+TX1 (A+B)+chlorothalonil (D), ethylene dichloride (C)+TX1 (A+B)+chlorothalonil (D), ethylene oxide (C)+TX1 (A+B)+chlorothalonil (D), EXD (C)+TX1 (A+B)+chlorothalonil (D), fenchlorphos (C)+TX1 (A+B)+chlorothalonil (D), fenethacarb (C)+TX1 (A+B)+chlorothalonil (D), fenitrothion (C)+TX1 (A+B)+chlorothalonil (D), fenoxacrim (C)+TX1 (A+B)+chlorothalonil (D), fenpirithrin (C)+TX1 (A+B)+chlorothalonil (D), fensulfothion (C)+TX1 (A+B)+chlorothalonil (D), fenthion-ethyl (C)+TX1 (A+B)+chlorothalonil (D), flucofuron (C)+TX1 (A+B)+chlorothalonil (D), fosmethilan (C)+TX1 (A+B)+chlorothalonil (D), fospirate (C)+TX1 (A+B)+chlorothalonil (D), fosthietan (C)+TX1 (A+B)+chlorothalonil (D), furathiocarb (C)+TX1 (A+B)+chlorothalonil (D), furethrin (C)+TX1 (A+B)+chlorothalonil (D), guazatine (C)+TX1 (A+B)+chlorothalonil (D), guazatine acetates (C)+TX1 (A+B)+chlorothalonil (D), sodium tetrathiocarbonate (C)+TX1 (A+B)+chlorothalonil (D), halfenprox (C)+TX1 (A+B)+chlorothalonil (D), HCH (C)+TX1 (A+B)+chlorothalonil (D), HEOD (C)+TX1 (A+B)+chlorothalonil (D), heptachlor (C)+TX1 (A+B)+chlorothalonil (D), heterophos (C)+TX1 (A+B)+chlorothalonil (D), HHDN (C)+TX1 (A+B)+chlorothalonil (D), hydrogen cyanide (C)+TX1 (A+B)+chlorothalonil (D), hyquincarb (C)+TX1 (A+B)+chlorothalonil (D), IPSP (C)+TX1 (A+B)+chlorothalonil (D), isazofos (C)+TX1 (A+B)+chlorothalonil (D), isobenzan (C)+TX1 (A+B)+chlorothalonil (D), isodrin (C)+TX1 (A+B)+chlorothalonil (D), isofenphos (C)+TX1 (A+B)+chlorothalonil (D), isolane (C)+TX1 (A+B)+chlorothalonil (D), isoprothiolane (C)+TX1 (A+B)+chlorothalonil (D), isoxathion (C)+TX1 (A+B)+chlorothalonil (D), juvenile hormone I (C)+TX1 (A+B)+chlorothalonil (D), juvenile hormone II (C)+TX1 (A+B)+chlorothalonil (D), juvenile hormone III (C)+TX1 (A+B)+chlorothalonil (D), kelevan (C)+TX1 (A+B)+chlorothalonil (D), kinoprene (C)+TX1 (A+B)+chlorothalonil (D), lead arsenate (C)+TX1 (A+B)+chlorothalonil (D), leptophos (C)+TX1 (A+B)+chlorothalonil (D), lirimfos (C)+TX1 (A+B)+chlorothalonil (D), lythidathion (C)+TX1 (A+B)+chlorothalonil (D), m-cumenyl methylcarbamate (C)+TX1 (A+B)+chlorothalonil (D), magnesium phosphide (C)+TX1 (A+B)+chlorothalonil (D), mazidox (C)+TX1 (A+B)+chlorothalonil (D), mecarphon (C)+TX1 (A+B)+chlorothalonil (D), menazon (C)+TX1 (A+B)+chlorothalonil (D), mercurous chloride (C)+TX1 (A+B)+chlorothalonil (D), mesulfenfos (C)+TX1 (A+B)+chlorothalonil (D), metam (C)+TX1 (A+B)+chlorothalonil (D), metam-potassium (C)+TX1 (A+B)+chlorothalonil (D), metam-sodium (C)+TX1 (A+B)+chlorothalonil (D), methanesulfonyl fluoride (C)+TX1 (A+B)+chlorothalonil (D), methocrotophos (C)+TX1 (A+B)+chlorothalonil (D), methoprene (C)+TX1 (A+B)+chlorothalonil (D), methothrin (C)+TX1 (A+B)+chlorothalonil (D), methoxychlor (C)+TX1 (A+B)+chlorothalonil (D), methyl isothiocyanate (C)+TX1 (A+B)+chlorothalonil (D), methylchloroform (C)+TX1 (A+B)+chlorothalonil (D), methylene chloride (C)+TX1 (A+B)+chlorothalonil (D), metoxadiazone (C)+TX1 (A+B)+chlorothalonil (D), mirex (C)+TX1 (A+B)+chlorothalonil (D), naftalofos (C)+TX1 (A+B)+chlorothalonil (D), naphthalene (C)+TX1 (A+B)+chlorothalonil (D), NC-170 (C)+TX1 (A+B)+chlorothalonil (D), nicotine (C)+TX1 (A+B)+chlorothalonil (D), nicotine sulfate (C)+TX1 (A+B)+chlorothalonil (D), nithiazine (C)+TX1 (A+B)+chlorothalonil (D), nornicotine (C)+TX1 (A+B)+chlorothalonil (D), O-5-dichloro-4-iodophenyl O-ethyl ethylphosphonothioate (C)+TX1 (A+B)+chlorothalonil (D), O,O-diethyl O-4-methyl-2-oxo-2H-chromen-7-yl phosphorothioate (C)+TX1 (A+B)+chlorothalonil (D), O,O-diethyl O-6-methyl-2-propylpyrimidin-4-yl phosphorothioate (C)+TX1 (A+B)+chlorothalonil (D), O,O,O′,O′-tetrapropyl dithiopyrophosphate (C)+TX1 (A+B)+chlorothalonil (D), oleic acid (C)+TX1 (A+B)+chlorothalonil (D), para-dichlorobenzene (C)+TX1 (A+B)+chlorothalonil (D), parathion-methyl (C)+TX1 (A+B)+chlorothalonil (D), pentachlorophenol (C)+TX1 (A+B)+chlorothalonil (D), pentachlorophenyl laurate (C)+TX1 (A+B)+chlorothalonil (D), PH 60-38 (C)+TX1 (A+B)+chlorothalonil (D), phenkapton (C)+TX1 (A+B)+chlorothalonil (D), phosnichlor (C)+TX1 (A+B)+chlorothalonil (D), phosphine (C)+TX1 (A+B)+chlorothalonil (D), phoxim-methyl (C)+TX1 (A+B)+chlorothalonil (D), pirimetaphos (C)+TX1 (A+B)+chlorothalonil (D), polychlorodicyclopentadiene isomers (C)+TX1 (A+B)+chlorothalonil (D), potassium arsenite (C)+TX1 (A+B)+chlorothalonil (D), potassium thiocyanate (C)+TX1 (A+B)+chlorothalonil (D), precocene I (C)+TX1 (A+B)+chlorothalonil (D), precocene II (C)+TX1 (A+B)+chlorothalonil (D), precocene III (C)+TX1 (A+B)+chlorothalonil (D), primidophos (C)+TX1 (A+B)+chlorothalonil (D), profluthrin (C)+TX1 (A+B)+chlorothalonil (D), promecarb (C)+TX1 (A+B)+chlorothalonil (D), prothiofos (C)+TX1 (A+B)+chlorothalonil (D), pyrazophos (C)+TX1 (A+B)+chlorothalonil (D), pyresmethrin (C)+TX1 (A+B)+chlorothalonil (D), Quassia (C)+TX1 (A+B)+chlorothalonil (D), quinalphos-methyl (C)+TX1 (A+B)+chlorothalonil (D), quinothion (C)+TX1 (A+B)+chlorothalonil (D), rafoxanide (C)+TX1 (A+B)+chlorothalonil (D), resmethrin (C)+TX1 (A+B)+chlorothalonil (D), rotenone (C)+TX1 (A+B)+chlorothalonil (D), kadethrin (C)+TX1 (A+B)+chlorothalonil (D), ryania (C)+TX1 (A+B)+chlorothalonil (D), ryanodine (C)+TX1 (A+B)+chlorothalonil (D), sabadilla (C)+TX1 (A+B)+chlorothalonil (D), schradan (C)+TX1 (A+B)+chlorothalonil (D), sebufos (C)+TX1 (A+B)+chlorothalonil (D), SI-0009 (C)+TX1 (A+B)+chlorothalonil (D), thiapronil (C)+TX1 (A+B)+chlorothalonil (D), sodium arsenite (C)+TX1 (A+B)+chlorothalonil (D), sodium cyanide (C)+TX1 (A+B)+chlorothalonil (D), sodium fluoride (C)+TX1 (A+B)+chlorothalonil (D), sodium hexafluorosilicate (C)+TX1 (A+B)+chlorothalonil (D), sodium pentachlorophenoxide (C)+TX1 (A+B)+chlorothalonil (D), sodium selenate (C)+TX1 (A+B)+chlorothalonil (D), sodium thiocyanate (C)+TX1 (A+B)+chlorothalonil (D), sulcofuron (C)+TX1 (A+B)+chlorothalonil (D), sulcofuron-sodium (C)+TX1 (A+B)+chlorothalonil (D), sulfuryl fluoride (C)+TX1 (A+B)+chlorothalonil (D), sulprofos (C)+TX1 (A+B)+chlorothalonil (D), tar oils (C)+TX1 (A+B)+chlorothalonil (D), tazimcarb (C)+TX1 (A+B)+chlorothalonil (D), TDE (C)+TX1 (A+B)+chlorothalonil (D), tebupirimfos (C)+TX1 (A+B)+chlorothalonil (D), temephos (C)+TX1 (A+B)+chlorothalonil (D), terallethrin (C)+TX1 (A+B)+chlorothalonil (D), tetrachloroethane (C)+TX1 (A+B)+chlorothalonil (D), thicrofos (C)+TX1 (A+B)+chlorothalonil (D), thiocyclam (C)+TX1 (A+B)+chlorothalonil (D), thiocyclam hydrogen oxalate (C)+TX1 (A+B)+chlorothalonil (D), thionazin (C)+TX1 (A+B)+chlorothalonil (D), thiosultap (C)+TX1 (A+B)+chlorothalonil (D), thiosultap-sodium (C)+TX1 (A+B)+chlorothalonil (D), tralomethrin (C)+TX1 (A+B)+chlorothalonil (D), transpermethrin (C)+TX1 (A+B)+chlorothalonil (D), triazamate (C)+TX1 (A+B)+chlorothalonil (D), trichlormetaphos-3 (C)+TX1 (A+B)+chlorothalonil (D), trichloronat (C)+TX1 (A+B)+chlorothalonil (D), trimethacarb (C)+TX1 (A+B)+chlorothalonil (D), tolprocarb (C)+TX1 (A+B)+chlorothalonil (D), triclopyricarb (C)+TX1 (A+B)+chlorothalonil (D), triprene (C)+TX1 (A+B)+chlorothalonil (D), veratridine (C)+TX1 (A+B)+chlorothalonil (D), veratrine (C)+TX1 (A+B)+chlorothalonil (D), XMC (C)+TX1 (A+B)+chlorothalonil (D), zetamethrin (C)+TX1 (A+B)+chlorothalonil (D), zinc phosphide (C)+TX1 (A+B)+chlorothalonil (D), zolaprofos (C)+TX1 (A+B)+chlorothalonil (D), meperfluthrin (C)+TX1 (A+B)+chlorothalonil (D), tetramethylfluthrin (C)+TX1 (A+B)+chlorothalonil (D), bis(tributyltin) oxide (C)+TX1 (A+B)+chlorothalonil (D), bromoacetamide (C)+TX1 (A+B)+chlorothalonil (D), ferric phosphate (C)+TX1 (A+B)+chlorothalonil (D), niclosamide-olamine (C)+TX1 (A+B)+chlorothalonil (D), tributyltin oxide (C)+TX1 (A+B)+chlorothalonil (D), pyrimorph (C)+TX1 (A+B)+chlorothalonil (D), trifenmorph (C)+TX1 (A+B)+chlorothalonil (D), 1,2-dibromo-3-chloropropane (C)+TX1 (A+B)+chlorothalonil (D), 1,3-dichloropropene (C)+TX1 (A+B)+chlorothalonil (D), 3,4-dichlorotetrahydrothiophene 1,1-dioxide (C)+TX1 (A+B)+chlorothalonil (D), 3-(4-chlorophenyl)-5-methylrhodanine (C)+TX1 (A+B)+chlorothalonil (D), 5-methyl-6-thioxo-1,3,5-thiadiazinan-3-ylacetic acid (C)+TX1 (A+B)+chlorothalonil (D), 6-isopentenylaminopurine (C)+TX1 (A+B)+chlorothalonil (D), anisiflupurin (C)+TX1 (A+B)+chlorothalonil (D), benclothiaz (C)+TX1 (A+B)+chlorothalonil (D), cytokinins (C)+TX1 (A+B)+chlorothalonil (D), DCIP (C)+TX1 (A+B)+chlorothalonil (D), furfural (C)+TX1 (A+B)+chlorothalonil (D), isamidofos (C)+TX1 (A+B)+chlorothalonil (D), kinetin (C)+TX1 (A+B)+chlorothalonil (D), Myrothecium verrucaria composition (C)+TX1 (A+B)+chlorothalonil (D), tetrachlorothiophene (C)+TX1 (A+B)+chlorothalonil (D), xylenols (C)+TX1 (A+B)+chlorothalonil (D), zeatin (C)+TX1 (A+B)+chlorothalonil (D), potassium ethylxanthate (C)+TX1 (A+B)+chlorothalonil (D), acibenzolar (C)+TX1 (A+B)+chlorothalonil (D), acibenzolar-S-methyl (C)+TX1 (A+B)+chlorothalonil (D), Reynoutria sachalinensis extract (C)+TX1 (A+B)+chlorothalonil (D), alpha-chlorohydrin (C)+TX1 (A+B)+chlorothalonil (D), antu (C)+TX1 (A+B)+chlorothalonil (D), barium carbonate (C)+TX1 (A+B)+chlorothalonil (D), bisthiosemi (C)+TX1 (A+B)+chlorothalonil (D), brodifacoum (C)+TX1 (A+B)+chlorothalonil (D), bromadiolone (C)+TX1 (A+B)+chlorothalonil (D), bromethalin (C)+TX1 (A+B)+chlorothalonil (D), chlorophacinone (C)+TX1 (A+B)+chlorothalonil (D), cholecalciferol (C)+TX1 (A+B)+chlorothalonil (D), coumachlor (C)+TX1 (A+B)+chlorothalonil (D), coumafuryl (C)+TX1 (A+B)+chlorothalonil (D), coumatetralyl (C)+TX1 (A+B)+chlorothalonil (D), crimidine (C)+TX1 (A+B)+chlorothalonil (D), difenacoum (C)+TX1 (A+B)+chlorothalonil (D), difethialone (C)+TX1 (A+B)+chlorothalonil (D), diphacinone (C)+TX1 (A+B)+chlorothalonil (D), ergocalciferol (C)+TX1 (A+B)+chlorothalonil (D), flocoumafen (C)+TX1 (A+B)+chlorothalonil (D), fluoroacetamide (C)+TX1 (A+B)+chlorothalonil (D), flupropadine (C)+TX1 (A+B)+chlorothalonil (D), flupropadine hydrochloride (C)+TX1 (A+B)+chlorothalonil (D), norbormide (C)+TX1 (A+B)+chlorothalonil (D), phosacetim (C)+TX1 (A+B)+chlorothalonil (D), phosphorus (C)+TX1 (A+B)+chlorothalonil (D), pindone (C)+TX1 (A+B)+chlorothalonil (D), pyrinuron (C)+TX1 (A+B)+chlorothalonil (D), scilliroside (C)+TX1 (A+B)+chlorothalonil (D), sodium fluoroacetate (C)+TX1 (A+B)+chlorothalonil (D), thallium sulfate (C)+TX1 (A+B)+chlorothalonil (D), warfarin (C)+TX1 (A+B)+chlorothalonil (D), 2-(2-butoxyethoxy)ethyl piperonylate (C)+TX1 (A+B)+chlorothalonil (D), 5-(1,3-benzodioxol-5-yl)-3-hexylcyclohex-2-enone (C)+TX1 (A+B)+chlorothalonil (D), farnesol with nerolidol (C)+TX1 (A+B)+chlorothalonil (D), verbutin (C)+TX1 (A+B)+chlorothalonil (D), MGK 264 (C)+TX1 (A+B)+chlorothalonil (D), piperonyl butoxide (C)+TX1 (A+B)+chlorothalonil (D), piprotal (C)+TX1 (A+B)+chlorothalonil (D), propyl isomer (C)+TX1 (A+B)+chlorothalonil (D), S421 (C)+TX1 (A+B)+chlorothalonil (D), sesamex (C)+TX1 (A+B)+chlorothalonil (D), sesasmolin (C)+TX1 (A+B)+chlorothalonil (D), sulfoxide (C)+TX1 (A+B)+chlorothalonil (D), anthraquinone (C)+TX1 (A+B)+chlorothalonil (D), copper naphthenate (C)+TX1 (A+B)+chlorothalonil (D), copper oxychloride (C)+TX1 (A+B)+chlorothalonil (D), dicyclopentadiene (C)+TX1 (A+B)+chlorothalonil (D), thiram (C)+TX1 (A+B)+chlorothalonil (D), zinc naphthenate (C)+TX1 (A+B)+chlorothalonil (D), ziram (C)+TX1 (A+B)+chlorothalonil (D), imanin (C)+TX1 (A+B)+chlorothalonil (D), ribavirin (C)+TX1 (A+B)+chlorothalonil (D), chloroinconazide (C)+TX1 (A+B)+chlorothalonil (D), mercuric oxide (C)+TX1 (A+B)+chlorothalonil (D), thiophanate-methyl (C)+TX1 (A+B)+chlorothalonil (D), azaconazole (C)+TX1 (A+B)+chlorothalonil (D), bitertanol (C)+TX1 (A+B)+chlorothalonil (D), bromuconazole (C)+TX1 (A+B)+chlorothalonil (D), cyproconazole (C)+TX1 (A+B)+chlorothalonil (D), difenoconazole (C)+TX1 (A+B)+chlorothalonil (D), diniconazole (C)+TX1 (A+B)+chlorothalonil (D), epoxiconazole (C)+TX1 (A+B)+chlorothalonil (D), fenbuconazole (C)+TX1 (A+B)+chlorothalonil (D), fluquinconazole (C)+TX1 (A+B)+chlorothalonil (D), flusilazole (C)+TX1 (A+B)+chlorothalonil (D), flutriafol (C)+TX1 (A+B)+chlorothalonil (D), furametpyr (C)+TX1 (A+B)+chlorothalonil (D), hexaconazole (C)+TX1 (A+B)+chlorothalonil (D), imazalil (C)+TX1 (A+B)+chlorothalonil (D), imibenconazole (C)+TX1 (A+B)+chlorothalonil (D), ipconazole (C)+TX1 (A+B)+chlorothalonil (D), metconazole (C)+TX1 (A+B)+chlorothalonil (D), myclobutanil (C)+TX1 (A+B)+chlorothalonil (D), paclobutrazole (C)+TX1 (A+B)+chlorothalonil (D), pefurazoate (C)+TX1 (A+B)+chlorothalonil (D), penconazole (C)+TX1 (A+B)+chlorothalonil (D), prothioconazole (C)+TX1 (A+B)+chlorothalonil (D), pyrifenox (C)+TX1 (A+B)+chlorothalonil (D), prochloraz (C)+TX1 (A+B)+chlorothalonil (D), propiconazole (C)+TX1 (A+B)+chlorothalonil (D), pyrisoxazole (C)+TX1 (A+B)+chlorothalonil (D), simeconazole (C)+TX1 (A+B)+chlorothalonil (D), tebuconazole (C)+TX1 (A+B)+chlorothalonil (D), tetraconazole (C)+TX1 (A+B)+chlorothalonil (D), triadimefon (C)+TX1 (A+B)+chlorothalonil (D), triadimenol (C)+TX1 (A+B)+chlorothalonil (D), triflumizole (C)+TX1 (A+B)+chlorothalonil (D), triticonazole (C)+TX1 (A+B)+chlorothalonil (D), ancymidol (C)+TX1 (A+B)+chlorothalonil (D), fenarimol (C)+TX1 (A+B)+chlorothalonil (D), nuarimol (C)+TX1 (A+B)+chlorothalonil (D), bupirimate (C)+TX1 (A+B)+chlorothalonil (D), dimethirimol (C)+TX1 (A+B)+chlorothalonil (D), ethirimol (C)+TX1 (A+B)+chlorothalonil (D), dodemorph (C)+TX1 (A+B)+chlorothalonil (D), fenpropidin (C)+TX1 (A+B)+chlorothalonil (D), fenpropimorph (C)+TX1 (A+B)+chlorothalonil (D), spiroxamine (C)+TX1 (A+B)+chlorothalonil (D), tridemorph (C)+TX1 (A+B)+chlorothalonil (D), cyprodinil (C)+TX1 (A+B)+chlorothalonil (D), mepanipyrim (C)+TX1 (A+B)+chlorothalonil (D), pyrimethanil (C)+TX1 (A+B)+chlorothalonil (D), fenpiclonil (C)+TX1 (A+B)+chlorothalonil (D), fludioxonil (C)+TX1 (A+B)+chlorothalonil (D), benalaxyl (C)+TX1 (A+B)+chlorothalonil (D), furalaxyl (C)+TX1 (A+B)+chlorothalonil (D), metalaxyl (C)+TX1 (A+B)+chlorothalonil (D), R-metalaxyl (C)+TX1 (A+B)+chlorothalonil (D), ofurace (C)+TX1 (A+B)+chlorothalonil (D), oxadixyl (C)+TX1 (A+B)+chlorothalonil (D), carbendazim (C)+TX1 (A+B)+chlorothalonil (D), debacarb (C)+TX1 (A+B)+chlorothalonil (D), fuberidazole (C)+TX1 (A+B)+chlorothalonil (D), thiabendazole (C)+TX1 (A+B)+chlorothalonil (D), chlozolinate (C)+TX1 (A+B)+chlorothalonil (D), dichlozoline (C)+TX1 (A+B)+chlorothalonil (D), myclozoline (C)+TX1 (A+B)+chlorothalonil (D), procymidone (C)+TX1 (A+B)+chlorothalonil (D), vinclozoline (C)+TX1 (A+B)+chlorothalonil (D), boscalid (C)+TX1 (A+B)+chlorothalonil (D), carboxin (C)+TX1 (A+B)+chlorothalonil (D), fenfuram (C)+TX1 (A+B)+chlorothalonil (D), flutolanil (C)+TX1 (A+B)+chlorothalonil (D), mepronil (C)+TX1 (A+B)+chlorothalonil (D), oxycarboxin (C)+TX1 (A+B)+chlorothalonil (D), penthiopyrad (C)+TX1 (A+B)+chlorothalonil (D), thifluzamide (C)+TX1 (A+B)+chlorothalonil (D), dodine (C)+TX1 (A+B)+chlorothalonil (D), iminoctadine (C)+TX1 (A+B)+chlorothalonil (D), azoxystrobin (C)+TX1 (A+B)+chlorothalonil (D), dimoxystrobin (C)+TX1 (A+B)+chlorothalonil (D), enestroburin (C)+TX1 (A+B)+chlorothalonil (D), fenaminstrobin (C)+TX1 (A+B)+chlorothalonil (D), flufenoxystrobin (C)+TX1 (A+B)+chlorothalonil (D), fluoxastrobin (C)+TX1 (A+B)+chlorothalonil (D), kresoxim-methyl (C)+TX1 (A+B)+chlorothalonil (D), metominostrobin (C)+TX1 (A+B)+chlorothalonil (D), trifloxystrobin (C)+TX1 (A+B)+chlorothalonil (D), orysastrobin (C)+TX1 (A+B)+chlorothalonil (D), picoxystrobin (C)+TX1 (A+B)+chlorothalonil (D), pyraclostrobin (C)+TX1 (A+B)+chlorothalonil (D), pyrametostrobin (C)+TX1 (A+B)+chlorothalonil (D), pyraoxystrobin (C)+TX1 (A+B)+chlorothalonil (D), ferbam (C)+TX1 (A+B)+chlorothalonil (D), chlorothalonil (C)+TX1 (A+B)+chlorothalonil (D), maneb (C)+TX1 (A+B)+chlorothalonil (D), metiram (C)+TX1 (A+B)+chlorothalonil (D), propineb (C)+TX1 (A+B)+chlorothalonil (D), zineb (C)+TX1 (A+B)+chlorothalonil (D), captafol (C)+TX1 (A+B)+chlorothalonil (D), captan (C)+TX1 (A+B)+chlorothalonil (D), fluoroimide (C)+TX1 (A+B)+chlorothalonil (D), folpet (C)+TX1 (A+B)+chlorothalonil (D), tolylfluanid (C)+TX1 (A+B)+chlorothalonil (D), bordeaux mixture (C)+TX1 (A+B)+chlorothalonil (D), copper oxide (C)+TX1 (A+B)+chlorothalonil (D), mancopper (C)+TX1 (A+B)+chlorothalonil (D), oxine-copper (C)+TX1 (A+B)+chlorothalonil (D), nitrothal-isopropyl (C)+TX1 (A+B)+chlorothalonil (D), edifenphos (C)+TX1 (A+B)+chlorothalonil (D), iprobenphos (C)+TX1 (A+B)+chlorothalonil (D), phosdiphen (C)+TX1 (A+B)+chlorothalonil (D), tolclofos-methyl (C)+TX1 (A+B)+chlorothalonil (D), anilazine (C)+TX1 (A+B)+chlorothalonil (D), benthiavalicarb (C)+TX1 (A+B)+chlorothalonil (D), blasticidin-S(C)+TX1 (A+B)+chlorothalonil (D), chloroneb (C)+TX1 (A+B)+chlorothalonil (D), chlorothalonil (C)+TX1 (A+B)+chlorothalonil (D), cyflufenamid (C)+TX1 (A+B)+chlorothalonil (D), cymoxanil (C)+TX1 (A+B)+chlorothalonil (D), cyclobutrifluram (C)+TX1 (A+B)+chlorothalonil (D), diclocymet (C)+TX1 (A+B)+chlorothalonil (D), diclomezine (C)+TX1 (A+B)+chlorothalonil (D), dicloran (C)+TX1 (A+B)+chlorothalonil (D), diethofencarb (C)+TX1 (A+B)+chlorothalonil (D), dimethomorph (C)+TX1 (A+B)+chlorothalonil (D), flumorph (C)+TX1 (A+B)+chlorothalonil (D), dithianon (C)+TX1 (A+B)+chlorothalonil (D), ethaboxam (C)+TX1 (A+B)+chlorothalonil (D), etridiazole (C)+TX1 (A+B)+chlorothalonil (D), famoxadone (C)+TX1 (A+B)+chlorothalonil (D), fenamidone (C)+TX1 (A+B)+chlorothalonil (D), fenoxanil (C)+TX1 (A+B)+chlorothalonil (D), ferimzone (C)+TX1 (A+B)+chlorothalonil (D), fluazinam (C)+TX1 (A+B)+chlorothalonil (D), flumetylsulforim (C)+TX1 (A+B)+chlorothalonil (D), fluopicolide (C)+TX1 (A+B)+chlorothalonil (D), fluoxytioconazole (C)+TX1 (A+B)+chlorothalonil (D), flusulfamide (C)+TX1 (A+B)+chlorothalonil (D), fluxapyroxad (C)+TX1 (A+B)+chlorothalonil (D), fenhexamid (C)+TX1 (A+B)+chlorothalonil (D), fosetyl-aluminium (C)+TX1 (A+B)+chlorothalonil (D), hymexazol (C)+TX1 (A+B)+chlorothalonil (D), iprovalicarb (C)+TX1 (A+B)+chlorothalonil (D), cyazofamid (C)+TX1 (A+B)+chlorothalonil (D), methasulfocarb (C)+TX1 (A+B)+chlorothalonil (D), metrafenone (C)+TX1 (A+B)+chlorothalonil (D), pencycuron (C)+TX1 (A+B)+chlorothalonil (D), phthalide (C)+TX1 (A+B)+chlorothalonil (D), polyoxins (C)+TX1 (A+B)+chlorothalonil (D), propamocarb (C)+TX1 (A+B)+chlorothalonil (D), pyribencarb (C)+TX1 (A+B)+chlorothalonil (D), proquinazid (C)+TX1 (A+B)+chlorothalonil (D), pyroquilon (C)+TX1 (A+B)+chlorothalonil (D), pyriofenone (C)+TX1 (A+B)+chlorothalonil (D), quinoxyfen (C)+TX1 (A+B)+chlorothalonil (D), quintozene (C)+TX1 (A+B)+chlorothalonil (D), tiadinil (C)+TX1 (A+B)+chlorothalonil (D), triazoxide (C)+TX1 (A+B)+chlorothalonil (D), tricyclazole (C)+TX1 (A+B)+chlorothalonil (D), triforine (C)+TX1 (A+B)+chlorothalonil (D), validamycin (C)+TX1 (A+B)+chlorothalonil (D), valifenalate (C)+TX1 (A+B)+chlorothalonil (D), silthiofam (C)+TX1 (A+B)+chlorothalonil (D), zoxamide (C)+TX1 (A+B)+chlorothalonil (D), mandipropamid (C)+TX1 (A+B)+chlorothalonil (D), flubeneteram (C)+TX1 (A+B)+chlorothalonil (D), isopyrazam (C)+TX1 (A+B)+chlorothalonil (D), sedaxane (C)+TX1 (A+B)+chlorothalonil (D), benzovindiflupyr (C)+TX1 (A+B)+chlorothalonil (D), pydiflumetofen (C)+TX1 (A+B)+chlorothalonil (D), 3-difluoromethyl-1-methyl-1H-pyrazole-4-carboxylic acid (3′,4′,5′-trifluoro-biphenyl-2-yl)-amide (C)+TX1 (A+B)+chlorothalonil (D), isoflucypram (C)+TX1 (A+B)+chlorothalonil (D), isotianil (C)+TX1 (A+B)+chlorothalonil (D), dipymetitrone (C)+TX1 (A+B)+chlorothalonil (D), 6-ethyl-5,7-dioxo-pyrrolo[4,5][1,4]dithiino[1,2-c]isothiazole-3-carbonitrile (C)+TX1 (A+B)+chlorothalonil (D), 2-(difluoromethyl)-N-[3-ethyl-1,1-dimethyl-indan-4-yl]pyridine-3-carboxamide (C)+TX1 (A+B)+chlorothalonil (D), 4-(2,6-difluorophenyl)-6-methyl-5-phenyl-pyridazine-3-carbonitrile (C)+TX1 (A+B)+chlorothalonil (D), (R)-3-(difluoromethyl)-1-methyl-N-[1,1,3-trimethylindan-4-yl]pyrazole-4-carboxamide (C)+TX1 (A+B)+chlorothalonil (D), 4-(2-bromo-4-fluoro-phenyl)-N-(2-chloro-6-fluoro-phenyl)-2,5-dimethyl-pyrazol-3-amine (C)+TX1 (A+B)+chlorothalonil (D), 4-(2-bromo-4-fluorophenyl)-N-(2-chloro-6-fluorophenyl)-1, 3-dimethyl-1H-pyrazol-5-amine (C)+TX1 (A+B)+chlorothalonil (D), fluindapyr (C)+TX1 (A+B)+chlorothalonil (D), coumethoxystrobin (jiaxiangjunzhi) (C)+TX1 (A+B)+chlorothalonil (D), Ivbenmixianan (C)+TX1 (A+B)+chlorothalonil (D), dichlobentiazox (C)+TX1 (A+B)+chlorothalonil (D), mandestrobin (C)+TX1 (A+B)+chlorothalonil (D), 3-(4,4-difluoro-3,4-dihydro-3,3-dimethylisoquinolin-1-yl)quinolone (C)+TX1 (A+B)+chlorothalonil (D), 2-[2-fluoro-6-[(8-fluoro-2-methyl-3-quinolyl)oxy]phenyl]propan-2-ol (C)+TX1 (A+B)+chlorothalonil (D), oxathiapiprolin (C)+TX1 (A+B)+chlorothalonil (D), tert-butyl N-[6-[[[(1-methyltetrazol-5-yl)-phenyl-methylene]amino]oxymethyl]-2-pyridyl]carbamate (C)+TX1 (A+B)+chlorothalonil (D), pyraziflumid (C)+TX1 (A+B)+chlorothalonil (D), inpyrfluxam (C)+TX1 (A+B)+chlorothalonil (D), trolprocarb (C)+TX1 (A+B)+chlorothalonil (D), mefentrifluconazole (C)+TX1 (A+B)+chlorothalonil (D), ipfentrifluconazole(C)+TX1 (A+B)+chlorothalonil (D), 2-(difluoromethyl)-N-[(3R)-3-ethyl-1,1-dimethyl-indan-4-yl]pyridine-3-carboxamide (C)+TX1 (A+B)+chlorothalonil (D), N′-(2,5-dimethyl-4-phenoxy-phenyl)-N-ethyl-N-methyl-formamidine (C)+TX1 (A+B)+chlorothalonil (D), N′-[4-(4,5-dichlorothiazol-2-yl)oxy-2,5-dimethyl-phenyl]-N-ethyl-N-methyl-formamidine (C)+TX1 (A+B)+chlorothalonil (D), [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl]methanesulfonate (C)+TX1 (A+B)+chlorothalonil (D), but-3-ynyl N-[6-[[(Z)-[(1-methyltetrazol-5-yl)-phenyl-methylene]amino]oxymethyl]-2-pyridyl]carbamate (C)+TX1 (A+B)+chlorothalonil (D), methyl N-[[5-[4-(2,4-dimethylphenyl)triazol-2-yl]-2-methyl-phenyl]methyl]carbamate (C)+TX1 (A+B)+chlorothalonil (D), 3-chloro-6-methyl-5-phenyl-4-(2,4,6-trifluorophenyl)pyridazine (C)+TX1 (A+B)+chlorothalonil (D), pyridachlometyl (C)+TX1 (A+B)+chlorothalonil (D), 3-(difluoromethyl)-1-methyl-N-[1,1,3-trimethylindan-4-yl]pyrazole-4-carboxamide (C)+TX1 (A+B)+chlorothalonil (D), 1-[2-[[1-(4-chlorophenyl)pyrazol-3-yl]oxymethyl]-3-methyl-phenyl]-4-methyl-tetrazol-5-one (C)+TX1 (A+B)+chlorothalonil (D), 1-methyl-4-[3-methyl-2-[[2-methyl-4-(3,4,5-trimethylpyrazol-1-yl)phenoxy]methyl]phenyl]tetrazol-5-one (C)+TX1 (A+B)+chlorothalonil (D), aminopyrifen (C)+TX1 (A+B)+chlorothalonil (D), ametoctradin (C)+TX1 (A+B)+chlorothalonil (D), amisulbrom (C)+TX1 (A+B)+chlorothalonil (D), penflufen (C)+TX1 (A+B)+chlorothalonil (D), (Z,2E)-5-[1-(4-chlorophenyl)pyrazol-3-yl]oxy-2-methoxyimino-N,3-dimethyl-pent-3-enamide (C)+TX1 (A+B)+chlorothalonil (D), florylpicoxamid (C)+TX1 (A+B)+chlorothalonil (D), fenpicoxamid (C)+TX1 (A+B)+chlorothalonil (D), metarylpicoxamid (C)+TX1 (A+B)+chlorothalonil (D), tebufloquin (C)+TX1 (A+B)+chlorothalonil (D), ipflufenoquin (C)+TX1 (A+B)+chlorothalonil (D), quinofumelin (C)+TX1 (A+B)+chlorothalonil (D), isofetamid (C)+TX1 (A+B)+chlorothalonil (D), ethyl 1-[[4-[[2-(trifluoromethyl)-1,3-dioxolan-2-yl]methoxy]phenyl]methyl]pyrazole-3-carboxylate (C)+TX1 (A+B)+chlorothalonil (D) (may be prepared from the methods described in WO 2020/056090), ethyl 1-[[4-[(Z)-2-ethoxy-3,3,3-trifluoro-prop-1-enoxy]phenyl]methyl]pyrazole-3-carboxylate (C)+TX1 (A+B)+chlorothalonil (D) (may be prepared from the methods described in WO 2020/056090), methyl N-[[4-[1-(4-cyclopropyl-2,6-difluoro-phenyl)pyrazol-4-yl]-2-methyl-phenyl]methyl]carbamate (C)+TX1 (A+B)+chlorothalonil (D) (may be prepared from the methods described in WO 2020/097012), methyl N-[[4-[1-(2,6-difluoro-4-isopropyl-phenyl)pyrazol-4-yl]-2-methyl-phenyl]methyl]carbamate (C)+TX1 (A+B)+chlorothalonil (D) (may be prepared from the methods described in WO 2020/097012), 6-chloro-3-(3-cyclopropyl-2-fluoro-phenoxy)-N-[2-(2,4-dimethylphenyl)-2,2-difluoro-ethyl]-5-methyl-pyridazine-4-carboxamide (C)+TX1 (A+B)+chlorothalonil (D) (may be prepared from the methods described in WO 2020/109391), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide (C)+TX1 (A+B)+chlorothalonil (D) (may be prepared from the methods described in WO 2020/109391), 6-chloro-3-(3-cyclopropyl-2-fluoro-phenoxy)-N-[2-(3,4-dimethylphenyl)-2,2-difluoro-ethyl]-5-methyl-pyridazine-4-carboxamide (C)+TX1 (A+B)+chlorothalonil (D) (may be prepared from the methods described in WO 2020/109391), N-[2-[2,4-dichloro-phenoxy]phenyl]-3-(difluoromethyl)-1-methyl-pyrazole-4-carboxamide (C)+TX1 (A+B)+chlorothalonil (D), N-[2-[2-chloro-4-(trifluoromethyl)phenoxy]phenyl]-3-(difluoromethyl)-1-methyl-pyrazole-4-carboxamide (C)+TX1 (A+B)+chlorothalonil (D), benzothiostrobin (C)+TX1 (A+B)+chlorothalonil (D), phenamacril (C)+TX1 (A+B)+chlorothalonil (D), 5-amino-1,3,4-thiadiazole-2-thiol zinc salt (2:1) (C)+TX1 (A+B)+chlorothalonil (D), fluopyram (C)+TX1 (A+B)+chlorothalonil (D), flufenoxadiazam (C)+TX1 (A+B)+chlorothalonil (D), flutianil (C)+TX1 (A+B)+chlorothalonil (D), fluopimomide (C)+TX1 (A+B)+chlorothalonil (D), pyrapropoyne (C)+TX1 (A+B)+chlorothalonil (D), picarbutrazox (C)+TX1 (A+B)+chlorothalonil (D), 2-(difluoromethyl)-N-(3-ethyl-1,1-dimethyl-indan-4-yl)pyridine-3-carboxamide (C)+TX1 (A+B)+chlorothalonil (D), 2-(difluoromethyl)-N-((3R) 1, 1, 3-trimethylindan-4-yl) pyridine-3-carboxamide (C)+TX1 (A+B)+chlorothalonil (D), 4-[[6-[2-(2,4-difluorophenyl)-1,1-difluoro-2-hydroxy-3-(1,2,4-triazol-1-yl)propyl]-3-pyridyl]oxy]benzonitrile (C)+TX1 (A+B)+chlorothalonil (D), metyltetraprole (C)+TX1 (A+B)+chlorothalonil (D), 2-(difluoromethyl) N-((3R)-1, 1, 3-trimethylindan-4-yl) pyridine-3-carboxamide (C)+TX1 (A+B)+chlorothalonil (D), α-(1, 1-dimethylethyl)-α-[4′-(trifluoromethoxy) [1,1′-biphenyl]-4-yl]-5-pyrimidinemethanol (C)+TX1 (A+B)+chlorothalonil (D), fluoxapiprolin (C)+TX1 (A+B)+chlorothalonil (D), enoxastrobin (C)+TX1 (A+B)+chlorothalonil (D), 4-[[6-[2-(2,4-difluorophenyl)-1,1-difluoro-2-hydroxy-3-(1,2,4-triazol-1-yl)propyl]-3-pyridyl]oxy]benzonitrile (C)+TX1 (A+B)+chlorothalonil (D), 4-[[6-[2-(2,4-difluorophenyl)-1,1-difluoro-2-hydroxy-3-(5-sulfanyl-1,2,4-triazol-1-yl)propyl]-3-pyridyl]oxy]benzonitrile (C)+TX1 (A+B)+chlorothalonil (D), 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile (C)+TX1 (A+B)+chlorothalonil (D), trinexapac (C)+TX1 (A+B)+chlorothalonil (D), coumoxystrobin (C)+TX1 (A+B)+chlorothalonil (D), zhongshengmycin (C)+TX1 (A+B)+chlorothalonil (D), thiodiazole copper (C)+TX1 (A+B)+chlorothalonil (D), zinc thiazole (C)+TX1 (A+B)+chlorothalonil (D), amectotractin (C)+TX1 (A+B)+chlorothalonil (D), iprodione (C)+TX1 (A+B)+chlorothalonil (D), seboctylamine (C)+TX1 (A+B)+chlorothalonil (D); N′-[5-bromo-2-methyl-6-[(1S)-1-methyl-2-propoxy-ethoxy]-3-pyridyl]-N-ethyl-N-methyl-formamidine (C)+TX1 (A+B)+chlorothalonil (D), N′-[5-bromo-2-methyl-6-[(1R)-1-methyl-2-propoxy-ethoxy]-3-pyridyl]-N-ethyl-N-methyl-formamidine (C)+TX1 (A+B)+chlorothalonil (D), N′-[5-bromo-2-methyl-6-(1-methyl-2-propoxy-ethoxy)-3-pyridyl]-N-ethyl-N-methyl-formamidine (C)+TX1 (A+B)+chlorothalonil (D), N′-[5-chloro-2-methyl-6-(1-methyl-2-propoxy-ethoxy)-3-pyridyl]-N-ethyl-N-methyl-formamidine (C)+TX1 (A+B)+chlorothalonil (D), N′-[5-bromo-2-methyl-6-(1-methyl-2-propoxy-ethoxy)-3-pyridyl]-N-isopropyl-N-methyl-formamidine (C)+TX1 (A+B)+chlorothalonil (D) (these compounds may be prepared from the methods described in WO2015/155075); N′-[5-bromo-2-methyl-6-(2-propoxypropoxy)-3-pyridyl]-N-ethyl-N-methyl-formamidine (C)+TX1 (A+B)+chlorothalonil (D) (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine(C)+TX1 (A+B)+chlorothalonil (D), N′-[4-(1-cyclopropyl-2,2,2-trifluoro-1-hydroxy-ethyl)-5-methoxy-2-methyl-phenyl]-N-isopropyl-N-methyl-formamidine (C)+TX1 (A+B)+chlorothalonil (D) (these compounds may be prepared from the methods described in WO2018/228896); N-ethyl-N′-[5-methoxy-2-methyl-4-[(2-trifluoromethyl)oxetan-2-yl]phenyl]-N-methyl-formamidine (C)+TX1 (A+B)+chlorothalonil (D), N-ethyl-N′-[5-methoxy-2-methyl-4-[(2-trifuoromethyl)tetrahydrofuran-2-yl]phenyl]-N-methyl-formamidine (C)+TX1 (A+B)+chlorothalonil (D) (these compounds may be prepared from the methods described in WO2019/110427); N-[(1R)-1-benzyl-3-chloro-1-methyl-but-3-enyl]-8-fluoro-quinoline-3-carboxamide (C)+TX1 (A+B)+chlorothalonil (D), N-[(1S)-1-benzyl-3-chloro-1-methyl-but-3-enyl]-8-fluoro-quinoline-3-carboxamide (C)+TX1 (A+B)+chlorothalonil (D), N-[(1R)-1-benzyl-3,3,3-trifluoro-1-methyl-propyl]-8-fluoro-quinoline-3-carboxamide (C)+TX1 (A+B)+chlorothalonil (D), N-[(1S)-1-benzyl-3,3,3-trifluoro-1-methyl-propyl]-8-fluoro-quinoline-3-carboxamide (C)+TX1 (A+B)+chlorothalonil (D), N-[(1R)-1-benzyl-1,3-dimethyl-butyl]-7,8-difluoro-quinoline-3-carboxamide (C)+TX1 (A+B)+chlorothalonil (D), N-[(1S)-1-benzyl-1,3-dimethyl-butyl]-7,8-difluoro-quinoline-3-carboxamide (C)+TX1 (A+B)+chlorothalonil (D), 8-fluoro-N-[(1R)-1-[(3-fluorophenyl)methyl]-1,3-dimethyl-butyl]quinoline-3-carboxamide (C)+TX1 (A+B)+chlorothalonil (D), 8-fluoro-N-[(1S)-1-[(3-fluorophenyl)methyl]-1,3-dimethyl-butyl]quinoline-3-carboxamide (C)+TX1 (A+B)+chlorothalonil (D), N-[(1R)-1-benzyl-1,3-dimethyl-butyl]-8-fluoro-quinoline-3-carboxamide (C)+TX1 (A+B)+chlorothalonil (D), N-[(1S)-1-benzyl-1,3-dimethyl-butyl]-8-fluoro-quinoline-3-carboxamide (C)+TX1 (A+B)+chlorothalonil (D), N-((1R)-1-benzyl-3-chloro-1-methyl-but-3-enyl)-8-fluoro-quinoline-3-carboxamide (C)+TX1 (A+B)+chlorothalonil (D), N-((1S)-1-benzyl-3-chloro-1-methyl-but-3-enyl)-8-fluoro-quinoline-3-carboxamide (C)+TX1 (A+B)+chlorothalonil (D) (these compounds may be prepared from the methods described in WO2017/153380); 1-(6,7-dimethylpyrazolo[1,5-a]pyridin-3-yl)-4,4,5-trifluoro-3,3-dimethyl-isoquinoline (C)+TX1 (A+B)+chlorothalonil (D), 1-(6,7-dimethylpyrazolo[1,5-a]pyridin-3-yl)-4,4,6-trifluoro-3,3-dimethyl-isoquinoline (C)+TX1 (A+B)+chlorothalonil (D), 4,4-difluoro-3,3-dimethyl-1-(6-methylpyrazolo[1,5-a]pyridin-3-yl)isoquinoline (C)+TX1 (A+B)+chlorothalonil (D), 4,4-difluoro-3,3-dimethyl-1-(7-methylpyrazolo[1,5-a]pyridin-3-yl)isoquinoline (C)+TX1 (A+B)+chlorothalonil (D), 1-(6-chloro-7-methyl-pyrazolo[1,5-a]pyridin-3-yl)-4,4-difluoro-3,3-dimethyl-isoquinoline (C)+TX1 (A+B)+chlorothalonil (D) (these compounds may be prepared from the methods described in WO2017/025510); 1-(4,5-dimethylbenzimidazol-1-yl)-4,4,5-trifluoro-3,3-dimethyl-isoquinoline (C)+TX1 (A+B)+chlorothalonil (D), 1-(4,5-dimethylbenzimidazol-1-yl)-4,4-difluoro-3,3-dimethyl-isoquinoline (C)+TX1 (A+B)+chlorothalonil (D), 6-chloro-4,4-difluoro-3,3-dimethyl-1-(4-methylbenzimidazol-1-yl)isoquinoline (C)+TX1 (A+B)+chlorothalonil (D), 4,4-difluoro-1-(5-fluoro-4-methyl-benzimidazol-1-yl)-3,3-dimethyl-isoquinoline (C)+TX1 (A+B)+chlorothalonil (D), 3-(4,4-difluoro-3,3-dimethyl-1-isoquinolyl)-7,8-dihydro-6H-cyclopenta[e]benzimidazole (C)+TX1 (A+B)+chlorothalonil (D) (these compounds may be prepared from the methods described in WO2016/156085); N-methoxy-N-[[4-[5-(trifluoromethyl)-1,2,4-oxadiazol-3-yl]phenyl]methyl]cyclopropanecarboxamide (C)+TX1 (A+B)+chlorothalonil (D), N,2-dimethoxy-N-[[4-[5-(trifluoromethyl)-1,2,4-oxadiazol-3-yl]phenyl]methyl]propanamide (C)+TX1 (A+B)+chlorothalonil (D), N-ethyl-2-methyl-N-[[4-[5-(trifluoromethyl)-1,2,4-oxadiazol-3-yl]phenyl]methyl]propanamide (C)+TX1 (A+B)+chlorothalonil (D), 1-methoxy-3-methyl-1-[[4-[5-(trifluoromethyl)-1,2,4-oxadiazol-3-yl]phenyl]methyl]urea (C)+TX1 (A+B)+chlorothalonil (D), 1,3-dimethoxy-1-[[4-[5-(trifluoromethyl)-1,2,4-oxadiazol-3-yl]phenyl]methyl]urea (C)+TX1 (A+B)+chlorothalonil (D), 3-ethyl-1-methoxy-1-[[4-[5-(trifluoromethyl)-1,2,4-oxadiazol-3-yl]phenyl]methyl]urea (C)+TX1 (A+B)+chlorothalonil (D), N-[[4-[5-(trifluoromethyl)-1,2,4-oxadiazol-3-yl]phenyl]methyl]propanamide (C)+TX1 (A+B)+chlorothalonil (D), 4,4-dimethyl-2-[[4-[5-(trifluoromethyl)-1,2,4-oxadiazol-3-yl]phenyl]methyl]isoxazolidin-3-one (C)+TX1 (A+B)+chlorothalonil (D), 5,5-dimethyl-2-[[4-[5-(trifluoromethyl)-1,2,4-oxadiazol-3-yl]phenyl]methyl]isoxazolidin-3-one (C)+TX1 (A+B)+chlorothalonil (D), ethyl 1-[[4-[5-(trifluoromethyl)-1,2,4-oxadiazol-3-yl]phenyl]methyl]pyrazole-4-carboxylate (C)+TX1 (A+B)+chlorothalonil (D), N,N-dimethyl-1-[[4-[5-(trifluoromethyl)-1,2,4-oxadiazol-3-yl]phenyl]methyl]-1,2,4-triazol-3-amine (C)+TX1 (A+B)+chlorothalonil (D). The compounds in this paragraph may be prepared from the methods described in WO 2017/055473, WO 2017/055469, WO 2017/093348 and WO 2017/118689; 2-[6-(4-chlorophenoxy)-2-(trifluoromethyl)-3-pyridyl]-1-(1,2,4-triazol-1-yl)propan-2-ol (C)+TX1 (A+B)+chlorothalonil (D) (this compound may be prepared from the methods described in WO 2017/029179); 2-[6-(4-bromophenoxy)-2-(trifluoromethyl)-3-pyridyl]-1-(1,2,4-triazol-1-yl)propan-2-ol (C)+TX1 (A+B)+chlorothalonil (D) (this compound may be prepared from the methods described in WO 2017/029179); 3-[2-(1-chlorocyclopropyl)-3-(2-fluorophenyl)-2-hydroxy-propyl]imidazole-4-carbonitrile (C)+TX1 (A+B)+chlorothalonil (D) (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile (C)+TX1 (A+B)+chlorothalonil (D) (this compound may be prepared from the methods described in WO 2016/156290); (4-phenoxyphenyl)methyl 2-amino-6-methyl-pyridine-3-carboxylate (C)+TX1 (A+B)+chlorothalonil (D) (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone (C)+TX1 (A+B)+chlorothalonil (D) (this compound may be prepared from the methods described in WO 2011/138281); N-methyl-4-[5-(trifluoromethyl)-1,2,4-oxadiazol-3-yl]benzenecarbothioamide (C)+TX1 (A+B)+chlorothalonil (D); N-methyl-4-[5-(trifluoromethyl)-1,2,4-oxadiazol-3-yl]benzamide (C)+TX1 (A+B)+chlorothalonil (D); (Z,2E)-5-[1-(2,4-dichlorophenyl)pyrazol-3-yl]oxy-2-methoxyimino-N,3-dimethyl-pent-3-enamide (C)+TX1 (A+B)+chlorothalonil (D) (this compound may be prepared from the methods described in WO 2018/153707); N′-(2-chloro-5-methyl-4-phenoxy-phenyl)-N-ethyl-N-methyl-formamidine (C)+TX1 (A+B)+chlorothalonil (D); N′-[2-chloro-4-(2-fluorophenoxy)-5-methyl-phenyl]-N-ethyl-N-methyl-formamidine (C)+TX1 (A+B)+chlorothalonil (D) (this compound may be prepared from the methods described in WO 2016/202742); 2-(difluoromethyl)-N-[(3S)-3-ethyl-1,1-dimethyl-indan-4-yl]pyridine-3-carboxamide (C)+TX1 (A+B)+chlorothalonil (D) (this compound may be prepared from the methods described in WO 2014/095675); (5-methyl-2-pyridyl)-[4-[5-(trifluoromethyl)-1,2,4-oxadiazol-3-yl]phenyl]methanone (C)+TX1 (A+B)+chlorothalonil (D), (3-methylisoxazol-5-yl)-[4-[5-(trifluoromethyl)-1,2,4-oxadiazol-3-yl]phenyl]methanone (C)+TX1 (A+B)+chlorothalonil (D) (these compounds may be prepared from the methods described in WO 2017/220485); 2-oxo-N-propyl-2-[4-[5-(trifluoromethyl)-1,2,4-oxadiazol-3-yl]phenyl]acetamide (C)+TX1 (A+B)+chlorothalonil (D) (this compound may be prepared from the methods described in WO 2018/065414); ethyl 1-[[5-[5-(trifluoromethyl)-1,2,4-oxadiazol-3-yl]-2-thienyl]methyl]pyrazole-4-carboxylate (C)+TX1 (A+B)+chlorothalonil (D) (this compound may be prepared from the methods described in WO 2018/158365); 2,2-difluoro-N-methyl-2-[4-[5-(trifluoromethyl)-1,2,4-oxadiazol-3-yl]phenyl]acetamide (C)+TX1 (A+B)+chlorothalonil (D), N-[(E)-methoxyiminomethyl]-4-[5-(trifluoromethyl)-1,2,4-oxadiazol-3-yl]benzamide (C)+TX1 (A+B)+chlorothalonil (D), N-[(Z)-methoxyiminomethyl]-4-[5-(trifluoromethyl)-1,2,4-oxadiazol-3-yl]benzamide (C)+TX1 (A+B)+chlorothalonil (D), N-[N-methoxy-C-methyl-carbonimidoyl]-4-[5-(trifluoromethyl)-1,2,4-oxadiazol-3-yl]benzamide (C)+TX1 (A+B)+chlorothalonil (D) (these compounds may be prepared from the methods described in WO 2018/202428).

The present invention also provides mixture compositions as follows (wherein the nature of the component, for example component (A), component (B) or component (C) is indicated in parenthesis), wherein the term “TX1” represents a composition (according to the definition of component (A) and component (B) as defined in table N1 above) selected from the group consisting of N1.001 to N1.038 and N2.001 to N2.038 and a biological control agent selected from the group consisting of:

(1) antibacterial agents selected from the group of
(1.1) bacteria, such as Bacillus subtilis, in particular strain QST713/AQ713 (available as SERENADE OPTI or SERENADE ASO from Bayer CropScience LP, US, having NRRL Accession No. B21661, U.S. Pat. No. 6,060,051) (C)+TX1 (A+B); Bacillus sp., in particular strain D747 (available as DOUBLE NICKEL® from Kumiai Chemical Industry Co., Ltd.), having Accession No. FERM BP-8234, U.S. Pat. No. 7,094,592 (C)+TX1 (A+B); Bacillus pumilus, in particular strain BU F-33, having NRRL Accession No. 50185 (available as part of the CARTISSA® product from BASF, EPA Reg. No. 71840-19) (C)+TX1 (A+B); Bacillus subtilis var. amyloliquefaciens strain FZB24 having Accession No. DSM 10271 (available from Novozymes as TAEGRO® or TAEGRO® ECO (EPA Registration No. 70127-5)) (C)+TX1 (A+B); a PaeniBacillus sp. strain having Accession No. NRRL B-50972 or Accession No. NRRL B-67129, WO 2016/154297 (C)+TX1 (A+B); Bacillus subtilis strain BU1814, (available as VELONDIS® PLUS, VELONDIS® FLEX and VELONDIS® EXTRA from BASF SE) (C)+TX1 (A+B); Bacillus mojavensis strain R3B (Accession No. NCAIM (P) B001389) (WO 2013/034938) from Certis USA LLC, a subsidiary of Mitsui & Co. (C)+TX1 (A+B); Bacillus subtilis CX-9060 from Certis USA LLC, a subsidiary of Mitsui & Co. (C)+TX1 (A+B); Paenibacillus polymyxa, in particular strain AC-1 (e.g. TOPSEED® from Green Biotech Company Ltd.) (C)+TX1 (A+B); Pseudomonas proradix (e.g. PRORADIX® from Sourcon Padena) (C)+TX1 (A+B); Pantoea agglomerans, in particular strain E325 (Accession No. NRRL B-21856) (available as BLOOMTIME BIOLOGICAL™ FD BIOPESTICIDE from Northwest Agri Products) (C)+TX1 (A+B); and
(1.2) fungi, such as Aureobasidium pullulans, in particular blastospores of strain DSM14940, blastospores of strain DSM 14941 or mixtures of blastospores of strains DSM14940 and DSM14941 (e.g., BOTECTOR® and BLOSSOM PROTECT® from bio-ferm, CH) (C)+TX1 (A+B); Pseudozyma aphidis (as disclosed in WO2011/151819 by Yissum Research Development Company of the Hebrew University of Jerusalem) (C)+TX1 (A+B); Saccharomyces cerevisiae, in particular strains CNCM No. 1-3936, CNCM No. 1-3937, CNCM No. 1-3938 or CNCM No. 1-3939 (WO 2010/086790) from Lesaffre et Compagnie, FR (C)+TX1 (A+B);
(2) biological fungicides selected from the group of: (2.1) bacteria, for example Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051) (C)+TX1 (A+B); Bacillus pumilus, in particular strain QST2808 (available as SONATA® from Bayer CropScience LP, US, having Accession No. NRRL B-30087 and described in U.S. Pat. No. 6,245,551) (C)+TX1 (A+B); Bacillus pumilus, in particular strain GB34 (available as Yield Shield® from Bayer AG, DE) (C)+TX1 (A+B); Bacillus pumilus, in particular strain BU F-33, having NRRL Accession No. 50185 (available as part of the CARTISSA product from BASF, EPA Reg. No. 71840-19) (C)+TX1 (A+B); Bacillus amyloliquefaciens, in particular strain D747 (available as Double Nickel™ from Kumiai Chemical Industry Co., Ltd., having accession number FERM BP-8234, U.S. Pat. No. 7,094,592) (C)+TX1 (A+B); Bacillus subtilis Y1336 (available as BIOBAC® WP from Bion-Tech, Taiwan, registered as a biological fungicide in Taiwan under Registration Nos. 4764, 5454, 5096 and 5277) (C)+TX1 (A+B); Bacillus subtilis strain MBI 600 (available as SUBTILEX from BASF SE), having Accession Number NRRL B-50595, U.S. Pat. No. 5,061,495 (C)+TX1 (A+B); Bacillus subtilis strain GB03 (available as Kodiak® from Bayer AG, DE) (C)+TX1 (A+B); Bacillus subtilis var. amyloliquefaciens strain FZB24 having Accession No. DSM 10271 (available from Novozymes as TAEGRO® or TAEGRO® ECO (EPA Registration No. 70127-5)) (C)+TX1 (A+B); Bacillus mycoides, isolate J, having Accession No. B-30890 (available as BMJ TGAI® or WG and LifeGard™ from Certis USA LLC, a subsidiary of Mitsui & Co.) (C)+TX1 (A+B); Bacillus licheniformis, in particular strain SB3086, having Accession No. ATCC 55406, WO 2003/000051 (available as ECOGUARD® Biofungicide and GREEN RELEAF™ from Novozymes) (C)+TX1 (A+B); a Paenibacillus sp. strain having Accession No. NRRL B-50972 or Accession No. NRRL B-67129, WO 2016/154297 (C)+TX1 (A+B); Bacillus subtilis strain BU1814, (available as VELONDIS® PLUS, VELONDIS® FLEX and VELONDIS® EXTRA from BASF SE) (C)+TX1 (A+B); Bacillus subtilis CX-9060 from Certis USA LLC, a subsidiary of Mitsui & Co. (C)+TX1 (A+B); Bacillus amyloliquefaciens strain F727 (also known as strain MB1110) (NRRL Accession No. B-50768; WO 2014/028521) (STARGUS® from Marrone Bio Innovations) (C)+TX1 (A+B); Bacillus amyloliquefaciens strain FZB42, Accession No. DSM 23117 (available as RHIZOVITAL® from ABiTEP, DE) (C)+TX1 (A+B); Bacillus licheniformis FMCH001 and Bacillus subtilis FMCH002 (QUARTZO® (WG) and PRESENCE® (WP) from FMC Corporation) (C)+TX1 (A+B); Bacillus mojavensis strain R3B (Accession No. NCAIM (P) B001389) (WO 2013/034938) from Certis USA LLC, a subsidiary of Mitsui & Co. (C)+TX1 (A+B); Paenibacillus polymyxa ssp. plantarum (WO 2016/020371) from BASF SE (C)+TX1 (A+B); Paenibacillus epiphyticus (WO 2016/020371) from BASF SE (C)+TX1 (A+B); Pseudomonas chlororaphis strain AFS009, having Accession No. NRRL B-50897, WO 2017/019448 (e.g., HOWLER™ and ZIO® from AgBiome Innovations, US) (C)+TX1 (A+B); Pseudomonas chlororaphis, in particular strain MA342 (e.g. CEDOMON®, CERALL®, and CEDRESS® by Bioagri and Koppert) (C)+TX1 (A+B); Streptomyces lydicus strain WYEC108 (also known as Streptomyces lydicus strain WYCD108US) (ACTINO-IRON® and ACTINOVATE® from Novozymes) (C)+TX1 (A+B); Agrobacterium radiobacter strain K84 (e.g. GALLTROL-A® from AgBioChem, CA) (C)+TX1 (A+B); Agrobacterium radiobacter strain K1026 (e.g. NOGALL™ from BASF SE) (C)+TX1 (A+B); Bacillus subtilis KTSB strain (FOLIACTIVE® from Donaghys) (C)+TX1 (A+B); Bacillus subtilis IAB/BS03 (AVIV™ from STK Bio-Ag Technologies) (C)+TX1 (A+B); Bacillus subtilis strain Y1336 (available as BIOBAC® WP from Bion-Tech, Taiwan, registered as a biological fungicide in Taiwan under Registration Nos. 4764, 5454, 5096 and 5277) (C)+TX1 (A+B); Bacillus amyloliquefaciens isolate B246 (e.g. AVOGREEN™ from University of Pretoria) (C)+TX1 (A+B); Bacillus methylotrophicus strain BAC-9912 (from Chinese Academy of Sciences' Institute of Applied Ecology) (C)+TX1 (A+B); Pseudomonas proradix (e.g. PRORADIX® from Sourcon Padena) (C)+TX1 (A+B); Streptomyces griseoviridis strain K61 (also known as Streptomyces galbus strain K61) (Accession No. DSM 7206) (MYCOSTOP® from Verdera; PREFENCE® from BioWorks; cf. Crop Protection 2006, 25, 468-475) (C)+TX1 (A+B); Pseudomonasfluorescens strain A506 (e.g. BLIGHTBAN® A506 by NuFarm) (C)+TX1 (A+B); and
(2.2) fungi, for example: Coniothyrium minitans, in particular strain CON/M/91-8 (Accession No. DSM9660; e.g. Contans® from Bayer CropScience Biologics GmbH) (C)+TX1 (A+B); Metschnikowia fructicola, in particular strain NRRL Y-30752 (C)+TX1 (A+B); (B2.2.3) Microsphaeropsis ochracea (C)+TX1 (A+B); Trichoderma atroviride, in particular strain SC1 (having Accession No. CBS 122089, WO 2009/116106 and U.S. Pat. No. 8,431,120 (from Bi-PA)), strain 77B (T77 from Andermatt Biocontrol) or strain LU132 (e.g. Sentinel from Agrimm Technologies Limited) (C)+TX1 (A+B); Trichoderma harzianum strain T-22 (e.g. Trianum-P from Andermatt Biocontrol or Koppert) or strain Cepa SimbT5 (from Simbiose Agro) (C)+TX1 (A+B); Gliocladium roseum (also known as Clonostachys rosea f rosea), in particular strain 321U from Adjuvants Plus, strain ACM941 as disclosed in Xue (Efficacy of Clonostachys rosea strain ACM941 and fungicide seed treatments for controlling the root tot complex of field pea, Can Jour Plant Sci 83(3): 519-524), or strain IK726 (Jensen D F, et al. Development of a biocontrol agent for plant disease control with special emphasis on the near commercial fungal antagonist Clonostachys rosea strain ‘IK726’; Australas Plant Pathol. 2007; 36:95-101) (C)+TX1 (A+B); Talaromyces flavus, strain V117b (C)+TX1 (A+B); Trichoderma viride, in particular strain B35 (Pietr et al., 1993, Zesz. Nauk. A R w Szczecinie 161: 125-137) (C)+TX1 (A+B); Trichoderma asperellum, in particular strain SKT-1, having Accession No. FERM P-16510 (e.g. ECO-HOPE® from Kumiai Chemical Industry), strain T34 (e.g. T34 Biocontrol by Biocontrol Technologies S.L., ES) or strain ICC 012 from Isagro (C)+TX1 (A+B); Trichoderma atroviride, strain CNCM 1-1237 (e.g. Esquive® WP from Agrauxine, FR) (C)+TX1 (A+B); Trichoderma atroviride, strain no. V08/002387 (C)+TX1 (A+B); Trichoderma atroviride, strain NMI no. V08/002388 (C)+TX1 (A+B); Trichoderma atroviride, strain NMI no. V08/002389 (C)+TX1 (A+B); Trichoderma atroviride, strain NMI no. V08/002390 (C)+TX1 (A+B); Trichoderma atroviride, strain LC52 (e.g. Tenet by Agrimm Technologies Limited) (C)+TX1 (A+B); Trichoderma atroviride, strain ATCC 20476 (IMI 206040) (C)+TX1 (A+B); Trichoderma atroviride, strain T11 (IM1352941/CECT20498) (C)+TX1 (A+B); Trichoderma harmatum (C)+TX1 (A+B); Trichoderma harzianum (C)+TX1 (A+B); Trichoderma harzianum rifai T39 (e.g. Trichodex® from Makhteshim, US) (C)+TX1 (A+B); Trichoderma asperellum, in particular, strain kd (e.g. T-Gro from Andermatt Biocontrol) (C)+TX1 (A+B); Trichoderma harzianum, strain ITEM 908 (e.g. Trianum-P from Koppert) (C)+TX1 (A+B); Trichoderma harzianum, strain TH35 (e.g. Root-Pro by Mycontrol) (C)+TX1 (A+B); Trichoderma virens (also known as Gliocladium virens), in particular strain GL-21 (e.g. SoilGard by Certis, US) (C)+TX1 (A+B); Trichoderma viride, strain TV1(e.g. Trianum-P by Koppert) (C)+TX1 (A+B); Ampelomyces quisqualis, in particular strain AQ 10 (e.g. AQ 10® by IntrachemBio Italia) (C)+TX1 (A+B); Aureobasidium pullulans, in particular blastospores of strain DSM14940 (C)+TX1 (A+B); Aureobasidium pullulans, in particular blastospores of strain DSM 14941 (C)+TX1 (A+B); Aureobasidium pullulans, in particular mixtures of blastospores of strains DSM14940 and DSM 14941 (e.g. Botector® by bio-ferm, CH) (C)+TX1 (A+B); Cladosporium cladosporioides, strain H39, having Accession No. CBS122244, US 2010/0291039 (by Stichting Dienst Landbouwkundig Onderzoek) (C)+TX1 (A+B); Gliocladium catenulatum (Synonym: Clonostachys rosea f. catenulate) strain J1446 (e.g. Prestop® by Lallemand) (C)+TX1 (A+B); Lecanicillium lecanii (formerly known as Verticillium lecanii) conidia of strain KV01 (e.g. Vertalec® by Koppert/Arysta) (C)+TX1 (A+B); Penicillium vermiculatum (C)+TX1 (A+B); Pichia anomala, strain WRL-076 (NRRL Y-30842), U.S. Pat. No. 7,579,183 (C)+TX1 (A+B); Trichoderma atroviride, strain SKT-1 (FERM P-16510), JP Patent Publication (Kokai) 11-253151 A (C)+TX1 (A+B); Trichoderma atroviride, strain SKT-2 (FERM P-16511), JP Patent Publication (Kokai) 11-253151 A (C)+TX1 (A+B); Trichoderma atroviride, strain SKT-3 (FERM P-17021), JP Patent Publication (Kokai) 11-253151 A (C)+TX1 (A+B); Trichoderma gamsii (formerly T. viride), strain ICC080 (IMI CC 392151 CABI, e.g. BioDerma by AGROBIOSOL DE MEXICO, S.A. DE C.V.) (C)+TX1 (A+B); Trichoderma harzianum, strain DB 103 (available as T-GRO® 7456 by Dagutat Biolab) (C)+TX1 (A+B); Trichoderma polysporum, strain IMI 206039 (e.g. Binab TF WP by BINAB Bio-Innovation AB, Sweden) (C)+TX1 (A+B); Trichoderma stromaticum, having Accession No. Ts3550 (e.g. Tricovab by CEPLAC, Brazil) (C)+TX1 (A+B); Ulocladium oudemansii strain U3, having Accession No. NM 99/06216 (e.g., BOTRY-ZEN® by Botry-Zen Ltd, New Zealand and BOTRYSTOP® from BioWorks, Inc.) (C)+TX1 (A+B); Verticillium albo-atrum (formerly V. dahliae), strain WCS850 having Accession No. WCS850, deposited at the Central Bureau for Fungi Cultures (e.g., DUTCH TRIG® by Tree Care Innovations) (C)+TX1 (A+B); Verticillium chlamydosporium (C)+TX1 (A+B); mixtures of Trichoderma asperellum strain ICC 012 (also known as Trichoderma harzianum ICC012), having Accession No. CABI CC IMI 392716 and Trichoderma gamsii (formerly T. viride) strain ICC 080, having Accession No. IMI 392151 (e.g., BIO-TAM™ from Isagro USA, Inc. and BIODERMA® by Agrobiosol de Mexico, S.A. de C.V.) (C)+TX1 (A+B); Trichoderma asperelloides JM41R (Accession No. NRRL B-50759) (TRICHO PLUS® from BASF SE) (C)+TX1 (A+B); Aspergillus flavus strain NRRL 21882 (products known as AFLA-GUARD® from Syngenta/ChemChina) (C)+TX1 (A+B); Chaetomium cupreum (Accession No. CABI 353812) (e.g. BIOKUPRUM™ by AgriLife) (C)+TX1 (A+B); Saccharomyces cerevisiae, in particular strain LASO2 (from Agro-Levures et Dérivés), strain LAS117 cell walls (CEREVISANE® from Lesaffre; ROMEO® from BASF SE), strains CNCM No. 1-3936, CNCM No. 1-3937, CNCM No. 1-3938, CNCM No. 1-3939 (WO 2010/086790) from Lesaffre et Compagnie, FR (C)+TX1 (A+B); Trichoderma virens strain G-41, formerly known as Gliocladium virens (Accession No. ATCC 20906) (e.g., ROOTSHIELD® PLUS WP and TURFSHIELD® PLUS WP from BioWorks, US) (C)+TX1 (A+B); Trichoderma hamatum, having Accession No. ATCC 28012 (C)+TX1 (A+B); Ampelomyces quisqualis strain AQ10, having Accession No. CNCM 1-807 (e.g., AQ 10® by IntrachemBio Italia) (C)+TX1 (A+B); Phlebiopsis gigantea strain VRA 1992 (ROTSTOP® C from Danstar Ferment) (C)+TX1 (A+B); Penicillium steckii (DSM 27859; WO 2015/067800) from BASF SE (C)+TX1 (A+B); Chaetomium globosum (available as RIVADIOM® by Rivale) (C)+TX1 (A+B); Cryptococcus flavescens, strain 3C (NRRL Y-50378) (C)+TX1 (A+B); (B2.2.99) Dactylaria candida (C)+TX1 (A+B); Dilophosphora alopecuri (available as TWIST FUNGUS®) (C)+TX1 (A+B); Fusarium oxysporum, strain Fo47 (available as FUSACLEAN® by Natural Plant Protection) (C)+TX1 (A+B); Pseudozyma flocculosa, strain PF-A22 UL (available as SPORODEX® L by Plant Products Co., CA) (C)+TX1 (A+B); (2.2.103) Trichoderma gamsii (formerly T. viride), strain ICC 080 (IMI CC 392151 CABI) (available as BIODERMA® by AGROBIOSOL DE MEXICO, S.A. DE C.V.) (C)+TX1 (A+B); Trichoderma fertile (e.g. product TrichoPlus from BASF) (C)+TX1 (A+B); Muscodor roseus, in particular strain A3-5 (Accession No. NRRL 30548) (C)+TX1 (A+B); Simplicillium lanosoniveum (C)+TX1 (A+B);
(3) biological control agents having an effect for improving plant growth and/or plant health which may be combined in the compound combinations according to the invention including
(3.1) bacteria selected from the group consisting of Bacillus pumilus, in particular strain QST2808 (having Accession No. NRRL No. B-30087) (C)+TX1 (A+B); Bacillus subtilis, in particular strain QST713/AQ713 (having NRRL Accession No. B-21661 and described in U.S. Pat. No. 6,060,051; available as SERENADE® OPTI or SERENADE® ASO from Bayer CropScience LP, US) (C)+TX1 (A+B); Bacillus subtilis, in particular strain AQ30002 (having Accession Nos. NRRL B-50421 and described in U.S. patent application Ser. No. 13/330,576) (C)+TX1 (A+B); Bacillus subtilis, in particular strain AQ30004 (and NRRL B-50455 and described in U.S. patent application Ser. No. 13/330,576) (C)+TX1 (A+B); Sinorhizobium meliloti strain NRG-185-1 (NITRAGIN® GOLD from Bayer CropScience) (C)+TX1 (A+B); Bacillus subtilis strain BU1814, (available as TEQUALIS® from BASF SE) (C)+TX1 (A+B); Bacillus subtilis rm303 (RHIZOMAX® from Biofilm Crop Protection) (C)+TX1 (A+B); Bacillus amyloliquefaciens pm414 (LOLI-PEPTA® from Biofilm Crop Protection) (C)+TX1 (A+B); Bacillus mycoides BT155 (NRRL No. B-50921) (C)+TX1 (A+B); Bacillus mycoides EE118 (NRRL No. B-50918) (C)+TX1 (A+B); Bacillus mycoides EE141 (NRRL No. B-50916) (C)+TX1 (A+B); Bacillus mycoides BT46-3 (NRRL No. B-50922) (C)+TX1 (A+B); Bacillus cereus family member EE128 (NRRL No. B-50917) (C)+TX1 (A+B); Bacillus thuringiensis BT013A (NRRL No. B-50924) also known as Bacillus thuringiensis 4Q7 (C)+TX1 (A+B); Bacillus cereus family member EE349 (NRRL No. B-50928) (C)+TX1 (A+B); Bacillus amyloliquefaciens SB3281 (ATCC #PTA-7542; WO 2017/205258) (C)+TX1 (A+B); Bacillus amyloliquefaciens TJ1000 (available as QUIKROOTS® from Novozymes) (C)+TX1 (A+B); Bacillus firmus, in particular strain CNMC 1-1582 (e.g. VOTIVO® from BASF SE) (C)+TX1 (A+B); Bacillus pumilus, in particular strain GB34 (e.g. YIELD SHIELD® from Bayer Crop Science, DE) (C)+TX1 (A+B); Bacillus amyloliquefaciens, in particular strain IN937a (C)+TX1 (A+B); Bacillus amyloliquefaciens, in particular strain FZB42 (e.g. RHIZOVITAL® from ABiTEP, DE) (C)+TX1 (A+B); Bacillus amyloliquefaciens BS27 (Accession No. NRRL B-5015) (C)+TX1 (A+B); a mixture of Bacillus licheniformis FMCH001 and Bacillus subtilis FMCH002 (available as QUARTZO® (WG), PRESENCE® (WP) from FMC Corporation) (C)+TX1 (A+B); Bacillus cereus, in particular strain BPO1 (ATCC 55675; e.g. MEPICHLOR® from Arysta Lifescience, US) (C)+TX1 (A+B); Bacillus subtilis, in particular strain MBI 600 (e.g. SUBTILEX® from BASF SE) (C)+TX1 (A+B); Bradyrhizobium japonicum (e.g. OPTIMIZE® from Novozymes) (C)+TX1 (A+B); Mesorhizobium cicer (e.g., NODULATOR from BASF SE) (C)+TX1 (A+B); Rhizobium leguminosarium biovar viciae (e.g., NODULATOR from BASF SE) (C)+TX1 (A+B); Delftia acidovorans, in particular strain RAY209 (e.g. BIOBOOST® from Brett Young Seeds) (C)+TX1 (A+B); Lactobacillus sp. (e.g. LACTOPLANT® from LactoPAFI) (C)+TX1 (A+B); Paenibacillus polymyxa, in particular strain AC-1 (e.g. TOPSEED® from Green Biotech Company Ltd.); Pseudomonas proradix (e.g. PRORADIX® from Sourcon Padena) (C)+TX1 (A+B); Azospirillum brasilense (e.g., VIGOR® from KALO, Inc.) (C)+TX1 (A+B); Azospirillum lipoferum (e.g., VERTEX-IF™ from TerraMax, Inc.) (C)+TX1 (A+B); a mixture ofAzotobactervinelandii and Clostridium pasteurianum (available as INVIGORATE® from Agrinos) (C)+TX1 (A+B); Pseudomonas aeruginosa, in particular strain PN1 (C)+TX1 (A+B); Rhizobium leguminosarum, in particular bv. viceae strain Z25 (Accession No. CECT 4585) (C)+TX1 (A+B); Azorhizobium caulinodans, in particular strain ZB-SK-5 (C)+TX1 (A+B); Azotobacter chroococcum, in particular strain H23 (C)+TX1 (A+B); Azotobacter vinelandii, in particular strain ATCC 12837 (C)+TX1 (A+B); Bacillus siamensis, in particular strain KCTC 13613T (C)+TX1 (A+B); Bacillus tequilensis, in particular strain NII-0943 (C)+TX1 (A+B); Serratia marcescens, in particular strain SRM (Accession No. MTCC 8708) (C)+TX1 (A+B); Thiobacillus sp. (e.g. CROPAID® from Cropaid Ltd UK) (C)+TX1 (A+B); and
(3.2) fungi selected from the group consisting of Purpureocillium lilacinum (previously known as Paecilomyces lilacinus) strain 251 (AGAL 89/030550; e.g. BioAct from Bayer CropScience Biologics GmbH) (C)+TX1 (A+B); Penicillium bilaii, strain ATCC 22348 (e.g. JumpStart® from Acceleron BioAg) (C)+TX1 (A+B); Talaromyces flavus, strain V117b (C)+TX1 (A+B); Trichoderma atroviride strain CNCM 1-1237 (e.g. Esquive® WP from Agrauxine, FR) (C)+TX1 (A+B); Trichoderma viride, e.g. strain B35 (Pietr et al., 1993, Zesz. Nauk. A R w Szczecinie 161: 125-137) (C)+TX1 (A+B); Trichoderma atroviride strain LC52 (also known as Trichoderma atroviride strain LU132; e.g. Sentinel from Agrimm Technologies Limited) (C)+TX1 (A+B); Trichoderma atroviride strain SC1 described in International Application No. PCT/IT2008/000196) (C)+TX1 (A+B); Trichoderma asperellum strain kd (e.g. T-Gro from Andermatt Biocontrol) (C)+TX1 (A+B); Trichoderma asperellum strain Eco-T (Plant Health Products, ZA) (C)+TX1 (A+B); Trichoderma harzianum strain T-22 (e.g. Trianum-P from Andermatt Biocontrol or Koppert) (C)+TX1 (A+B); Myrothecium verrucaria strain AARC-0255 (e.g. DiTera™ from Valent Biosciences) (C)+TX1 (A+B); Penicillium bilaii strain ATCC ATCC20851 (C)+TX1 (A+B); Pythium oligandrum strain M1 (ATCC 38472; e.g. Polyversum from Bioprepraty, CZ) (C)+TX1 (A+B); Trichoderma virens strain GL-21 (e.g. SoilGard® from Certis, USA) (C)+TX1 (A+B); Verticillium alboatrum (formerly V. dahliae) strain WCS850 (CBS 276.92; e.g. Dutch Trig from Tree Care Innovations) (C)+TX1 (A+B); Trichoderma atroviride, in particular strain no. V08/002387, strain no. NMI No. V08/002388, strain no. NMI No. V08/002389, strain no. NMI No. V08/002390 (C)+TX1 (A+B); Trichoderma harzianum strain ITEM 908 (C)+TX1 (A+B); Trichoderma harzianum, strain TSTh20 (C)+TX1 (A+B); Trichoderma harzianum strain 1295-22 (C)+TX1 (A+B); Pythium oligandrum strain DV74 (C)+TX1 (A+B); Rhizopogon amylopogon (e.g. comprised in Myco-Sol from Helena Chemical Company) (C)+TX1 (A+B); Rhizopogon fulvigleba (e.g. comprised in Myco-Sol from Helena Chemical Company) (C)+TX1 (A+B); and Trichoderma virens strain GI-3 (C)+TX1 (A+B);
(4) insecticidally active biological control agents selected from
(4.1) bacteria selected from the group consisting of Agrobacterium radiobacter strain K84 (Galltrol from AgBiochem Inc.) (C)+TX1 (A+B); Bacillus amyloliquefaciens, in particular strain PTS-4838 (e.g. AVEO from Valent Biosciences, US) (C)+TX1 (A+B); Bacillus firmus, in particular strain CNMC 1-1582 (e.g. VOTIVO® from BASF SE) (C)+TX1 (A+B); Bacillus thuringiensis subsp. aizawai, in particular strain ABTS-1857 (SD-1372; e.g. XENTARI® from Valent BioSciences) (C)+TX1 (A+B); Bacillus mycoides, isolate J. (e.g. BmJ from Certis USA LLC, a subsidiary of Mitsui & Co.) (C)+TX1 (A+B); Bacillus sphaericus, in particular Serotype H5a5b strain 2362 (strain ABTS-1743) (e.g. VECTOLEX® from Valent BioSciences, US) (C)+TX1 (A+B); Bacillus thuringiensis subsp. kurstaki strain BMP 123 from Becker Microbial Products, IL (BARITONE from Bayer CropScience) (C)+TX1 (A+B); Bacillus thuringiensis subsp. aizawai, in particular serotype H-7 (e.g. FLORBAC® WG from Valent BioSciences, US) (C)+TX1 (A+B); Bacillus thuringiensis subsp. kurstaki strain HD-1 (e.g. DIPEL® ES from Valent BioSciences, US) (C)+TX1 (A+B); Bacillus thuringiensis subsp. kurstaki strain BMP 123 by Becker Microbial Products, IL (C)+TX1 (A+B); Bacillus thuringiensis israelensis strain BMP 144 (e.g. AQUABAC® by Becker Microbial Products IL) (C)+TX1 (A+B); Brevibacillus laterosporus (LATERAL from Ecolibrium Biologicals) (C)+TX1 (A+B); Burkholderia spp., in particular Burkholderia rinojensis strain A396 (also known as Burkholderia rinojensis strain MBI 305) (Accession No. NRRL B-50319; WO 2011/106491 and WO 2013/032693; e.g. MB1206 TGAI and ZELTO® from Marrone Bio Innovations) (C)+TX1 (A+B); Chromobacterium subtsugae, in particular strain PRAA4-1T (MBI-203; e.g. GRANDEVO® from Marrone Bio Innovations) (C)+TX1 (A+B); Lecanicillium muscarium Ve6 (MYCOTAL from Koppert) (C)+TX1 (A+B); Paenibacillus popilliae (formerly Bacillus popilliae; e.g. MILKY SPORE POWDER™ and MILKY SPORE GRANULAR™ from St. Gabriel Laboratories) (C)+TX1 (A+B); Pasteuria nishizawae strain Pnl (CLARIVA from Syngenta/ChemChina) (C)+TX1 (A+B); Bacillus thuringiensis subsp. israelensis (serotype H-14) strain AM65-52 (Accession No. ATCC 1276) (e.g. VECTOBAC® by Valent BioSciences, US) (C)+TX1 (A+B); Bacillus thuringiensis var. kurstaki strain EVB-113-19 (e.g., BIOPROTEC® from AEF Global) (C)+TX1 (A+B); Bacillus thuringiensis subsp. tenebrionis strain NB 176 (SD-5428; e.g. NOVODOR® FC from BioFa DE) (C)+TX1 (A+B); Bacillus thuringiensis var. japonensis strain Buibui; Bacillus thuringiensis subsp. kurstaki strain ABTS 351 (C)+TX1 (A+B); Bacillus thuringiensis subsp. kurstaki strain PB 54 (C)+TX1 (A+B); Bacillus thuringiensis subsp. kurstaki strain SA 11 (JAVELIN from Certis, US) (C)+TX1 (A+B); Bacillus thuringiensis subsp. kurstaki strain SA 12 (THURICIDE, Certis, USA)) (C)+TX1 (A+B); Bacillus thuringiensis subsp. kurstaki strain EG 2348 (LEPINOX, Certis USA) (C)+TX1 (A+B); Bacillus thuringiensis subsp. kurstaki strain EG 7841 (CRYMAX from Certis, US) (C)+TX1 (A+B); Bacillus thuringiensis var. colmeri (e.g. TIANBAOBTC by Changzhou Jianghai Chemical Factory) (C)+TX1 (A+B); Bacillus thuringiensis subsp. aizawai strain GC-91 (C)+TX1 (A+B); Serratia entomophila (e.g. INVADE® by Wrightson Seeds) (C)+TX1 (A+B); Serratia marcescens, in particular strain SRM (Accession No. MTCC 8708) (C)+TX1 (A+B); Trichoderma asperellum (TRICHODERMAX from Novozymes) (C)+TX1 (A+B); and Wolbachia pipientis ZAP strain (e.g., ZAP MALES® from MosquitoMate) (C)+TX1 (A+B); and
(4.2) fungi selected from the group consisting of Isaria fumosorosea (previously known as Paecilomyces fumosoroseus) strain apopka 97 PREFERAL from SePRO(C)+TX1 (A+B); Beauveria bassiana strain ATCC 74040 (e.g. NATURALIS® from Intrachem Bio Italia) (C)+TX1 (A+B); Beauveria bassiana strain GHA (Accession No. ATCC74250; e.g. BOTANIGUARD® ES and MYCONTROL-O® from Laverlam International Corporation) (C)+TX1 (A+B); Zoophtora radicans(C)+TX1 (A+B); Metarhizium robertsii 15013-1 (deposited under NRRL accession number 67073) (C)+TX1 (A+B); Metarhizium robertsii 23013-3 (deposited under NRRL accession number 67075) (C)+TX1 (A+B); Metarhizium anisopliae 3213-1 (deposited under NRRL accession number 67074) (WO 2017/066094; Pioneer Hi-Bred International) (C)+TX1 (A+B); Paecilomyces lilacinus strain 251 (MELOCON from Certis, US) (C)+TX1 (A+B); and Beauveria bassiana strain ATPO2 (Accession No. DSM 24665) (C)+TX1 (A+B); and (5) Viruses selected from the group consisting of Adoxophyes orana (summer fruit tortrix) granulosis virus (GV) (C)+TX1 (A+B); Cydia pomonella (codling moth) granulosis virus (GV) (C)+TX1 (A+B); Helicoverpa armigera (cotton bollworm) nuclear polyhedrosis virus (NPV) (C)+TX1 (A+B); Spodoptera exigua (beet armyworm) mNPV (C)+TX1 (A+B); Spodoptera frugiperda (fall armyworm) mNPV (C)+TX1 (A+B); and Spodoptera littoralis (African cotton leafworm) NPV (C)+TX1 (A+B); and
(6) Bacteria and fungi which can be added as ‘inoculant’ to plants or plant parts or plant organs and which, by virtue of their particular properties, promote plant growth and plant health selected from the group consisting of Agrobacterium spp. (C)+TX1 (A+B); Azorhizobium caulinodans (C)+TX1 (A+B); Azospirillum spp. (C)+TX1 (A+B); Azotobacter spp. (C)+TX1 (A+B); Bradyrhizobium spp. (C)+TX1 (A+B); Burkholderia spp. (C)+TX1 (A+B); in particular Burkholderia cepacia (formerly known as Pseudomonas cepacia) (C)+TX1 (A+B); Gigaspora spp. (C)+TX1 (A+B); Gigaspora monosporum (C)+TX1 (A+B); Glomus spp. (C)+TX1 (A+B); Laccaria spp. (C)+TX1 (A+B); LactoBacillus buchneri (C)+TX1 (A+B); Paraglomus spp. (C)+TX1 (A+B); Pisolithus tinctorus (C)+TX1 (A+B); Pseudomonas spp. (C)+TX1 (A+B); Rhizobium spp. (C)+TX1 (A+B); in particular Rhizobium trifolii (C)+TX1 (A+B); Rhizopogon spp. (C)+TX1 (A+B); Scleroderma spp. (C)+TX1 (A+B); Suillus spp. (C)+TX1 (A+B); and Streptomyces spp. (C)+TX1 (A+B); and
(7) Plant extracts and products formed by microorganisms including proteins and secondary metabolites which can be used as biological control agents, such as Allium sativum (NEMGUARD from Eco-Spray; BRALIC from ADAMA) (C)+TX1 (A+B); Artemisia absinthium (C)+TX1 (A+B); azadirachtin (e.g. AZATIN XL from Certis, US), Biokeeper WP (C)+TX1 (A+B); Cassia nigricans (C)+TX1 (A+B); Celastrus angulatus (C)+TX1 (A+B); Chenopodium anthelminticum (C)+TX1 (A+B); chitin (C)+TX1 (A+B); Armour-Zen (C)+TX1 (A+B); Dryopteris filix-mas (C)+TX1 (A+B); Equisetum arvense (C)+TX1 (A+B); Fortune Aza (C)+TX1 (A+B); Fungastop (C)+TX1 (A+B); Heads Up (Chenopodium quinoa saponin extract) (C)+TX1 (A+B); PROBLAD (naturally occurring Blad polypeptide from Lupin seeds) (C)+TX1 (A+B); Certis EU, FRACTURE (naturally occurring Blad polypeptide from Lupin seeds) (C)+TX1 (A+B); FMC, Pyrethrum/Pyrethrins, Quassia amara (C)+TX1 (A+B); Quercus (C)+TX1 (A+B); Quillaja extract (QL AGR/35 from BASF) (C)+TX1 (A+B), Reynoutria sachalinensis extract (REGALLIA/REGALIA MAXX from Marrone Bio) (C)+TX1 (A+B); “Requiem™ Insecticide” (C)+TX1 (A+B); rotenone (C)+TX1 (A+B); ryania/ryanodine (C)+TX1 (A+B); Symphytum officinale (C)+TX1 (A+B); Tanacetum vulgare (C)+TX1 (A+B); thymol (C)+TX1 (A+B); Thymol mixed with Geraniol (CEDROZ from Eden Research) (C)+TX1 (A+B); Thymol mixed with Geraniol and Eugenol (MEVALONE from Eden Research) (C)+TX1 (A+B); Triact 70 (C)+TX1 (A+B); TriCon (C)+TX1 (A+B); Tropaeulum majus (C)+TX1 (A+B); Melaleuca alternifolia extract (TIMOREX GOLD from STK) (C)+TX1 (A+B); Urtica dioica (C)+TX1 (A+B); Veratrin (C)+TX1 (A+B); Viscum album (C)+TX1 (A+B); and Brassicaceae extract, in particular oilseed rape powder or mustard powder (C)+TX1 (A+B).

In one set of embodiments particularly preferred three-way compositions of the invention will comprise, and more preferably consist of the composition N1.001 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.002 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.003 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.004 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.005 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.006 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.007 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.008 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.009 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.010 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.011 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.012 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.013 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.014 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.015 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.016 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.017 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.018 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.019 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.020 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.021 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.022 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.023 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.024 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.025 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.026 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.027 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.028 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.029 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.030 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.031 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.032 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.033 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.034 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.035 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.036 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.037 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N1.038 (disclosed in table N1) as component (A) and component (B) (represented by the term “TX1”) in any of the three-way combinations with a biological control agent described directly above.

In one set of embodiments particularly preferred three-way compositions of the invention will comprise, and more preferably consist of the composition N2.001 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.002 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.003 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.004 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.005 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.006 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.007 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.008 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.009 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.010 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.011 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.012 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.013 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.014 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.015 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.016 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.017 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.018 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.019 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.020 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.021 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.022 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.023 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.024 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.025 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.026 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.027 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.028 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.029 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.030 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.031 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.032 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.033 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.034 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.035 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.036 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.037 (disclosed in table N1) as component (A) and component (B) (represented by the term “TX1”) in any of the three-way combinations with a biological control agent described directly above.

In another set of embodiments particularly preferred three-way compositions of the invention will comprise, and more preferably consist of the composition N2.038 (disclosed in table N1) as component (A) and component (B) (represented by the term “TX1”) in any of the three-way combinations with a biological control agent described directly above.

The mixtures comprising a compound selected from Tables M1 to M64 (above) and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds selected from Tables M1 to M64 (above) and the active ingredients as described above is not essential for working the present invention.

The compositions of the present invention may also be used in crop enhancement. According to the present invention, ‘crop enhancement’ means an improvement in plant vigour, an improvement in plant quality, improved tolerance to stress factors, and/or improved input use efficiency.

According to the present invention, an ‘improvement in plant vigour’ means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels of amino acids in storage tissues and/or less inputs needed (e.g. less fertiliser, water and/or labour needed). A plant with improved vigour may have an increase in any of the aforementioned traits or any combination or two or more of the aforementioned traits.

In an embodiment of the invention there is provided the use of a composition, wherein the composition is a composition selected from the group consisting of all the compositions disclosed in tables M1 to M64 above i.e M1.001 to M1.033, M2.001 to M2.032, M3.001 to M3.031, M4.001 to M4.030, M5.001 to M5.029, M6.001 to M6.028, M7.001 to M7.027, M8.001 to M8.026, M9.001 to M9.025, M10.001 to M10.024, M11.001 to M11.023, M12.001 to M12.022, M13.001 to M13.021, M14.001 to M14.020, M15.001 to M15.019, M16.001 to M16.018, M17.001 to M17.017, M18.001 to M18.016, M19.001 to M19.015, M20.001 to M20.014, M21.001 to M21.013, M22.001 to M22.012, M23.001 to M23.011, M24.001 to M24.010, M25.001 to M.25.009, M26.001 to M26.008, M27.001 to M27.007, M28.001 to M28.006, M29.001 to M29.005, M30.001 to M30.004, M31.001 to M31.003, M32.001 to M32.003, M33.001 to M33.033, M34.001 to M34.032, M35.001 to M35.031, M36.001 to M36.030, M37.001 to M37.029, M38.001 to M38.028, M39.001 to M39.027, M40.001 to M40.026, M41.001 to M41.025, M42.001 to M42.024, M43.001 to M43.023, M44.001 to M44.022, M45.001 to M45.021, M46.001 to M46.020, M47.001 to M47.019, M48.001 to M48.018, M49.001 to M49.017, M50.001 to M50.016, M51.001 to M51.015, M52.001 to M52.014, M53.001 to M53.013, M54.001 to M54.012, M55.001 to M55.011, M56.001 to M56.010, M57.001 to M.57.009, M58.001 to M58.008, M59.001 to M59.007, M60.001 to M60.006, M61.001 to M61.005, M62.001 to M62.004, M63.001 to M63.003 and M64.001 to M64.003 (preferably M34.003, M34.007, M34.024, M35.002, M35.023, M37.004, M37.021, M37.024, M37.029, M41.017, M58.003 and M58.004) for an improvement in plant vigour, an improvement in plant quality, improved tolerance to stress factors, and/or improved input use efficiency.

According to the present invention, an ‘improvement in plant quality’ means that certain traits are improved qualitatively or quantitatively when compared with the same trait in a control plant which has been grown under the same conditions in the absence of the method of the invention. Such traits include, but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronised germination, flowering and/or fruiting of plants), and/or improved seed quality (e.g. for use in following seasons). A plant with improved quality may have an increase in any of the aforementioned traits or any combination or two or more of the aforementioned traits.

According to the present invention, an ‘improved tolerance to stress factors’ means that certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients (e.g. nitrogen and/or phosphorus nutrients). A plant with improved tolerance to stress factors may have an increase in any of the aforementioned traits or any combination or two or more of the aforementioned traits. In the case of drought and nutrient stress, such improved tolerances may be due to, for example, more efficient uptake, use or retention of water and nutrients.

According to the present invention, an ‘improved input use efficiency’ means that the plants are able to grow more effectively using given levels of inputs compared to the grown of control plants which are grown under the same conditions in the absence of the method of the invention. In particular, the inputs include, but are not limited to fertiliser (such as nitrogen, phosphorous, potassium, micronutrients), light and water. A plant with improved input use efficiency may have an improved use of any of the aforementioned inputs or any combination of two or more of the aforementioned inputs.

Other crop enhancements of the present invention include a decrease in plant height, or reduction in tillering, which are beneficial features in crops or conditions where it is desirable to have less biomass and fewer tillers.

Any or all of the above crop enhancements may lead to an improved yield by improving e.g. plant physiology, plant growth and development and/or plant architecture. In the context of the present invention ‘yield’ includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present invention. According to the present invention, it is preferred that the yield be increased by at least 0.5%, more preferred at least 1%, even more preferred at least 2%, still more preferred at least 4%, preferably 5% or even more.

Any or all of the above crop enhancements may also lead to an improved utilisation of land, i.e. land which was previously unavailable or sub-optimal for cultivation may become available. For example, plants which show an increased ability to survive in drought conditions, may be able to be cultivated in areas of sub-optimal rainfall, e.g. perhaps on the fringe of a desert or even the desert itself.

In one aspect of the present invention, crop enhancements are made in the substantial absence of pressure from pests and/or diseases and/or abiotic stress. In a further aspect of the present invention, improvements in plant vigour, stress tolerance, quality and/or yield are made in the substantial absence of pressure from pests and/or diseases. For example pests and/or diseases may be controlled by a pesticidal treatment that is applied prior to, or at the same time as, the method of the present invention.

In a still further aspect of the present invention, improvements in plant vigour, stress tolerance, quality and/or yield are made in the absence of pest and/or disease pressure. In a further embodiment, improvements in plant vigour, quality and/or yield are made in the absence, or substantial absence, of abiotic stress.

The compositions of the present invention may also be used in the field of protecting storage goods against attack of fungi. According to the present invention, the term “storage goods” is understood to denote natural substances of vegetable and/or animal origin and their processed forms, which have been taken from the natural life cycle and for which long-term protection is desired. Storage goods of vegetable origin, such as plants or parts thereof, for example stalks, leafs, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The composition according the present invention can prevent disadvantageous effects such as decay, discoloration or mold. Preferably “storage goods” is understood to denote natural substances of vegetable origin and/or their processed forms, more preferably fruits and their processed forms, such as pomes, stone fruits, soft fruits and citrus fruits and their processed forms. In another preferred embodiment of the invention “storage goods” is understood to denote wood.

Therefore a further aspect of the present invention is a method of protecting storage goods, which comprises applying to the storage goods a composition according to the invention.

The composition of the present invention may also be used in the field of protecting technical material against attack of fungi. According to the present invention, the term “technical material” includes paper; carpets; constructions; cooling and heating systems; wall-boards; ventilation and air conditioning systems and the like; preferably “technical material” is understood to denote wall-boards. The composition according the present invention can prevent disadvantageous effects such as decay, discoloration or mold.

The composition according to the invention is generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the formulations according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The formulations according to the invention can include an additive comprising an oil of vegetable or animal origin, a mineral oil, alkyl esters of such oils or mixtures of such oils and oil derivatives. The amount of oil additive in the formulation according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010. The formulations generally comprise from 0.1 to 99% by weight, especially from 0.1 to 95% by weight, of compounds of component (A), component (B) and component (C) and from 1 to 99.9% by weight of a formulation adjuvant which preferably includes from 0 to 25% by weight of a surface-active substance.

Whereas commercial products may preferably be formulated as concentrates, the end user will normally employ dilute formulations.

The rates of application vary within wide limits and depend on the nature of the soil, the method of application, the crop plant, the pest to be controlled, the prevailing climatic conditions, and other factors governed by the method of application, the time of application and the target crop. As a general guideline compounds may be applied at a rate of from 1 to 2000 I/ha, especially from 10 to 1000 I/ha.

Certain mixture compositions comprising components (A), (B) and (C) described above may show a synergistic effect. This occurs whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):
ppm=milligrams of active ingredient (=a.i.) per liter of spray mixture
X=% action by active ingredient (A) using p ppm of active ingredient
Y=% action by active ingredients (B+C) using q ppm of active ingredient.
Or:
X=% action by active ingredient (A+B) using p ppm of active ingredient
Y=% action by active ingredient (C) using q ppm of active ingredient.
Or:
X=% action by active ingredient (A+C) using p ppm of active ingredient
Y=% action by active ingredient (B) using q ppm of active ingredient.

According to COLBY, the expected (additive) action of active ingredients (A)+(B+C) or (A+B)+(C) or

$$E = X + Y - \frac{X \cdot Y}{100} .$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

Synergism can also be calculated by using the following formula:

$$E ( expected value ) = X + Y + Z - [ ( XY ) + ( X Z ) + ( YZ ) / 100 + [ XYZ / 10000 ]$$

X, Y, Z=% action by active ingredient (A), (B) and (C) alone using p ppm of active ingredient.

However, besides the actual synergistic action with respect to fungicidal activity, the composition according to the invention may also have further surprising advantageous properties. Examples of such advantageous properties that may be mentioned are: more advantageous degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

The composition according to the invention can be applied to the phytopathogenic microorganisms, the useful plants, the locus thereof, the propagation material thereof, storage goods or technical materials threatened by microorganism attack.

The composition according to the invention may be applied before or after infection of the useful plants, the propagation material thereof, storage goods or technical materials by the microorganisms.

The amount of a composition according to the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of fungi to be controlled or the application time.

When applied to the useful plants component (A) is typically applied at a rate of 5 to 2000 g a.i./ha, particularly 10 to 1000 g a.i./ha, e.g. 50, 75, 100 or 200 g a.i./ha, typically in association with 1 to 5000 g a.i./ha, particularly 2 to 2000 g a.i./ha, e.g. 100, 250, 500, 800, 1000, 1500 g a.i./ha of component (B) and (C), depending on the class of chemical employed as component (B) and (C). Preferably component (A) is applied at a rate of from 25 to 75 g a.i/ha.

Preferably, when component (B) or component (C) is difenoconazole it is applied at a rate of from 35 to 115 g a.i/ha.

Preferably, when component (B) or component (C) is difenoconazole it is applied at a rate of from 35 to 115 g a.i/ha.

Preferably, when component (B) or component (C) is cyproconazole it is applied at a rate of from 25 to 75 g a.i/ha.

Preferably, when component (B) or component (C) is prothioconazole it is applied at a rate of from 50 to 150 g a.i/ha.

Preferably, when component (B) or component (C) is tebuconazole it is applied at a rate of from 50 to 150 g a.i/ha.

Preferably, when component (B) or component (C) is mancozeb it is applied at a rate of from 500 to 2,000 g a.i/ha.

Preferably, when component (B) or component (C) is chlorothalonil it is applied at a rate of from 500 to 1,500 g a.i/ha.

Preferably, when component (B) or component (C) is benzovindiflupyr it is applied at a rate of from 25 to 75 g a.i/ha.

Preferably, when component (B) or component (C) is pydiflumetofen it is applied at a rate of from 25 to 75 g a.i/ha.

In agricultural practice the application rates of the composition according to the invention depend on the type of effect desired, and typically range from 20 to 4000 g of total composition per hectare.

When the composition according to the invention is used for treating seed, rates of 0.001 to 50 g of a compound of component (A) per kg of seed, preferably from 0.01 to 10 g per kg of seed, and 0.001 to 50 g of a compound of component (B) and (C), per kg of seed, preferably from 0.01 to 10 g per kg of seed, are generally sufficient.

The invention also provides fungicidal compositions comprising a combination of components (A) and (B) and (C) as mentioned above in a synergistically effective amount, together with an agriculturally acceptable carrier, and optionally a surfactant. In said compositions, the weight ratio of (A) to (B+C) is preferably between 1000:1 and 1:1000. In a preferred embodiment of the invention, the ratios by weight in said compositions of component (A) to the mixture of components (B) and (C) are 6:1 to 1:6. In a preferred embodiment of the invention, ratios by weight of component (B) to component (C) in said compositions are from 2:1 to 1:6.

For the avoidance of doubt, where a literary reference, patent application, or patent, is cited within the text of this application, the entire text of said citation is herein incorporated by reference.

### EXAMPLES

The Examples which follow serve to illustrate the invention.

### Formulation Examples

| Wettable powders | a) | b) | c) |
|---|---|---|---|
| active ingredients [components (A) and (B)] | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The active ingredient is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients [components (A) and (B)] | 25% | 50% | 75% |
| light mineral oil | 5% | 5% | 5% |
| highly dispersed silicic acid | 5% | 5% | — |
| Kaolin | 65% | 40% | — |
| Talcum | — | — | 20% |

The active ingredient is thoroughly mixed with the adjuvants and the mixture is thoroughly ground in a suitable mill, affording powders that can be used directly for seed treatment.

Emulsifiable concentrate

| | |
|---|---|
| active ingredients [components (A) and (B)] | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| active ingredients [components (A) and (B)] | 5% | 6% | 4% |
| talcum | 95% | — | — |
| Kaolin | — | 94% | — |
| mineral filler | — | — | 96% |

Ready-for-use dusts are obtained by mixing the active ingredient with the carrier and grinding the mixture in a suitable mill. Such powders can also be used for dry dressings for seed.

Extruder granules

| | |
|---|---|
| active ingredients [components (A) and (B)] | 15% |
| sodium lignosulfonate | 2% |
| carboxymethylcellulose | 1% |
| Kaolin | 82% |

The active ingredient is mixed and ground with the adjuvants, and the mixture is moistened with water. The mixture is extruded and then dried in a stream of air.

Coated granules

| | |
|---|---|
| active ingredients [components (A) and (B)] | 8% |
| polyethylene glycol (mol. wt. 200) | 3% |
| Kaolin | 89% |

The finely ground active ingredient is uniformly applied, in a mixer, to the kaolin moistened with polyethylene glycol. Non-dusty coated granules are obtained in this manner.

Suspension concentrate

| | |
|---|---|
| active ingredients [components (A) and (B)] | 40% |
| propylene glycol | 10% |
| nonylphenol polyethylene glycol ether | 6% |
| (15 mol of ethylene oxide) | |
| Sodium lignosulfonate | 10% |
| carboxymethylcellulose | 1% |
| silicone oil (in the form of a 75% emulsion in water) | 1% |
| Water | 32% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| active ingredients [components (A) and (B)] | 40% |
| propylene glycol | 5% |
| copolymer butanol PO/EO | 2% |
| tristyrenephenole with 10-20 moles EO | 2% |
| 1,2-benzisothiazolin-3-one (in the | 0.5% |
| form of a 20% solution in water) | |
| monoazo-pigment calcium salt | 5% |
| Silicone oil (in the form of a 75% emulsion in water) | 0.2% |
| Water | 45.3% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Slow Release Capsule Suspension 28 parts of a combination of the active ingredients [components (A) and (B)] is mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

### Biological Examples

### Methodology:

Fungicidal activity against Zymoseptoria tritici (Septoria tritici) (leaf blotch) Conidia of the fungus from cryogenic storage were directly mixed into nutrient broth (PDB potato dextrose broth). A DMSO solution of the test compounds was placed into a microtiter plate (96-well format) and the nutrient broth containing the fungal spores was added to it. The test plates were incubated at 24° C. and after 72 hours the fungal growth was assessed visually and compared to the growth in untreated wells. The scores were recorded as % control compared to the untreated wells.

Fungicidal activity against Glomerella lagenarium (Colletotrichum lagenarium) liquid culture/cucumber/preventative (Anthracnose)

Conidia of the fungus from cryogenic storage were directly mixed into nutrient broth (PDB potato dextrose broth). A DMSO solution of the test compounds was placed into a microtiter plate (96-well format) and the nutrient broth containing the fungal spores was added to it. The test plates were incubated at 24° C. and after 72 hours the fungal growth was assessed visually and compared to the growth in untreated wells. The scores were recorded as % control compared to the untreated wells.

Fungicidal Activity Against Mycosphaerella arachidis Syn. Cercospora arachidicola (Brown Leaf Spot)

Conidia of the fungus from cryogenic storage were directly mixed into nutrient broth (PDB potato dextrose broth). A DMSO solution of the test compounds was placed into a microtiter plate (96-well format) and the nutrient broth containing the fungal spores was added to it. The test plates were incubated at 24° C. and after 5 days the fungal growth was assessed visually and compared to the growth in untreated wells. The scores were recorded as % control compared to the untreated wells.

The action to be expected E for a given active ingredient combination was calculated using the COLBY formula as follows:
ppm=milligrams of active ingredient (=a.i.) per liter of spray mixture
X=% action by active ingredient (A) using p ppm of active ingredient
Y=% action by active ingredients (B+C) using q ppm of active ingredient.

According to COLBY, the expected (additive) action of active ingredients (A)+(B+C) using p+q ppm of active ingredient is:

$$E = X + Y - \frac{X \cdot Y}{100} .$$

### Compound List and Abbreviations in Tables B1 to B12 Below:

Compound X.04 is methyl (Z)-2-(5-cyclohexyl-2-methyl-phenoxy)-3-methoxy-prop-2-enoate
CTN is Chlorothalonil
MZB is Mancozeb
DFZ is Difenoconazole
CCZ is Cyproconazole
TCZ is Tebuconazole
PTZ is Prothioconazole
BZV is Benzovindiflupyr
PDM is Pydiflumetofen

TABLE B1
Fungicidal activity of the ternary combination compound
X.04 + difenoconazole (DFZ) + cyproconazole
(CCZ) (composition M58.004 disclosed in table M58 above):

| | | | Zymoseptoria | | Colletotrichum | | Mycosphaerella | |
|---|---|---|---|---|---|---|---|---|
| Ai rates | | | tritici | | lagenarium | | arachidis | |
| (ppm) | | | % control | | % control | | % control | |
| Cpd | | | E | | E | | E | |
| X.04 | DFZ | CCZ | (colby) | Score | (colby) | Score | (colby) | Score |
| 0.02 | — | — | — | 0 | — | 0 | — | 70 |
| 0.07 | — | — | — | 0 | — | 70 | — | 70 |
| 0.2 | — | — | — | 0 | — | 100 | — | 70 |
| — | 0.07 | 0.07 | — | 70 | — | 0 | — | 100 |
| — | 0.07 | 0.2 | — | 70 | — | 0 | — | 100 |
| — | 0.07 | 0.6 | — | 70 | — | 0 | — | 100 |
| — | 0.2 | 0.07 | — | 70 | — | 0 | — | 100 |
| — | 0.2 | 0.2 | — | 70 | — | 0 | — | 100 |
| — | 0.2 | 0.6 | — | 70 | — | 0 | — | 100 |
| — | 0.6 | 0.07 | — | 90 | — | 20 | — | 100 |
| — | 0.6 | 0.2 | — | 90 | — | 20 | — | 100 |
| — | 0.6 | 0.6 | — | 90 | — | 20 | — | 100 |
| 0.02 | 0.07 | 0.07 | 70 | 70 | 0 | 0 | 100 | 100 |
| 0.02 | 0.07 | 0.2 | 70 | 70 | 0 | 0 | 100 | 100 |
| 0.02 | 0.07 | 0.6 | 70 | 70 | 0 | 0 | 100 | 100 |
| 0.02 | 0.2 | 0.07 | 70 | 90 | 0 | 0 | 100 | 100 |
| 0.02 | 0.2 | 0.2 | 70 | 90 | 0 | 0 | 100 | 100 |
| 0.02 | 0.2 | 0.6 | 70 | 90 | 0 | 0 | 100 | 100 |
| 0.02 | 0.6 | 0.07 | 90 | 90 | 20 | 20 | 100 | 100 |
| 0.02 | 0.6 | 0.2 | 90 | 90 | 20 | 20 | 100 | 100 |
| 0.02 | 0.6 | 0.6 | 90 | 90 | 20 | 20 | 100 | 100 |
| 0.02 | 0.07 | 0.07 | 70 | 70 | 70 | 20 | 100 | 100 |
| 0.02 | 0.07 | 0.2 | 70 | 70 | 70 | 20 | 100 | 100 |
| 0.02 | 0.07 | 0.6 | 70 | 70 | 70 | 20 | 100 | 100 |
| 0.02 | 0.2 | 0.07 | 70 | 70 | 70 | 20 | 100 | 100 |
| 0.02 | 0.2 | 0.2 | 70 | 70 | 70 | 20 | 100 | 100 |
| 0.02 | 0.2 | 0.6 | 70 | 70 | 70 | 20 | 100 | 100 |
| 0.02 | 0.6 | 0.07 | 90 | 90 | 76 | 70 | 100 | 100 |
| 0.02 | 0.6 | 0.2 | 90 | 90 | 76 | 70 | 100 | 100 |
| 0.02 | 0.6 | 0.6 | 90 | 90 | 76 | 70 | 100 | 100 |
| 0.02 | 0.07 | 0.07 | 70 | 70 | 100 | 100 | 100 | 100 |
| 0.02 | 0.07 | 0.2 | 70 | 70 | 100 | 100 | 100 | 100 |
| 0.02 | 0.07 | 0.6 | 70 | 70 | 100 | 100 | 100 | 100 |
| 0.02 | 0.2 | 0.07 | 70 | 70 | 100 | 100 | 100 | 100 |
| 0.02 | 0.2 | 0.2 | 70 | 70 | 100 | 100 | 100 | 100 |
| 0.02 | 0.2 | 0.6 | 70 | 70 | 100 | 100 | 100 | 100 |
| 0.02 | 0.6 | 0.07 | 90 | 90 | 100 | 100 | 100 | 100 |
| 0.02 | 0.6 | 0.2 | 90 | 90 | 100 | 100 | 100 | 100 |
| 0.02 | 0.6 | 0.6 | 90 | 90 | 100 | 100 | 100 | 100 |

TABLE B2
Fungicidal activity of the ternary combination compound
X.04 + difenoconazole + chlorothalonil
(composition M58.003 disclosed in table M58 above):

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | DFZ | CTN | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.74 | — | 70 | — | 0 | — | 100 |
| — | 0.07 | 2.22 | — | 70 | — | 0 | — | 100 |
| — | 0.07 | 6.67 | — | 70 | — | 0 | — | 100 |
| — | 0.2 | 0.74 | — | 70 | — | 0 | — | 100 |
| — | 0.2 | 2.22 | — | 70 | — | 0 | — | 100 |
| — | 0.2 | 6.67 | — | 70 | — | 0 | — | 100 |
| — | 0.6 | 0.74 | — | 90 | — | 50 | — | 100 |
| — | 0.6 | 2.22 | — | 90 | — | 50 | — | 100 |
| — | 0.6 | 6.67 | — | 90 | — | 50 | — | 100 |
| 0.02 | 0.07 | 0.74 | 70 | 100 | 0 | 100 | 100 | 100 |
| 0.02 | 0.07 | 2.22 | 70 | 100 | 0 | 100 | 100 | 100 |
| 0.02 | 0.07 | 6.67 | 70 | 100 | 0 | 100 | 100 | 100 |
| 0.02 | 0.2 | 0.74 | 70 | 100 | 0 | 100 | 100 | 100 |
| 0.02 | 0.2 | 2.22 | 70 | 100 | 0 | 100 | 100 | 100 |
| 0.02 | 0.2 | 6.67 | 70 | 100 | 0 | 100 | 100 | 100 |
| 0.02 | 0.6 | 0.74 | 90 | 100 | 50 | 100 | 100 | 100 |
| 0.02 | 0.6 | 2.22 | 90 | 100 | 50 | 100 | 100 | 100 |
| 0.02 | 0.6 | 6.67 | 90 | 100 | 50 | 100 | 100 | 100 |
| 0.02 | 0.07 | 0.74 | 70 | 100 | 70 | 100 | 100 | 100 |
| 0.02 | 0.07 | 2.22 | 70 | 100 | 70 | 100 | 100 | 100 |
| 0.02 | 0.07 | 6.67 | 70 | 100 | 70 | 100 | 100 | 100 |
| 0.02 | 0.2 | 0.74 | 70 | 100 | 70 | 100 | 100 | 100 |
| 0.02 | 0.2 | 2.22 | 70 | 100 | 70 | 100 | 100 | 100 |
| 0.02 | 0.2 | 6.67 | 70 | 100 | 70 | 100 | 100 | 100 |
| 0.02 | 0.6 | 0.74 | 90 | 100 | 85 | 100 | 100 | 100 |
| 0.02 | 0.6 | 2.22 | 90 | 100 | 85 | 100 | 100 | 100 |
| 0.02 | 0.6 | 6.67 | 90 | 100 | 85 | 100 | 100 | 100 |
| 0.02 | 0.07 | 0.74 | 70 | 100 | 100 | 100 | 100 | 100 |
| 0.02 | 0.07 | 2.22 | 70 | 100 | 100 | 100 | 100 | 100 |
| 0.02 | 0.07 | 6.67 | 70 | 100 | 100 | 100 | 100 | 100 |
| 0.02 | 0.2 | 0.74 | 70 | 100 | 100 | 100 | 100 | 100 |
| 0.02 | 0.2 | 2.22 | 70 | 100 | 100 | 100 | 100 | 100 |
| 0.02 | 0.2 | 6.67 | 70 | 100 | 100 | 100 | 100 | 100 |
| 0.02 | 0.6 | 0.74 | 90 | 100 | 100 | 100 | 100 | 100 |
| 0.02 | 0.6 | 2.22 | 90 | 100 | 100 | 100 | 100 | 100 |
| 0.02 | 0.6 | 6.67 | 90 | 100 | 100 | 100 | 100 | 100 |

TABLE B3
Fungicidal activity of the ternary combination
compound X.04 + difenoconazole + mancozeb
(composition M41.017 disclosed in table M41 above):

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | DFZ | MZB | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 2.22 | — | 70 | — | 0 | — | 100 |
| — | 0.07 | 6.67 | — | 70 | — | 100 | — | 100 |
| — | 0.07 | 20 | — | 70 | — | 100 | — | 100 |
| — | 0.2 | 2.22 | — | 70 | — | 0 | — | 100 |
| — | 0.2 | 6.67 | — | 90 | — | 100 | — | 100 |
| — | 0.2 | 20 | — | 90 | — | 100 | — | 100 |
| — | 0.6 | 2.22 | — | 90 | — | 20 | — | 100 |
| — | 0.6 | 6.67 | — | 90 | — | 100 | — | 100 |
| — | 0.6 | 20 | — | 90 | — | 100 | — | 100 |
| 0.02 | 0.07 | 2.22 | 70 | 70 | 0 | 100 | 100 | 100 |
| 0.02 | 0.07 | 6.67 | 70 | 100 | 100 | 10 | 100 | 100 |
| 0.02 | 0.07 | 20 | 70 | 100 | 100 | 100 | 100 | 100 |
| 0.02 | 0.2 | 2.22 | 70 | 70 | 0 | 100 | 100 | 100 |
| 0.02 | 0.2 | 6.67 | 90 | 100 | 100 | 100 | 100 | 100 |
| 0.02 | 0.2 | 20 | 90 | 100 | 100 | 100 | 100 | 100 |
| 0.02 | 0.6 | 2.22 | 90 | 70 | 20 | 100 | 100 | 100 |
| 0.02 | 0.6 | 6.67 | 90 | 100 | 100 | 100 | 100 | 100 |
| 0.02 | 0.6 | 20 | 90 | 100 | 100 | 100 | 100 | 100 |
| 0.02 | 0.07 | 2.22 | 70 | 70 | 70 | 10 | 100 | 100 |
| 0.02 | 0.07 | 6.67 | 70 | 100 | 100 | 100 | 100 | 100 |
| 0.02 | 0.07 | 20 | 70 | 100 | 100 | 100 | 100 | 100 |
| 0.02 | 0.2 | 2.22 | 70 | 70 | 70 | 100 | 100 | 100 |
| 0.02 | 0.2 | 6.67 | 90 | 100 | 100 | 100 | 100 | 100 |
| 0.02 | 0.2 | 20 | 90 | 100 | 100 | 100 | 100 | 100 |
| 0.02 | 0.6 | 2.22 | 90 | 70 | 76 | 100 | 100 | 100 |
| 0.02 | 0.6 | 6.67 | 90 | 100 | 100 | 100 | 100 | 100 |
| 0.02 | 0.6 | 20 | 90 | 100 | 100 | 100 | 100 | 100 |
| 0.02 | 0.07 | 2.22 | 70 | 70 | 100 | 100 | 100 | 100 |
| 0.02 | 0.07 | 6.67 | 70 | 100 | 100 | 100 | 100 | 100 |
| 0.02 | 0.07 | 20 | 70 | 100 | 100 | 100 | 100 | 100 |
| 0.02 | 0.2 | 2.22 | 70 | 70 | 100 | 100 | 100 | 100 |
| 0.02 | 0.2 | 6.67 | 90 | 100 | 100 | 100 | 100 | 100 |
| 0.02 | 0.2 | 20 | 90 | 100 | 100 | 100 | 100 | 100 |
| 0.02 | 0.6 | 2.22 | 90 | 70 | 100 | 100 | 100 | 100 |
| 0.02 | 0.6 | 6.67 | 90 | 100 | 100 | 100 | 100 | 100 |
| 0.02 | 0.6 | 20 | 90 | 100 | 100 | 100 | 100 | 100 |

TABLE B4
Fungicidal activity of the ternary combination compound
X.04 + difenoconazole + benzovindiflupyr
(composition M35.023 disclosed in table M35 above):

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | DFZ | BZV | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.07 | — | 70 | — | 50 | — | 90 |
| — | 0.07 | 0.2 | — | 70 | — | 100 | — | 100 |
| — | 0.07 | 0.6 | — | 90 | — | 100 | — | 100 |
| — | 0.2 | 0.07 | — | 70 | — | 50 | — | 100 |
| — | 0.2 | 0.2 | — | 90 | — | 100 | — | 100 |
| — | 0.2 | 0.6 | — | 90 | — | 100 | — | 100 |
| — | 0.6 | 0.07 | — | 90 | — | 70 | — | 100 |
| — | 0.6 | 0.2 | — | 90 | — | 100 | — | 100 |
| — | 0.6 | 0.6 | — | 100 | — | 100 | — | 100 |
| 0.02 | 0.07 | 0.07 | 70 | 70 | 50 | 70 | 97 | 100 |
| 0.02 | 0.07 | 0.2 | 70 | 70 | 100 | 100 | 100 | 100 |
| 0.02 | 0.07 | 0.6 | 90 | 90 | 100 | 100 | 100 | 100 |
| 0.02 | 0.2 | 0.07 | 70 | 70 | 50 | 70 | 100 | 100 |
| 0.02 | 0.2 | 0.2 | 90 | 70 | 100 | 100 | 100 | 100 |
| 0.02 | 0.2 | 0.6 | 90 | 90 | 100 | 100 | 100 | 100 |
| 0.02 | 0.6 | 0.07 | 90 | 70 | 70 | 90 | 100 | 100 |
| 0.02 | 0.6 | 0.2 | 90 | 90 | 100 | 100 | 100 | 100 |
| 0.02 | 0.6 | 0.6 | 100 | 100 | 100 | 100 | 100 | 100 |
| 0.02 | 0.07 | 0.07 | 70 | 70 | 85 | 70 | 99 | 100 |
| 0.02 | 0.07 | 0.2 | 70 | 70 | 100 | 100 | 100 | 100 |
| 0.02 | 0.07 | 0.6 | 90 | 90 | 100 | 100 | 100 | 100 |
| 0.02 | 0.2 | 0.07 | 70 | 70 | 85 | 90 | 100 | 100 |
| 0.02 | 0.2 | 0.2 | 90 | 70 | 100 | 100 | 100 | 100 |
| 0.02 | 0.2 | 0.6 | 90 | 90 | 100 | 100 | 100 | 100 |
| 0.02 | 0.6 | 0.07 | 90 | 70 | 91 | 90 | 100 | 100 |
| 0.02 | 0.6 | 0.2 | 90 | 90 | 100 | 100 | 100 | 100 |
| 0.02 | 0.6 | 0.6 | 100 | 100 | 100 | 100 | 100 | 100 |
| 0.02 | 0.07 | 0.07 | 70 | 70 | 100 | 100 | 99 | 100 |
| 0.02 | 0.07 | 0.2 | 70 | 70 | 100 | 100 | 100 | 100 |
| 0.02 | 0.07 | 0.6 | 90 | 90 | 100 | 100 | 100 | 100 |
| 0.02 | 0.2 | 0.07 | 70 | 70 | 100 | 100 | 100 | 100 |
| 0.02 | 0.2 | 0.2 | 90 | 70 | 100 | 100 | 100 | 100 |
| 0.02 | 0.2 | 0.6 | 90 | 90 | 100 | 100 | 100 | 100 |
| 0.02 | 0.6 | 0.07 | 90 | 70 | 100 | 100 | 100 | 100 |
| 0.02 | 0.6 | 0.2 | 90 | 90 | 100 | 100 | 100 | 100 |
| 0.02 | 0.6 | 0.6 | 100 | 100 | 100 | 100 | 100 | 100 |

TABLE B5
Fungicidal activity of the ternary combination compound
X.04 + difenoconazole + tebuconazole
(composition M34.024 disclosed in table M34 above):

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | DFZ | TCZ | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.07 | — | 70 | — | 0 | — | 100 |
| — | 0.07 | 0.2 | — | 70 | — | 0 | — | 100 |
| — | 0.07 | 0.6 | — | 70 | — | 0 | — | 100 |
| — | 0.2 | 0.07 | — | 70 | — | 0 | — | 100 |
| — | 0.2 | 0.2 | — | 90 | — | 0 | — | 100 |
| — | 0.2 | 0.6 | — | 90 | — | 0 | — | 100 |
| — | 0.6 | 0.07 | — | 90 | — | 20 | — | 100 |
| — | 0.6 | 0.2 | — | 90 | — | 20 | — | 100 |
| — | 0.6 | 0.6 | — | 100 | — | 20 | — | 100 |
| 0.02 | 0.07 | 0.07 | 70 | 70 | 0 | 0 | 100 | 100 |
| 0.02 | 0.07 | 0.2 | 70 | 70 | 0 | 0 | 100 | 100 |
| 0.02 | 0.07 | 0.6 | 70 | 70 | 0 | 0 | 100 | 100 |
| 0.02 | 0.2 | 0.07 | 70 | 70 | 0 | 0 | 100 | 100 |
| 0.02 | 0.2 | 0.2 | 90 | 90 | 0 | 0 | 100 | 100 |
| 0.02 | 0.2 | 0.6 | 90 | 90 | 0 | 0 | 100 | 100 |
| 0.02 | 0.6 | 0.07 | 90 | 90 | 20 | 20 | 100 | 100 |
| 0.02 | 0.6 | 0.2 | 90 | 90 | 20 | 20 | 100 | 100 |
| 0.02 | 0.6 | 0.6 | 100 | 90 | 20 | 20 | 100 | 100 |
| 0.02 | 0.07 | 0.07 | 70 | 70 | 70 | 50 | 100 | 100 |
| 0.02 | 0.07 | 0.2 | 70 | 70 | 70 | 50 | 100 | 100 |
| 0.02 | 0.07 | 0.6 | 70 | 70 | 70 | 70 | 100 | 100 |
| 0.02 | 0.2 | 0.07 | 70 | 70 | 70 | 50 | 100 | 100 |
| 0.02 | 0.2 | 0.2 | 90 | 90 | 70 | 70 | 100 | 100 |
| 0.02 | 0.2 | 0.6 | 90 | 90 | 70 | 70 | 100 | 100 |
| 0.02 | 0.6 | 0.07 | 90 | 90 | 76 | 70 | 100 | 100 |
| 0.02 | 0.6 | 0.2 | 90 | 90 | 76 | 70 | 100 | 100 |
| 0.02 | 0.6 | 0.6 | 100 | 90 | 76 | 70 | 100 | 100 |
| 0.02 | 0.07 | 0.07 | 70 | 70 | 100 | 100 | 100 | 100 |
| 0.02 | 0.07 | 0.2 | 70 | 70 | 100 | 100 | 100 | 100 |
| 0.02 | 0.07 | 0.6 | 70 | 90 | 100 | 100 | 100 | 100 |
| 0.02 | 0.2 | 0.07 | 70 | 70 | 100 | 100 | 100 | 100 |
| 0.02 | 0.2 | 0.2 | 90 | 90 | 100 | 100 | 100 | 100 |
| 0.02 | 0.2 | 0.6 | 90 | 90 | 100 | 100 | 100 | 100 |
| 0.02 | 0.6 | 0.07 | 90 | 90 | 100 | 100 | 100 | 100 |
| 0.02 | 0.6 | 0.2 | 90 | 90 | 100 | 100 | 100 | 100 |
| 0.02 | 0.6 | 0.6 | 100 | 90 | 100 | 100 | 100 | 100 |

TABLE B6
Fungicidal activity of the ternary combination compound
X.04 + prothioconazole + pydiflumetofen
(composition M37.029 disclosed in table M37 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | PTZ | PDM | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.01 | — | 70 | — | 70 | — | 100 |
| — | 0.07 | 0.02 | — | 100 | — | 70 | — | 100 |
| — | 0.07 | 0.06 | — | 100 | — | 70 | — | 100 |
| — | 0.2 | 0.01 | — | 70 | — | 100 | — | 100 |
| — | 0.2 | 0.02 | — | 100 | — | 100 | — | 100 |
| — | 0.2 | 0.06 | — | 100 | — | 100 | — | 100 |
| — | 0.6 | 0.01 | — | 70 | — | 100 | — | 100 |
| — | 0.6 | 0.02 | — | 100 | — | 100 | — | 100 |
| — | 0.6 | 0.06 | — | 100 | — | 100 | — | 100 |
| 0.02 | 0.07 | 0.01 | 70 | 70 | 70 | 70 | 100 | 100 |
| 0.02 | 0.07 | 0.02 | 100 | 100 | 70 | 70 | 100 | 100 |
| 0.02 | 0.07 | 0.06 | 100 | 100 | 70 | 70 | 100 | 100 |
| 0.02 | 0.2 | 0.0 | 70 | 70 | 100 | 100 | 100 | 100 |
| 0.02 | 0.2 | 0.02 | 100 | 100 | 100 | 100 | 100 | 100 |
| 0.02 | 0.2 | 0.06 | 100 | 100 | 100 | 100 | 100 | 100 |
| 0.02 | 0.6 | 0.01 | 70 | 70 | 100 | 100 | 100 | 100 |
| 0.02 | 0.6 | 0.02 | 100 | 100 | 100 | 100 | 100 | 100 |
| 0.02 | 0.6 | 0.06 | 100 | 100 | 100 | 100 | 100 | 100 |
| 0.02 | 0.07 | 0.01 | 70 | 70 | 91 | 90 | 100 | 100 |
| 0.02 | 0.07 | 0.02 | 100 | 100 | 91 | 90 | 100 | 100 |
| 0.02 | 0.07 | 0.06 | 100 | 100 | 91 | 90 | 100 | 100 |
| 0.02 | 0.2 | 0.01 | 70 | 70 | 100 | 100 | 100 | 100 |
| 0.02 | 0.2 | 0.02 | 100 | 100 | 100 | 100 | 100 | 100 |
| 0.02 | 0.2 | 0.06 | 100 | 100 | 100 | 100 | 100 | 100 |
| 0.02 | 0.6 | 0.0 | 70 | 70 | 100 | 100 | 100 | 100 |
| 0.02 | 0.6 | 0.02 | 100 | 100 | 100 | 100 | 100 | 100 |
| 0.02 | 0.6 | 0.06 | 100 | 100 | 100 | 100 | 100 | 100 |
| 0.02 | 0.07 | 0.01 | 70 | 70 | 100 | 100 | 100 | 100 |
| 0.02 | 0.07 | 0.02 | 100 | 100 | 100 | 100 | 100 | 100 |
| 0.02 | 0.07 | 0.06 | 100 | 100 | 100 | 100 | 100 | 100 |
| 0.02 | 0.2 | 0.01 | 70 | 70 | 100 | 100 | 100 | 100 |
| 0.02 | 0.2 | 0.02 | 100 | 100 | 100 | 100 | 100 | 100 |
| 0.02 | 0.2 | 0.06 | 100 | 100 | 100 | 100 | 100 | 100 |
| 0.02 | 0.6 | 0.01 | 70 | 70 | 100 | 100 | 100 | 100 |
| 0.02 | 0.6 | 0.02 | 100 | 100 | 100 | 100 | 100 | 100 |
| 0.02 | 0.6 | 0.06 | 100 | 100 | 100 | 100 | 100 | 100 |

TABLE B7
Fungicidal activity of the ternary combination compound
X.04 + prothioconazole + chlorothalonil
(composition M37.024 disclosed in table M37 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | PTZ | CTN | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.74 | — | 100 | — | 100 | — | 100 |
| — | 0.07 | 2.22 | — | 100 | — | 100 | — | 100 |
| — | 0.07 | 6.67 | — | 100 | — | 100 | — | 100 |
| — | 0.2 | 0.74 | — | 100 | — | 100 | — | 100 |
| — | 0.2 | 2.22 | — | 100 | — | 100 | — | 100 |
| — | 0.2 | 6.67 | — | 100 | — | 100 | — | 100 |
| — | 0.6 | 0.74 | — | 100 | — | 100 | — | 100 |
| — | 0.6 | 2.22 | — | 100 | — | 100 | — | 100 |
| — | 0.6 | 6.67 | — | 100 | — | 100 | — | 100 |
| 0.02 | 0.07 | 0.74 | 100 | 100 | 100 | 100 | 100 | 100 |
| 0.02 | 0.07 | 2.22 | 100 | 100 | 100 | 100 | 100 | 100 |
| 0.02 | 0.07 | 6.67 | 100 | 100 | 100 | 100 | 100 | 100 |
| 0.02 | 0.2 | 0.74 | 100 | 100 | 100 | 100 | 100 | 100 |
| 0.02 | 0.2 | 2.22 | 100 | 100 | 100 | 100 | 100 | 100 |
| 0.02 | 0.2 | 6.67 | 100 | 100 | 100 | 100 | 100 | 100 |
| 0.02 | 0.6 | 0.74 | 100 | 100 | 100 | 100 | 100 | 100 |
| 0.02 | 0.6 | 2.22 | 100 | 100 | 100 | 100 | 100 | 100 |
| 0.02 | 0.6 | 6.67 | 100 | 100 | 100 | 100 | 100 | 100 |
| 0.02 | 0.07 | 0.74 | 100 | 100 | 100 | 100 | 100 | 100 |
| 0.02 | 0.07 | 2.22 | 100 | 100 | 100 | 100 | 100 | 100 |
| 0.02 | 0.07 | 6.67 | 100 | 100 | 100 | 100 | 100 | 100 |
| 0.02 | 0.2 | 0.74 | 100 | 100 | 100 | 100 | 100 | 100 |
| 0.02 | 0.2 | 2.22 | 100 | 100 | 100 | 100 | 100 | 100 |
| 0.02 | 0.2 | 6.67 | 100 | 100 | 100 | 100 | 100 | 100 |
| 0.02 | 0.6 | 0.74 | 100 | 100 | 100 | 100 | 100 | 100 |
| 0.02 | 0.6 | 2.22 | 100 | 100 | 100 | 100 | 100 | 100 |
| 0.02 | 0.6 | 6.67 | 100 | 100 | 100 | 100 | 100 | 100 |
| 0.02 | 0.07 | 0.74 | 100 | 100 | 100 | 100 | 100 | 100 |
| 0.02 | 0.07 | 2.22 | 100 | 100 | 100 | 100 | 100 | 100 |
| 0.02 | 0.07 | 6.67 | 100 | 100 | 100 | 100 | 100 | 100 |
| 0.02 | 0.2 | 0.74 | 100 | 100 | 100 | 100 | 100 | 100 |
| 0.02 | 0.2 | 2.22 | 100 | 100 | 100 | 100 | 100 | 100 |
| 0.02 | 0.2 | 6.67 | 100 | 100 | 100 | 100 | 100 | 100 |
| 0.02 | 0.6 | 0.74 | 100 | 100 | 100 | 100 | 100 | 100 |
| 0.02 | 0.6 | 2.22 | 100 | 100 | 100 | 100 | 100 | 100 |
| 0.02 | 0.6 | 6.67 | 100 | 100 | 100 | 100 | 100 | 100 |

TABLE B8
Fungicidal activity of the ternary combination compound
X.04 + prothioconazole + difenoconazole
(composition M37.021 disclosed in table M37 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | PTZ | DFZ | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.07 | — | 70 | — | 70 | — | 100 |
| — | 0.07 | 0.2 | — | 90 | — | 70 | — | 100 |
| — | 0.07 | 0.6 | — | 90 | — | 90 | — | 100 |
| — | 0.2 | 0.07 | — | 70 | — | 100 | — | 100 |
| — | 0.2 | 0.2 | — | 90 | — | 100 | — | 100 |
| — | 0.2 | 0.6 | — | 90 | — | 100 | — | 100 |
| — | 0.6 | 0.07 | — | 70 | — | 100 | — | 100 |
| — | 0.6 | 0.2 | — | 90 | — | 100 | — | 100 |
| — | 0.6 | 0.6 | — | 90 | — | 100 | — | 100 |
| 0.02 | 0.07 | 0.07 | 70 | 70 | 70 | 70 | 100 | 100 |
| 0.02 | 0.07 | 0.2 | 90 | 90 | 70 | 70 | 100 | 100 |
| 0.02 | 0.07 | 0.6 | 90 | 90 | 90 | 90 | 100 | 100 |
| 0.02 | 0.2 | 0.07 | 70 | 70 | 100 | 100 | 100 | 100 |
| 0.02 | 0.2 | 0.2 | 90 | 90 | 100 | 100 | 100 | 100 |
| 0.02 | 0.2 | 0.6 | 90 | 90 | 100 | 100 | 100 | 100 |
| 0.02 | 0.6 | 0.07 | 70 | 70 | 100 | 100 | 100 | 100 |
| 0.02 | 0.6 | 0.2 | 90 | 90 | 100 | 100 | 100 | 100 |
| 0.02 | 0.6 | 0.6 | 90 | 90 | 100 | 100 | 100 | 100 |
| 0.02 | 0.07 | 0.07 | 70 | 70 | 91 | 90 | 100 | 100 |
| 0.02 | 0.07 | 0.2 | 90 | 90 | 91 | 90 | 100 | 100 |
| 0.02 | 0.07 | 0.6 | 90 | 90 | 97 | 100 | 100 | 100 |
| 0.02 | 0.2 | 0.07 | 70 | 70 | 100 | 100 | 100 | 100 |
| 0.02 | 0.2 | 0.2 | 90 | 90 | 100 | 100 | 100 | 100 |
| 0.02 | 0.2 | 0.6 | 90 | 90 | 100 | 100 | 100 | 100 |
| 0.02 | 0.6 | 0.07 | 70 | 70 | 100 | 100 | 100 | 100 |
| 0.02 | 0.6 | 0.2 | 90 | 90 | 100 | 100 | 100 | 100 |
| 0.02 | 0.6 | 0.6 | 90 | 90 | 100 | 100 | 100 | 100 |
| 0.02 | 0.07 | 0.07 | 70 | 70 | 100 | 100 | 100 | 100 |
| 0.02 | 0.07 | 0.2 | 90 | 90 | 100 | 100 | 100 | 100 |
| 0.02 | 0.07 | 0.6 | 90 | 90 | 100 | 100 | 100 | 100 |
| 0.02 | 0.2 | 0.07 | 70 | 70 | 100 | 100 | 100 | 100 |
| 0.02 | 0.2 | 0.2 | 90 | 90 | 100 | 100 | 100 | 100 |
| 0.02 | 0.2 | 0.6 | 90 | 90 | 100 | 100 | 100 | 100 |
| 0.02 | 0.6 | 0.07 | 70 | 70 | 100 | 100 | 100 | 100 |
| 0.02 | 0.6 | 0.2 | 90 | 90 | 100 | 100 | 100 | 100 |
| 0.02 | 0.6 | 0.6 | 90 | 90 | 100 | 100 | 100 | 100 |

TABLE B9
Fungicidal activity of the ternary combination
compound X.04 + prothioconazole + mancozeb
(composition M37.004 disclosed in table M37 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | PTZ | MZB | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 2.22 | — | 0 | — | 100 | — | 90 |
| — | 0.07 | 6.67 | — | 50 | — | 100 | — | 100 |
| — | 0.07 | 20 | — | 50 | — | 100 | — | 100 |
| — | 0.2 | 2.22 | — | 0 | — | 100 | — | 100 |
| — | 0.2 | 6.67 | — | 50 | — | 100 | — | 100 |
| — | 0.2 | 20 | — | 50 | — | 100 | — | 100 |
| — | 0.6 | 2.22 | — | 0 | — | 100 | — | 100 |
| — | 0.6 | 6.67 | — | 50 | — | 100 | — | 100 |
| — | 0.6 | 20 | — | 50 | — | 100 | — | 100 |
| 0.02 | 0.07 | 2.22 | 0 | 0 | 100 | 100 | 97 | 100 |
| 0.02 | 0.07 | 6.67 | 50 | 100 | 100 | 100 | 100 | 100 |
| 0.02 | 0.07 | 20 | 50 | 90 | 100 | 100 | 100 | 100 |
| 0.02 | 0.2 | 2.22 | 0 | 0 | 100 | 100 | 100 | 100 |
| 0.02 | 0.2 | 6.67 | 50 | 100 | 100 | 100 | 100 | 100 |
| 0.02 | 0.2 | 20 | 50 | 90 | 100 | 100 | 100 | 100 |
| 0.02 | 0.6 | 2.22 | 0 | 0 | 100 | 100 | 100 | 100 |
| 0.02 | 0.6 | 6.67 | 50 | 100 | 100 | 100 | 100 | 100 |
| 0.02 | 0.6 | 20 | 50 | 90 | 100 | 100 | 100 | 100 |
| 0.02 | 0.07 | 2.22 | 0 | 0 | 100 | 100 | 99 | 100 |
| 0.02 | 0.07 | 6.67 | 50 | 100 | 100 | 100 | 100 | 100 |
| 0.02 | 0.07 | 20 | 50 | 90 | 100 | 100 | 100 | 100 |
| 0.02 | 0.2 | 2.22 | 0 | 0 | 100 | 100 | 100 | 100 |
| 0.02 | 0.2 | 6.67 | 50 | 100 | 100 | 100 | 100 | 100 |
| 0.02 | 0.2 | 20 | 50 | 90 | 100 | 100 | 100 | 100 |
| 0.02 | 0.6 | 2.22 | 0 | 0 | 100 | 100 | 100 | 100 |
| 0.02 | 0.6 | 6.67 | 50 | 100 | 100 | 100 | 100 | 100 |
| 0.02 | 0.6 | 20 | 50 | 90 | 100 | 100 | 100 | 100 |
| 0.02 | 0.07 | 2.22 | 0 | 0 | 100 | 100 | 99 | 100 |
| 0.02 | 0.07 | 6.67 | 50 | 100 | 100 | 100 | 100 | 100 |
| 0.02 | 0.07 | 20 | 50 | 90 | 100 | 100 | 100 | 100 |
| 0.02 | 0.2 | 2.22 | 0 | 0 | 100 | 100 | 100 | 100 |
| 0.02 | 0.2 | 6.67 | 50 | 100 | 100 | 100 | 100 | 100 |
| 0.02 | 0.2 | 20 | 50 | 90 | 100 | 100 | 100 | 100 |
| 0.02 | 0.6 | 2.22 | 0 | 0 | 100 | 100 | 100 | 100 |
| 0.02 | 0.6 | 6.67 | 50 | 100 | 100 | 100 | 100 | 100 |
| 0.02 | 0.6 | 20 | 50 | 90 | 100 | 100 | 100 | 100 |

TABLE B10
Fungicidal activity of the ternary combination compound
X.04 + prothioconazole + benzovindiflupyr
(composition M35.002 disclosed in table M35 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | PTZ | BZV | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.07 | — | 20 | — | 100 | — | 100 |
| — | 0.07 | 0.2 | — | 50 | — | 100 | — | 100 |
| — | 0.07 | 0.6 | — | 90 | — | 100 | — | 100 |
| — | 0.2 | 0.07 | — | 20 | — | 100 | — | 100 |
| — | 0.2 | 0.2 | — | 50 | — | 100 | — | 100 |
| — | 0.2 | 0.6 | — | 90 | — | 100 | — | 100 |
| — | 0.6 | 0.07 | — | 20 | — | 100 | — | 100 |
| — | 0.6 | 0.2 | — | 50 | — | 100 | — | 100 |
| — | 0.6 | 0.6 | — | 90 | — | 100 | — | 100 |
| 0.02 | 0.07 | 0.07 | 20 | 20 | 100 | 90 | 100 | 100 |
| 0.02 | 0.07 | 0.2 | 50 | 50 | 100 | 100 | 100 | 100 |
| 0.02 | 0.07 | 0.6 | 90 | 90 | 100 | 100 | 100 | 100 |
| 0.02 | 0.2 | 0.07 | 20 | 20 | 100 | 100 | 100 | 100 |
| 0.02 | 0.2 | 0.2 | 50 | 50 | 100 | 100 | 100 | 100 |
| 0.02 | 0.2 | 0.6 | 90 | 90 | 100 | 100 | 100 | 100 |
| 0.02 | 0.6 | 0.07 | 20 | 20 | 100 | 100 | 100 | 100 |
| 0.02 | 0.6 | 0.2 | 50 | 50 | 100 | 100 | 100 | 100 |
| 0.02 | 0.6 | 0.6 | 90 | 90 | 100 | 100 | 100 | 100 |
| 0.02 | 0.07 | 0.07 | 20 | 20 | 100 | 100 | 100 | 100 |
| 0.02 | 0.07 | 0.2 | 50 | 50 | 100 | 100 | 100 | 100 |
| 0.02 | 0.07 | 0.6 | 90 | 90 | 100 | 100 | 100 | 100 |
| 0.02 | 0.2 | 0.07 | 20 | 20 | 100 | 100 | 100 | 100 |
| 0.02 | 0.2 | 0.2 | 50 | 50 | 100 | 100 | 100 | 100 |
| 0.02 | 0.2 | 0.6 | 90 | 90 | 100 | 100 | 100 | 100 |
| 0.02 | 0.6 | 0.07 | 20 | 20 | 100 | 100 | 100 | 100 |
| 0.02 | 0.6 | 0.2 | 50 | 50 | 100 | 100 | 100 | 100 |
| 0.02 | 0.6 | 0.6 | 90 | 90 | 100 | 100 | 100 | 100 |
| 0.02 | 0.07 | 0.07 | 20 | 20 | 100 | 100 | 100 | 100 |
| 0.02 | 0.07 | 0.2 | 50 | 50 | 100 | 100 | 100 | 100 |
| 0.02 | 0.07 | 0.6 | 90 | 90 | 100 | 100 | 100 | 100 |
| 0.02 | 0.2 | 0.07 | 20 | 20 | 100 | 100 | 100 | 100 |
| 0.02 | 0.2 | 0.2 | 50 | 50 | 100 | 100 | 100 | 100 |
| 0.02 | 0.2 | 0.6 | 90 | 90 | 100 | 100 | 100 | 100 |
| 0.02 | 0.6 | 0.07 | 20 | 20 | 100 | 100 | 100 | 100 |
| 0.02 | 0.6 | 0.2 | 50 | 50 | 100 | 100 | 100 | 100 |
| 0.02 | 0.6 | 0.6 | 90 | 90 | 100 | 100 | 100 | 100 |

TABLE B11
Fungicidal activity of the ternary combination compound
X.04 + prothioconazole + tebuconazole
(composition M34.003 disclosed in table M34 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | PTZ | TCZ | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 0.07 | — | 0 | — | 70 | — | 100 |
| — | 0.07 | 0.2 | — | 0 | — | 70 | — | 100 |
| — | 0.07 | 0.6 | — | 50 | — | 70 | — | 100 |
| — | 0.2 | 0.07 | — | 0 | — | 100 | — | 100 |
| — | 0.2 | 0.2 | — | 0 | — | 100 | — | 100 |
| — | 0.2 | 0.6 | — | 50 | — | 100 | — | 100 |
| — | 0.6 | 0.07 | — | 0 | — | 100 | — | 100 |
| — | 0.6 | 0.2 | — | 20 | — | 100 | — | 100 |
| — | 0.6 | 0.6 | — | 50 | — | 100 | — | 100 |
| 0.02 | 0.07 | 0.07 | 0 | 0 | 70 | 70 | 100 | 100 |
| 0.02 | 0.07 | 0.2 | 0 | 0 | 70 | 70 | 100 | 100 |
| 0.02 | 0.07 | 0.6 | 50 | 50 | 70 | 70 | 100 | 100 |
| 0.02 | 0.2 | 0.07 | 0 | 0 | 100 | 100 | 100 | 100 |
| 0.02 | 0.2 | 0.2 | 0 | 0 | 100 | 100 | 100 | 100 |
| 0.02 | 0.2 | 0.6 | 50 | 50 | 100 | 100 | 100 | 100 |
| 0.02 | 0.6 | 0.07 | 0 | 20 | 100 | 100 | 100 | 100 |
| 0.02 | 0.6 | 0.2 | 20 | 20 | 100 | 100 | 100 | 100 |
| 0.02 | 0.6 | 0.6 | 50 | 50 | 100 | 100 | 100 | 100 |
| 0.02 | 0.07 | 0.07 | 0 | 0 | 91 | 90 | 100 | 100 |
| 0.02 | 0.07 | 0.2 | 0 | 0 | 91 | 90 | 100 | 100 |
| 0.02 | 0.07 | 0.6 | 50 | 20 | 91 | 90 | 100 | 100 |
| 0.02 | 0.2 | 0.07 | 0 | 0 | 100 | 100 | 100 | 100 |
| 0.02 | 0.2 | 0.2 | 0 | 0 | 100 | 100 | 100 | 100 |
| 0.02 | 0.2 | 0.6 | 50 | 50 | 100 | 100 | 100 | 100 |
| 0.02 | 0.6 | 0.07 | 0 | 0 | 100 | 100 | 100 | 100 |
| 0.02 | 0.6 | 0.2 | 20 | 20 | 100 | 100 | 100 | 100 |
| 0.02 | 0.6 | 0.6 | 50 | 50 | 100 | 100 | 100 | 100 |
| 0.02 | 0.07 | 0.07 | 0 | 0 | 100 | 100 | 100 | 100 |
| 0.02 | 0.07 | 0.2 | 0 | 0 | 100 | 100 | 100 | 100 |
| 0.02 | 0.07 | 0.6 | 50 | 20 | 100 | 100 | 100 | 100 |
| 0.02 | 0.2 | 0.07 | 0 | 0 | 100 | 100 | 100 | 100 |
| 0.02 | 0.2 | 0.2 | 0 | 0 | 100 | 100 | 100 | 100 |
| 0.02 | 0.2 | 0.6 | 50 | 50 | 100 | 100 | 100 | 100 |
| 0.02 | 0.6 | 0.07 | 0 | 0 | 100 | 100 | 100 | 100 |
| 0.02 | 0.6 | 0.2 | 20 | 20 | 100 | 100 | 100 | 100 |
| 0.02 | 0.6 | 0.6 | 50 | 50 | 100 | 100 | 100 | 100 |

TABLE B12
Fungicidal activity of the ternary combination compound
X.04 + tebuconazole + mancozeb (composition
M34.007 disclosed in table M34 above)

| | | | Zymoseptoria | | Colletotrichum | | Mycosphaerella | |
|---|---|---|---|---|---|---|---|---|
| Ai | | | tritici | | lagenarium | | arachidis | |
| rates (ppm) | | | % control | | % control | | % control | |
| Cpd | | | E | | E | | E | |
| X.04 | TCZ | MZB | (colby) | Score | (colby) | Score | (colby) | Score |
| 0.02 | — | — | — | 0 | — | 0 | — | 70 |
| 0.07 | — | — | — | 0 | — | 70 | — | 90 |
| 0.2 | — | — | — | 0 | — | 100 | — | 90 |
| — | 0.07 | 2.22 | — | 0 | — | 100 | — | 20 |
| — | 0.07 | 6.67 | — | 50 | — | 100 | — | 100 |
| — | 0.07 | 20 | — | 20 | — | 100 | — | 100 |
| — | 0.2 | 2.22 | — | 0 | — | 100 | — | 90 |
| — | 0.2 | 6.67 | — | 50 | — | 100 | — | 100 |
| — | 0.2 | 20 | — | 50 | — | 100 | — | 100 |
| — | 0.6 | 2.22 | — | 20 | — | 100 | — | 100 |
| — | 0.6 | 6.67 | — | 70 | — | 100 | — | 100 |
| — | 0.6 | 20 | — | 50 | — | 100 | — | 100 |
| 0.02 | 0.07 | 2.22 | 0 | 0 | 100 | 100 | 76 | 90 |
| 0.02 | 0.07 | 6.67 | 50 | 90 | 100 | 100 | 100 | 100 |
| 0.02 | 0.07 | 20 | 20 | 50 | 100 | 100 | 100 | 100 |
| 0.02 | 0.2 | 2.22 | 0 | 0 | 100 | 100 | 97 | 90 |
| 0.02 | 0.2 | 6.67 | 50 | 100 | 100 | 100 | 100 | 100 |
| 0.02 | 0.2 | 20 | 50 | 70 | 100 | 100 | 100 | 100 |
| 0.02 | 0.6 | 2.22 | 20 | 20 | 100 | 100 | 100 | 100 |
| 0.02 | 0.6 | 6.67 | 70 | 100 | 100 | 100 | 100 | 100 |
| 0.02 | 0.6 | 20 | 50 | 70 | 100 | 100 | 100 | 100 |
| 0.02 | 0.07 | 2.22 | 0 | 0 | 100 | 100 | 92 | 100 |
| 0.02 | 0.07 | 6.67 | 50 | 90 | 100 | 100 | 100 | 100 |
| 0.02 | 0.07 | 20 | 20 | 70 | 100 | 100 | 100 | 100 |
| 0.02 | 0.2 | 2.22 | 0 | 0 | 100 | 100 | 99 | 100 |
| 0.02 | 0.2 | 6.67 | 50 | 90 | 100 | 100 | 100 | 100 |
| 0.02 | 0.2 | 20 | 50 | 70 | 100 | 100 | 100 | 100 |
| 0.02 | 0.6 | 2.22 | 20 | 20 | 100 | 100 | 100 | 100 |
| 0.02 | 0.6 | 6.67 | 70 | 100 | 100 | 100 | 100 | 100 |
| 0.02 | 0.6 | 20 | 50 | 70 | 100 | 100 | 100 | 100 |
| 0.02 | 0.07 | 2.22 | 0 | 0 | 100 | 100 | 92 | 100 |
| 0.02 | 0.07 | 6.67 | 50 | 90 | 100 | 100 | 100 | 100 |
| 0.02 | 0.07 | 20 | 20 | 70 | 100 | 100 | 100 | 100 |
| 0.02 | 0.2 | 2.22 | 0 | 0 | 100 | 100 | 99 | 100 |
| 0.02 | 0.2 | 6.67 | 50 | 90 | 100 | 100 | 100 | 100 |
| 0.02 | 0.2 | 20 | 50 | 70 | 100 | 100 | 100 | 100 |
| 0.02 | 0.6 | 2.22 | 20 | 20 | 100 | 100 | 100 | 100 |
| 0.02 | 0.6 | 6.67 | 70 | 100 | 100 | 100 | 100 | 100 |
| 0.02 | 0.6 | 20 | 50 | 70 | 100 | 100 | 100 | 100 |

1. A fungicidal composition comprising a mixture of components (A), (B) and (C) as active ingredients, wherein component (A) is a compound selected from:
methyl (Z)-2-(5-cyclobutyl-2-methyl-phenoxy)-3-methoxy-prop-2-enoate (compound X.01),
methyl (Z)-2-(5-cyclopentyl-2-methyl-phenoxy)-3-methoxy-prop-2-enoate (compound X.02),
methyl (Z)-2-(5-cyclopropyl-2-methyl-phenoxy)-3-methoxy-prop-2-enoate (compound X.03), or
methyl (Z)-2-(5-cyclohexyl-2-methyl-phenoxy)-3-methoxy-prop-2-enoate (compound X.04);
or an agronomically acceptable salt thereof,
component (B) is a compound selected from the group consisting of:
bixafen, acibenzolar, acibenzolar-S-methyl, copper sulfate, copper hydroxide, copper oxychloride, copper oxide, cyproconazole, difenoconazole, hexaconazole, prothioconazole, propiconazole, tebuconazole, epoxiconazole, fenpropidin, fenpropimorph, azoxystrobin, dimoxystrobin, trifloxystrobin, picoxystrobin, pyraclostrobin, mancozeb, chlorothalonil, fluazinam, fluxapyroxad, isopyrazam, sedaxane, boscalid, flufenoxadiazam, benzovindiflupyr, pydiflumetofen, isoflucypram, fluindapyr, inpyrfluxam, mefentrifluconazole, florylpicoxamid, metarylpicoxamid and metyltetraprole;
and
component (C) is a compound selected from the group consisting of:
bixafen, fenpyrazamine, copper sulfate, copper hydroxide, triclopyricarb, acibenzolar, acibenzolar-S-methyl, copper oxychloride, copper oxide, azaconazole, bitertanol, bromuconazole, cyproconazole, difenoconazole, diniconazole, epoxiconazole, fenbuconazole, fluquinconazole, flusilazole, flutriafol, furametpyr, hexaconazole, imazalil, imibenconazole, ipconazole, metconazole, myclobutanil, pefurazoate, penconazole, prothioconazole, pyrifenox, prochloraz, propiconazole, pyrisoxazole, simeconazole, tebuconazole, tetraconazole, triadimefon, triadimenol, triflumizole, triticonazole, fenarimol, nuarimol, dodemorph, fenpropidin, fenpropimorph, spiroxamine, tridemorph, boscalid, carboxin, fenfuram, flutolanil, mepronil, oxycarboxin, penthiopyrad, thifluzamide, azoxystrobin, dimoxystrobin, fenaminstrobin, flufenoxystrobin, fluoxastrobin, kresoxim-methyl, metominostrobin, trifloxystrobin, orysastrobin, picoxystrobin, pyraclostrobin, pyrametostrobin, pyraoxystrobin, mancozeb, chlorothalonil, cyclobutrifluram, famoxadone, fenamidone, fluazinam, fluoxytioconazole, fluxapyroxad, fenhexamid, pyribencarb, triforine, isopyrazam, sedaxane, benzovindiflupyr, pydiflumetofen, isoflucypram, fluindapyr, mandestrobin, pyraziflumid, inpyrfluxam, mefentrifluconazole, ipfentrifluconazole, penflufen, florylpicoxamid, metarylpicoxamid, isofetamid, ethyl 1-[[4-[[2-(trifluoromethyl)-1,3-dioxolan-2-yl]methoxy]phenyl]methyl]pyrazole-3-carboxylate, ethyl 1-[[4-[(Z)-2-ethoxy-3,3,3-trifluoro-prop-1-enoxy]phenyl]methyl]pyrazole-3-carboxylate, methyl N-[[4-[1-(4-cyclopropyl-2,6-difluoro-phenyl)pyrazol-4-yl]-2-methyl-phenyl]methyl]carbamate, methyl N-[[4-[1-(2,6-difluoro-4-isopropyl-phenyl)pyrazol-4-yl]-2-methyl-phenyl]methyl]carbamate, fluopyram, flufenoxadiazam, metyltetraprole, enoxastrobin, coumoxystrobin, N′-[5-bromo-2-methyl-6-[(1S)-1-methyl-2-propoxy-ethoxy]-3-pyridyl]-N-ethyl-N-methyl-formamidine, N′-[5-bromo-2-methyl-6-[(1R)-1-methyl-2-propoxy-ethoxy]-3-pyridyl]-N-ethyl-N-methyl-formamidine, N′-[5-bromo-2-methyl-6-(1-methyl-2-propoxy-ethoxy)-3-pyridyl]-N-ethyl-N-methyl-formamidine, N′-[5-chloro-2-methyl-6-(1-methyl-2-propoxy-ethoxy)-3-pyridyl]-N-ethyl-N-methyl-formamidine, N′-[5-bromo-2-methyl-6-(1-methyl-2-propoxy-ethoxy)-3-pyridyl]-N-isopropyl-N-methyl-formamidine, N′-[5-bromo-2-methyl-6-(2-propoxypropoxy)-3-pyridyl]-N-ethyl-N-methyl-formamidine, N-isopropyl-N′-[5-methoxy-2-methyl-4-(2,2,2-trifluoro-1-hydroxy-1-phenyl-ethyl)phenyl]-N-methyl-formamidine, N′-[4-(1-cyclopropyl-2,2,2-trifluoro-1-hydroxy-ethyl)-5-methoxy-2-methyl-phenyl]-N-isopropyl-N-methyl-formamidine, N-ethyl-N′-[5-methoxy-2-methyl-4-[(2-trifluoromethyl)oxetan-2-yl]phenyl]-N-methyl-formamidine, N-ethyl-N′-[5-methoxy-2-methyl-4-[(2-trifluoromethyl)tetrahydrofuran-2-yl]phenyl]-N-methyl-formamidine, N-[(1R)-1-benzyl-3-chloro-1-methyl-but-3-enyl]-8-fluoro-quinoline-3-carboxamide, N-[(1S)-1-benzyl-3-chloro-1-methyl-but-3-enyl]-8-fluoro-quinoline-3-carboxamide, N-[(1R)-1-benzyl-3,3,3-trifluoro-1-methyl-propyl]-8-fluoro-quinoline-3-carboxamide, N-[(1S)-1-benzyl-3,3,3-trifluoro-1-methyl-propyl]-8-fluoro-quinoline-3-carboxamide, N-[(1R)-1-benzyl-1,3-dimethyl-butyl]-7,8-difluoro-quinoline-3-carboxamide,
N-[(1S)-1-benzyl-1,3-dimethyl-butyl]-7,8-difluoro-quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluorophenyl)methyl]-1,3-dimethyl-butyl]quinoline-3-carboxamide, N-[(1R)-1-benzyl-1,3-dimethyl-butyl]-8-fluoro-quinoline-3-carboxamide, N-[(1S)-1-benzyl-1,3-dimethyl-butyl]-8-fluoro-quinoline-3-carboxamide,
N-((1R)-1-benzyl-3-chloro-1-methyl-but-3-enyl)-8-fluoro-quinoline-3-carboxamide, N-((1S)-1-benzyl-3-chloro-1-methyl-but-3-enyl)-8-fluoro-quinoline-3-carboxamide, 1-(6,7-dimethylpyrazolo[1,5-a]pyridin-3-yl)-4,4,5-trifluoro-3,3-dimethyl-isoquinoline, 1-(6,7-dimethylpyrazolo[1,5-a]pyridin-3-yl)-4,4,6-trifluoro-3,3-dimethyl-isoquinoline, 4,4-difluoro-3,3-dimethyl-1-(6-methylpyrazolo[1,5-a]pyridin-3-yl)isoquinoline, 4,4-difluoro-3,3-dimethyl-1-(7-methylpyrazolo[1,5-a]pyridin-3-yl)isoquinoline, 1-(6-chloro-7-methyl-pyrazolo[1,5-a]pyridin-3-yl)-4,4-difluoro-3,3-dimethyl-isoquinoline, 1-(4,5-dimethylbenzimidazol-1-yl)-4,4,5-trifluoro-3,3-dimethyl-isoquinoline, 1-(4,5-dimethylbenzimidazol-1-yl)-4,4-difluoro-3,3-dimethyl-isoquinoline, 6-chloro-4,4-difluoro-3,3-dimethyl-1-(4-methylbenzimidazol-1-yl)isoquinoline, 4,4-difluoro-1-(5-fluoro-4-methyl-benzimidazol-1-yl)-3,3-dimethyl-isoquinoline, 3-(4,4-difluoro-3,3-dimethyl-1-isoquinolyl)-7,8-dihydro-6H-cyclopenta[e]benzimidazole, 2-[6-(4-chlorophenoxy)-2-(trifluoromethyl)-3-pyridyl]-1-(1,2,4-triazol-1-yl)propan-2-ol, 2-[6-(4-bromophenoxy)-2-(trifluoromethyl)-3-pyridyl]-1-(1,2,4-triazol-1-yl)propan-2-ol, 3-[2-(1-chlorocyclopropyl)-3-(2-fluorophenyl)-2-hydroxy-propyl]imidazole-4-carbonitrile, 3-[2-(1-chlorocyclopropyl)-3-(3-chloro-2-fluoro-phenyl)-2-hydroxy-propyl]imidazole-4-carbonitrile, (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone, 2-oxo-N-propyl-2-[4-[5-(trifluoromethyl)-1,2,4-oxadiazol-3-yl]phenyl]acetamide, ethyl 1-[[5-[5-(trifluoromethyl)-1,2,4-oxadiazol-3-yl]-2-thienyl]methyl]pyrazole-4-carboxylate, 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide and N-[N-methoxy-C-methyl-carbonimidoyl]-4-[5-(trifluoromethyl)-1,2,4-oxadiazol-3-yl]benzamide.
with the proviso that component (B) is different from component (C).

2. A fungicidal composition according to claim 1, wherein component (A) is:
methyl (Z)-2-(5-cyclopentyl-2-methyl-phenoxy)-3-methoxy-prop-2-enoate (compound X.02);
or an agronomically acceptable salt thereof.

3. A fungicidal composition according to claim 1, wherein component (A) is:
methyl (Z)-2-(5-cyclohexyl-2-methyl-phenoxy)-3-methoxy-prop-2-enoate (compound X.04);
or an agronomically acceptable salt thereof.

4. A fungicidal composition according to claim 1, wherein component (B) is a compound selected from the group consisting of cyproconazole, difenoconazole, hexaconazole, prothioconazole, propiconazole, tebuconazole, epoxiconazole, fenpropidin, fenpropimorph, mancozeb, chlorothalonil, fluazinam, fluxapyroxad, isopyrazam, flufenoxadiazam, benzovindiflupyr, pydiflumetofen, isoflucypram, fluindapyr, inpyrfluxam, mefentrifluconazole, florylpicoxamid, metarylpicoxamid and metyltetraprole.

5. A fungicidal composition according to claim 1, wherein component (B) is a compound selected from the group consisting of cyproconazole, difenoconazole, hexaconazole, prothioconazole, tebuconazole, fenpropidin, mancozeb, chlorothalonil, benzovindiflupyr and pydiflumetofen.

6. A fungicidal composition according to claim 1, wherein component (C) is a compound selected from the group consisting of bixafen, copper sulfate, copper hydroxide, acibenzolar, acibenzolar-S-methyl, copper oxychloride, copper oxide, cyproconazole, difenoconazole, diniconazole, epoxiconazole, fenbuconazole, fluquinconazole, hexaconazole, imibenconazole, ipconazole, metconazole, penconazole, prothioconazole, propiconazole, pyrisoxazole, simeconazole, tebuconazole, tetraconazole, triticonazole, fenpropidin, fenpropimorph, boscalid, azoxystrobin, dimoxystrobin, trifloxystrobin, picoxystrobin, pyraclostrobin, pyrametostrobin, pyraoxystrobin, mancozeb, chlorothalonil, fluazinam, fluxapyroxad, pyribencarb, isopyrazam, sedaxane, benzovindiflupyr, pydiflumetofen, isoflucypram, fluindapyr, inpyrfluxam, mefentrifluconazole, ipfentrifluconazole, florylpicoxamid, metarylpicoxamid, flufenoxadiazam, metyltetraprole, N-[(1R)-1-benzyl-3-chloro-1-methyl-but-3-enyl]-8-fluoro-quinoline-3-carboxamide, (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone, 2-oxo-N-propyl-2-[4-[5-(trifluoromethyl)-1,2,4-oxadiazol-3-yl]phenyl]acetamide, ethyl 1-[[5-[5-(trifluoromethyl)-1,2,4-oxadiazol-3-yl]-2-thienyl]methyl]pyrazole-4-carboxylate, 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide and N-[N-methoxy-C-methyl-carbonimidoyl]-4-[5-(trifluoromethyl)-1,2,4-oxadiazol-3-yl]benzamide.

7. A fungicidal composition according to claim 1, wherein component (C) is a compound selected from the group consisting of cyproconazole, difenoconazole, hexaconazole, prothioconazole, propiconazole, tebuconazole, epoxiconazole, fenpropidin, fenpropimorph, mancozeb, chlorothalonil, fluazinam, fluxapyroxad, isopyrazam, flufenoxadiazam, benzovindiflupyr, pydiflumetofen, isoflucypram, fluindapyr, inpyrfluxam, mefentrifluconazole, florylpicoxamid, metarylpicoxamid and metyltetraprole.

8. A fungicidal composition according to claim 1, wherein component (C) is a compound selected from the group consisting of cyproconazole, difenoconazole, hexaconazole, prothioconazole, tebuconazole, fenpropidin, mancozeb, chlorothalonil, benzovindiflupyr and pydiflumetofen.

9. A fungicidal composition according to claim 1, wherein component (B) is a compound selected from the group consisting of cyproconazole, difenoconazole, hexaconazole, prothioconazole and tebuconazole; and component (C) is a compound selected from the group consisting of cyproconazole, difenoconazole, hexaconazole, prothioconazole, tebuconazole, fenpropidin, mancozeb, chlorothalonil, benzovindiflupyr and pydiflumetofen.

10. A fungicidal composition according to claim 1, wherein component (B) is the compound difenoconazole or prothioconazole; and component (C) is a compound selected from the group consisting of cyproconazole, tebuconazole, fenpropidin, mancozeb, chlorothalonil, benzovindiflupyr and pydiflumetofen.

11. A fungicidal composition according to claim 1, wherein the weight ratio of (A) to (B+C) is from 2000:1 to 1:1000.

12. A fungicidal composition according to claim 1, wherein the composition further comprises an agriculturally acceptable carrier and, optionally, a surfactant and/or formulation adjuvants.

13. A method of controlling or preventing phytopathogenic diseases, especially phytopathogenic fungi, on useful plants or on propagation material thereof, which comprises applying to the useful plants, the locus thereof or propagation material thereof a fungicidal composition as defined in claim 1.

14. A method according to claim 13, wherein the composition components (A), (B) and (C) are applied in a sequential manner.
